(19) United States
(12) Patent Application Publication
(10) Pub. No.: US 2026/0174147 A1
(43) Pub. Date: Jun. 25, 2026

(54) Heat Not Burn Vaporizer Devices

(71) Applicant: JUUL Labs, Inc., Washington, DC (US)

(72) Inventors: Ariel Atkins, San Francisco, CA (US); Christopher L. Belisle, Somerset, WI (US); Orville F. Buenaventura, San Bruno, CA (US); Brandon Cheung, San Francisco, CA (US); Steven Christensen, Burlingame, CA (US); Andrew S. Harmon, Tulsa, OK (US); Alexander M. Hoopai, San Francisco, CA (US); Eric Joseph Johnson, San Francisco, CA (US); Wayne A. Jordan, Castro Valley, CA (US); Jason King, San Francisco, CA (US); Justine M. Knight-Hawley, San Bruno, CA (US); Joshua A. Kurzman, San Francisco, CA (US); Esteban Leon Duque, Berkeley, CA (US); Kevin Lomeli, San Francisco, CA (US); Johnathan A. Marquez, San Francisco, CA (US); Andrew L. Murphy, San Francisco, CA (US); John R. Pelochino, Portland, OR (US); Jason G. Schray, San Francisco, CA (US); Val Valentine, San Francisco, CA (US); Eric Wu, San Francisco, CA (US); Wing W. Yee, San Francisco, CA (US)

(21) Appl. No.: 19/545,459

(22) Filed: Feb. 20, 2026

Related U.S. Application Data
(63) Continuation of application No. PCT/US24/43607, filed on Aug. 23, 2024.
(60) Provisional application No. 63/534,346, filed on Aug. 23, 2023.
(60) Provisional application No. 63/645,095, filed on May 9, 2024.
(60) Provisional application No. 63/661,527, filed on Jun. 18, 2024.
(60) Provisional application No. 63/684,831, filed on Aug. 19, 2024.

(51) Int. Cl. A24F 40/465; A24F 40/42; A24F 40/51; A24F 40/57; H05B 6/36

(52) U.S. Cl. CPC A24F 40/465; A24F 40/42; A24F 40/51; A24F 40/57; H05B 6/36

(57) ABSTRACT

Vaporizer devices for generating an inhalable aerosol are provided, methods of manufacturing thereof, and cartridges for use therewith are provided. In one aspect, the vaporizer device can include a cartridge that can include a heating element having a first region, a second region, and one or more cut-out regions between the first and second regions; and a vaporizer body having a receptacle configured to insertably receive at least a portion of the cartridge, at least one first inductive coil configured to generate a first magnetic and/or electromagnetic field to heat the first region, at least one second inductive coil configured to generate a second magnetic and/or electromagnetic field to heat the second region, and a controller configured to independently apply power to the at least one first inductive coil and the at least one second inductive coil. Heating assemblies and methods of manufacturing thereof are also provided.

### CROSS REFERENCE TO RELATED APPLICATIONS

This application is a continuation application, filed under 35 U.S.C. 120, of PCT International Patent Application No. PCT/US2024/043607 with an International Filing Date of Aug. 23, 2024, and entitled “Heat Not Burn Vaporizer Devices” which claims the benefit to U.S. Provisional Application No. 63/534,346 filed Aug. 23, 2023, and entitled “HEAT NOT BURN VAPORIZER DEVICES,” to U.S. Provisional Application No. 63/645,095 filed May 9, 2024, and entitled “HEAT NOT BURN VAPORIZER DEVICES,” to U.S. Provisional Application No. 63/661,527 filed Jun. 18, 2024, and entitled “HEAT NOT BURN VAPORIZER DEVICES,” and to U.S. Provisional Application No. 63/684,831 filed Aug. 19, 2024, and entitled “HEAT NOT BURN VAPORIZER DEVICES.” The disclosures of the foregoing applications are incorporated herein by reference in their entirety.

### TECHNICAL FIELD

The subject matter described herein relates to vaporizer devices, including vaporizer devices comprising a vaporizer body configured to heat a cartridge containing vaporizable material.

### BACKGROUND

Vaporizer devices, which can also be referred to as vaporizers, electronic vaporizer devices, or e-vaporizer devices, can be used for delivery of an aerosol (for example, a gas-phase and/or a condensed-phase material suspended in a stationary or moving mass of air or some other gas carrier) containing one or more active ingredients by inhalation of the aerosol by a user of the vaporizer device. For example, electronic nicotine delivery systems (ENDS) include a class of vaporizer devices that are battery powered and that can be used to simulate the experience of smoking, but without burning of tobacco or other substances. Vaporizer devices are gaining increasing popularity both for prescriptive medical use, in delivering medicaments, and for consumption of tobacco, nicotine, and other plant-based materials. Vaporizer devices can be portable, self-contained, and/or convenient for use.

In use of a vaporizer device, the user inhales an aerosol, colloquially referred to as “vapor,” which can be generated by a heating element that vaporizes (e.g., causes a liquid or solid to at least partially transition to the gas phase) a vaporizable material, which can be liquid, a solution, a solid, a paste, a wax, and/or any other form compatible for use with a specific vaporizer device. The vaporizable material used with a vaporizer device can be provided within a cartridge (e.g., a separable part of the vaporizer device that contains vaporizable material) that includes an outlet (e.g., a mouthpiece or an outlet in fluid communication with a mouthpiece) for inhalation of the aerosol by a user.

To receive an inhalable aerosol generated by a vaporizer device, a user can, in certain examples, activate the vaporizer device by taking a puff, by pressing a button, and/or by some other approach. A puff as used herein can refer to inhalation by the user in a manner that causes a volume of air to be drawn into the vaporizer device such that the inhalable aerosol is generated by a combination of vaporized material (e.g., gas-phase material) with the volume of air.

An approach by which a vaporizer device generates an inhalable aerosol from a vaporizable material involves heating the vaporizable material (e.g., within a cartridge, an insert, a vaporization chamber, a heater chamber, an oven, and/or a compartment associated with a heating element) to cause at least a portion of the vaporizable material to be converted to vaporized material (e.g., gas-phase material). A vaporization chamber, heater chamber, oven, or the like can refer to an area or volume in the vaporizer device within which a heat source (for example, a conductive, convective, and/or radiative heat source) causes heating of a vaporizable material to produce a vaporized material and allow the vaporized material to mix with air to form an aerosol for inhalation by a user of the vaporizer device.

Vaporizer devices can be controlled by one or more controllers, electronic circuits (for example, sensors, heating elements, buttons, switches), and/or the like on or in the vaporizer device. Vaporizer devices can also wirelessly communicate with an external controller (e.g., a computing device such as a personal computer or smartphone).

In some implementations, cartridges that contain solid vaporizable material (e.g., comprising plant material such as tobacco leaves and/or parts of tobacco leaves) must be heated to undesirably high temperatures in order to cause inner regions of the vaporizable material to be heated to a minimum temperature required for vaporization. As a result, portions of the solid vaporizable material contained within a cartridge can burn or char at these high temperatures and produce combustion or partial combustion byproducts (e.g., chemical elements or chemical compounds) that can have undesirable characteristics, such as unpleasant smells or tastes, negative health impacts, etc. Furthermore, uniform heating of the vaporizable material in current conduction-based vaporizers may be difficult to achieve due to the low thermal conductivity of certain vaporizable materials (e.g., plant materials, such as tobacco). Accordingly, controlled and even distribution of heat is desirable in such devices.

Some issues with current vaporizer devices include the inability to efficiently and effectively heat the vaporizable material without wasting a significant amount of energy. For example, some vaporizer devices include a heater body surrounding a tobacco consumable, requiring the entire heater body to be heated to create an oven. Such a configuration requires additional energy to maintain a sufficiently high temperature in an area that is exposed to the airstream, thereby losing at least a portion of thermal energy produced by the heater that could have been used to heat the tobacco material. As such, energy can be wasted as the generated heat is not effectively utilized.

Vaporizer devices configured to embed some or part of a heater apparatus inside of the tobacco material can include airflow passing through the tobacco material thereby prohibiting tight tobacco compaction around the heater, thus diminishing heat transfer from the heater to the tobacco material. Furthermore, vaporizer devices with a heater element embedded within or at least partially surrounded by the tobacco can also experience cleaning and hygiene issues. For example, as the heater pierces the tobacco, residue can be left on the heater element after use, thereby requiring the user to clean the heater element before continued use.

### SUMMARY

Aspects of the current subject matter relate to vaporizer devices including various implementation of a vaporizer body and/or cartridge of vaporizable material configured to generate an inhalable aerosol. For purposes of summarizing, certain aspects, advantages, and novel features have been described herein. It is to be understood that not all such advantages can be achieved in accordance with any one particular implementation. Thus, the disclosed subject matter can be implemented, embodied, or carried out in a manner that achieves or optimizes one advantage or group of advantages without achieving all advantages as taught or suggested herein. The various features and items described herein can be incorporated together or separable, except as would not be feasible based on the current disclosure and what a skilled artisan would understand from it.

In various implementations, a vaporizer device for generating an inhalable aerosol is disclosed. The vaporizer device includes a cartridge and a vaporizer body. The cartridge extends from a first cartridge end to a second cartridge end. The cartridge includes a wrapper, a heating element. The wrapper is configured to hold a vaporizable material disposed therein. The heating element includes an infrared reflective material configured to heat the vaporizable material and reflect heat towards the vaporizable material to generate a vapor. The vaporizer body includes a receptacle and at least one inductor proximate the receptacle. The receptacle is configured to insertably receive at least a portion of the cartridge, and the at least one inductor is configured to generate a magnetic and/or electromagnetic field to heat the heating element.

In some implementations, the infrared reflective material can be disposed on a portion of an outer surface of the wrapper. In certain implementations, the portion of the outer surface can extend from the first cartridge end towards the second cartridge end. In other implementations, the portion of the outer surface can extend towards the second cartridge end, from a location that is spaced apart at a distance from the first cartridge end.

In some implementations, the infrared reflective material can be disposed about and extend along at least a portion of an outer perimeter of the wrapper. In certain implementations, the infrared reflective material can be disposed entirely on an outer surface of the wrapper.

In some implementations, the infrared reflective material can include a plasma vapor deposition (PVD) material.

In some implementations, the infrared reflective material can include gold, chrome, aluminum, silver, nickel, copper, or any combination thereof.

In some implementations, the infrared reflective material can have an emissivity of thermal radiation from about 0% to about 35%.

In some implementations, the infrared reflective material can have a thickness from about 10 nm to about 40 microns. In certain implementations, the infrared reflective material can have a thickness from about 10 nm to about 200 nanometers. In other implementations, the infrared reflective material can have a thickness from about 20 microns to about 35 microns. In yet other implementations, the infrared reflective material can have a thickness from about 500 nm to about 2 microns.

In some implementations, the vaporizer body can include a frame that defines the receptacle, in which, when the cartridge is at least partially inserted into the receptacle, an outer surface of the cartridge is spaced a distance from an inner surface of the frame, the distance being generally uniform thereby creating a generally uniform gap between the outer surface of the cartridge and the inner surface of the frame. In certain implementations, air can be present within the generally uniform gap.

In some implementations, the vaporizer body can include a frame that defines the receptacle, in which, when the cartridge is at least partially inserted into the receptacle, an outer surface of the cartridge is spaced two or more distances from an inner surface of the frame, the two or more distances being different from each other thereby creating a variable gap between the outer surface of cartridge and the inner surface of the frame. In certain implementations, the two or more distances can include a first distance and a second distance, in which the first distance is greater than the second distance. In some implementations, the first distance can be from about 10% to 3000% greater than the second distance. In some implementations, air can present within the variable gap.

In some implementations, the at least one inductor can include a first helical coil and a second helical coil. In certain implementations, the first helical coil and the second helical coil can be disposed proximate opposing ends of the receptacle. In some implementations, the first helical coil can be configured to surround a first region of the receptacle and the second helical coil can be configured to surround a second region of the receptacle. In certain implementations, the first helical coil and the second helical coil can be configured to operate independently to respectively heat a first region of the heating element and a second region of the heating element at different temperatures.

In some implementations, the heating element can be configured to generate the heat via eddy currents.

In some implementations, the vaporizer body can include a controller configured to operate the at least one inductor at a low frequency of 200 kHz to 600 kHz.

In some implementations, the vaporizer body can include a controller configured to operate the at least one inductor at a high frequency of 1 MHz to 50 MHz.

In some implementations, the vaporizer device can include one or more inserts. In certain implementations, the one or more inserts can include a first insert positioned proximal to the first cartridge end, the first insert configured to allow air to into and at least partially through the cartridge. In some implementations, the one or more inserts can include a second insert positioned proximal to the second cartridge end, the second insert configured to allow egress of vapor from the cartridge.

In some implementations, the cartridge can include a divider having a first surface and an opposing, second surface, in which the divider includes a body extending between the first and second surfaces of the divider. The body can include at least one through-hole extending from the first surface to the second surface of the body. In certain implementations, the at least one through-hole is positioned at or proximate to a center region of the body. In some implementations, the body can include one or more conduits configured to allow air to pass therethrough. In such implementations, the divider can include at least one seal that can be positioned proximate to the one or more conduits. In certain implementations, the at least one seal can extend outward from the body of the divider.

In some implementations where the cartridge includes the divider, the cartridge can include another infrared reflective material that can be positioned on the first surface of the divider.

In some implementations where the cartridge includes the divider, the cartridge can include another infrared reflective material on the second surface of the divider.

In some implementations where the cartridge includes the divider, the body can have a corrugated configuration.

In some implementations where the cartridge includes the divider, the body can include a base with a first base surface and an opposing, second base surface; a first rib extending outward from the first surface of the base in a first direction; and a second rib extending outward from the second surface in a second direction. In such implementations, the first rib can define at least a portion of a perimeter of the base, and the second rib can define the same or different portion of the perimeter of the base.

In some implementations where the cartridge includes the divider, the divider can have a H-shaped cross-section.

In some implementations where the cartridge includes the divider, the divider can include one or more perforated layers coupled to the body. In certain implementations, the one or more perforated layers can include paper, aluminum, or a combination thereof. In some implementations, the one or more perforated layers can include a first perforated layer positioned on a bottom surface of the body. In some implementations, the one or more perforated layers can include a second perforated layer positioned on a top surface of the body. In some implementations, the divider can include a layer positioned on a top surface of the body, the layer having at least one through-hole extending therethrough.

In some implementations, the wrapper can include a substrate, in which the infrared reflective material is disposed on at least one surface of the substrate, and the substrate is rolled into a plurality of rolls. In such implementations, the cartridge can include a conductive material interposed between the wrapper and the infrared reflective material, in which the conductive material is configured to create an electrical connection between the plurality of rolls. In certain implementations, the wrapper can include one or more punctures configured to create an electrical connection between the plurality of rolls.

In some implementations, the heating element can be printed onto at least a portion of the wrapper.

In some implementations, the cartridge can include an adhesive at least between the heating element and the wrapper. In such implementations, the infrared reflective material is in the form of particles.

In some implementations, the cartridge can include a tipping layer positioned at or proximate to the second cartridge end. In certain implementations, the tipping layer can dispose about a portion of the infrared reflective material.

In some implementations, the cartridge can include a barrier layer disposed on at least a portion of an inner surface of the wrapper, the barrier layer configured to inhibit moisture ingress into the wrapper.

In some implementations, the device can include a frame defining the receptacle, in which the frame includes a base and at least one side wall extending therefrom. In certain implementations, the vaporizer body can include a plurality of first protrusions extending from the at least one side wall and toward the receptacle, the plurality of first protrusions positioned distal from the base of the frame. In such implementations, the device can include a plurality of second protrusions extending from the base toward the receptacle. In such implementations, at least one second protrusion of the second plurality of protrusions extends along the at least one sidewall of the frame. In some implementations, when the cartridge is inserted into the receptacle, the first cartridge end can engage with the at least one second protrusion such that the first cartridge end is spaced a distance from the base end of the frame. In some implementations, at least two second protrusions of the second plurality of protrusions can form a channel therebetween, and the channel is configured to direct airflow toward the base end thereby allowing air present within the receptacle to enter the cartridge through the first cartridge end.

In some implementations, the cartridge can include one or more bypass air inlets. In certain implementations, the one or more bypass air inlets can be positioned proximate to the divider.

In some implementations, the heating element can include a top region, a bottom region, and one or more cut-out regions between the top region and the bottom region. In some implementations, the one or more cut-out regions can include a first cut-out region defined within a first side of the heating element, and a second cut-out region defined with a second, opposing side of the heating element.

In various implementations, a vaporizer device for generating an inhalable aerosol is disclosed. The vaporizer device includes a cartridge extending from a first cartridge end to a second cartridge end and a vaporizer body. The cartridge includes a wrapper configured to hold a vaporizable material disposed therein, a heating element that includes a susceptor configured to heat the vaporizable material, and an infrared reflective material configured to reflect heat towards the vaporizable material to generate the vapor. The vaporizer body includes a receptacle and at least one inductor proximate the receptacle. The receptacle is configured to insertably receive at least a portion of the cartridge. The at least one inductor is configured to generate a magnetic and/or electromagnetic field to heat the heating element.

In some implementations, the susceptor can be disposed on at least a portion of an inner surface of the wrapper. In other implementations, the susceptor can abut at least a portion of an inner surface of the wrapper.

In some implementations, the infrared reflective material can be disposed on a portion of an outer surface of the wrapper. In certain implementations, the infrared reflective material can surround at least a portion of the heating element. In some implementations, the portion of the outer surface can extend from the first cartridge end towards the second cartridge end. In other implementations, the portion of the outer surface can extend towards the second cartridge end, from a location that is spaced apart at a distance from the first cartridge end.

In some implementations, the infrared reflective material can be disposed about and extends along at least a portion of an outer perimeter of the wrapper. In certain implementations, the infrared reflective material can be disposed entirely on an outer surface of the wrapper.

In some implementations, the infrared reflective material can be disposed on a portion of an outer surface of the wrapper, and the susceptor can be disposed about an outer surface of the infrared reflective material.

In some implementations, the infrared reflective material can include a plasma vapor deposition (PVD) material.

In some implementations, the infrared reflective material can include gold, chrome, aluminum, silver, nickel, copper, or any combination thereof.

In some implementations, the infrared reflective material can have an emissivity of thermal radiation from about 0% to about 35%.

In some implementations, the infrared reflective material can have a thickness from about 10 nm to about 200 nm.

In some implementations, the vaporizer body can include a frame that defines the receptacle, in which, when the cartridge is at least partially inserted into the receptacle, an outer surface of the cartridge is spaced a distance from an inner surface of the frame, the distance being generally uniform thereby creating a generally uniform gap between the outer surface of the cartridge and the inner surface of the frame. In certain implementations, air can be present within the generally uniform gap.

In some implementations, the vaporizer body can include a frame that defines the receptacle, in which, when the cartridge is at least partially inserted into the receptacle, an outer surface of the cartridge is spaced two or more distances from an inner surface of the frame, the two or more distances being different from each other thereby creating a variable gap between the outer surface of cartridge and the inner surface of the frame. In certain implementations, the two or more distances can include a first distance and a second distance, in which the first distance is greater than the second distance. In some implementations, the first distance can be from about 10% to 3000% greater than the second distance. In some implementations, air can be present within the variable gap.

In some implementations, the at least one inductor can include a first helical coil and a second helical coil. In certain implementations, the first helical coil and the second helical coil can be disposed proximate opposing ends of the receptacle. In some implementations, the first helical coil can be configured to surround a first region of the receptacle and the second helical coil can be configured to surround a second region of the receptacle. In certain implementations, the first helical coil and the second helical coil can be configured to operate independently to respectively heat a first region of the heating element and a second region of the heating element at different temperatures.

In some implementations, the heating element can be configured to generate the heat via eddy currents.

In some implementations, the vaporizer body can include a controller configured to operate the at least one inductor at a low frequency of 200 kHz to 600 kHz.

In some implementations, the vaporizer device can include one or more inserts. In certain implementations, the one or more inserts can include a first insert positioned proximal to the first cartridge end, the first insert configured to allow air to into and at least partially through the cartridge. In some implementations, the one or more inserts can include a second insert positioned proximal to the second cartridge end, the second insert configured to allow egress of vapor from the cartridge.

In some implementations, the cartridge can include a divider having a first surface and an opposing, second surface, in which the divider includes a body extending between the first and second surfaces of the divider. The body can include at least one through-hole extending from the first surface to the second surface of the body. In certain implementations, the at least one through-hole is positioned at or proximate to a center region of the body. In some implementations, the body can include one or more conduits configured to allow air to pass therethrough. In such implementations, the divider can include at least one seal that can be positioned proximate to the one or more conduits. In certain implementations, the at least one seal can extend outward from the body of the divider.

In some implementations where the cartridge includes the divider, the cartridge can include another infrared reflective material positioned on the first surface of the divider.

In some implementations where the cartridge includes the divider, the cartridge can include another infrared reflective material on the second surface of the divider.

In some implementations where the cartridge includes the divider, the body can have a corrugated configuration.

In some implementations where the cartridge includes the divider, the body can include a base with a first base surface and an opposing, second base surface; a first rib extending outward from the first surface of the base in a first direction; and a second rib extending outward from the second surface in a second direction. In such implementations, the first rib can define at least a portion of a perimeter of the base, and the second rib can define the same or different portion of the perimeter of the base.

In some implementations where the cartridge includes the divider, the divider can have a H-shaped cross-section.

In some implementations where the cartridge includes the divider, the divider can include a perforated layer coupled to the body. In certain implementation, the perforated layer can include paper or aluminum, or a combination thereof.

In some implementations, the cartridge can include a tipping layer positioned proximate to the second cartridge end. In certain implementations, the tipping layer can be disposed about a portion of the infrared reflective material.

In some implementations, the cartridge can include a barrier layer disposed on at least a portion of an inner surface of the wrapper, the barrier layer being configured to inhibit moisture ingress into the wrapper.

In some implementations, the device can include a frame defining the receptacle, wherein the frame comprises a base and at least one side wall extending therefrom. In certain implementations, the vaporizer body can include a plurality of first protrusions extending from the at least one side wall and toward the receptacle, the plurality of first protrusions positioned distal from the base of the frame. In such implementations, the device can include a plurality of second protrusions extending from the base toward the receptacle. In such implementations, at least one second protrusion of the plurality of second protrusions extends along the at least one sidewall of the frame. In some implementations, when the cartridge is inserted into the receptacle, the first cartridge end can engage with the at least one second protrusion such that the first cartridge end is spaced a distance from the base end of the frame. In some implementations, at least two second protrusions of the plurality of second protrusions can form a channel therebetween, and the channel is configured to direct airflow toward the base end thereby allowing air present within the receptacle to enter the cartridge through the first cartridge end.

In some implementations, the cartridge can include one or more bypass air inlets. In certain implementations, the one or more bypass air inlets can be positioned proximate to the divider.

In some implementations, the heating element can include a top region, a bottom region, and one or more cut-out regions between the top region and the bottom region. In certain implementations, the one or more cut-out regions can include a first cut-out region defined within a first side of the heating element, and a second cut-out region defined with a second, opposing side of the heating element.

In various implementations, a vaporizer device for generating an inhalable aerosol is disclosed. The vaporizer device includes a cartridge extending from a first cartridge end to a second cartridge end, and a vaporizer body. The cartridge includes a wrapper configured to hold a vaporizable material disposed therein, and a heating element comprising a susceptor configured to heat the vaporizable material. The vaporizer body includes a frame that defines a receptacle and at least one inductor proximate the receptacle, and an infrared reflective material configured to reflect heat towards the vaporizable material to generate the vapor. The receptacle is configured to insertably receive at least a portion of the cartridge, and the at least one inductor configured to generate a magnetic and/or electromagnetic field to heat the heating element.

In some implementations, the infrared reflective material can be disposed on at least a portion of an inner surface of the frame.

In some implementations, the infrared reflective material can at least partially surround the heating element when the cartridge is insertably received within the receptacle.

In some implementations, the susceptor can be disposed on at least a portion of an inner surface of the wrapper.

In some implementations, the infrared reflective material can include a plasma vapor deposition (PVD) material.

In some implementations, the infrared reflective material can include gold, chrome, aluminum, silver, nickel, copper, or any combination thereof.

In some implementations, the infrared reflective material can have an emissivity of thermal radiation from about 0% to about 35%.

In some implementations, the infrared reflective material can have a thickness from about 10 nm to about 200 nm.

In some implementations, when the cartridge is at least partially inserted into the receptacle, an outer surface of the cartridge can be spaced a distance from an inner surface of the frame, the distance being generally uniform thereby creating a generally uniform gap between the outer surface of the cartridge and the inner surface of the frame. In some implementations, air can be present within the generally uniform gap.

In some implementations, when the cartridge is at least partially inserted into the receptacle, an outer surface of the cartridge can be spaced two or more distances from an inner surface of the frame, the two or more distances being different from each other thereby creating a variable gap between the outer surface of cartridge and the inner surface of the frame. In certain implementations, the two or more distances can include a first distance and a second distance, wherein the first distance is greater than the second distance. In some implementations, the first distance can be from about 10% to 3000% greater than the second distance. In some implementations, air can be present within the variable gap.

In some implementations, the at least one inductor can include a first helical coil and a second helical coil. In certain implementations, the first helical coil and the second helical coil can be disposed proximate opposing ends of the receptacle. In some implementations, the first helical coil can be configured to surround a first region of the receptacle and the second helical coil can be configured to surround a second region of the receptacle. In some implementations, the first helical coil and the second helical coil can be configured to operate independently to respectively heat a first region of the heating element and a second region of the heating element at different temperatures.

In some implementations, the heating element can be configured to generate the heat via eddy currents.

In some implementations, the vaporizer body can include a controller configured to operate the at least one inductor at a low frequency of 200 kHz to 600 kHz.

In some implementations, the vaporizer body can include a controller configured to operate the at least one inductor at a high frequency of 1 mHz to 50 mHz.

In some implementations, the vaporizer device can include one or more inserts.

In certain implementations, the one or more inserts can include a first insert positioned proximal to the first cartridge end, the first insert configured to allow air to into and at least partially through the cartridge. In some implementations, the one or more inserts can include a second insert positioned proximal to the second cartridge end, the second insert configured to allow egress of vapor from the cartridge.

In some implementations, the cartridge can include a divider having a first surface and an opposing, second surface, in which the divider includes a body extending between the first and second surfaces of the divider. The body can include at least one through-hole extending from the first surface to the second surface of the body. In certain implementations, the at least one through-hole can be positioned at or proximate to a center region of the body. In some implementations, the body can include one or more conduits configured to allow air to pass therethrough. In such implementations, the divider can include at least one seal positioned proximate to the one or more conduits. In certain implementations, the at least one seal can extend outward from the body of the divider.

In some implementations where the cartridge includes the divider, the cartridge can include an infrared reflective material positioned on the first surface of the divider.

In some implementations where the cartridge includes the divider, the cartridge can include another infrared reflective material on the second surface of the divider.

In some implementations where the cartridge includes the divider, the body can have a corrugated configuration.

In some implementations where the cartridge includes the divider, the body can include a base with a first base surface and an opposing, second base surface; a first rib extending outward from the first surface of the base in a first direction; and a second rib extending outward from the second surface in a second direction. In such implementations, the first rib can define at least a portion of a perimeter of the base, and the second rib can define the same or different portion of the perimeter of the base.

In some implementations where the cartridge includes the divider, the divider can have a H-shaped cross-section.

In some implementations where the cartridge includes the divider, the divider can include a perforated layer coupled to the body. In certain implementations, the perforated layer can include paper or aluminum, or a combination thereof.

In some implementations, the cartridge can include a barrier layer disposed on at least a portion of an inner surface of the wrapper, the barrier layer configured to inhibit moisture ingress into the wrapper.

In some implementations, the frame can include a base and at least one side wall extending therefrom. In such implementation, the vaporizer body can include a plurality of first protrusions extending from the at least one side wall and toward the receptacle, the plurality of first protrusions positioned distal from the base of the frame. In such implementations, the device can include a plurality of second protrusions extending from the base toward the receptacle. In such implementations, at least one second protrusion of the plurality of second protrusions extends along the at least one sidewall of the frame. In such implementations, when the cartridge is inserted into the receptacle, the first cartridge end can engage with the second protrusions such that the first cartridge end is spaced a distance from the base end of the frame. In some implementations, at least two second protrusions of the plurality of second protrusions can form a channel therebetween, and the channel is configured to direct airflow toward the base end thereby allowing air present within the receptacle to enter the cartridge through the first cartridge end.

In some implementations, the cartridge can include one or more bypass air inlets. In certain implementations, the one or more bypass air inlets can be positioned proximate to the divider.

In some implementations, the heating element can include a top region, a bottom region, and one or more cut-out regions between the top region and the bottom region. In certain implementations, the one or more cut-out regions can include a first cut-out region defined within a first side of the heating element, and a second cut-out region defined with a second, opposing side of the heating element.

In various implementations, a vaporizer device for generating an inhalable aerosol is disclosed. The vaporizer device includes a cartridge extending from a first cartridge end to a second cartridge end, and a vaporizer body. The cartridge includes a wrapper configured to hold a vaporizable material disposed therein, a heating element configured to heat the vaporizable material. The vaporizer body includes a frame that defines a receptacle and at least one inductor proximate the receptacle. The receptacle is configured to insertably receive at least a portion of the cartridge. The at least one inductor is configured to generate a magnetic and/or electromagnetic field to heat the heating element. When the cartridge is at least partially inserted into the receptacle, an outer surface of the cartridge is spaced two or more distances from an inner surface of the frame, the two or more distances being different from each other thereby creating a variable gap between the outer surface of cartridge and the inner surface of the frame.

In some implementations, the two or more distances can include a first distance and a second distance, wherein the first distance is greater than the second distance. In certain implementations, the first distance can be from about 10% to 3000% greater than the second distance.

In some implementations, air can be present within the variable gap.

In some implementations, the at least one inductor can include a first helical coil and a second helical coil. In certain implementations, the first helical coil and the second helical coil can be disposed proximate opposing ends of the receptacle. In some implementations, the first helical coil can be configured to surround a first region of the receptacle and the second helical coil can be configured to surround a second region of the receptacle. In certain implementations, the first helical coil and the second helical coil can be configured to operate independently to respectively heat a first region of the heating element and a second region of the heating element at different temperatures.

In some implementations, the heating element can be configured to generate the heat via eddy currents.

In some implementations, the vaporizer body can include a controller configured to operate the at least one inductor at a low frequency of 200 kHz to 600 kHz.

In some implementations, the vaporizer body can include a controller configured to operate the at least one inductor at a high frequency of 1 mHz to 50 mHz.

In some implementations, the vaporizer device can include one or more inserts. In certain implementations, the one or more inserts can include a first insert positioned proximal to the first cartridge end, the first insert configured to allow air to into and at least partially through the cartridge. In some implementations, the one or more inserts can include a second insert positioned proximal to the second cartridge end, the second insert configured to allow egress of vapor from the cartridge.

In some implementations, the cartridge can include a divider having a first surface and an opposing, second surface, in which the divider includes a body extending between the first and second surfaces of the divider. The body can include at least one through-hole extending from the first surface to the second surface of the body. In certain implementations, the at least one through-hole can be positioned at or proximate to a center region of the body. In some implementations, the body can include one or more conduits configured to allow air to pass therethrough. In such implementations, the divider can include at least one seal positioned proximate to the one or more conduits. In such implementations, the at least one seal extends outward from the body of the divider.

In some implementations where the cartridge includes the divider, the cartridge can include an infrared reflective material positioned on the first surface of the divider.

In some implementations where the cartridge includes the divider, the cartridge can include another infrared reflective material on the second surface of the divider.

In some implementations where the cartridge includes the divider, the body can have a corrugated configuration. In some implementations where the cartridge includes the divider, the body can have a base with a first base surface and an opposing, second base surface; a first rib extending outward from the first surface of the base in a first direction; and a second rib extending outward from the second surface in a second direction. In such implementations, the first rib can define at least a portion of a perimeter of the base, and the second rib can define the same or different portion of the perimeter of the base.

In some implementations where the cartridge includes the divider, the divider can have a H-shaped cross-section.

In some implementations where the cartridge includes the divider, the divider can include a perforated layer coupled to the body. In such implementations, the perforated layer can include paper or aluminum, or a combination thereof.

In some implementations, the wrapper can include a substrate, the infrared reflective material being disposed on at least one surface of the substrate, and the substrate is rolled into a plurality of rolls. In such implementations, the cartridge can include a conductive material interposed between the wrapper and the infrared reflective material, the conductive material configured to create an electrical connection between the plurality of rolls. In certain implementations, the wrapper can further include one or more punctures configured to create an electrical connection between the plurality of rolls.

In some implementations, the heating element can be printed onto at least a portion of the wrapper.

In some implementations, the cartridge can include an adhesive at least between the heating element and the wrapper. In such implementations, the infrared reflective material can be in the form of particles.

In some implementations, the cartridge can include a tipping layer positioned at or proximate to the second cartridge end. In such implementations, the tipping layer can be disposed about a portion of the heating element.

In some implementations, the cartridge can include a barrier layer disposed on at least a portion of an inner surface of the wrapper, the barrier layer configured to inhibit moisture ingress into the wrapper.

In some implementations, the frame can include a base and at least one side wall extending therefrom. In such implementations, the vaporizer body can include a plurality of first protrusions extending from the at least one side wall and toward the receptacle, the plurality of first protrusions positioned distal from the base of the frame. In such implementations, the device can include a plurality of second protrusions extending from the base toward the receptacle. In such implementations, at least one second protrusion of the plurality of second protrusions extends along the at least one sidewall of the frame. In such implementations, when the cartridge is inserted into the receptacle, the first cartridge end engages with the at least one second protrusion such that the first cartridge end is spaced a distance from the base end of the frame. In some implementations, at least two second protrusions from the plurality of second protrusions can form a channel therebetween, and the channel is configured to direct airflow toward the base end thereby allowing air present within the receptacle to enter the cartridge through the first cartridge end.

In some implementations, the cartridge can include one or more bypass air inlets. In such implementations, the one or more bypass air inlets can be positioned proximate to the divider.

In some implementations, the heating element can include a top region, a bottom region, and one or more cut-out regions between the top region and the bottom region. In such implementations, the one or more cut-out regions can include a first cut-out region defined within a first side of the heating element, and a second cut-out region defined with a second, opposing side of the heating element.

In some implementations, the cartridge can include an oblong configuration.

In some implementations, the at least one inductor can include an inductive material on a flexible substrate. In such implementations, the at least one inductor can include an inductive material etched on a printing circuit board. In such implementations, the inductive material can include copper.

In some implementations, the vaporizer body can include one or more sensors configured to detect an external magnetic field relative to the vaporizer device.

In various implementations, a vaporizer device for generating an inhalable aerosol is disclosed. The vaporizer device can include vaporizer body. The vaporizer body includes a frame, a first inductor, and a first flux concentrator. The frame defines a receptacle configured to insertably receive at least a portion of a cartridge, the frame having a first region, a second region, and a third region positioned between the first and second regions. The first inductor is proximate the receptacle, the first inductor configured to generate a first magnetic and/or electromagnetic field to heat a heating element of the cartridge. The first flux concentrator includes a first segment, a second segment, and a third segment. The first segment is positioned on an outer surface of the first inductor, the first segment configured to direct the first field towards the receptacle. The second segment is positioned on an outer surface of the first region of the frame, the second segment configured to direct the first field away from the receptacle such that the first field is inhibited from penetrating through the first region of the frame. The third segment is positioned on an outer surface of the second region of the frame, the third segment configured to direct the first field away from the receptacle such that the first field is inhibited from penetrating through the second region of the frame. In response to the generation of first field, the first flux concentrator directs the first field to the third region of the frame such that the first field penetrates through the third region of the frame and into the receptacle.

In some implementations, the first segment can have a C-shaped cross-section.

In some implementations, the frame can include a fourth region, a fifth region, and a sixth region positioned between the fourth and the fifth regions. In such implementations, the vaporizer device includes a second inductor proximate the receptacle and a second flux concentrator. The second inductor is configured to generate a second magnetic and/or electromagnetic field to heat the heating element of the cartridge. The second flux concentrator includes a fourth segment positioned on an outer surface of the second inductor, the fourth segment configured to direct the second field towards the receptacle; a fifth segment positioned on an outer surface of the fourth region of the frame, the fifth segment configured to direct the second field away from the receptacle such that the second field is inhibited from penetrating through the fourth region of the frame; and a sixth segment positioned on an outer surface of the fifth region of the frame, the sixth segment configured to direct the second field away from the receptacle such that the second field is inhibited from penetrating through the fifth region of the frame, in which, in response to the generation of second field, the second flux concentrator directs the second field to the sixth region of the frame such that the second field penetrates through the sixth region of the frame and into the receptacle. In such implementations, the fourth segment can have a C-shaped cross-section. In some implementations, the second inductor can be an inductive coil. In some implementations, the second flux concentrator can include a third intermediate segment extending from the fourth segment inward to the fifth segment, the third intermediate segment configured to direct the second field towards the receptacle. In such implementations, the second flux concentrator can include a fourth intermediate segment extending from the fourth segment inward to the sixth segment, the fourth intermediate segment configured to direct the second field towards the receptacle.

In some implementations, the frame and at least the first inductor can be spaced a distance apart thereby defining a first gap extending therebetween. In some implementations, the frame and the second inductor can be spaced a distance apart thereby further defining a second gap extending therebetween. In certain implementations, air can be present within at least one of the first gap or the second gap. In some implementations, the vaporizer device can include an insulative material disposed within at least one of the first gap or the second gap.

In some implementations, the first inductor can be an inductive coil.

In some implementations, the vaporizer device can include the cartridge, where the cartridge can include a heating element. The heating element includes an infrared reflective material configured to heat vaporizable material disposed within the cartridge and reflect heat towards the vaporizable material to generate the vapor.

In some implementations, the vaporizer device can include the cartridge, where the cartridge can include a heating element. The heating element can include a susceptor and an infrared reflective material. The susceptor is configured to heat vaporizable material disposed within the cartridge. The infrared reflective material is configured to heat the vaporizable material and reflect heat towards the vaporizable material to generate the vapor.

In some implementations, the cartridge can include one or more inserts.

In some implementations, the cartridge can include a divider.

In some implementations, the first flux concentrator can include a first intermediate segment extending from the first segment inward to the second segment, the first intermediate segment configured to direct the first field towards the receptacle. In such implementations, the second flux concentrator can include a second intermediate segment extending from the first segment inward to the third segment, the second intermediate segment configured to direct the first field towards the receptacle.

In some implementations, the vaporizer body can include one or more sensors configured to detect an external magnetic field relative to the vaporizer device.

In various implementations, a vaporizer device for generating an inhalable aerosol is disclosed. The vaporizer device includes a vaporizer body. The vaporizer body includes a frame that defines a receptacle configured to insertably receive at least a portion of the cartridge, a first inductor proximate the receptacle, the first inductor configured to generate a first magnetic and/or electromagnetic field to heat a heating element of the cartridge, and a first flux concentrator. The first flux concentrator includes a first segment, a second segment, and a third segment. The first segment is positioned on an outer surface of the first inductor, the first segment configured to direct the first field towards the receptacle, the first segment having a first end, a second, opposing end, and a longitudinal axis extending therebetween. The second segment extends from the first segment and toward the receptacle, the second segment configured to direct the first field toward the receptacle. The third segment extends from the first segment and toward the receptacle, the third segment configured to direct the first field toward the receptacle. In response to the generation of first field, the first flux concentrator directs the first field to the frame such that the first field penetrates through the frame and into the receptacle.

In some implementations, the first flux concentrator can have a C-shaped cross-section.

In some implementations, the first flux concentrator can include a first angled segment extending from the second segment towards the receptacle, the first angled segment configured to direct the first field toward the receptacle, and the first angled segment extends in a direction that is orthogonal to the longitudinal axis of the first segment.

In some implementations, the first flux concentrator can include a first angled segment extending from the second segment towards the receptacle, the first angled segment configured to direct the first field toward the receptacle, and the first angled segment extends in a direction that is greater than 90 degrees relative to the longitudinal axis of the first segment.

In some implementations, the first flux concentrator can include a first angled segment extending from the second segment towards the receptacle, the first angled segment configured to direct the first field toward the receptacle, and the first angled segment extends in a direction that is less than 90 degrees relative to the longitudinal axis of the first segment.

In some implementations, the first flux concentrator can include a first additional segment extending from the second segment in a direction parallel to the longitudinal axis of the first segment, the first additional segment configured to direct the first field away from the receptacle.

In some implementations, the first flux concentrator can include a second angled segment extending from the third segment towards the receptacle, the second angled segment configured to direct the first field toward the receptacle, and the second angled segment extends in a direction that is orthogonal to the longitudinal axis of the first segment.

In some implementations, the first flux concentrator can include a second angled segment extending from the third segment towards the receptacle, the second angled segment configured to direct the first field toward the receptacle, and the second angled segment extends in a direction that is greater than 90 degrees relative to the longitudinal axis of the first segment.

In some implementations, the first flux concentrator can include a second angled segment extending from the third segment towards the receptacle, the second angled segment configured to direct the first field toward the receptacle, and the second angled segment extends in a direction that is less than 90 degrees relative to the longitudinal axis of the first segment.

In some implementations, the first flux concentrator can include a second additional segment extending from the third segment in a direction parallel to the longitudinal axis of the first segment, the second additional segment configured to direct the first field away from the receptacle.

In some implementations, the second and third segments can extend in respective directions that are generally parallel relative to each other.

In some implementations, the vaporizer device can include a second inductor proximate the receptacle and a second flux concentrator. The second inductor is configured to generate a second magnetic and/or electromagnetic field to heat the heating element of the cartridge. The second flux concentrator includes a fourth segment positioned on an outer surface of the first inductor, the fourth segment configured to direct the second field towards the receptacle, the fourth segment having a first end, a second, opposing end, and a longitudinal axis extending therebetween; a fifth segment extending from the fourth segment and toward the receptacle, the fifth segment configured to direct the second field toward the receptacle; and a sixth segment extending from the fourth segment and toward the receptacle, the sixth segment configured to direct the second field toward the receptacle. In response to the generation of second field, the second flux concentrator directs the second field to the frame such that the second field penetrates through the frame and into the receptacle. In some implementations, the second flux concentrator can have a C-shaped cross-section. In some implementations, the second inductor can be inductive coil.

In some implementations, when the vaporizer device includes the second flux concentrator, the second flux concentrator can include a third angled segment extending from the fifth segment towards the receptacle, the third angled segment configured to direct the second field toward the receptacle, and the third angled segment extends in a direction that is orthogonal to the longitudinal axis of the fourth segment.

In some implementations, when the vaporizer device includes the second flux concentrator, the second flux concentrator can include a third angled segment extending from the fifth segment towards the receptacle, and the third angled segment configured to direct the second field toward the receptacle, and the third angled segment extends in a direction that is greater than 90 degrees relative to the longitudinal axis of the fourth segment.

In some implementations, when the vaporizer device includes the second flux concentrator, the second flux concentrator can include a third angled segment extending from the fifth segment towards the receptacle, and the third angled segment configured to direct the second field toward the receptacle, and the third angled segment extends in a direction that is less than 90 degrees relative to the longitudinal axis of the fourth segment.

In some implementations, when the vaporizer device includes the second flux concentrator, the second flux concentrator can include a third additional segment extending from the fifth segment in a direction that is parallel to the longitudinal axis of the fourth segment, and the third addition segment configured to direct the second field away from the receptacle.

In some implementations, when the vaporizer device includes the second flux concentrator, the second flux concentrator can include a fourth angled segment extending from the sixth segment towards the receptacle, the fourth angled segment configured to direct the second field toward the receptacle, and the fourth angled segment extends in a direction that is orthogonal to the longitudinal axis of the fourth segment.

In some implementations, when the vaporizer device includes the second flux concentrator, the second flux concentrator can include a fourth angled segment extending from the sixth segment towards the receptacle, the fourth angled segment configured to direct the second field toward the receptacle, and the fourth angled segment extends in a direction that is greater than 90 degrees relative to the longitudinal axis of the fourth segment.

In some implementations, when the vaporizer device includes the second flux concentrator, the second flux concentrator can include a fourth angled segment extending from the sixth segment towards the receptacle, the fourth angled segment configured to direct the second field toward the receptacle, and the fourth angled segment extends in a direction that is less than 90 degrees relative to the longitudinal axis of the fourth segment.

In some implementations, when the vaporizer device includes the second flux concentrator, the second flux concentrator can include a fourth additional segment extending from the sixth segment in a direction that is parallel to the longitudinal axis of the fourth segment, the fourth additional segment configured to direct the second field away from the receptacle.

In some implementations, the vaporizer device can include the cartridge. The cartridge includes a heating element that includes an infrared reflective material configured to heat vaporizable material disposed within the cartridge and reflect heat towards the vaporizable material to generate the vapor.

In some implementations, the vaporizer device can include the cartridge. The cartridge includes a heating element that includes a susceptor and an infrared reflective material. The susceptor is configured to heat vaporizable material disposed within the cartridge, and the infrared reflective material configured to heat the vaporizable material and reflect heat towards the vaporizable material to generate the vapor.

In some implementations, the heating element can extend a length from a first end to a second end. In certain implementations, at least one of the first inductor or the second inductor can extend a respective inductor length from a first end to a second, opposing end, and the respective inductor length is less than the length of the heating element. In other implementations, at least one of the first inductor or the second inductor can extend a respective inductor length from a first end to a second, opposing end, and the respective inductor length is greater than the length of the heating element. In yet other implementations, at least one of the first inductor or the second inductor can extend a respective inductor length from a first end to a second, opposing end, and wherein the respective inductor length is equal to the length of the heating element.

In some implementations, the frame and the first inductor can be spaced a distance apart thereby defining a first gap extending therebetween. In some implementations, the frame and the second inductor are spaced a distance apart thereby further defining a second gap extending therebetween. In certain implementations, the vaporizer device can include an insulative material disposed within at least one of the first gap or the second gap. In such implementations, air can be present within at least one of the first gap or the second gap.

In some implementations, the first inductor can be an inductive coil.

In some implementations, the cartridge can include one or more inserts.

In some implementations, the cartridge can include a divider.

In some implementations, the vaporizer body can include one or more sensors configured to detect an external magnetic field relative to the vaporizer device.

In various implementations, a cartridge for use with a vaporizer device for generating an inhalable aerosol is disclosed. The cartridge can include a first portion and a second portion. The first portion can include a heating element configured to heat a vaporizable material to generate a vapor, the heating element defining at least a portion of a perimeter of a heater chamber containing the vaporizable material, and one or more cartridge inlets configured to allow external air to enter the heater chamber and entrain the vapor. The second portion can include at least one vapor inlet, and a divider comprising a plurality of stand-offs adjacent to the vaporizable material, with the plurality of stand-offs defining at least one trench therebetween. The second portion can further include one or more airflow outlet channels in fluid communication with the heater chamber through the divider, the one or more airflow outlet channels including at least one condensation chamber configured to condense the entrained vapor to form the inhalable aerosol, and at least one airflow outlet configured to deliver the inhalable aerosol to a user, the at least one airflow outlet in fluid communication with the at least one condensation chamber.

In some implementations, the second portion can further include one or more bypass air inlets, with the at least one condensation chamber in fluid communication with ambient air through the one or more bypass air inlets.

In some implementations, the at least one trench extends perpendicular to a longitudinal axis of the cartridge.

In some implementations, the at least one trench can include a first trench extending perpendicular to a longitudinal axis of the cartridge and a second trench extending perpendicular to the longitudinal axis of the cartridge and perpendicular to the first trench. In such implementations, the first trench can extend between opposing long sides of the cartridge with the second trench extending between opposing short sides of the cartridge. Additionally, or alternatively, in some implementations, the first trench can intersect with and/or bisect the second trench, and the second trench can intersect with and/or bisect the first trench.

In some implementations, the at least one trench can include a plurality of trenches extending parallel to a longitudinal axis of the cartridge, and each of the plurality of trenches can be adjacent another one of the plurality of trenches.

In some implementations, the at least one trench can separate a first stand-off of the plurality of stand-offs from a second stand-off of the plurality of stand-offs.

In some implementations, the one or more airflow outlet channels can include a first airflow outlet channel and a second airflow outlet channel downstream of the first airflow outlet channel, with a first interior space of the first airflow channel being smaller than a second interior space of the second airflow channel. In such implementations, the first interior space can be less than 10% of the volume of the second interior space, less than 5% of the volume of the second interior space, less than 3% of the volume of the second interior space, or the like. Additionally, or alternatively, in some implementations, the first airflow outlet channel can be defined within or through an interior of the divider, and/or the second airflow outlet channel can be defined in part by an exterior surface of the divider.

In some implementations, the cartridge can include a wrapper, with the second airflow outlet channel further defined by an interior surface of the wrapper. Additionally, or alternatively, in some implementations, the second portion can include an insert proximate to the at least one airflow outlet, with the second airflow outlet channel further defined by an upstream surface of the insert.

In some implementations, the second portion can include one or more bypass air inlets, with the one or more bypass air inlets configured to direct ambient air into the first airflow outlet channel.

In some implementations, the divider can include one or more baffles extending between opposing stand-offs of the plurality of stand-offs, with the at least one trench configured to direct the entrained vapor towards the one or more baffles. In such implementations, the one or more baffles can be configured to divert the entrained vapor around the one or more baffles and to the first airflow outlet channel, with the first airflow outlet channel configured to direct the entrained vapor to the second airflow outlet channel.

In some implementations, the one or more airflow outlet channels can include a plurality of first airflow outlet channels and a second airflow outlet channel downstream of the plurality of first airflow outlet channels. In such implementations, a first interior space of each of the plurality of first airflow channels can be smaller than a second interior space of the second airflow channel. In such implementations, the first interior space can be less than 10% of the volume of the second interior space, less than 5% of the volume of the second interior space, less than 3% of the volume of the second interior space, or the like.

In some implementations, the plurality of first airflow outlet channels can include a pair of first airflow outlet channels disposed proximate opposing long sides of the cartridge.

In some implementations, the cartridge can include a wrapper, with the plurality of first airflow outlet channels defined between an exterior surface of the divider and an interior surface of the wrapper.

In some implementations, the second airflow outlet channel can be defined in part by an exterior surface of the divider. In such implementations, the second airflow outlet channel can be further defined by an interior surface of the wrapper. Additionally, or alternatively, in some implementations, the second portion can include an insert proximate to the at least one airflow outlet, with the second airflow outlet channel further defined by an upstream surface of the insert.

In some implementations, the second portion can further include a plurality of bypass air inlets, with the plurality of bypass air inlets configured to direct ambient air into the plurality of first airflow outlet channels.

In some implementations, the second portion can further include a plurality of bypass air inlets, with the plurality of bypass air inlets downstream of the plurality of first airflow outlet channels and configured to direct ambient air into the second airflow outlet channel.

In some implementations, the at least one trench can be configured to direct the entrained vapor to the plurality of first airflow outlet channels, with each of the plurality of first airflow outlet channels configured to direct the entrained vapor to the second airflow outlet channel.

In some implementations, the cartridge can further include a wrapper extending between a first end of the cartridge and a second end of the cartridge opposite the first end of the cartridge. In such implementations, the first portion of the cartridge can be proximate the first end of the cartridge, with the second portion of the cartridge proximate the second end of the cartridge.

In some implementations, the second portion of the cartridge further includes a mouthpiece.

In some implementations, a first portion of the heating element can be proximate a first end of the heating element and at least partially overlapping with a second portion of the heating element proximate a second end of the heating element. In such implementations, the first portion can be on an exterior face of the heating element with the second portion on an interior face of the heating element, or the first portion and the second portion can each be on an interior face of the heating element. In some implementations, the first portion and the second portion can be connected. In such implementations, the first portion and the second portion can be welded together, glued together, crimped together, interlocked together, pressed together, knurled, and/or folded over one another.

In some implementations, the heating element can at least partially define an interior volume configured to hold the vaporizable material.

In some implementations, the heating element can include an electrically conductive top region, an electrically conductive bottom region, and at least one hole or cut-out region. In such implementations, the at least one hole or cut-out region is formed between the top region and the bottom region. In some implementations, the at least one hole or cut-out region can include a pair of holes or cut-out regions disposed at opposing long sides of the cartridge. In some implementations, the at least one hole or cut-out region can be configured to reduce heat transferred between the top region and the bottom region and/or reduce current flow between the top region and the bottom region.

In some implementations, the heating element can include a susceptor configured to generate heat via eddy currents, or via hysteresis. In some implementations, the heating element can include a metal layer and at least one layer of paper.

In various implementations, a vaporizer device for generating an inhalable aerosol is disclosed. The vaporizer device includes a cartridge and a vaporizer body. The cartridge can include a first portion and a second portion. The first portion can include a heating element configured to heat a vaporizable material to generate a vapor, the heating element defining at least a portion of a perimeter of a heater chamber containing the vaporizable material, and one or more cartridge inlets configured to allow external air to enter the heater chamber and entrain the vapor. The second portion can include at least one vapor inlet, and a divider comprising a plurality of stand-offs adjacent to the vaporizable material, with the plurality of stand-offs defining at least one trench therebetween. The second portion can further include one or more airflow outlet channels in fluid communication with the heater chamber through the divider, the one or more airflow outlet channels including at least one condensation chamber configured to condense the entrained vapor to form the inhalable aerosol, and at least one airflow outlet configured to deliver the inhalable aerosol to a user, the at least one airflow outlet in fluid communication with the at least one condensation chamber. The vaporizer body can include a receptacle configured to insertably receive at least a portion of the cartridge, and at least one inductive coil configured to generate a first magnetic and/or electromagnetic field to heat the heating element to generate a vapor from the vaporizable material.

In some implementations, the second portion can further include one or more bypass air inlets, with the at least one condensation chamber in fluid communication with ambient air through the one or more bypass air inlets.

In some implementations, the at least one trench extends perpendicular to a longitudinal axis of the cartridge.

In some implementations, the at least one trench can include a first trench extending perpendicular to a longitudinal axis of the cartridge and a second trench extending perpendicular to the longitudinal axis of the cartridge and perpendicular to the first trench. In such implementations, the first trench can extend between opposing long sides of the cartridge with the second trench extending between opposing short sides of the cartridge. Additionally, or alternatively, in some implementations, the first trench can intersect with and/or bisect the second trench, and the second trench can intersect with and/or bisect the first trench.

In some implementations, the at least one trench can include a plurality of trenches extending parallel to a longitudinal axis of the cartridge, and each of the plurality of trenches can be adjacent another one of the plurality of trenches.

In some implementations, the at least one trench can separate a first stand-off of the plurality of stand-offs from a second stand-off of the plurality of stand-offs.

In some implementations, the one or more airflow outlet channels can include a first airflow outlet channel and a second airflow outlet channel downstream of the first airflow outlet channel, with a first interior space of the first airflow channel being smaller than a second interior space of the second airflow channel. In such implementations, the first interior space can be less than 10% of the volume of the second interior space, less than 5% of the volume of the second interior space, less than 3% of the volume of the second interior space, or the like. Additionally, or alternatively, in some implementations, the first airflow outlet channel can be defined within or through an interior of the divider, and/or the second airflow outlet channel can be defined in part by an exterior surface of the divider.

In some implementations, the cartridge can include a wrapper, with the second airflow outlet channel further defined by an interior surface of the wrapper. Additionally, or alternatively, in some implementations, the second portion can include an insert proximate to the at least one airflow outlet, with the second airflow outlet channel further defined by an upstream surface of the insert.

In some implementations, the second portion can include one or more bypass air inlets, with the one or more bypass air inlets configured to direct ambient air into the first airflow outlet channel.

In some implementations, the divider can include one or more baffles extending between opposing stand-offs of the plurality of stand-offs, with the at least one trench configured to direct the entrained vapor towards the one or more baffles. In such implementations, the one or more baffles can be configured to divert the entrained vapor around the one or more baffles and to the first airflow outlet channel, with the first airflow outlet channel configured to direct the entrained vapor to the second airflow outlet channel.

In some implementations, the one or more airflow outlet channels can include a plurality of first airflow outlet channels and a second airflow outlet channel downstream of the plurality of first airflow outlet channels. In such implementations, a first interior space of each of the plurality of first airflow channels can be smaller than a second interior space of the second airflow channel. In such implementations, the first interior space can be less than 10% of the volume of the second interior space, less than 5% of the volume of the second interior space, less than 3% of the volume of the second interior space, or the like.

In some implementations, the plurality of first airflow outlet channels can include a pair of first airflow outlet channels disposed proximate opposing long sides of the cartridge.

In some implementations, the cartridge can include a wrapper, with the plurality of first airflow outlet channels defined between an exterior surface of the divider and an interior surface of the wrapper.

In some implementations, the second airflow outlet channel can be defined in part by an exterior surface of the divider. In such implementations, the second airflow outlet channel can be further defined by an interior surface of the wrapper. Additionally, or alternatively, in some implementations, the second portion can include an insert proximate to the at least one airflow outlet, with the second airflow outlet channel further defined by an upstream surface of the insert.

In some implementations, the second portion can further include a plurality of bypass air inlets, with the plurality of bypass air inlets configured to direct ambient air into the plurality of first airflow outlet channels.

In some implementations, the second portion can further include a plurality of bypass air inlets, with the plurality of bypass air inlets downstream of the plurality of first airflow outlet channels and configured to direct ambient air into the second airflow outlet channel.

In some implementations, the at least one trench can be configured to direct the entrained vapor to the plurality of first airflow outlet channels, with each of the plurality of first airflow outlet channels configured to direct the entrained vapor to the second airflow outlet channel.

In some implementations, the cartridge can further include a wrapper extending between a first end of the cartridge and a second end of the cartridge opposite the first end of the cartridge. In such implementations, the first portion of the cartridge can be proximate the first end of the cartridge, with the second portion of the cartridge proximate the second end of the cartridge.

In some implementations, the second portion of the cartridge further includes a mouthpiece.

In some implementations, a first portion of the heating element can be proximate a first end of the heating element and at least partially overlapping with a second portion of the heating element proximate a second end of the heating element. In such implementations, the first portion can be on an exterior face of the heating element with the second portion on an interior face of the heating element, or the first portion and the second portion can each be on an interior face of the heating element. In some implementations, the first portion and the second portion can be connected. In such implementations, the first portion and the second portion can be welded together, glued together, crimped together, interlocked together, pressed together, knurled, and/or folded over one another.

In some implementations, the heating element can at least partially define an interior volume configured to hold the vaporizable material.

In some implementations, the heating element can include an electrically conductive top region, an electrically conductive bottom region, and at least one hole or cut-out region. In such implementations, the at least one hole or cut-out region is formed between the top region and the bottom region. In some implementations, the at least one hole or cut-out region can include a pair of holes or cut-out regions disposed at opposing long sides of the cartridge. In some implementations, the at least one hole or cut-out region can be configured to reduce heat transferred between the top region and the bottom region and/or reduce current flow between the top region and the bottom region.

In some implementations, the heating element can include a susceptor configured to generate heat via eddy currents, or via hysteresis. In some implementations, the heating element can include a metal layer and at least one layer of paper.

In some implementations, the at least one inductive coil can include at least one first inductive coil configured to generate a first magnetic and/or electromagnetic field to heat a first region of the heating element to generate a vapor from a first portion of the vaporizable material, and/or at least one second inductive coil configured to generate a second magnetic and/or electromagnetic field to heat a second region of the heating element to generate a vapor from a second portion of the vaporizable material. In such implementations, the heating element can include one or more cut-outs region between the first region and the second region.

In some implementations, the heating element can include a first heating element and a second heating element. In such implementations, the at least one inductive coil can include at least one first inductive coil configured to generate a first magnetic and/or electromagnetic field to heat the first heating element to generate a vapor from a first portion of the vaporizable material, and/or at least one second inductive coil configured to generate a second magnetic and/or electromagnetic field to heat the second heating element to generate a vapor from a second portion of the vaporizable material. In such implementations, the first heating element can be separate and apart from the second heating element.

In some implementations, the vaporizer body can further include a controller configured to independently apply power to at least some of or each of the at least one inductive coil, such as to the at least one first inductive coil and the at least one second inductive coil.

In various implementations, a vaporizer device for generating an inhalable aerosol is disclosed. The vaporizer device includes a vaporizer body. The vaporizer body can include a receptacle configured to insertably receive at least a portion of a cartridge comprising a heating element, and at least one first inductive coil configured to generate a first magnetic and/or electromagnetic field to heat a first region of the heating element to generate a vapor from a first portion of a vaporizable material. The vaporizer body can further include at least one second inductive coil configured to generate a second magnetic and/or electromagnetic field to heat a second region of the heating element to generate a vapor from a second portion of the vaporizable material, with the heating element including one or more cut-out regions between the first region and the second region. The vaporizer body can further include a controller configured to independently apply power to the at least one first inductive coil and the at least one second inductive coil.

In some implementations, the vaporizer body can further include a holder assembly at least partially defining the cartridge receptacle. In such implementations, the at least one first inductive coil and the at least one second inductive coil can be disposed on an exterior of the holder assembly, with the cartridge receptacle interior to the holder assembly.

In some implementations, the at least one first inductive coil and the at least one second inductive coil can be affixed to the holder assembly.

In some implementations, the holder assembly can extend parallel to a longitudinal axis of the vaporizer body.

In some implementations, the at least one first inductive coil and the at least one second inductive coil can be disposed proximate opposing ends of the receptacle.

In some implementations, the at least one first inductive coil can include a helical coil surrounding a first region of the cartridge receptacle.

In some implementations, the at least one second inductive coil can include a pair of coils proximate opposing long sides of the vaporizer body.

In some implementations, the at least one first inductive coil can extend perpendicular to a longitudinal axis of the vaporizer body and the at least one second inductive coil can extend parallel to a longitudinal axis of the vaporizer body.

In some implementations, the at least one second inductive coil can be flattened and defines an open center region. In such implementations, the vaporizer body can further include a sensor disposed at least partially within the open center region. In such implementations, the sensor can include a temperature sensor configured to detect a temperature of the at least one second inductive coil. In such implementations, the controller can be configured to apply power to the at least one second inductive coil based on the detected temperature.

In some implementations, the vaporizer body can further include an external shell and one or more flux concentrators, with the one or more flux concentrators disposed between the at least one first inductive coil and the external shell, and with the one or more flux concentrators disposed between the at least one second inductive coil and the external shell. In such implementations, the one or more flux concentrators can be disposed between the at least one first inductive coil and the at least one second inductive coil.

In some implementations, the vaporizer body can further include one or more ridges configured to hold the cartridge within the cartridge receptacle. In such implementations, the holder assembly can include the one or more ridges, with the one or more ridges including a first set of ridges proximate a first end of the holder assembly and a second set of ridges proximate a second end of the holder assembly. In such implementations, the first set of ridges can form a space for air to enter the cartridge receptacle. Additionally, or alternatively, in some implementations, the second set of ridges can form a space for air to enter the cartridge.

In some implementations, the vaporizer device can include the cartridge.

In some implementations, the heating element can at least partially define an interior volume configured to hold the vaporizable material.

In some implementations, the first region of the heating element can include an electrically conductive top region, with the second region of the heating element including an electrically conductive bottom region.

In some implementations, the one or more cut-out regions can include a first cut-out region defined within a first side of the heating element and a second cut-out region defined within a second side of the heating element, the first side of the heating element opposing the second side of the heating element along a width or a depth of the heating element (e.g., transverse to a longitudinal dimension of the heating element).

In some implementations, the cut-out region(s) can be configured to reduce heat transferred between the top region and the bottom region of the heating element and/or reduce current flow between the top region and the bottom region of the heating element.

In some implementations, when the cartridge is inserted into the cartridge receptacle, the top region can be disposed proximate the at least one first inductive coil with the bottom region disposed proximate the at least one second inductive coil.

In some implementations, the controller can be configured to heat the top region of the heating element to a first temperature at a first time, and the controller can be configured to heat the bottom region of the heating element to a second temperature at a second time, with the first temperature being higher than the second temperature and the second time being after the first time. In such implementations, the first temperature can be at or below 270 degrees Celsius, with the second temperature being at or above 170 degrees Celsius. Additionally, or alternatively, in some implementations, the second time can be at least 10 seconds, at least 20 seconds, or the like after the first time.

In some implementations, the controller can be further configured to heat the top region of the heating element to a third temperature at a third time, and the controller can be further configured to heat the bottom region of the heating element to a fourth temperature at a fourth time, with the first temperature being higher than the third temperature and the fourth temperature being higher than the second temperature. Additionally, or alternatively, in some implementations, the third time can be after the first time and the fourth time can be after the second time.

In some implementations, the third temperature can be at least 15 degrees Celsius colder than the first temperature, with the fourth temperature being at least 5 degrees Celsius hotter than the second temperature. In some implementations, the third time can be at least 10 seconds, at least 20 seconds, or the like after the first time and/or the fourth time can be at least 10 seconds, at least 20 seconds, or the like after the second time.

In some implementations, the heating element can include a susceptor configured to generate heat via eddy currents, or via hysteresis. In some implementations, the heating element can include a metal layer and at least one layer of paper.

In some implementations, the first magnetic and/or electromagnetic field can oppose and/or be orthogonal to the second magnetic and/or electromagnetic field.

In various implementations, a vaporizer device for generating an inhalable aerosol is disclosed. The vaporizer device includes a cartridge and a vaporizer body. The cartridge can include a heating element having a first region and a second region, with the heating element including one or more cut-out regions between the first region and the second region. The cartridge can further include a vaporizable material having a first portion and a second portion. The vaporizer body can include a receptacle configured to insertably receive at least a portion of the cartridge, and at least one first inductive coil configured to generate a first magnetic and/or electromagnetic field to heat the first region of the heating element to generate a vapor from the first portion of the vaporizable material. The vaporizer body can further include at least one second inductive coil configured to generate a second magnetic and/or electromagnetic field to heat the second region of the heating element to generate a vapor from the second portion of the vaporizable material. The vaporizer body can further include a controller configured to independently apply power to the at least one first inductive coil and the at least one second inductive coil.

In some implementations, the vaporizer body can further include a holder assembly at least partially defining the cartridge receptacle. In such implementations, the at least one first inductive coil and the at least one second inductive coil can be disposed on an exterior of the holder assembly, with the cartridge receptacle interior to the holder assembly.

In some implementations, the at least one first inductive coil and the at least one second inductive coil can be affixed to the holder assembly.

In some implementations, the holder assembly can extend parallel to a longitudinal axis of the vaporizer body.

In some implementations, the at least one first inductive coil and the at least one second inductive coil can be disposed proximate opposing ends of the receptacle.

In some implementations, the at least one first inductive coil can include a helical coil surrounding a first region of the cartridge receptacle.

In some implementations, the at least one second inductive coil can include a pair of coils proximate opposing long sides of the vaporizer body.

In some implementations, the at least one first inductive coil can extend perpendicular to a longitudinal axis of the vaporizer body and the at least one second inductive coil can extend parallel to a longitudinal axis of the vaporizer body.

In some implementations, the at least one second inductive coil can be flattened and defines an open center region. In such implementations, the vaporizer body can further include a sensor disposed at least partially within the open center region. In such implementations, the sensor can include a temperature sensor configured to detect a temperature of the at least one second inductive coil. In such implementations, the controller can be configured to apply power to the at least one second inductive coil based on the detected temperature.

In some implementations, the vaporizer body can further include an external shell and one or more flux concentrators, with the one or more flux concentrators disposed between the at least one first inductive coil and the external shell, and with the one or more flux concentrators disposed between the at least one second inductive coil and the external shell. In such implementations, the one or more flux concentrators can be disposed between the at least one first inductive coil and the at least one second inductive coil.

In some implementations, the vaporizer body can further include one or more ridges configured to hold the cartridge within the cartridge receptacle. In such implementations, the holder assembly can include the one or more ridges, with the one or more ridges including a first set of ridges proximate a first end of the holder assembly and a second set of ridges proximate a second end of the holder assembly. In such implementations, the first set of ridges can form a space for air to enter the cartridge receptacle. Additionally, or alternatively, in some implementations, the second set of ridges can form a space for air to enter the cartridge.

In some implementations, the heating element can at least partially define an interior volume configured to hold the vaporizable material.

In some implementations, the first region of the heating element can include an electrically conductive top region, with the second region of the heating element including an electrically conductive bottom region.

In some implementations, the one or more cut-out regions can include a first cut-out region defined within a first side of the heating element and a second cut-out region defined within a second side of the heating element, the first side of the heating element opposing the second side of the heating element along a width or a depth of the heating element (e.g., transverse to a longitudinal dimension of the heating element).

In some implementations, the cut-out region(s) can be configured to reduce heat transferred between the top region and the bottom region of the heating element and/or reduce current flow between the top region and the bottom region of the heating element.

In some implementations, when the cartridge is inserted into the cartridge receptacle, the top region can be disposed proximate the at least one first inductive coil with the bottom region disposed proximate the at least one second inductive coil.

In some implementations, the controller can be configured to heat the top region of the heating element to a first temperature at a first time, and the controller can be configured to heat the bottom region of the heating element to a second temperature at a second time, with the first temperature being higher than the second temperature and the second time being after the first time. In such implementations, the first temperature can be at or below 270 degrees Celsius, with the second temperature being at or above 170 degrees Celsius. Additionally, or alternatively, in some implementations, the second time can be at least 10 seconds, at least 20 seconds, or the like after the first time.

In some implementations, the controller can be further configured to heat the top region of the heating element to a third temperature at a third time, and the controller can be further configured to heat the bottom region of the heating element to a fourth temperature at a fourth time, with the first temperature being higher than the third temperature and the fourth temperature being higher than the second temperature. Additionally, or alternatively, in some implementations, the third time can be after the first time and the fourth time can be after the second time.

In some implementations, the third temperature can be at least 15 degrees Celsius colder than the first temperature, with the fourth temperature being at least 5 degrees Celsius hotter than the second temperature. In some implementations, the third time can be at least 10 seconds, at least 20 seconds, or the like after the first time and/or the fourth time can be at least 10 seconds, at least 20 seconds, or the like after the second time.

In some implementations, the heating element can include a susceptor configured to generate heat via eddy currents, or via hysteresis. In some implementations, the heating element can include a metal layer and at least one layer of paper.

In some implementations, the first magnetic and/or electromagnetic field can oppose and/or be orthogonal to the second magnetic and/or electromagnetic field.

In various implementations, a vaporizer device for generating an inhalable aerosol is disclosed. The vaporizer device can include a vaporizer body. The vaporizer body can include a receptacle configured to insertably receive at least a portion of a cartridge comprising a first heating element and a second heating element, and at least one first inductive coil configured to generate a first magnetic and/or electromagnetic field to heat the first heating element to generate a vapor from a first portion of a vaporizable material. The vaporizer body can further include at least one second inductive coil configured to generate a second magnetic and/or electromagnetic field to the second heating element to generate a vapor from a second portion of the vaporizable material, wherein the first heating element is separate and apart from the second heating element, and a controller configured to independently apply power to the at least one first inductive coil and the at least one second inductive coil.

In some implementations, the vaporizer body can further include a holder assembly at least partially defining the cartridge receptacle. In such implementations, the at least one first inductive coil and the at least one second inductive coil can be disposed on an exterior of the holder assembly, with the cartridge receptacle interior to the holder assembly.

In some implementations, the at least one first inductive coil and the at least one second inductive coil can be affixed to the holder assembly.

In some implementations, the holder assembly can extend parallel to a longitudinal axis of the vaporizer body.

In some implementations, the at least one first inductive coil and the at least one second inductive coil can be disposed proximate opposing ends of the receptacle.

In some implementations, the at least one first inductive coil can include a helical coil surrounding a first region of the cartridge receptacle.

In some implementations, the at least one second inductive coil can include a pair of coils proximate opposing long sides of the vaporizer body.

In some implementations, the at least one first inductive coil can extend perpendicular to a longitudinal axis of the vaporizer body and the at least one second inductive coil can extend parallel to a longitudinal axis of the vaporizer body.

In some implementations, the at least one second inductive coil can be flattened and defines an open center region. In such implementations, the vaporizer body can further include a sensor disposed at least partially within the open center region. In such implementations, the sensor can include a temperature sensor configured to detect a temperature of the at least one second inductive coil. In such implementations, the controller can be configured to apply power to the at least one second inductive coil based on the detected temperature.

In some implementations, the vaporizer body can further include an external shell and one or more flux concentrators, with the one or more flux concentrators disposed between the at least one first inductive coil and the external shell, and with the one or more flux concentrators disposed between the at least one second inductive coil and the external shell. In such implementations, the one or more flux concentrators can be disposed between the at least one first inductive coil and the at least one second inductive coil.

In some implementations, the vaporizer body can further include one or more ridges configured to hold the cartridge within the cartridge receptacle. In such implementations, the holder assembly can include the one or more ridges, with the one or more ridges including a first set of ridges proximate a first end of the holder assembly and a second set of ridges proximate a second end of the holder assembly. In such implementations, the first set of ridges can form a space for air to enter the cartridge receptacle. Additionally, or alternatively, in some implementations, the second set of ridges can form a space for air to enter the cartridge.

In some implementations, the vaporizer device can include the cartridge.

In some implementations, the first heating element and the second heating element can each at least partially define an interior volume configured to hold a portion of the vaporizable material.

In some implementations, the first heating element can be disposed closer to a proximal end of the cartridge, with the second heating element disposed closer to a distal end of the cartridge.

In some implementations, current flowing through the first heating element can be separate and apart from current flowing through the second heating element.

In some implementations, when the cartridge is inserted into the cartridge receptacle, the first heating element can be disposed proximate the at least one first inductive coil and the second heating element can be disposed proximate the at least one second inductive coil.

In some implementations, the controller can be configured to heat the first heating element to a first temperature at a first time, and the controller can be further configured to heat the second heating element to a second temperature at a second time, with the first temperature being higher than the second temperature and the second time being after the first time. In such implementations, the first temperature can be at or below 270 degrees Celsius, with the second temperature being at or above 170 degrees Celsius. Additionally, or alternatively, in some implementations, the second time can be at least 10 seconds, at least 20 seconds, or the like after the first time.

In some implementations, the controller can be further configured to heat the first heating element to a third temperature at a third time, and the controller can be further configured to heat the second heating element to a fourth temperature at a fourth time, with the first temperature being higher than the third temperature and the fourth temperature being higher than the second temperature. Additionally, or alternatively, in some implementations, the third time can be after the first time and the fourth time can be after the second time.

In some implementations, the third temperature can be at least 15 degrees Celsius colder than the first temperature, with the fourth temperature being at least 5 degrees Celsius hotter than the second temperature. In some implementations, the third time can be at least 10 seconds, at least 20 seconds, or the like after the first time and/or the fourth time can be at least 10 seconds, at least 20 seconds, or the like after the second time.

In some implementations, the first heating element and the second heating element can each include a susceptor configured to generate heat via eddy currents, or via hysteresis. In some implementations, the first heating element and the second heating element can each include a metal layer and at least one layer of paper.

In some implementations, the first magnetic and/or electromagnetic field can oppose and/or be orthogonal to the second magnetic and/or electromagnetic field.

In various implementations, a vaporizer device for generating an inhalable aerosol is disclosed. The vaporizer device includes a cartridge and a vaporizer body. The cartridge extends from a first cartridge end to a second cartridge end. The cartridge includes a wrapper configured to hold a vaporizable material disposed therein, a mouthpiece insert proximate to the first cartridge end, and a heating element configured to heat the vaporizable material to generate a vapor. The heating element includes a first region, a second region, and a third region, wherein the second region is spaced apart from the first region by the third region, and wherein the third region includes perforations. The vaporizer body includes at least one inductor configured to generate a magnetic and/or electromagnetic field to heat the heating element.

In some implementations, the heating element can be disposed within the wrapper and can define at least a portion of a perimeter of a heater chamber containing the vaporizable material.

In some implementations, the cartridge can include a support structure, in which the mouthpiece insert is positioned within the support structure. In such implementations, the cartridge can include a condensation chamber that is defined by at least a portion of the support structure and is positioned between the mouthpiece insert and the vaporizable material. In such implementations, the cartridge can include one or more bypass air inlets that extend through the support structure and the wrapper to thereby allow ambient air to pass therethrough and into the condensation chamber.

In some implementations, the cartridge can include an insert that is positioned proximate to the second cartridge end. The insert includes one or more air inlets allowing ambient air to enter the heater chamber. In such implementations, the insert can include a cellulose acetate.

In some implementations, the wrapper can extend from the first cartridge end to the second cartridge end.

In some implementations, the mouthpiece insert can include a cellulose acetate.

In some implementations, the heating element can be configured to generate heat via eddy currents.

In some implementations, the heating element can include a sheet wrapped around the vaporizable material. In certain implementations, the sheet can include one or more metals.

In some implementations, the heating element can include two opposing sides that are attached to one another to form a loop. In such implementations, the two opposing sides can be glued or welded to one another to form a loop.

In some implementations, the first region, the second region, the third region, or any combination thereof, each can extend around a perimeter of the vaporizable material.

In some implementations, the vaporizable material can be cut rag tobacco.

In various implementations, a vaporizer device for generating an inhalable aerosol is disclosed. The vaporizer device includes a cartridge and a vaporizer body. The cartridge extends from a first cartridge end to a second cartridge end. The cartridge includes a wrapper configured to hold a vaporizable material disposed therein, and a mouthpiece insert proximate to the first cartridge end. The cartridge further includes a heating assembly includes a substrate and a plurality of heating elements disposed on a surface of the substrate, the substrate extending from a first end to a second end. The first heating element of the plurality of heating elements is positioned proximate to the first end, and a second heating element of the plurality of heating elements is disposed proximate to the second end, wherein the second heating element is spaced apart from the first heating element by a region. The vaporizer body includes at least one inductor configured to generate a magnetic and/or electromagnetic field to heat the heating element.

In some implementations, the region can not include the plurality of heating elements.

In some implementations, the surface can be an exterior surface of the substrate. In other implementations, the surface can be an interior surface of the substrate.

In some implementations, the heating assembly can be disposed within the wrapper and can define at least a portion of a perimeter of a heater chamber containing the vaporizable material.

In some implementations, the cartridge can include a support structure, in which the mouthpiece insert is positioned within the support structure. In such implementations, the cartridge can include a condensation chamber that is defined by at least a portion of the support structure and is positioned between the mouthpiece insert and the vaporizable material. In such implementations, the cartridge can include one or more bypass air inlets that extend through the support structure and the wrapper to thereby allow ambient air to pass therethrough and into the condensation chamber.

In some implementations, the cartridge can include an insert that is positioned proximate to the second cartridge end. The insert includes one or more air inlets allowing ambient air to enter the heater chamber. In such implementations, the insert can include a cellulose acetate.

In some implementations, the wrapper can extend from the first cartridge end to the second cartridge end.

In some implementations, the mouthpiece insert can include a cellulose acetate.

In some implementations, the plurality of heating elements can be configured to generate heat via eddy currents.

In some implementations, the substrate of the heating assembly can include a sheet wrapped around the vaporizable material. The sheet can include paper.

In some implementations, the first and the second heating elements can include one or more metals. The one or more metals can include aluminum, and the aluminum is disposed on a surface of the substrate.

In some implementations, the heating assembly can include two opposing sides that are attached to one another to form a loop. In such implementations, the two opposing sides can be glued or welded to one another to form a loop.

In some implementations, the first heating element, the second heating element, the region, or any combination thereof, can each extend around a perimeter of the vaporizable material.

In some implementations, the vaporizable material can include cut rag tobacco.

In various implementations, a method of manufacturing a vaporizer device is disclosed. The method includes inserting a mouthpiece insert into a support structure such that the mouthpiece insert is positioned proximate to a first end of the support structure. The method further includes wrapping a heating element around a vaporizable material and positioning the heating element adjacent to a second end of the support structure, the second end opposing the first end of the support structure, and the heating element configured to generate heat by induction and heat the vaporizable material to generate a vapor. The heating element includes a first region, a second region, and a third region, wherein the third region is positioned between the first and the second sections, and in which the third region includes perforations. The method also includes wrapping a wrapper around the support structure and the heating element, the heating element being positioned adjacent to the second end of the support structure.

In some implementations, the heating element can include one or more metals. In such implementations, the one or more metals can include aluminum.

In some implementation, the heating element can include a sheet.

In some implementations, wrapping the heating element around the vaporizable material can include attaching two opposing sides of the heating element to form a loop. In certain implementations, attaching the two opposing sides can include welding two opposing sides of the heating element to form the loop. In other implementations, attaching the two opposing sides can include gluing two opposing sides of the heating element to form the loop.

In some implementations, the method can include positioning an insert adjacent to a first end of the heating element and a second end of the heating element is adjacent the support structure. In certain implementations, the insert can include a cellulose acetate.

In some implementations, the method can include creating one or more bypass air inlets through the support structure and the wrapper to thereby allow ambient air to pass through the one or more bypass air inlets and into the condensation chamber. In such implementations, creating the one or more bypass air inlets can include laser cutting the one or more bypass air inlets through the support structure and the wrapper.

In various implementations, a method of manufacturing a vaporizer device is disclosed. The method includes inserting a mouthpiece insert into a support structure such that the mouthpiece insert is positioned proximate to a first end of the support structure. The method further includes providing a heating assembly and wrapping the heating assembly around a vaporizable material and positioning the heating assembly adjacent to a second end of the support structure, the second end opposing the first end of the support structure, and the heating assembly configured to generate heat by induction and heat the vaporizable material to generate a vapor. The heating assembly includes a plurality of heating elements, wherein a first heating element of the plurality of heating elements is positioned proximate to the first end, and a second heating element of the plurality of heating elements is disposed proximate to the second end, wherein the second heating element is spaced apart from the first heating element by a region. The method also includes wrapping a wrapper around the support structure and the heating assembly, the heating assembly being positioned adjacent to the second end of the support structure.

In some implementations, providing the heating assembly can include applying the plurality of heating elements onto a substrate to form the heating assembly. In such implementations, applying the plurality of heating elements onto the substrate can include laminating the plurality of heating elements.

In some implementations, the plurality of heating elements can include one or more metals. In certain implementations, the one or more metals can include aluminum.

In some implementations, the substrate can include paper.

In some implementations, wrapping the heating assembly around the vaporizable material can include attaching two opposing sides of the heating assembly to form a loop. In certain implementations, attaching the two opposing sides can include welding the two opposing sides of the heating assembly to form the loop. In other implementations, attaching the two opposing sides can include gluing the two opposing sides of the heating assembly to form the loop.

In some implementations, positioning an insert adjacent to a first end of the heating assembly and a second end of the heating assembly is adjacent the support structure. In such implementations, the insert can include a cellulose acetate.

In some implementations, the method can include creating one or more bypass air inlets through the support structure and the wrapper to thereby allow ambient air to pass through the one or more bypass air inlets and into the condensation chambers. In such implementations, creating the one or more bypass air inlets can include laser cutting the one or more bypass air inlets through the support structure and the wrapper.

In some implementations, wrapping the heating assembly around the vaporizable material can include attaching a first edge portion of the substrate to a second edge portion, opposite to the first edge portion, of the substrate; and attaching a first edge segment of the plurality of heating elements to a second edge segment, opposite to the first edge segment, of the plurality of heating elements. In such implementations, the first edge segment of the plurality of heating elements can extend over the first edge portion of the substrate. In certain implementations, the second edge segment of the plurality of heating elements can extend over the second edge portion of the substrate.

In some implementations, attaching the first edge portion of the substrate to the second edge portion of the substrate can include gluing the first edge portion of the substrate to the second edge portion of the substrate. In other implementations, attaching the first edge segment of the plurality of heating elements to the second edge segment of the plurality of heating elements can include welding the first edge segment of the plurality of heating elements to the second edge segment of the plurality of heating elements. In yet other implementations, attaching a first edge portion of the substrate to a second edge portion of the substrate can include welding the first edge portion of the substrate to the second edge portion of the substrate, and folding and gluing the welded edge portion and second edge portion of the substrate toward and onto an exterior surface of the heating assembly.

In various implementations, a heating assembly for use with a vaporizer device is disclosed. The heating assembly includes a first support substrate and a first plurality of heating elements disposed on a first surface of the first support substrate, and a second support substrate and a second plurality of heating elements disposed on a first surface of the second support substrate. The first plurality of heating elements at least partially extends between two opposing sides of the first support substrate. The second plurality of heating elements at least partially extend between two opposing sides of the second support substrate. A first side of the two opposing sides of the first support substrate is in contact with a first side of the two opposing sides of the second support substrate. A second side of the two opposing sides of the first support substrate is in contact with a second side of the two opposing sides of the second support substrate. When the first support substrate is in contact with the second support substrate, at least a portion of the first surface of the first support substrate contacts at least a portion of the first surface of the second support substrate such that at least a portion of the first plurality of heating elements contacts at least a portion of the second plurality of heating element.

In some implementations, the first plurality of heating elements can extend from a first side of the two opposing sides to a second side of the two opposing sides of the first support substrate.

In some implementations, the second plurality of heating elements can extend from a first side of the two opposing sides to a second side of the two opposing sides of the second plurality of heating elements.

In some implementations, a second heating element of the first plurality of heating elements can be spaced a distance apart from a first heating element of the first plurality of heating elements and a second heating element of the second plurality of heating elements can be spaced a distance apart from a first heating element of the second plurality of heating elements.

In some implementations, when the first support substrate is in contact with the second support substrate, at least a portion of the first surface of the first support substrate can face at least a portion of the first surface of the second support substrate.

In some implementations, when the first support substrate is in contact with the second support substrate, the first support substrate and the second support substrate can form, in combination, a continuous loop.

In some implementations, when the first support substrate is in contact with the second support substrate, a respective first segment of the first plurality of heating elements can be positioned and in contact with a respective first segment of the second plurality of heating elements, and a respective second segment of the first plurality of heating elements can be positioned and in contact with a respective second segment of the second plurality of heating elements.

In some implementations, the heating assembly can include a secondary substrate, in which at least the first support substrate, the second support substrate, or both are coupled to a surface of the secondary substrate. In certain implementations, the secondary substrate can be paper.

In various implementations, a method of manufacturing a heating assembly for a vaporizer device is disclosed herein. The method includes providing a first support substrate and a second support substrate. A first plurality of heating elements is disposed on a first surface of the first support substrate, and the first plurality of heating elements extending between two opposing sides of the first support substrate. A second plurality of heating elements is disposed on a first surface of the second support substrate, wherein the second plurality of heating elements extending between two opposing sides of the second support substrate. The method further includes contacting a first side of the two opposing sides of the first support substrate to a first side of the two opposing sides of the second support substrate and contacting a second side of the two opposing sides of the first support substrate to a second side of the two opposing sides of the second support substrate. When the first support substrate is in contact with the second support substrate, at least a portion of the first surface of the first support substrate contacts at least a portion of the first surface of the second support substrate such that at least a portion of the first plurality of heating elements contacts at least a portion of the second plurality of heating elements.

In some implementations, a first heating element of the first plurality of heating elements can be spaced a distance apart from a second heating element of the first plurality of heating elements, and a first heating element of the second plurality of heating elements can be spaced a distance apart from a second heating element of the second plurality of heating elements.

In some implementations, when the first support substrate is in contact with the second support substrate, at least a portion of the first surface of the first support substrate can face at least a portion of the first surface of the second support substrate.

In some implementations, when the first support substrate is in contact with the second support substrate, the first support substrate and the second support substrate can form, in combination, a continuous loop.

In some implementations, when the first support substrate is in contact with the second support substrate, a respective first segment of the first plurality of heating elements can be positioned and in contact with a respective first segment of the second plurality of heating elements, and a respective second segment of the first plurality of heating elements can be positioned and in contact with a respective second segment of the second plurality of heating elements.

In some implementations, the method can include coupling the first support substrate, the second support substrate, or a combination thereof to a surface of a secondary substrate. In certain implementations, the secondary substrate can include paper.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### BRIEF DESCRIPTION OF THE DRAWINGS

The accompanying drawings, which are incorporated in and constitute a part of this specification, show certain implementations of the subject matter disclosed herein and, together with the description, help explain some of the principles associated with the disclosed implementations. The patent or application file contains at least one drawing executed in color. Copies of this patent or patent application with color drawing(s) will be provided by the Office upon request and payment of the necessary fee. In the drawings:

FIG. 1A illustrates a block diagram of a vaporizer device, consistent with implementations of the current subject matter;

FIG. 1B illustrates a block diagram of a vaporizer device, consistent with implementations of the current subject matter;

FIG. 1C illustrates a block diagram of a vaporizer device, consistent with implementations of the current subject matter;

FIG. 2 illustrates a front perspective view of an implementation of a vaporizer device, consistent with implementations of the current subject matter;

FIG. 3 illustrates a front perspective exploded view of an implementation of a cartridge for use with a vaporizer device, consistent with implementations of the current subject matter;

FIG. 4A illustrates a cross-sectional view of a vaporizer device, consistent with implementations of the current subject matter;

FIG. 4B illustrates a front cross-sectional view of the vaporizer device of FIG. 4A, consistent with implementations of the current subject matter;

FIG. 4C illustrates a front cross-sectional view of a vaporizer device, consistent with implementations of the current subject matter;

FIG. 4D illustrates a front cross-sectional view of a vaporizer device, consistent with implementations of the current subject matter;

FIG. 4E illustrates a front cross-sectional view of a vaporizer device, consistent with implementations of the current subject matter;

FIG. 4F illustrates a front cross-sectional view of a vaporizer device, consistent with implementations of the current subject matter;

FIG. 4G illustrates a front cross-sectional view of a vaporizer device, consistent with implementations of the current subject matter;

FIG. 4H illustrates a front cross-sectional view of a vaporizer device, consistent with implementations of the current subject matter;

FIG. 41 illustrates a front cross-sectional view of a vaporizer device, consistent with implementations of the current subject matter;

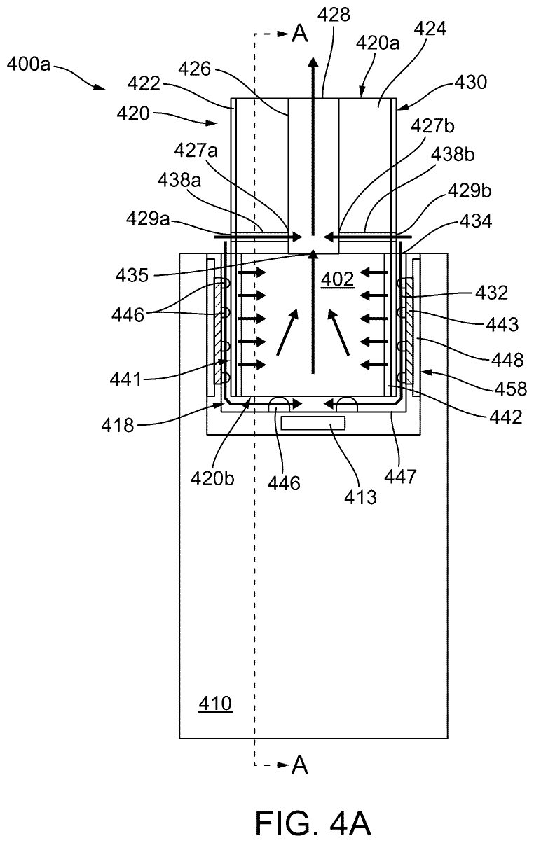

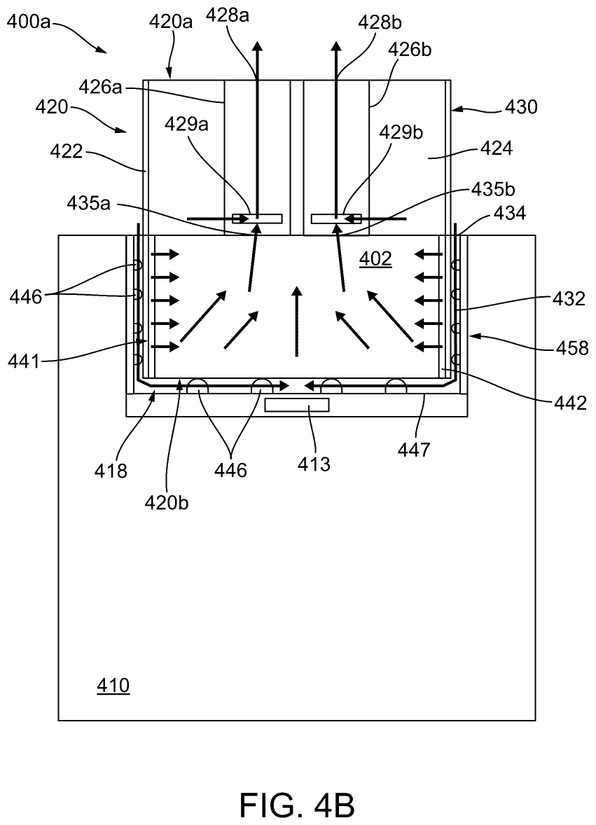

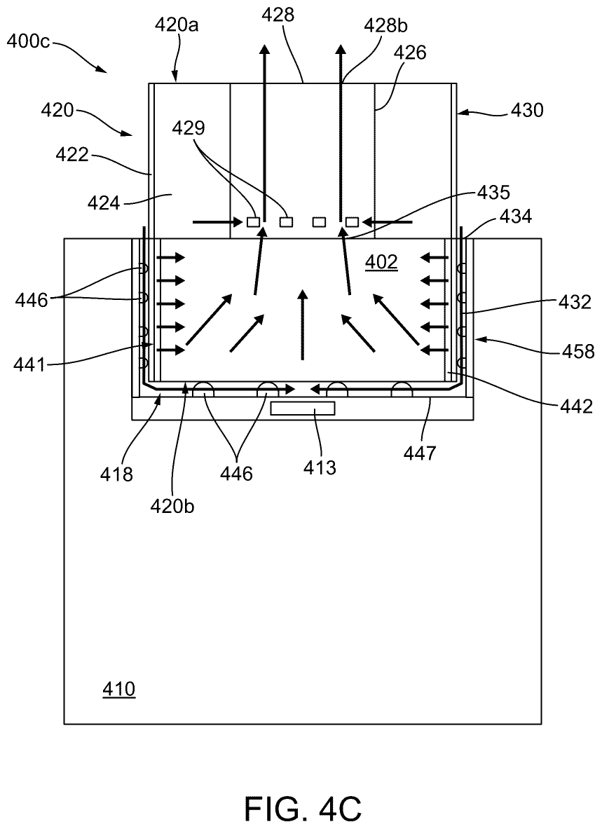

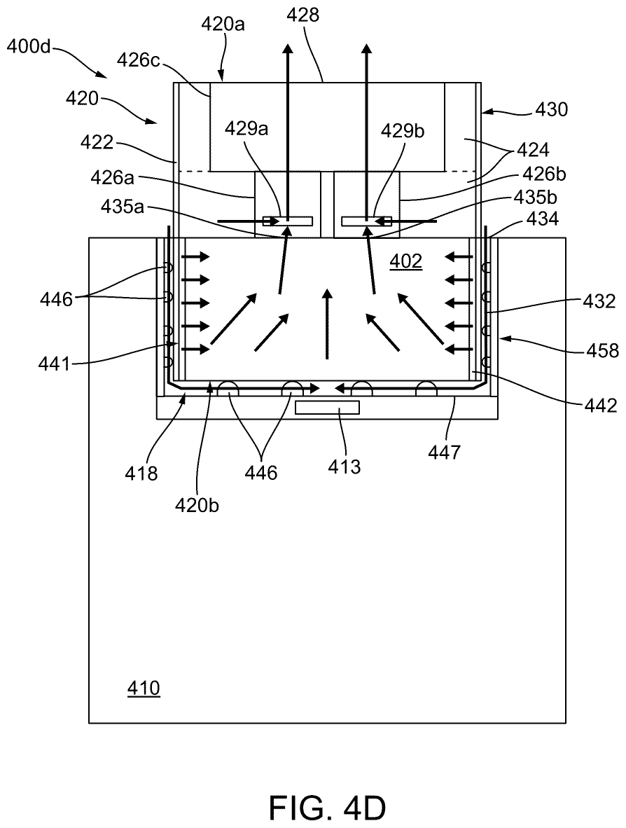

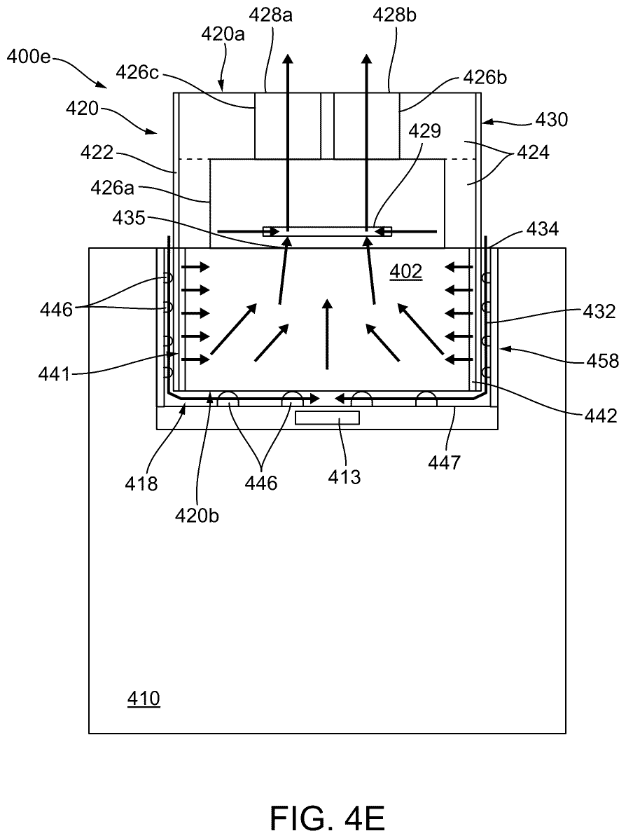

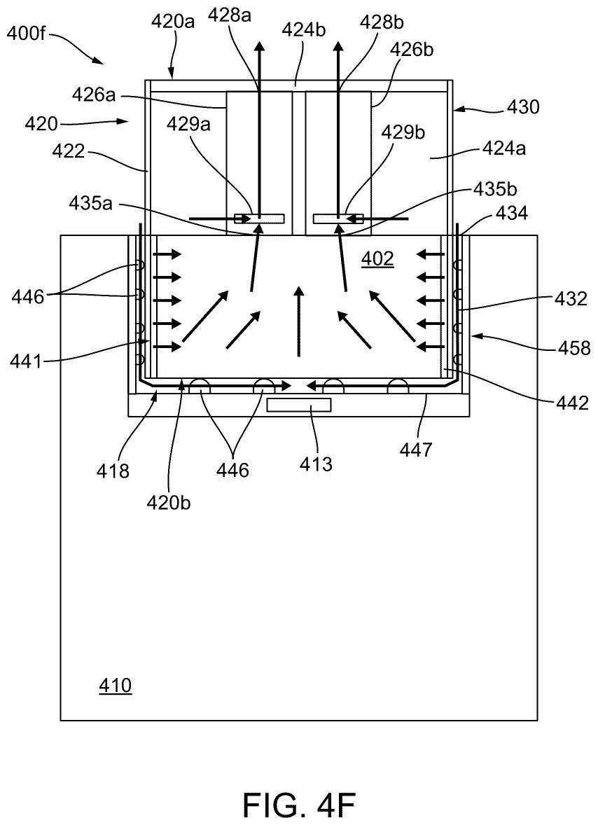

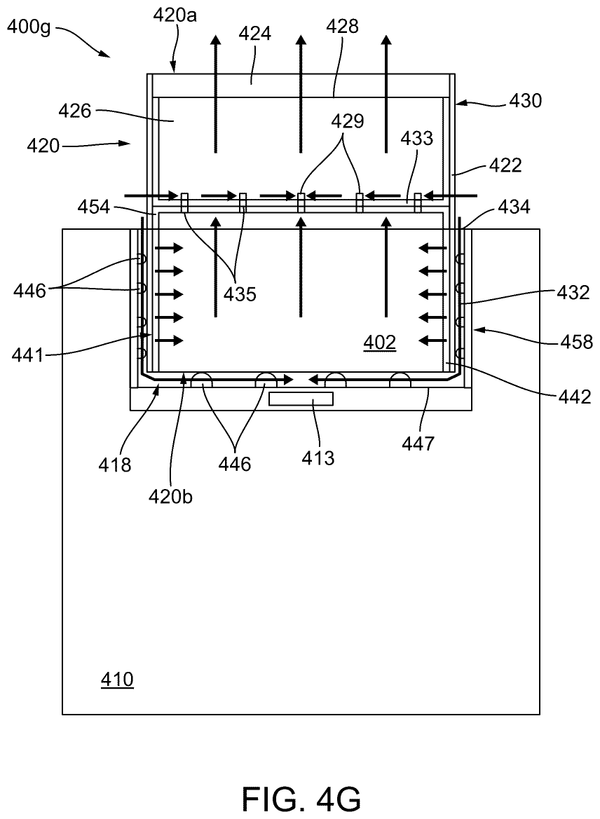

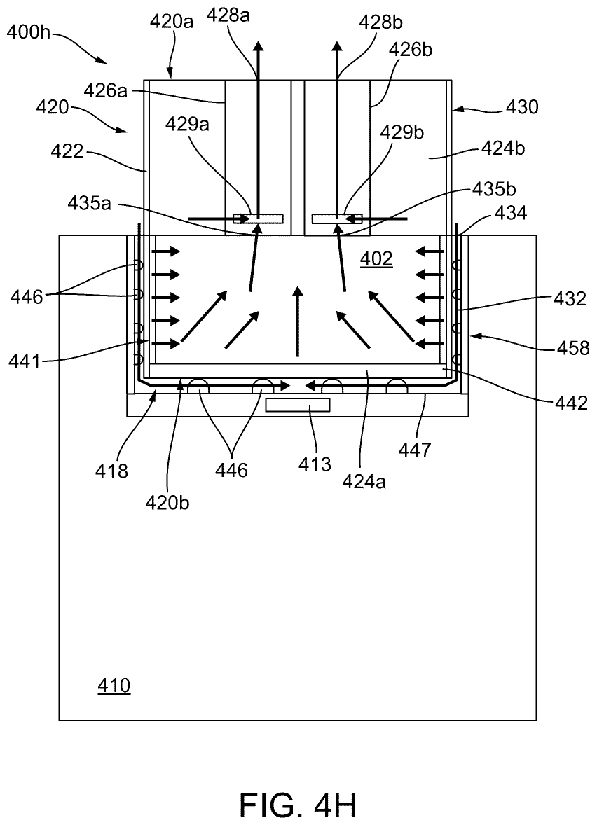

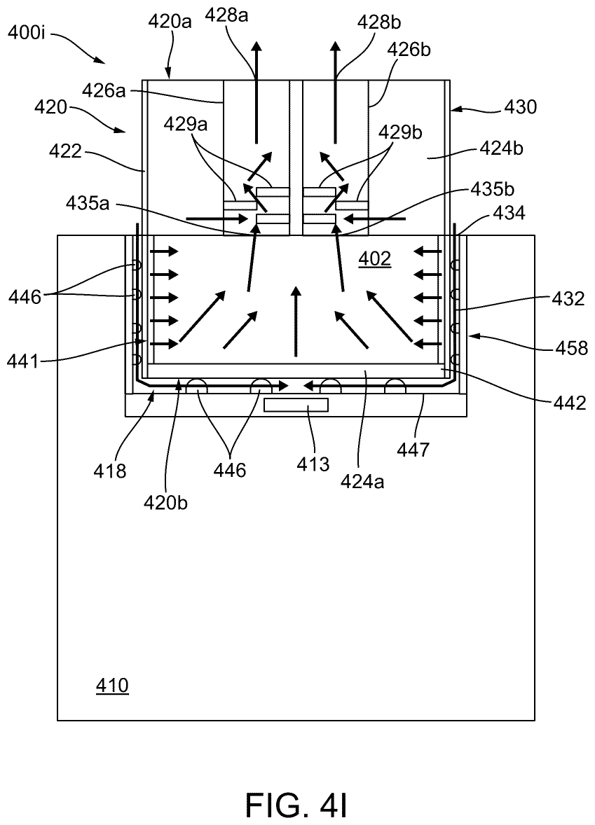

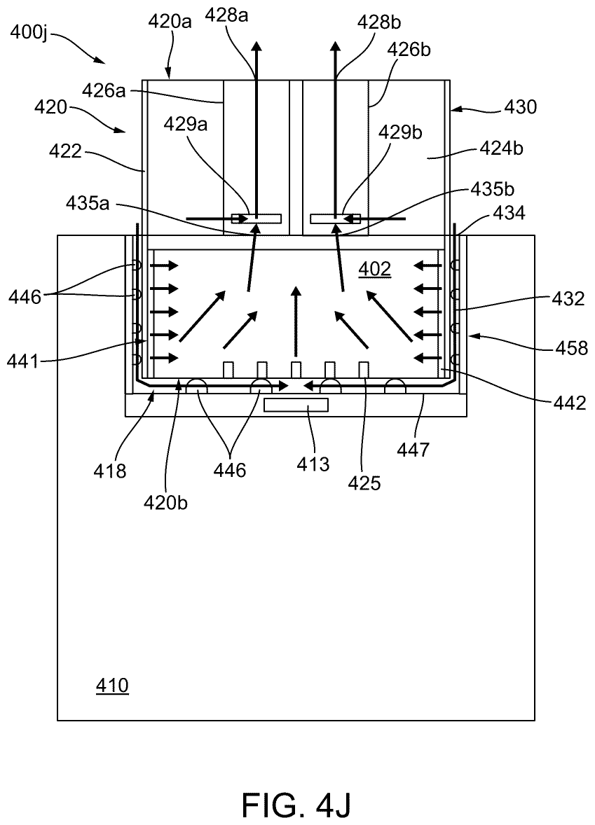

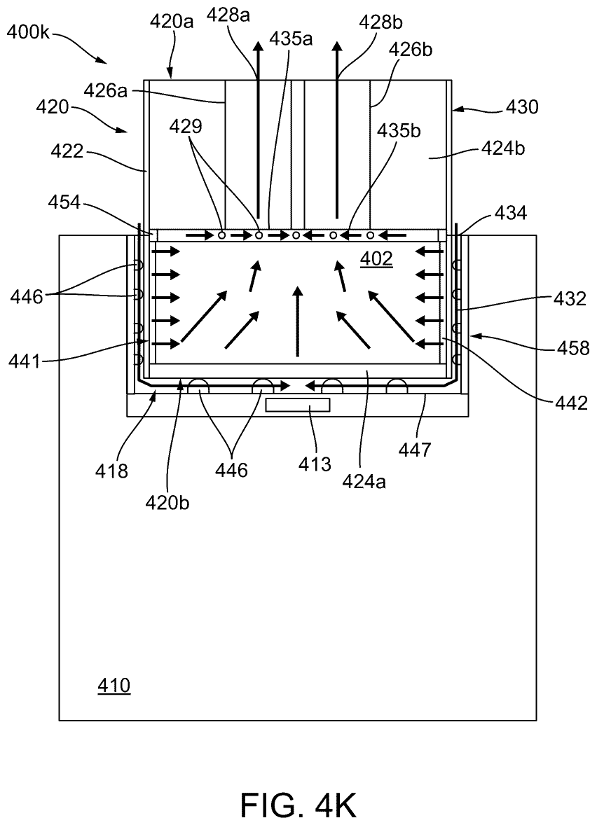

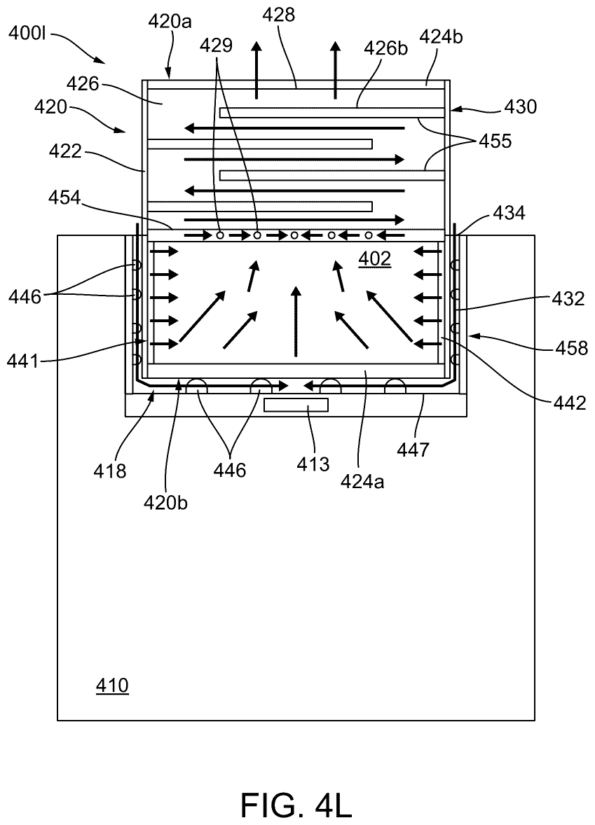

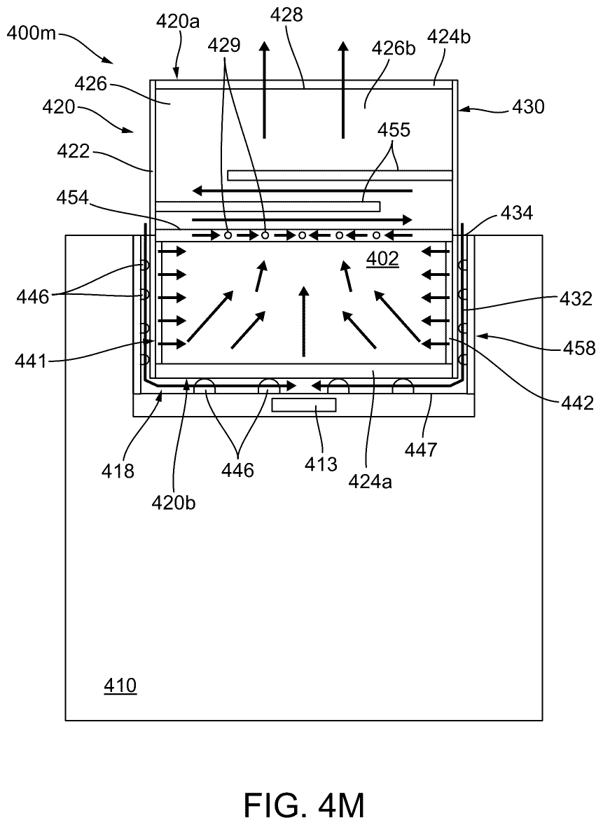

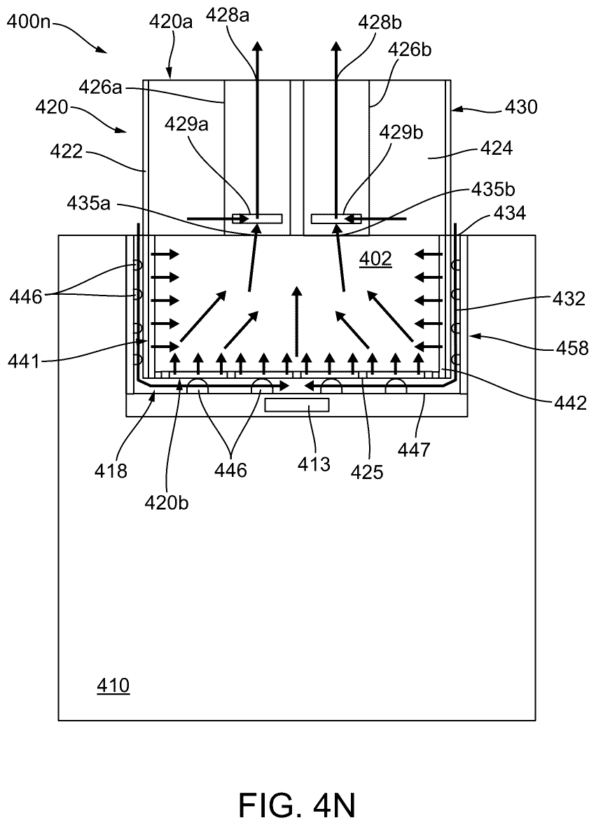

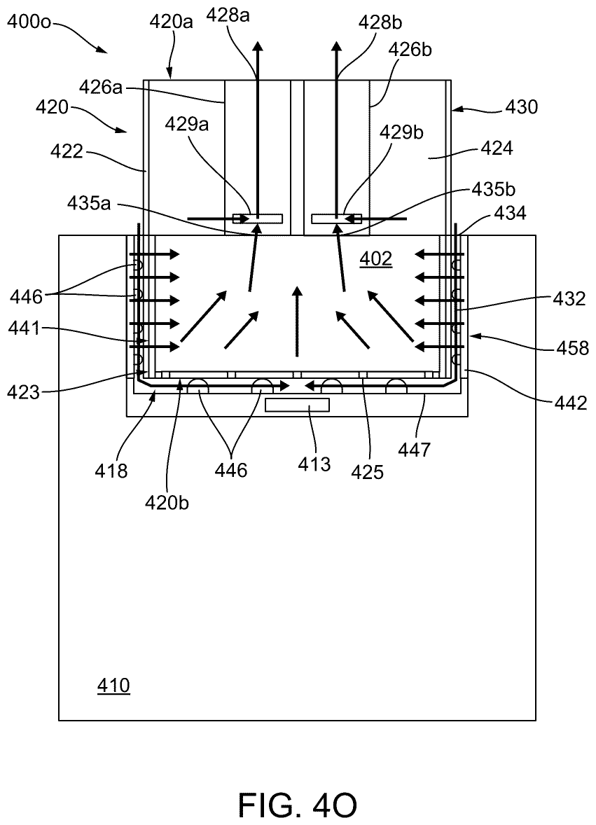

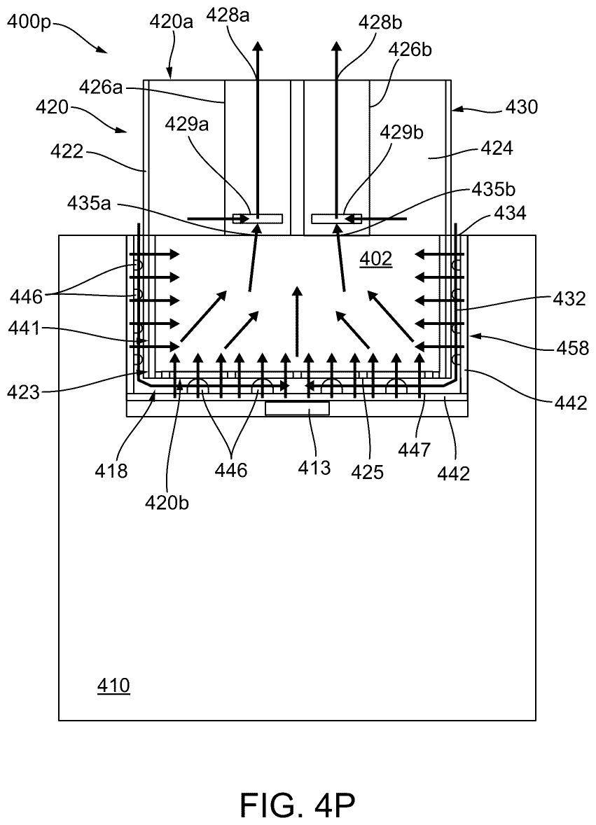

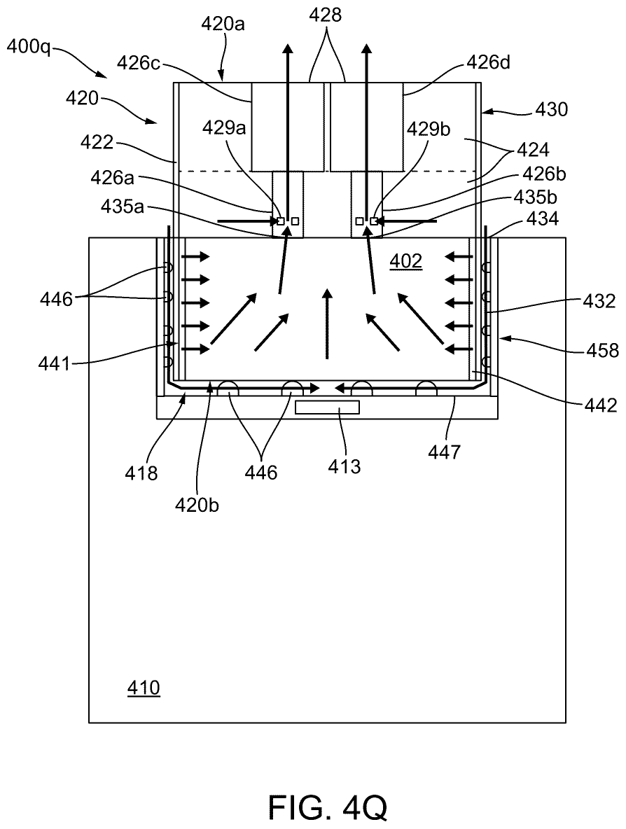

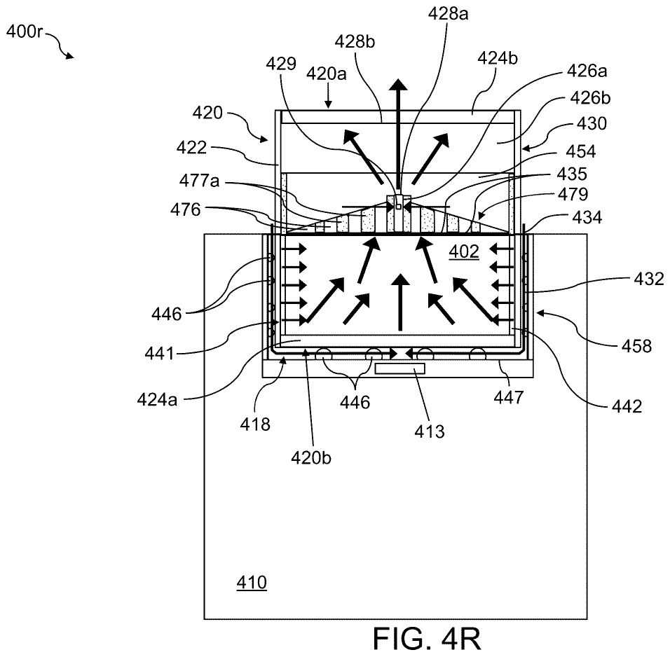

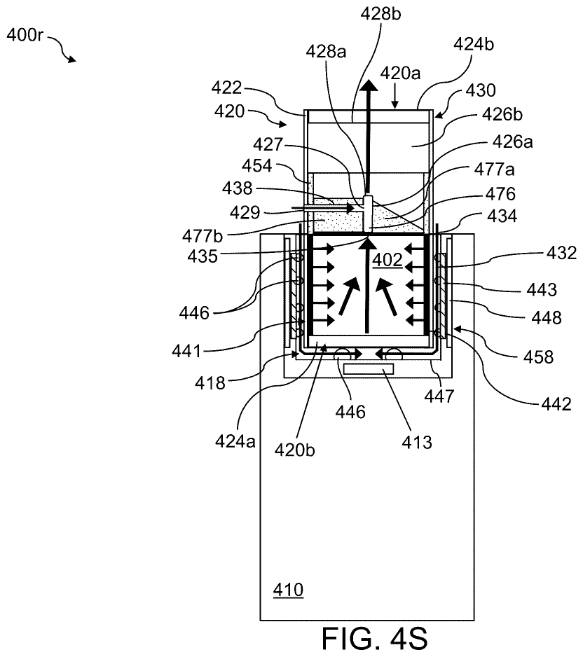

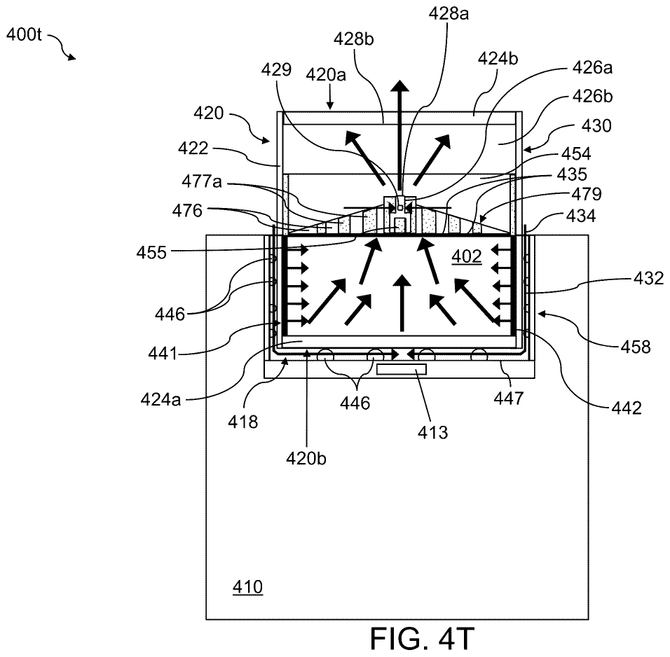

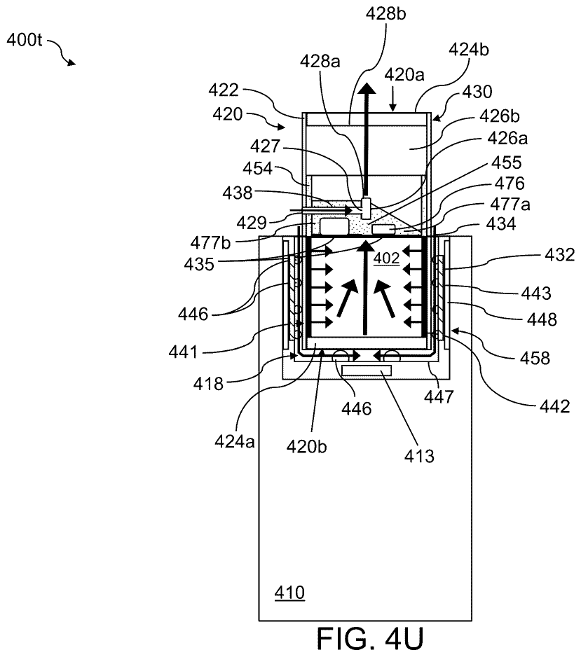

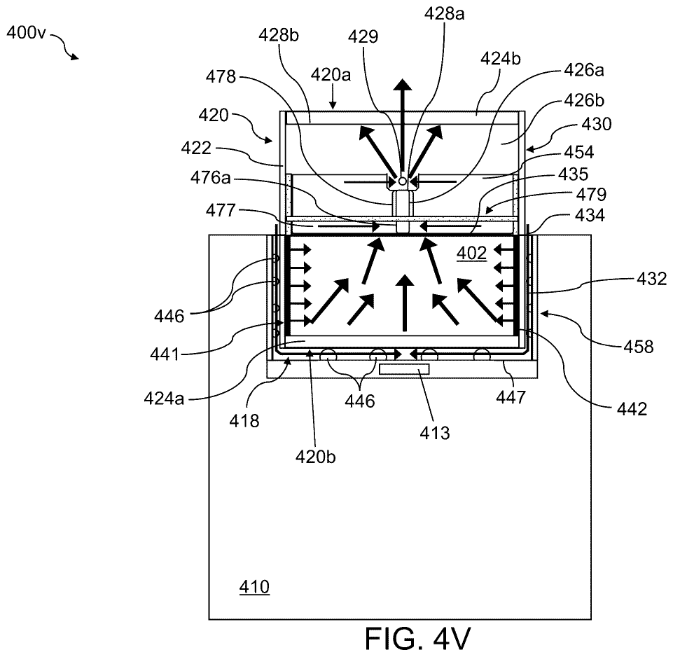

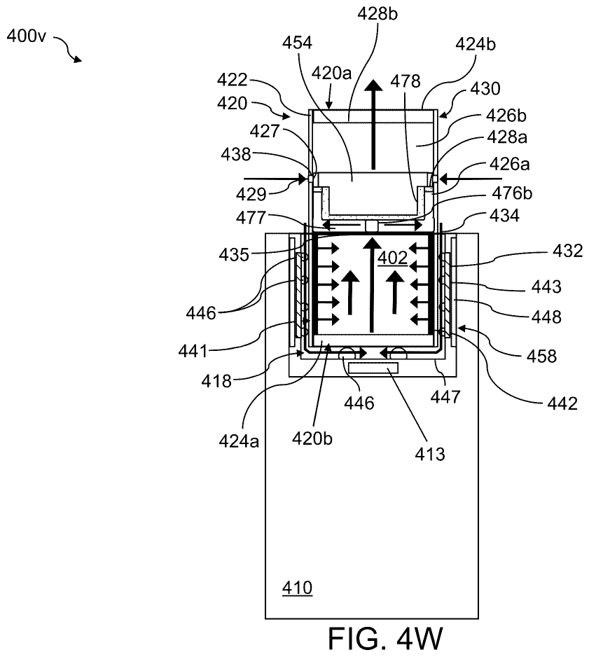

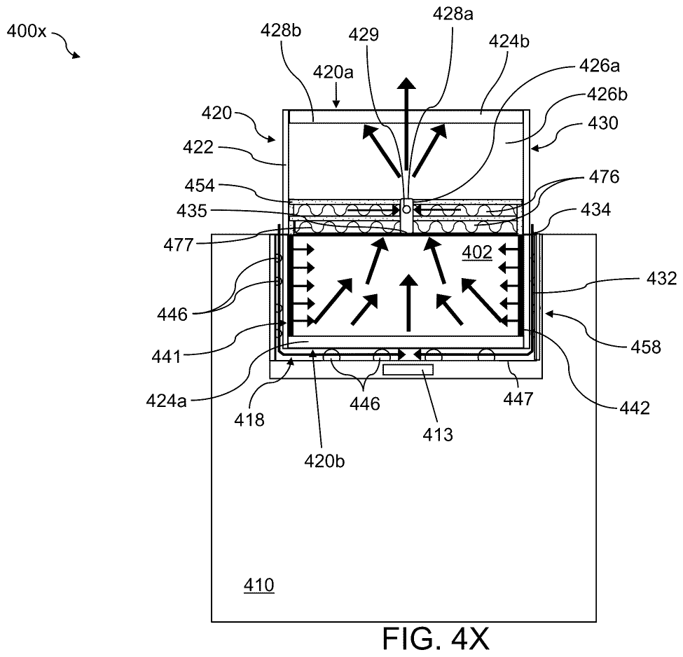

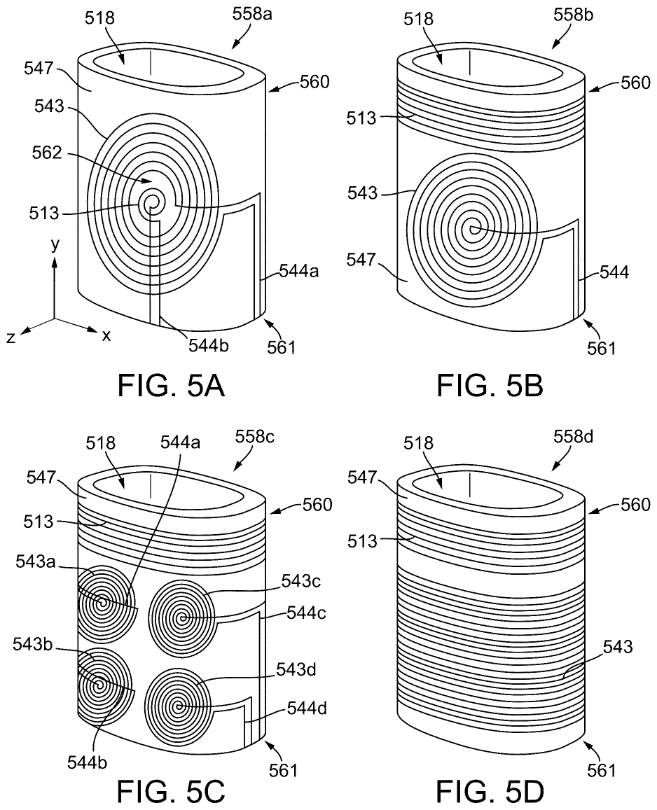

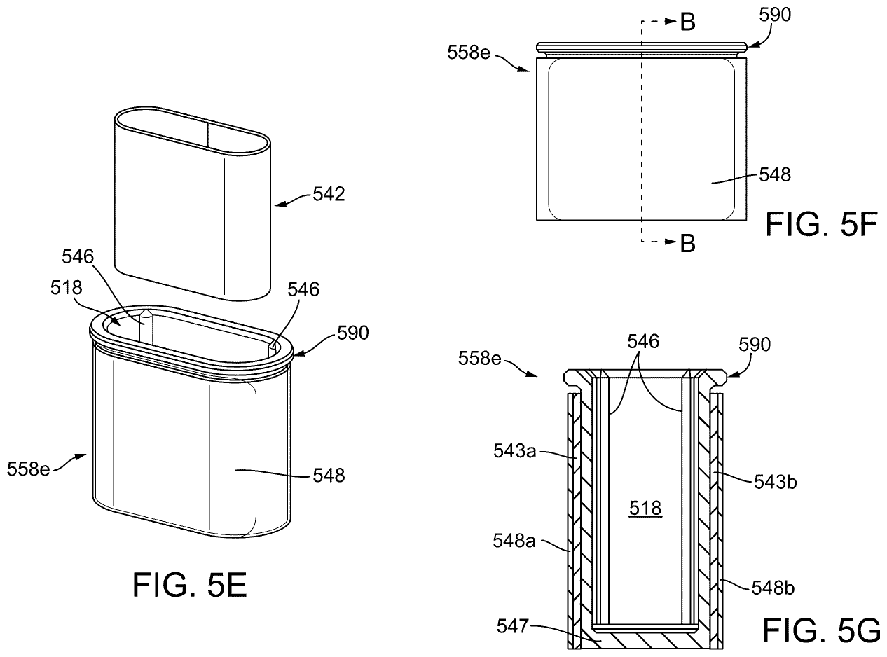

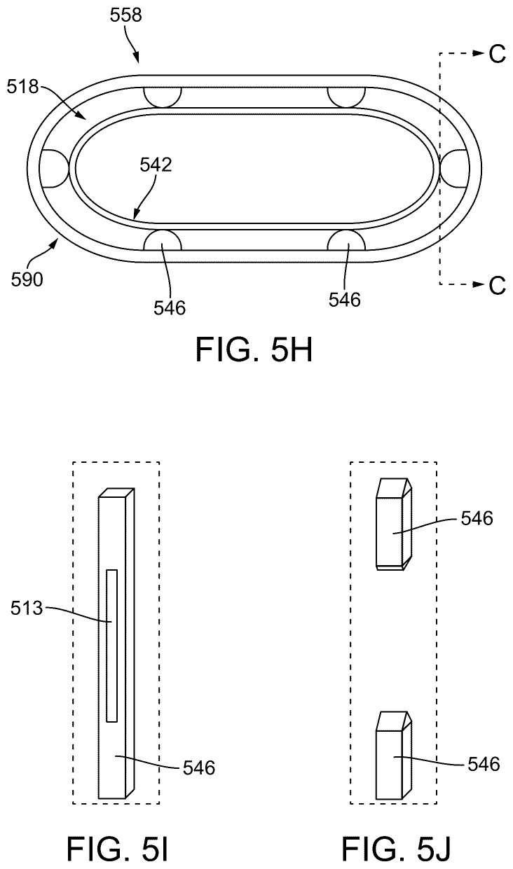

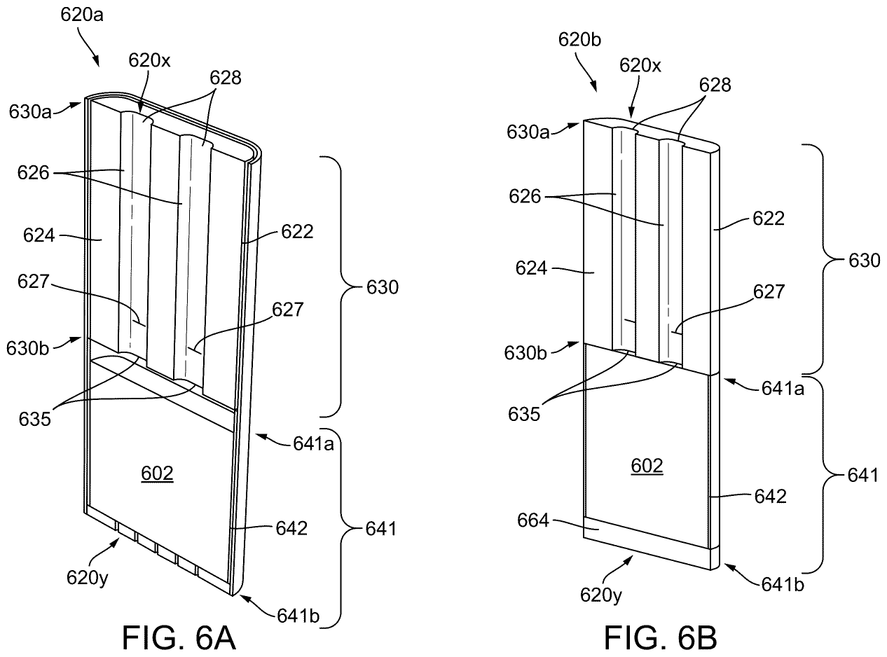

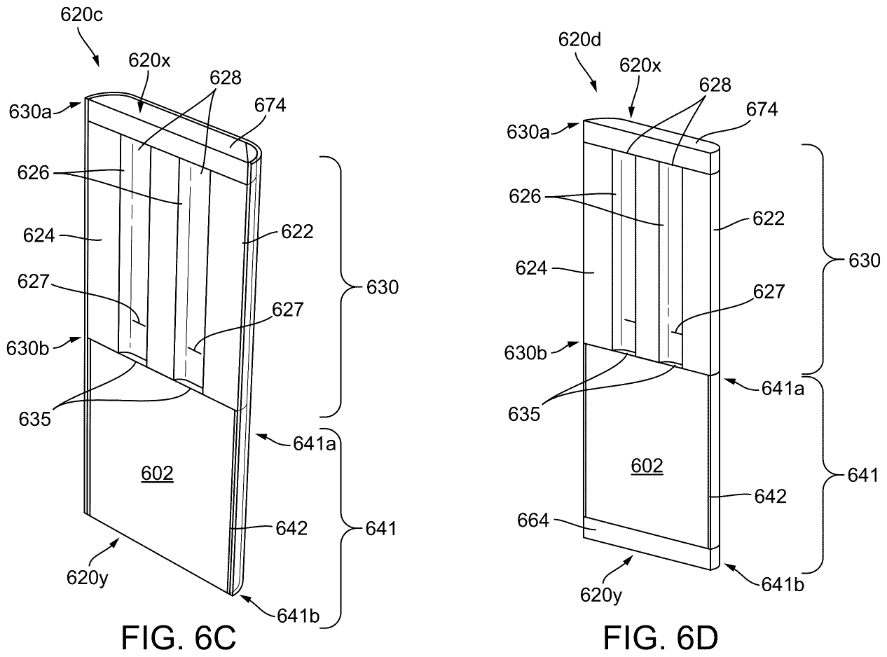

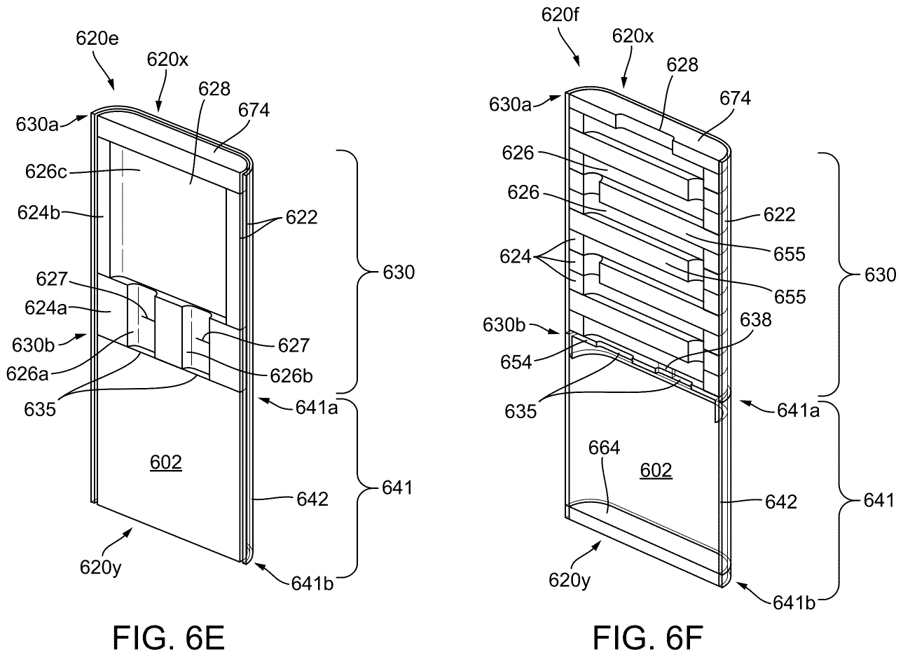

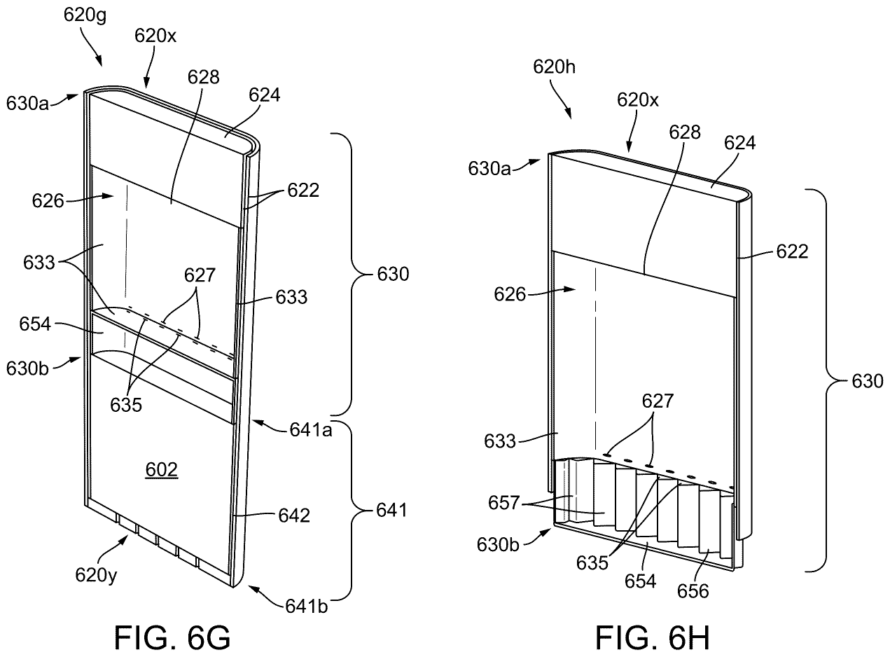

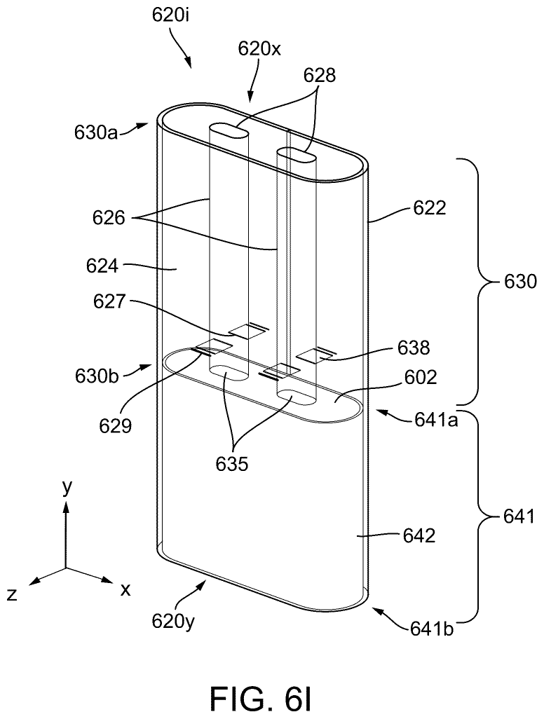

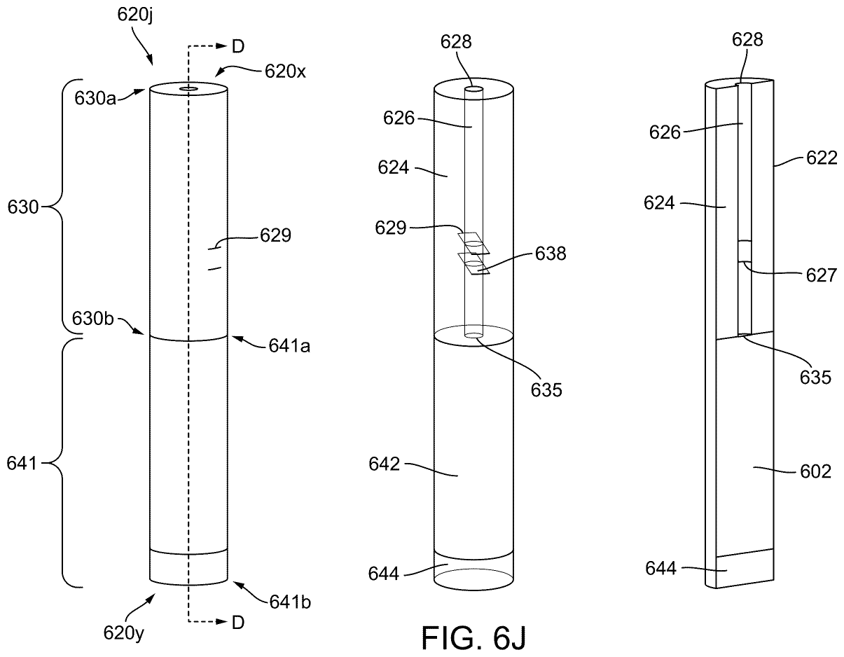

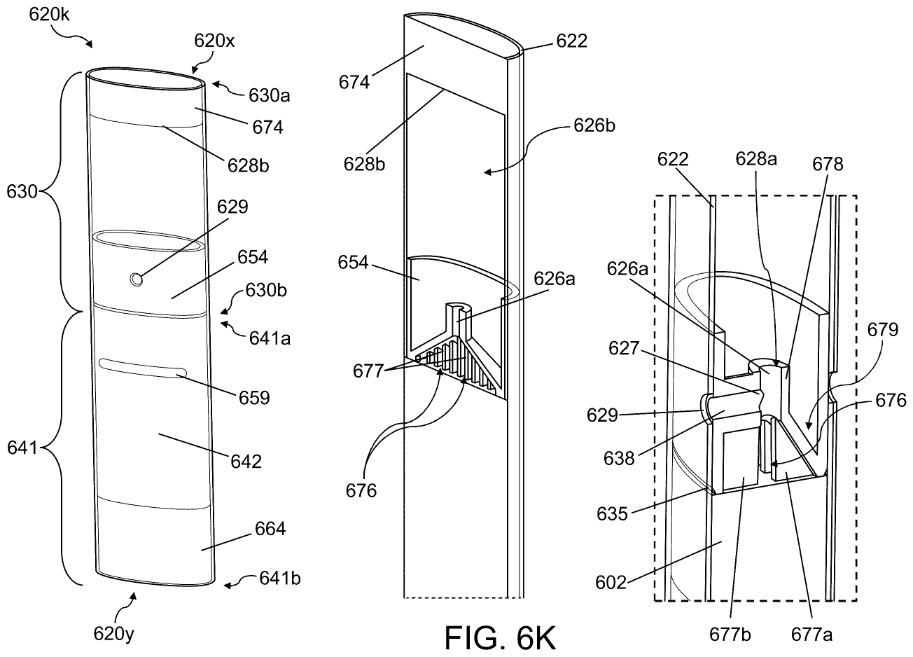

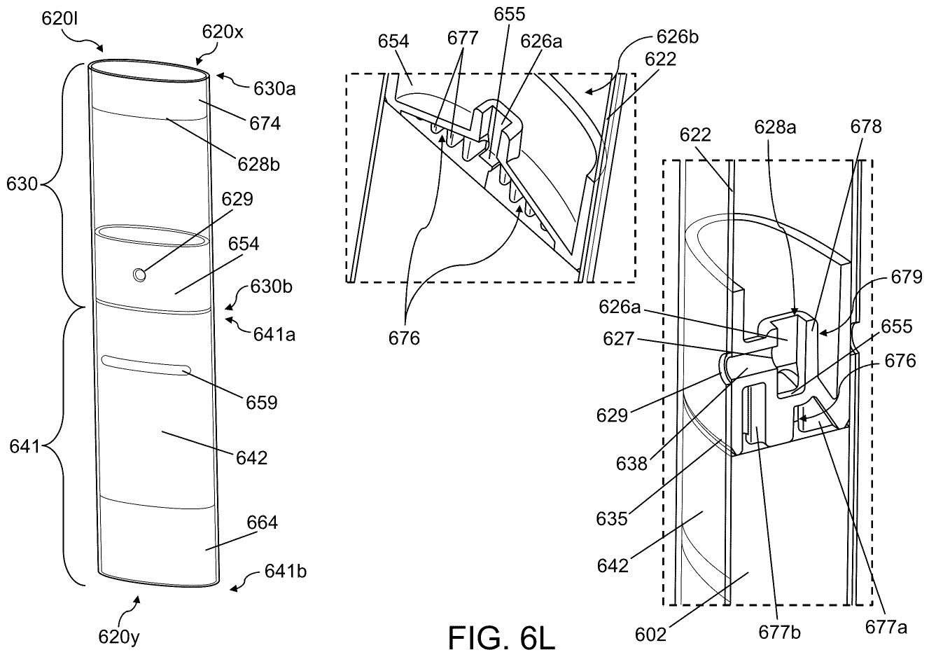

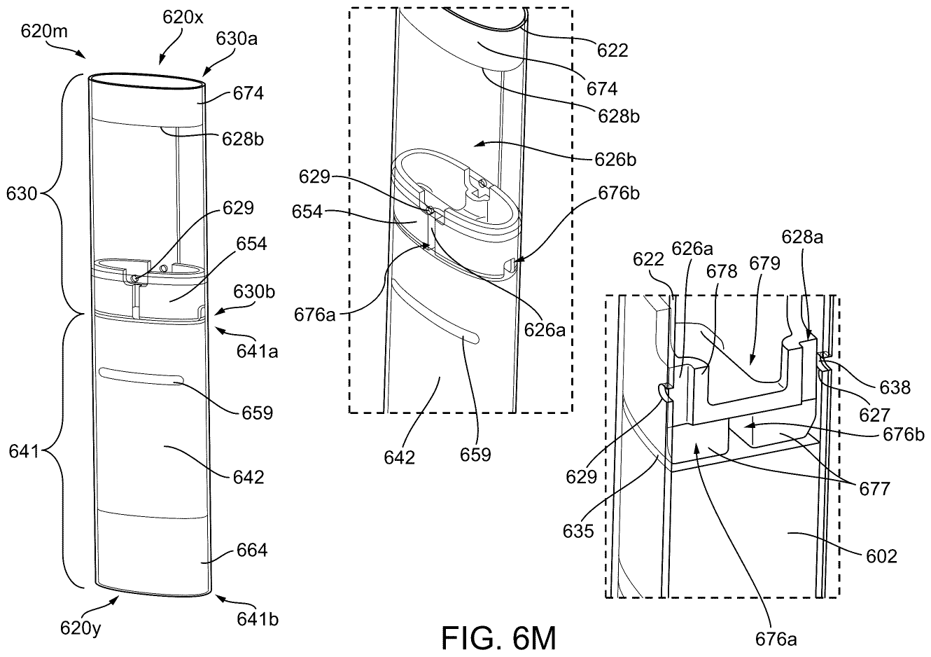

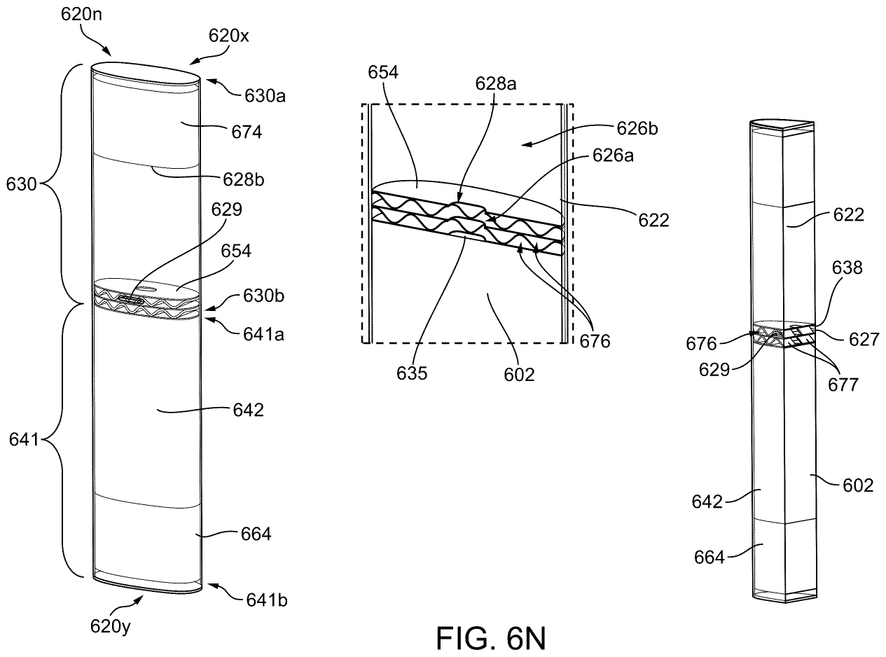

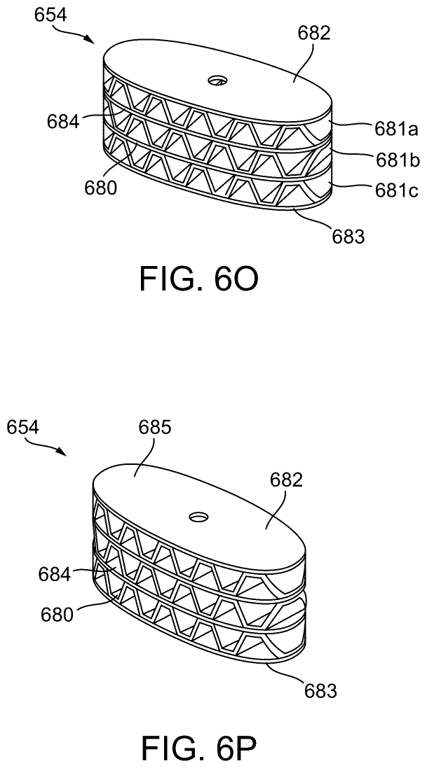

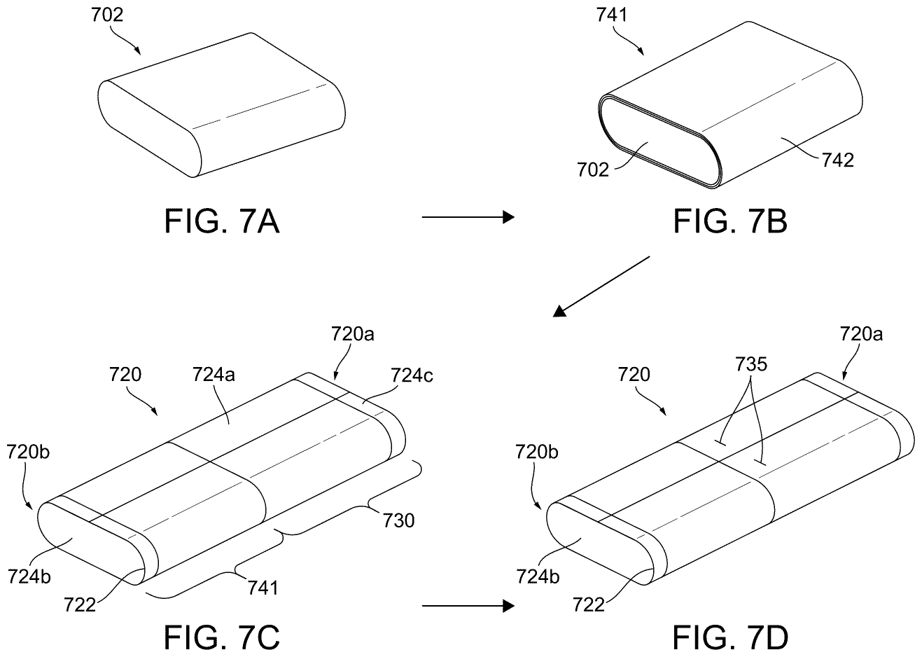

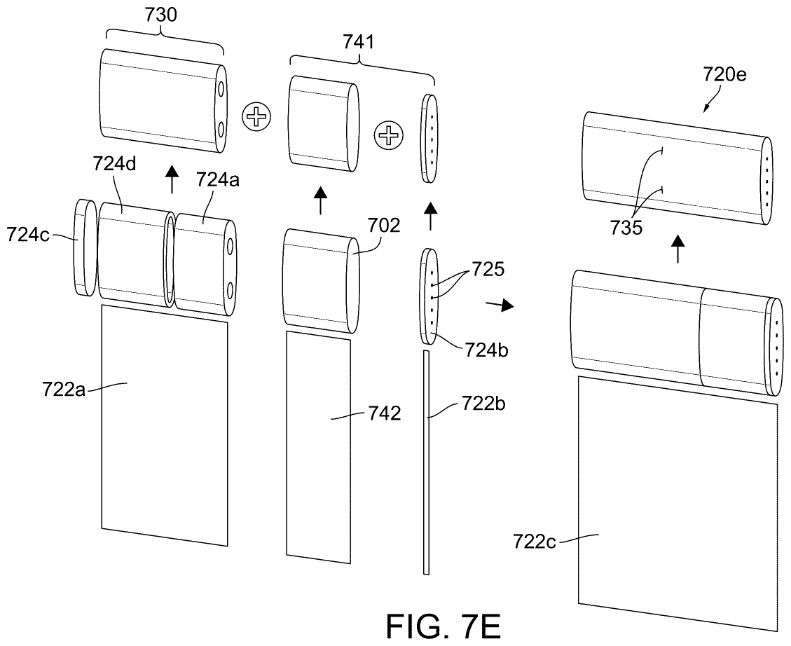

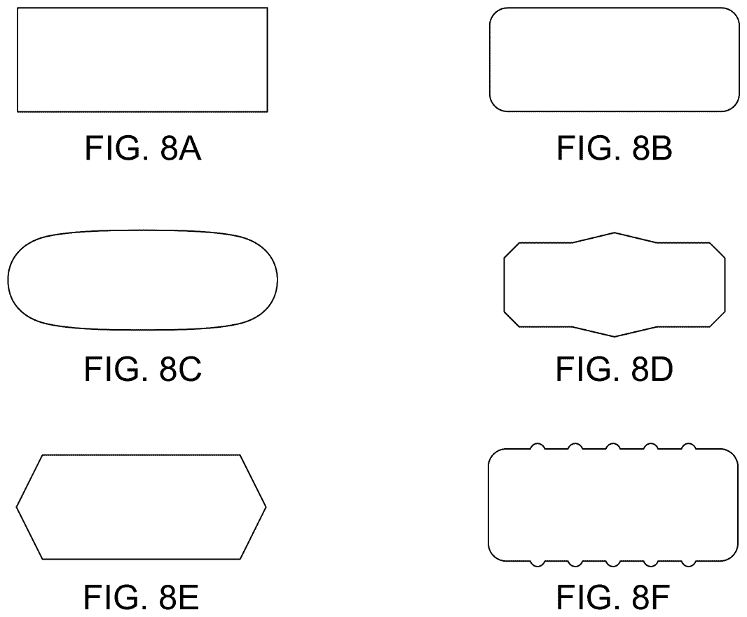

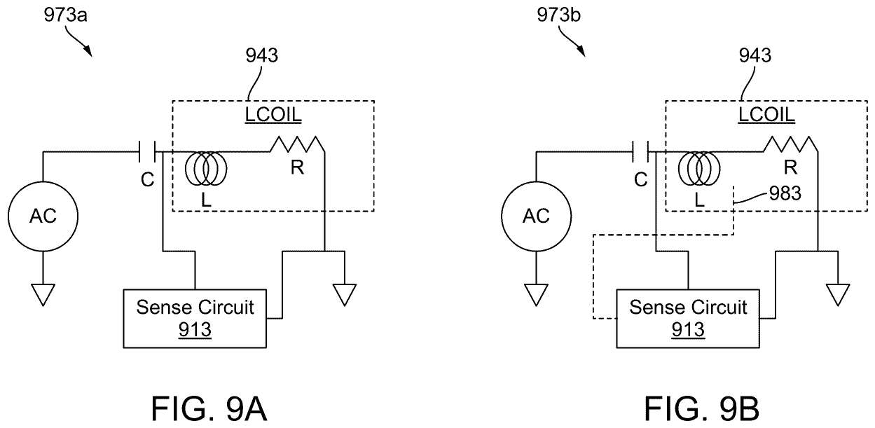

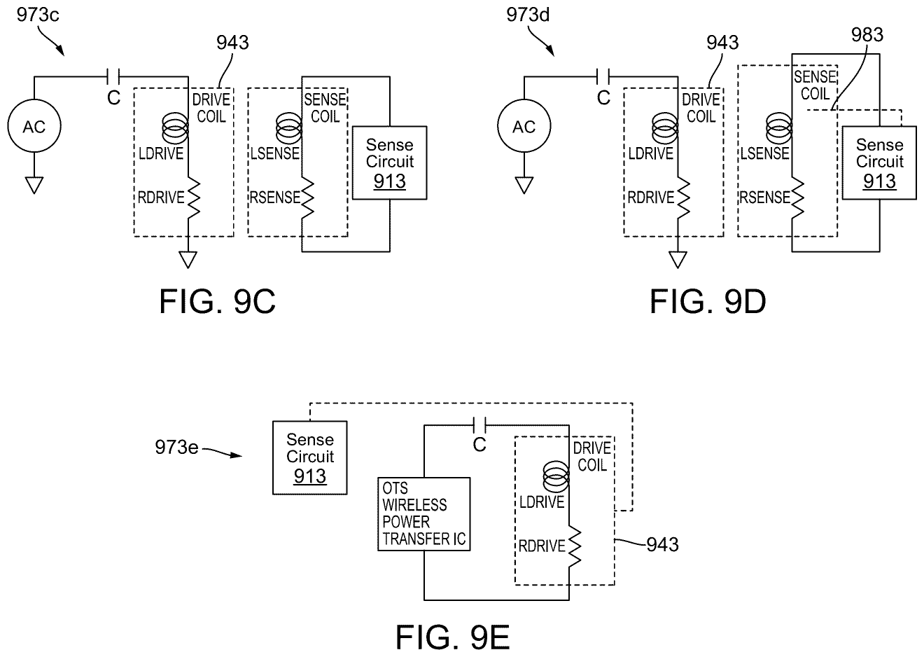

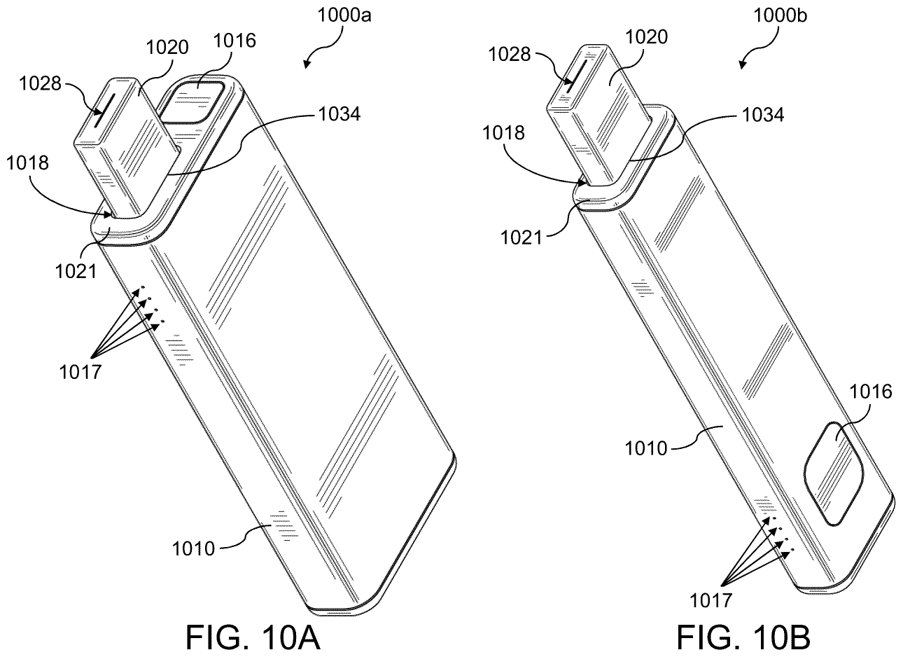

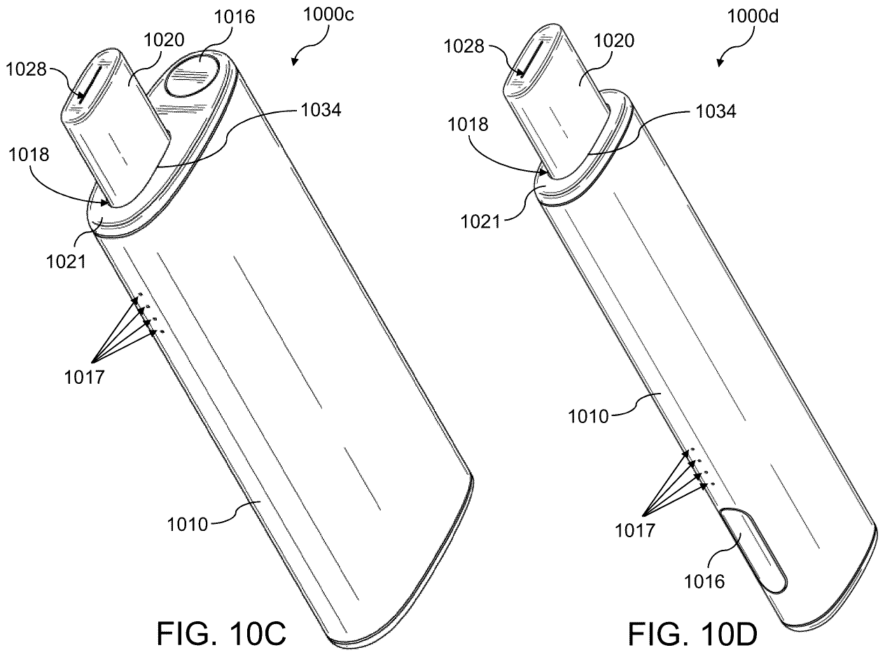

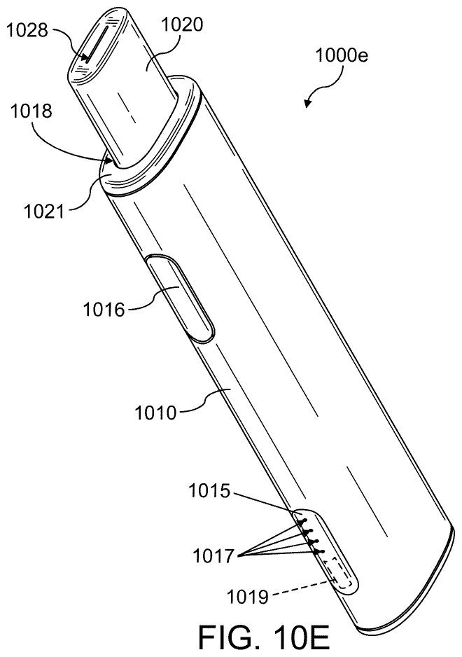

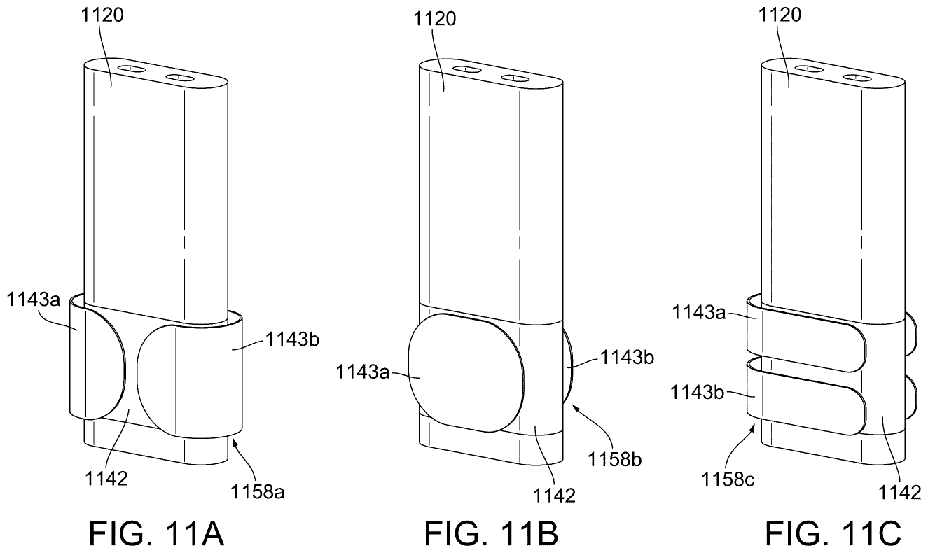

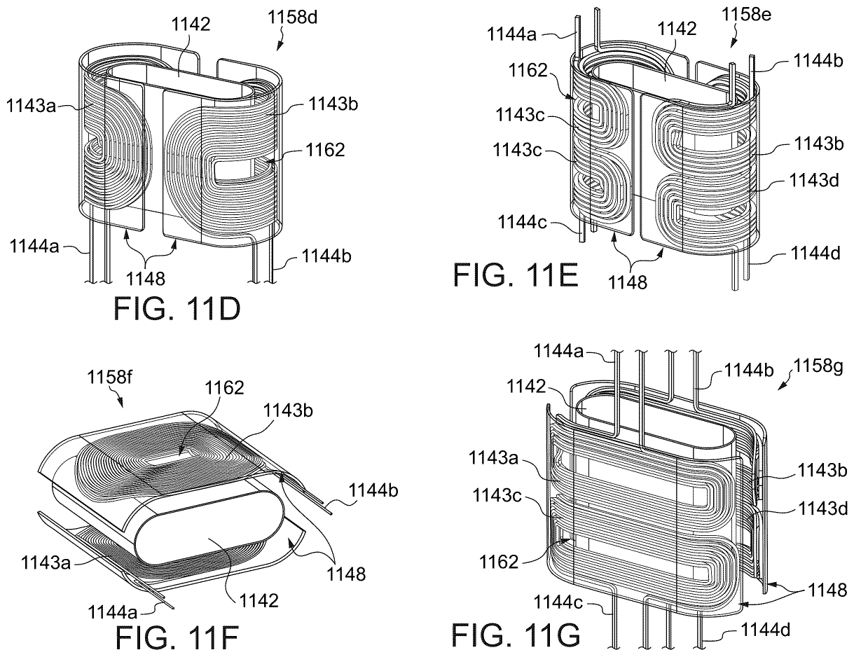

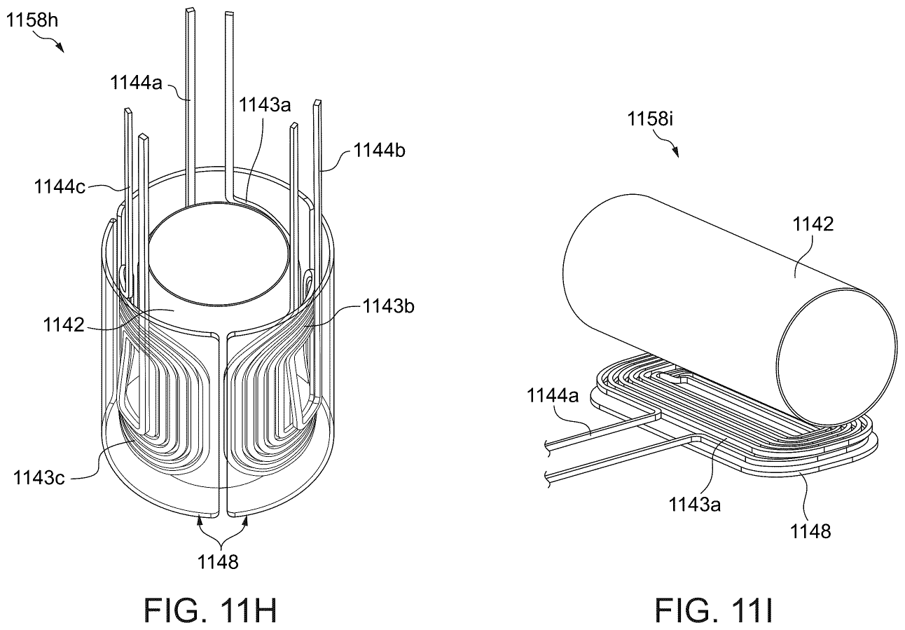

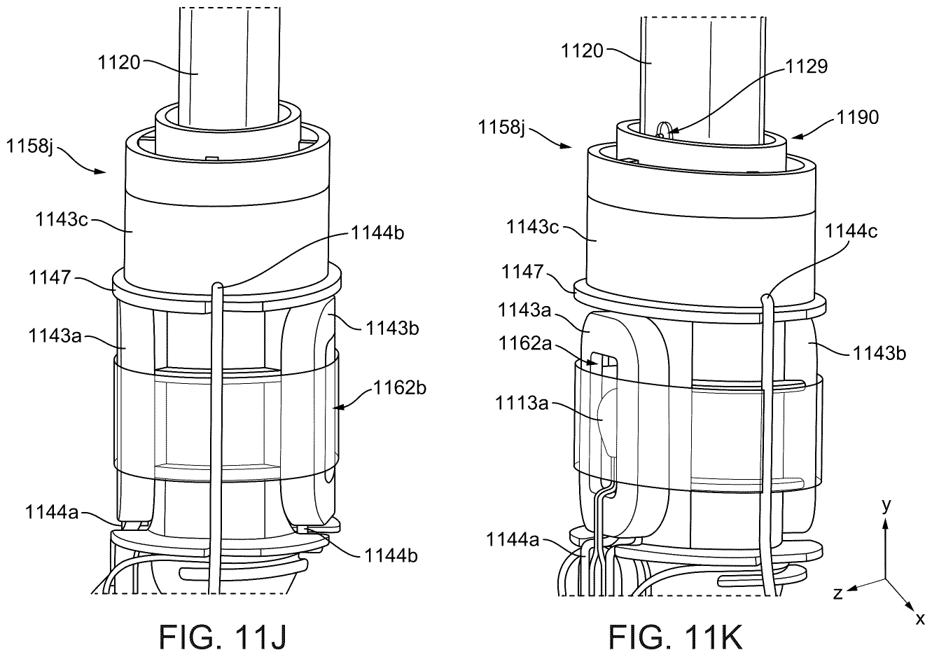

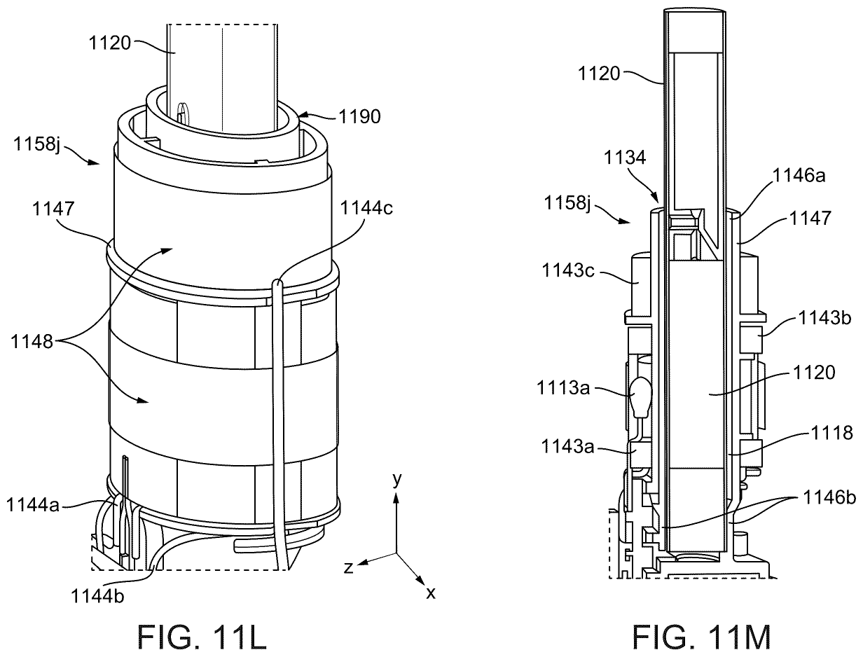

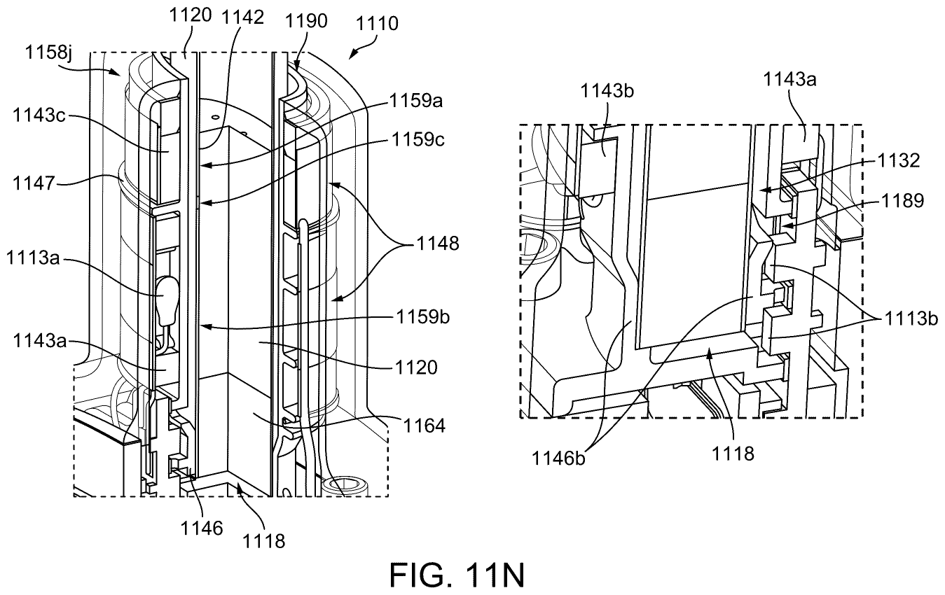

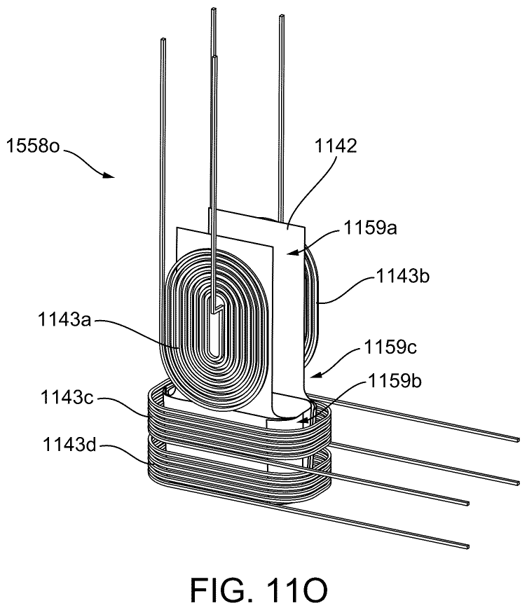

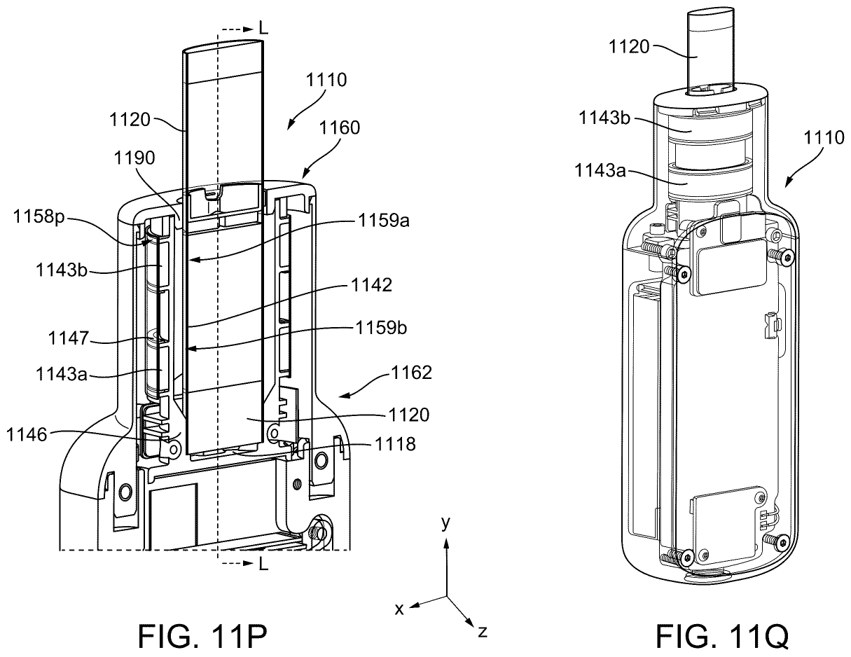

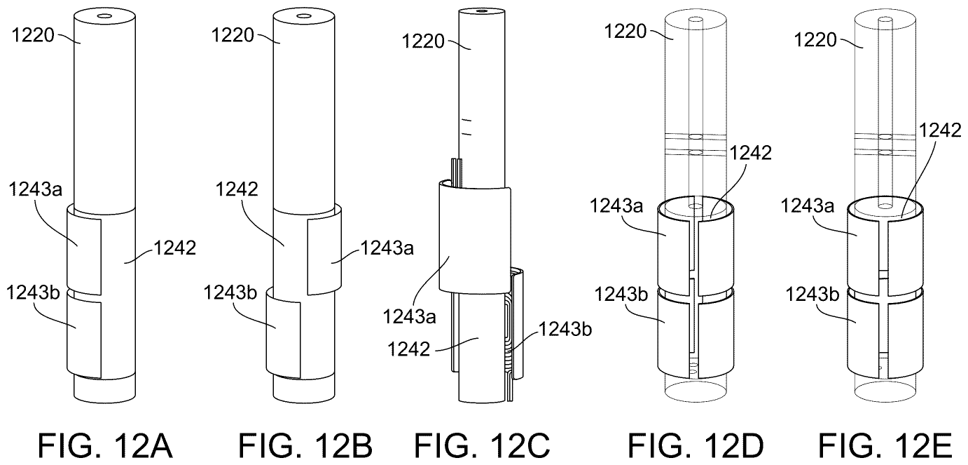

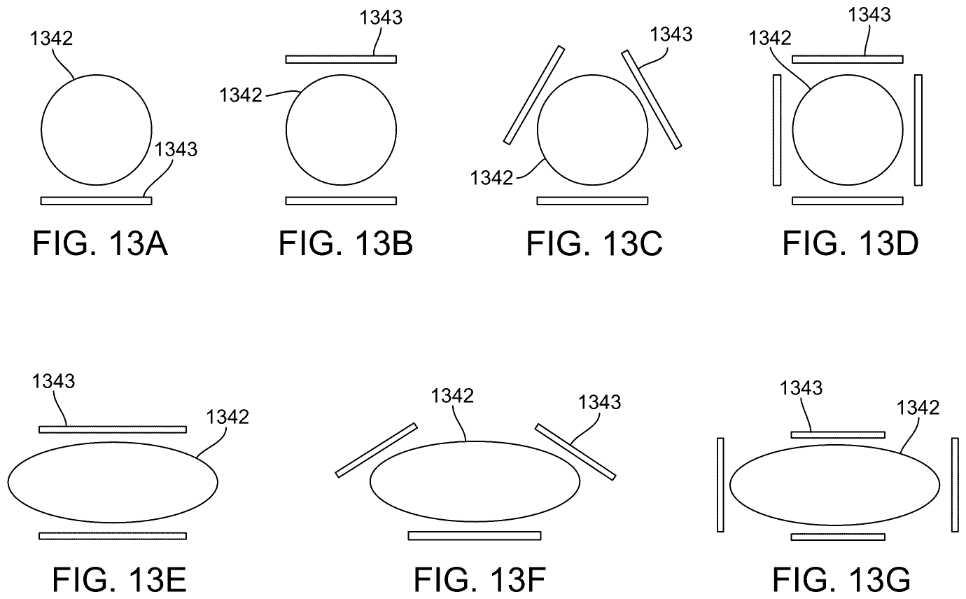

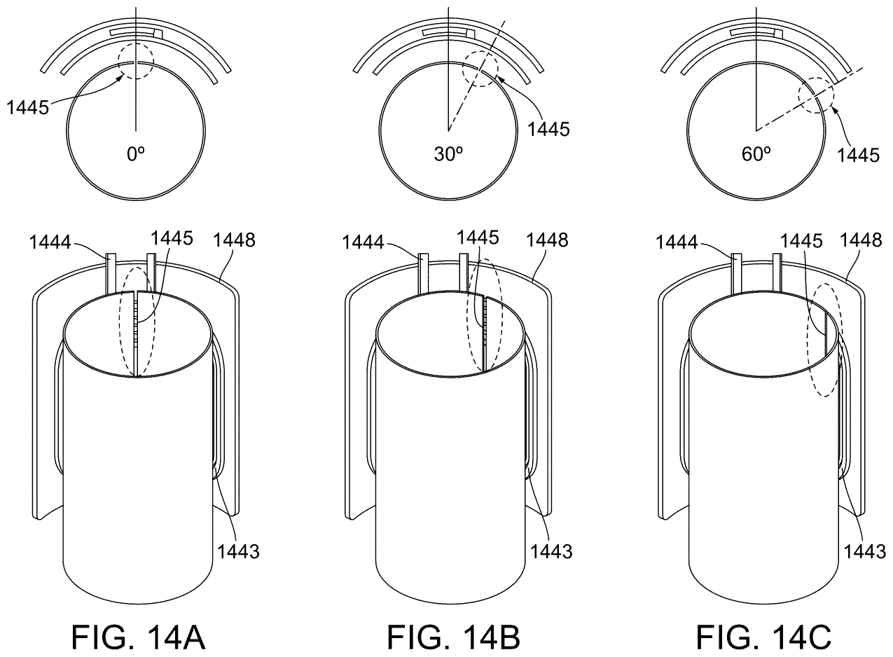

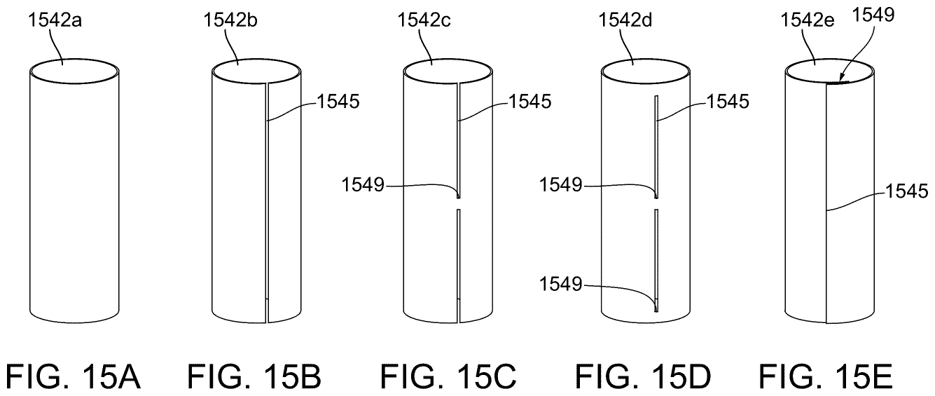

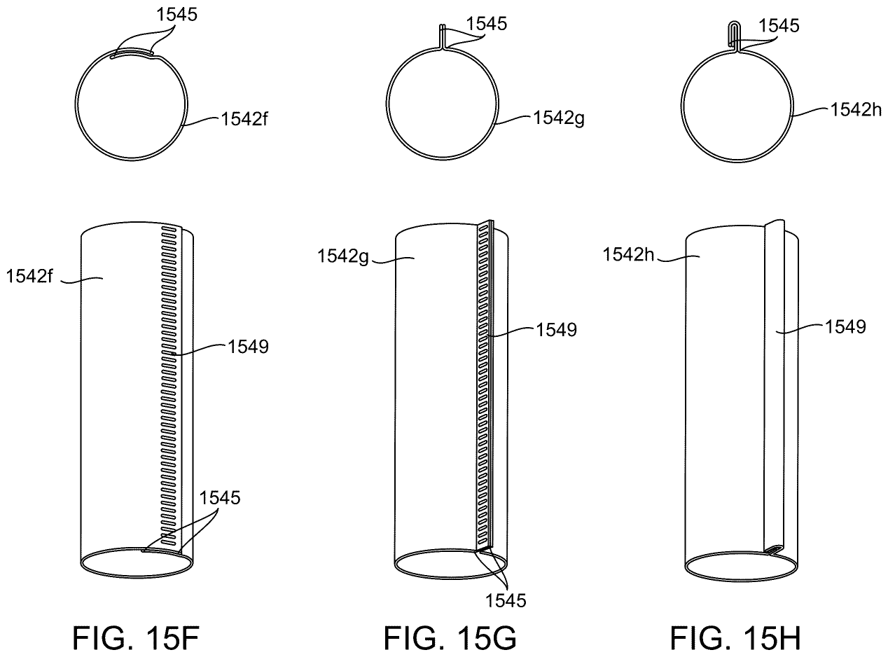

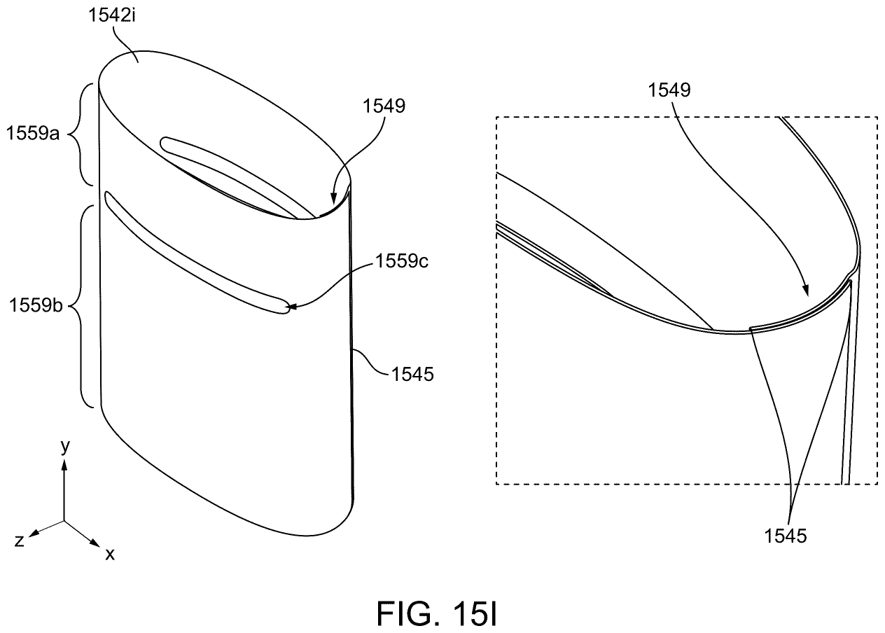

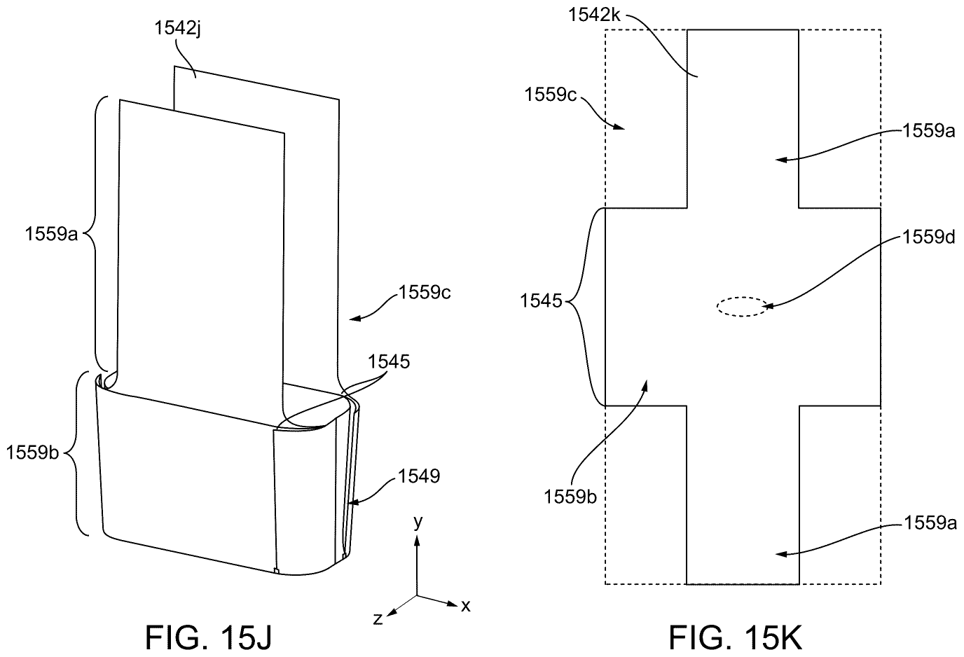

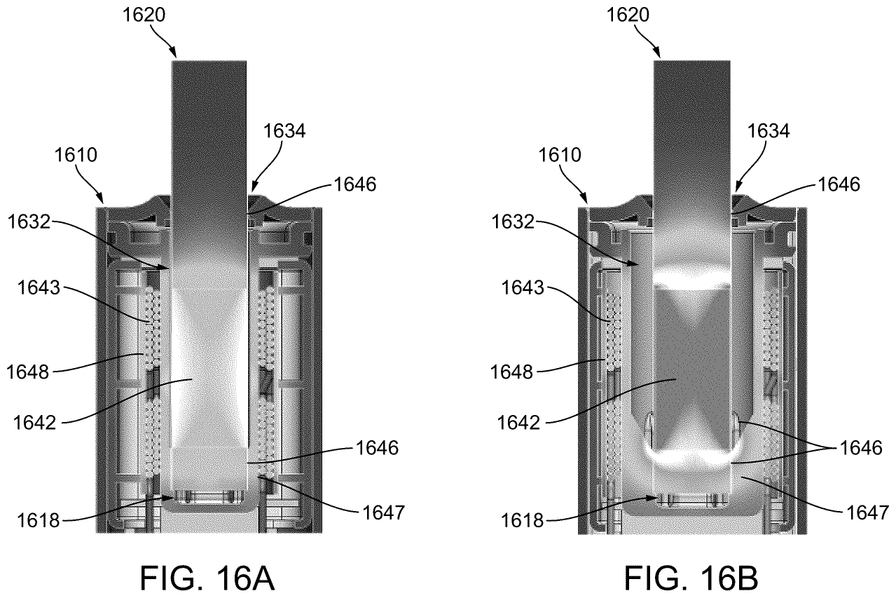

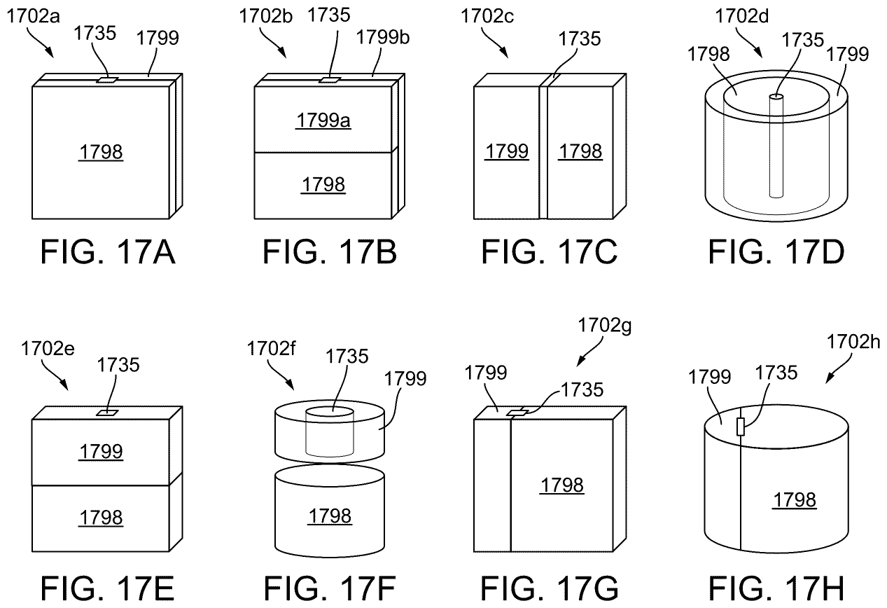

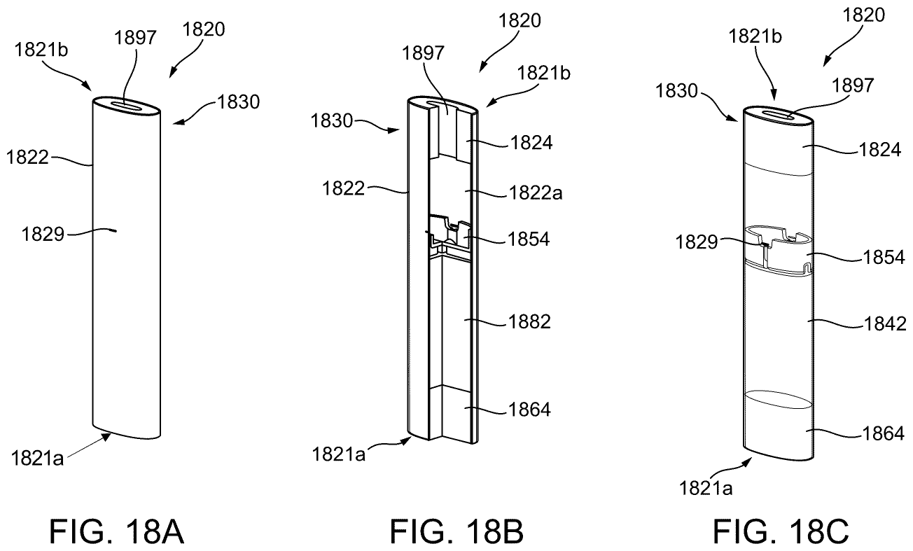

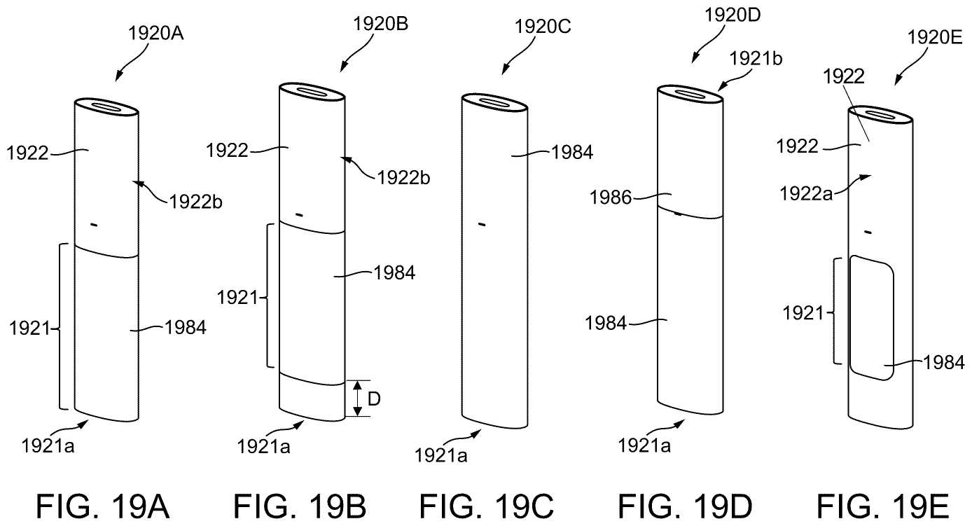

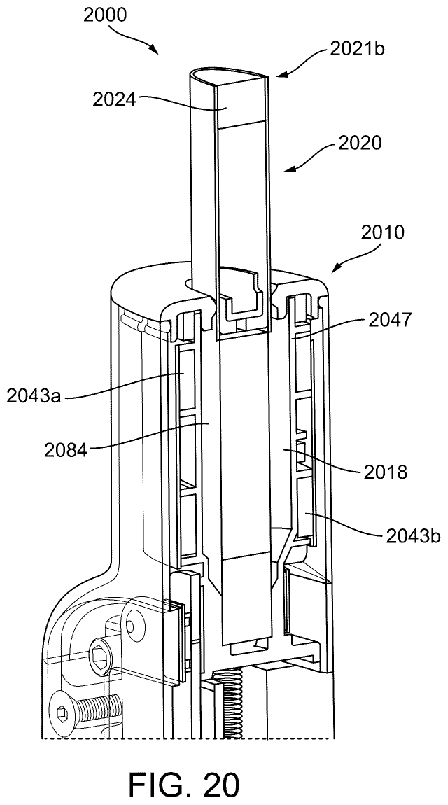

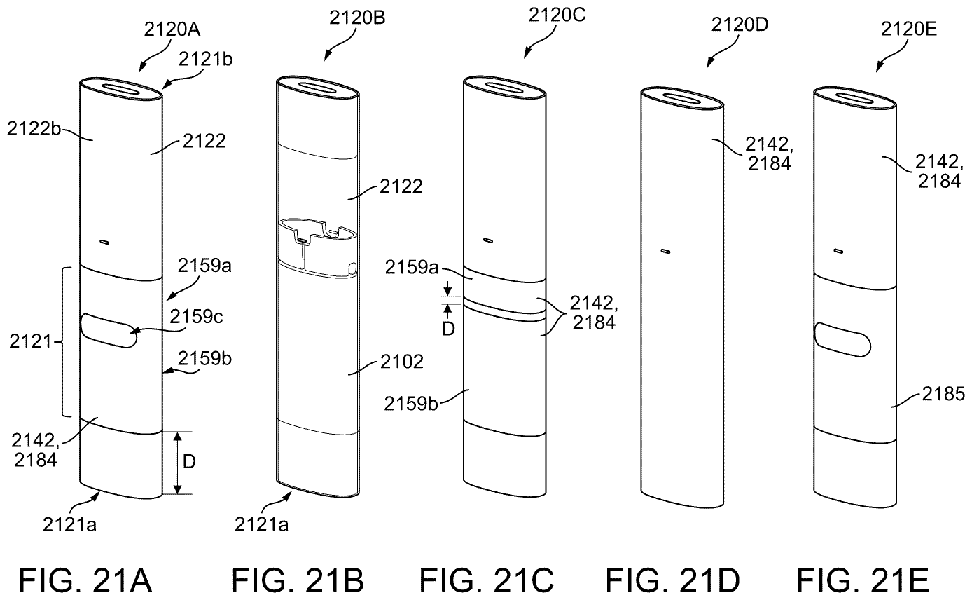

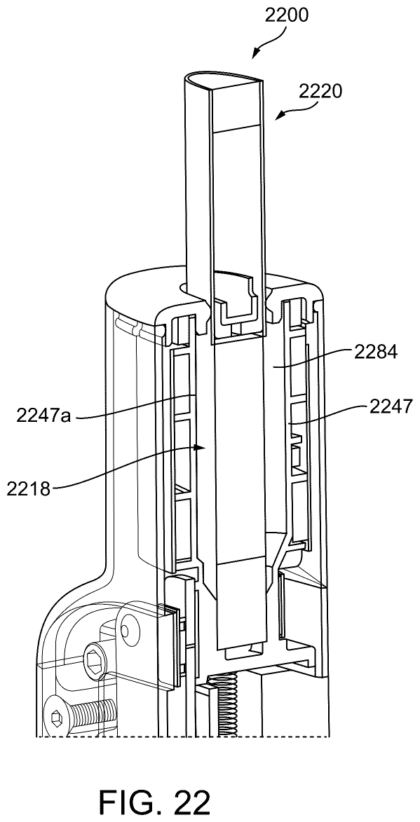

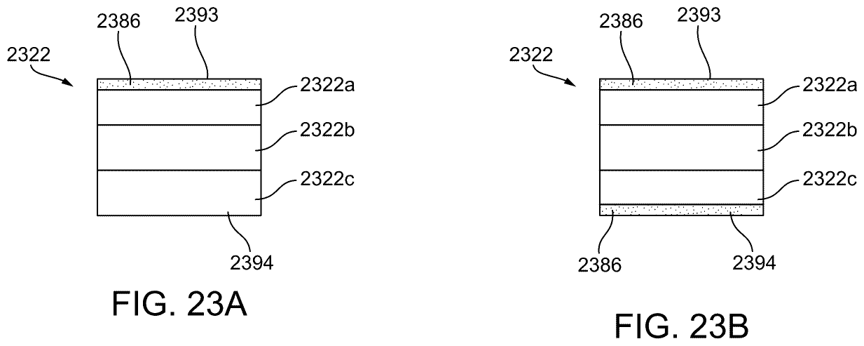

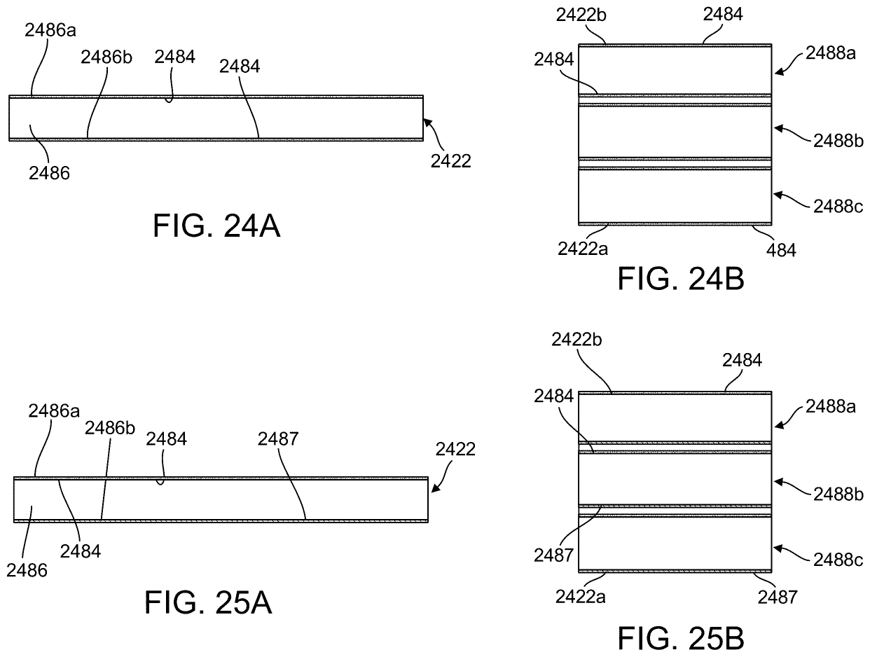

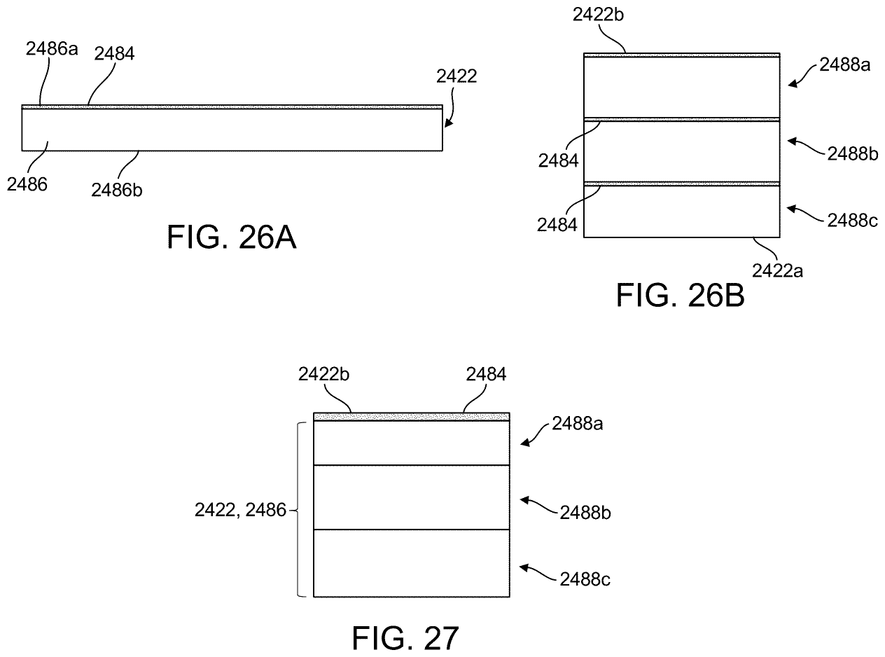

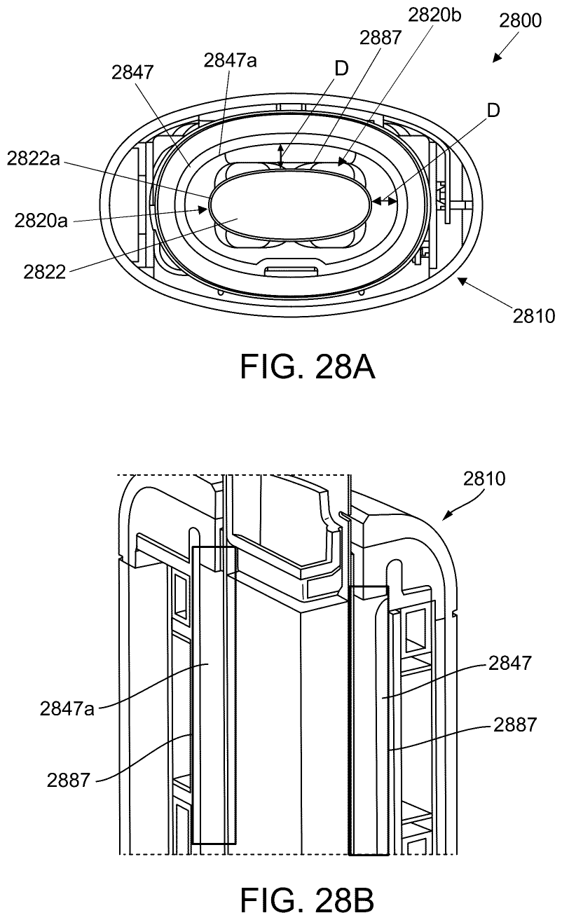

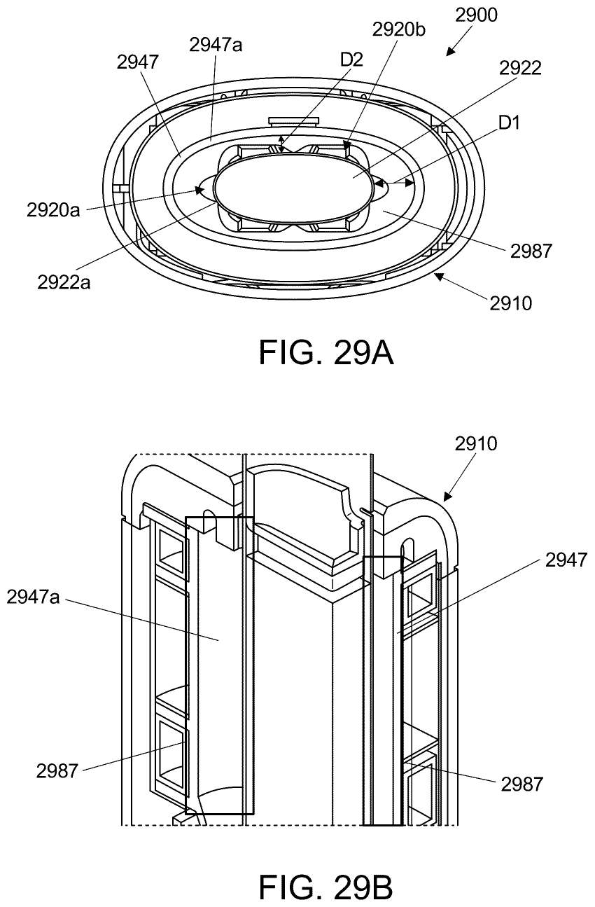

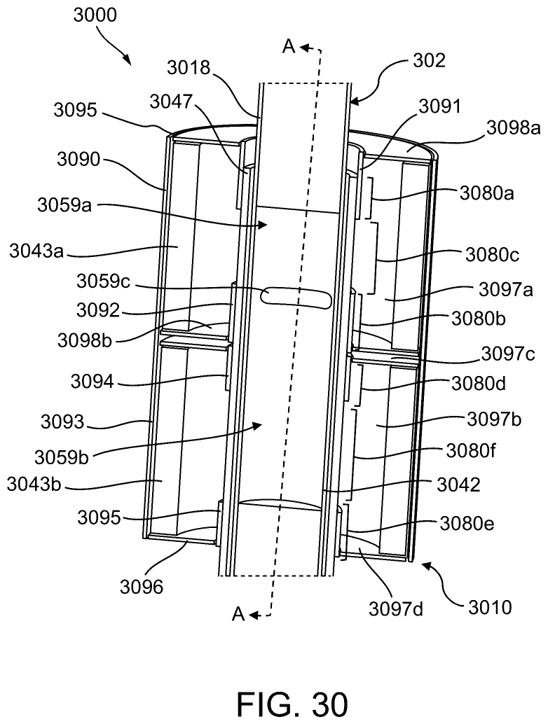

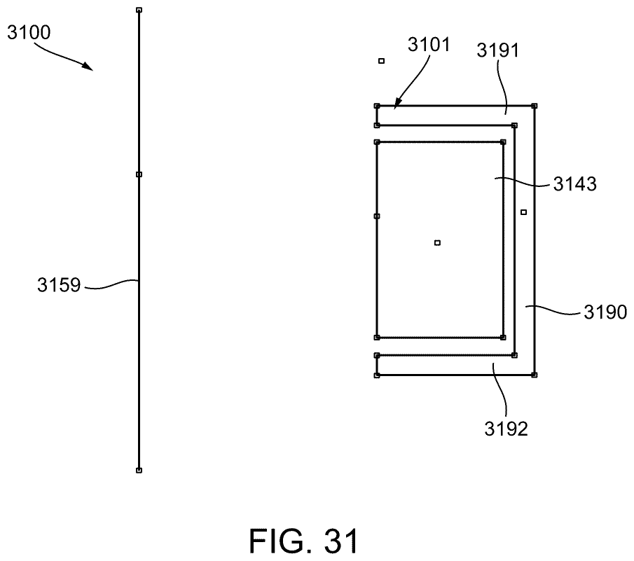

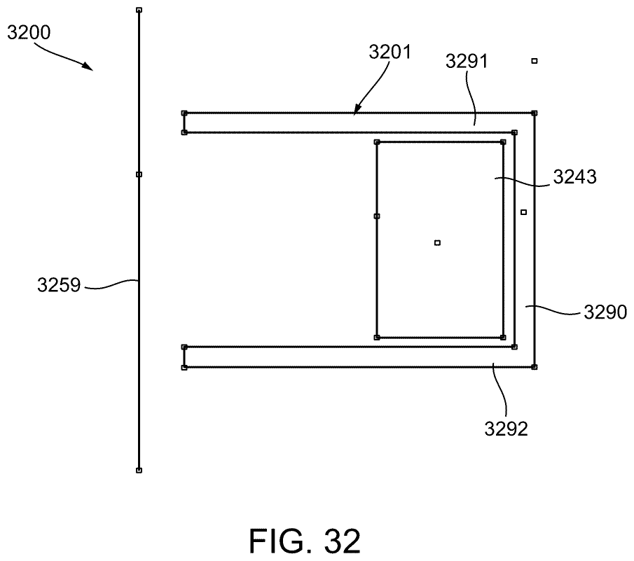

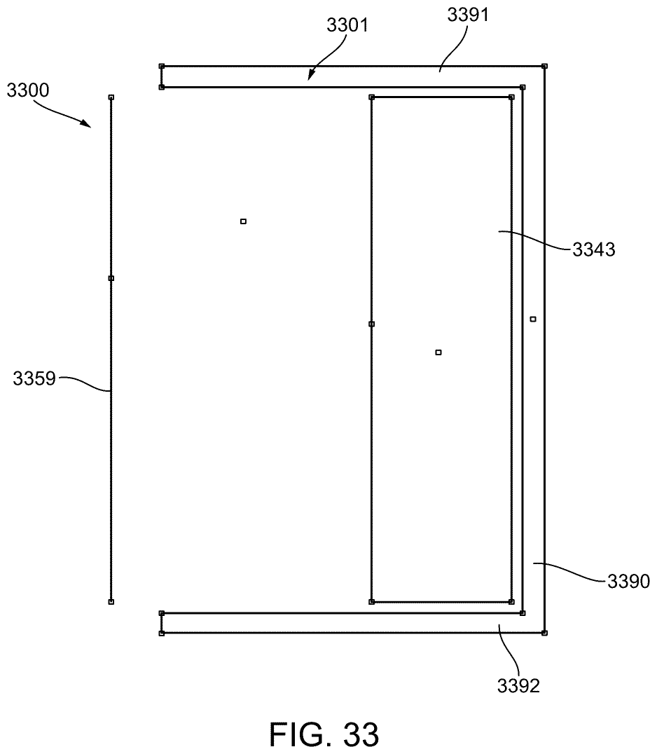

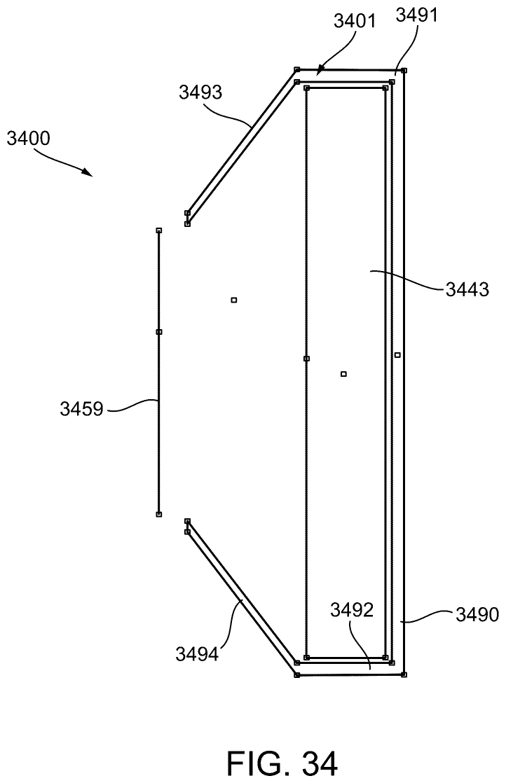

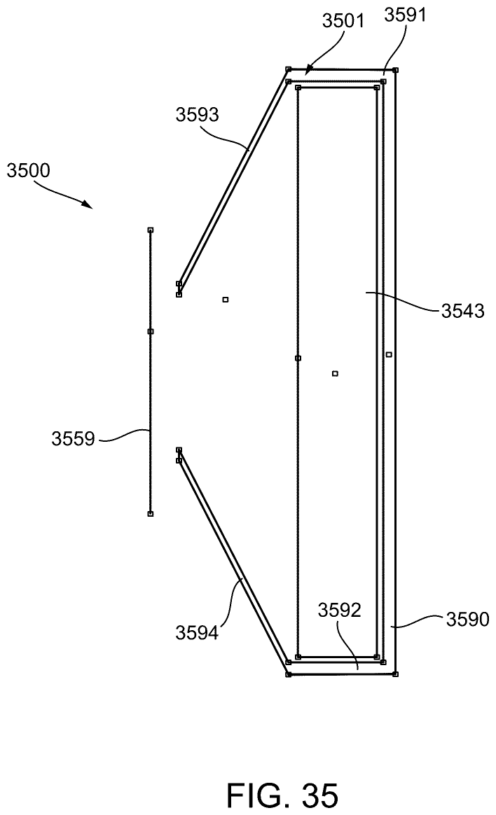

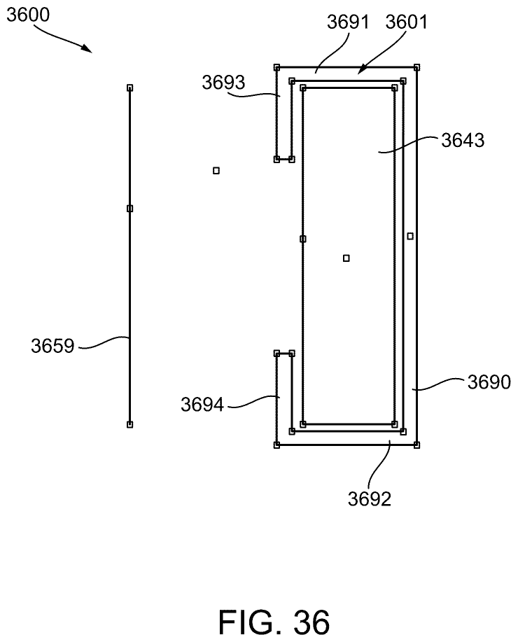

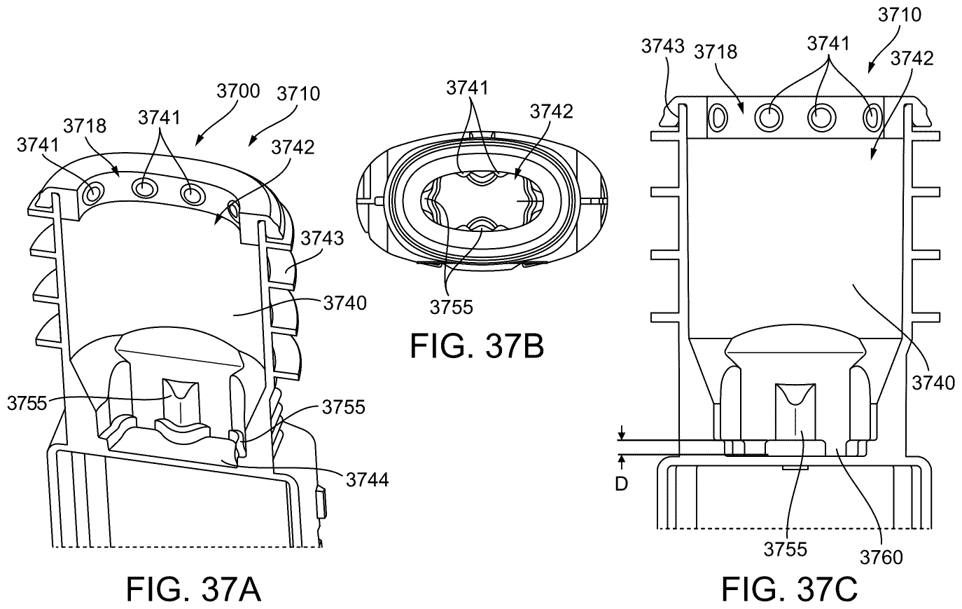

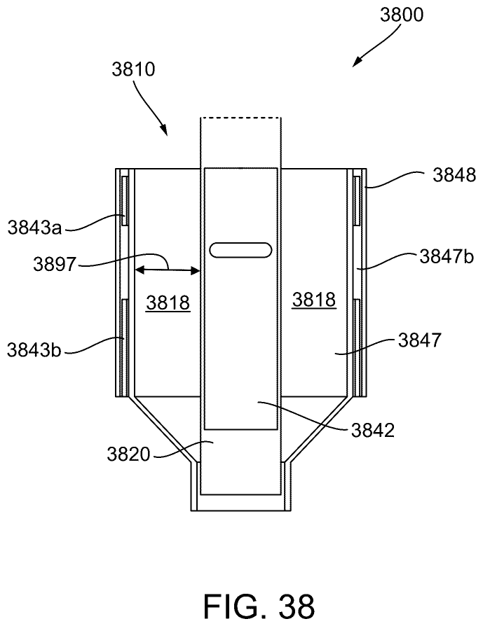

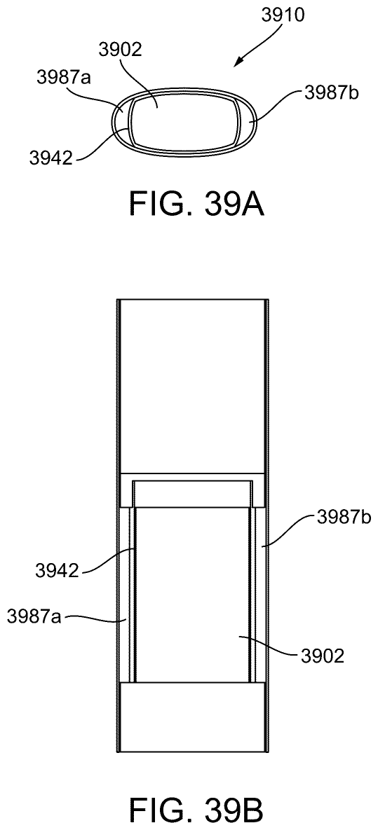

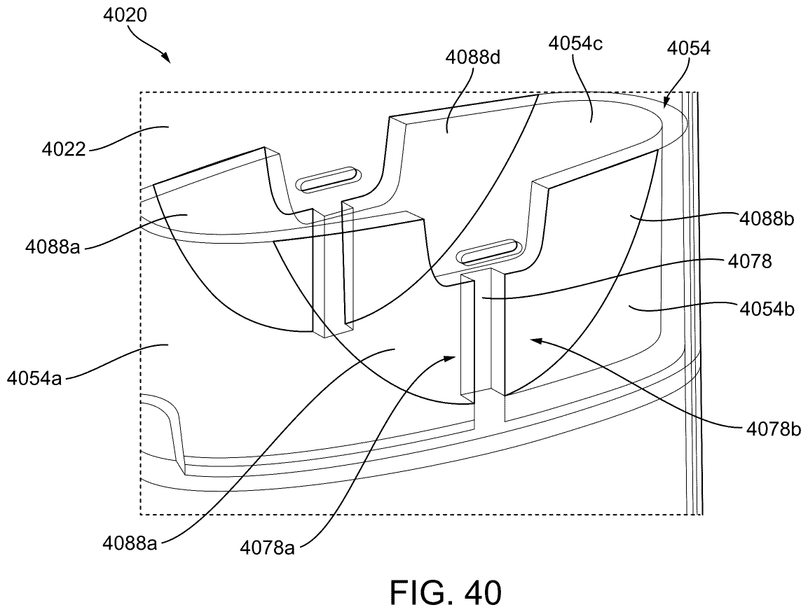

FIG. 4J illustrates a front cross-sectional view of a vaporizer device, consistent with implementations of the current subject matter;

FIG. 4K illustrates a front cross-sectional view of a vaporizer device, consistent with implementations of the current subject matter;

FIG. 4L illustrates a front cross-sectional view of a vaporizer device, consistent with implementations of the current subject matter;

FIG. 4M illustrates a front cross-sectional view of a vaporizer device, consistent with implementations of the current subject matter;

FIG. 4N illustrates a front cross-sectional view of a vaporizer device, consistent with implementations of the current subject matter;

FIG. 4O illustrates a front cross-sectional view of a vaporizer device, consistent with implementations of the current subject matter;

FIG. 4P illustrates a front cross-sectional view of a vaporizer device, consistent with implementations of the current subject matter;

FIG. 4Q illustrates a front cross-sectional view of a vaporizer device, consistent with implementations of the current subject matter;

FIG. 4R illustrates a cross-sectional view of a vaporizer device, consistent with implementations of the current subject matter;

FIG. 4S illustrates a cross-sectional view of the vaporizer device of FIG. 4R, consistent with implementations of the current subject matter;

FIG. 4T illustrates a front cross-sectional view of a vaporizer device, consistent with implementations of the current subject matter;

FIG. 4U illustrates a cross-sectional view of the vaporizer device of FIG. 4T, consistent with implementations of the current subject matter;

FIG. 4V illustrates a front cross-sectional view of a vaporizer device, consistent with implementations of the current subject matter;

FIG. 4W illustrates a cross-sectional view of the vaporizer device of FIG. 4V, consistent with implementations of the current subject matter;

FIG. 4X illustrates a front cross-sectional view of a vaporizer device, consistent with implementations of the current subject matter;

FIG. 5A illustrates a perspective view of a holder assembly for use in a vaporizer device, consistent with implementations of the current subject matter;

FIG. 5B illustrates a perspective view of a holder assembly for use in a vaporizer device, consistent with implementations of the current subject matter;

FIG. 5C illustrates a perspective view of a holder assembly for use in a vaporizer device, consistent with implementations of the current subject matter;

FIG. 5D illustrates a perspective view of a holder assembly for use in a vaporizer device, consistent with implementations of the current subject matter;

FIG. 5E illustrates a perspective view of a holder assembly for use in a vaporizer device, consistent with implementations of the current subject matter;

FIG. 5F illustrates a front view of a holder assembly for use in a vaporizer device, consistent with implementations of the current subject matter;

FIG. 5G illustrates a cross-sectional view taken across line B-B of a holder assembly for use in a vaporizer device, consistent with implementations of the current subject matter;

FIG. 5H illustrates a top view of a holder assembly for use in a vaporizer device, consistent with implementations of the current subject matter;

FIG. 5I illustrates a cross-sectional view taken across line C-C of the holder assembly in FIG. 5H;

FIG. 5J illustrates a cross-sectional view taken across line C-C of the holder assembly in FIG. 5H;

FIG. 6A illustrates a cross-sectional perspective view of a vaporizer cartridge, consistent with implementations of the current subject matter;

FIG. 6B illustrates a cross-sectional perspective view of a vaporizer cartridge, consistent with implementations of the current subject matter;

FIG. 6C illustrates a cross-sectional perspective view of a vaporizer cartridge, consistent with implementations of the current subject matter;

FIG. 6D illustrates a cross-sectional perspective view of a vaporizer cartridge, consistent with implementations of the current subject matter;

FIG. 6E illustrates a cross-sectional perspective view of a vaporizer cartridge, consistent with implementations of the current subject matter;

FIG. 6F illustrates a cross-sectional perspective view of a vaporizer cartridge, consistent with implementations of the current subject matter;

FIG. 6G illustrates a cross-sectional perspective view of a vaporizer cartridge, consistent with implementations of the current subject matter;

FIG. 6H illustrates a cross-sectional perspective view of a vaporizer cartridge, consistent with implementations of the current subject matter;

FIG. 6I illustrates a perspective view of a vaporizer cartridge, consistent with implementations of the current subject matter;

FIG. 6J illustrates a perspective and cross-sectional views of a vaporizer cartridge, consistent with implementations of the current subject matter;

FIG. 6K illustrates perspective and cross-sectional views of a vaporizer cartridge, consistent with implementations of the current subject matter;

FIG. 6L illustrates perspective and cross-sectional views of a vaporizer cartridge, consistent with implementations of the current subject matter;

FIG. 6M illustrates perspective and cross-sectional views of a vaporizer cartridge, consistent with implementations of the current subject matter;

FIG. 6N illustrates perspective and cross-sectional views of a vaporizer cartridge, consistent with implementations of the current subject matter;

FIG. 6O illustrates a perspective view of a vaporizer cartridge, consistent with implementations of the current subject matter;

FIG. 6P illustrates a perspective view of a vaporizer cartridge, consistent with implementations of the current subject matter;

FIG. 7A illustrates a perspective view of vaporizable material for use in a vaporizer cartridge, consistent with implementations of the current subject matter;

FIG. 7B illustrates a perspective view of a heater for use in a vaporizer cartridge, consistent with implementations of the current subject matter;

FIG. 7C illustrates a perspective view of a vaporizer cartridge, consistent with implementations of the current subject matter;

FIG. 7D illustrates a perspective view of a vaporizer cartridge, consistent with implementations of the current subject matter;

FIG. 7E illustrates a perspective exploded view of a vaporizer cartridge, consistent with implementations of the current subject matter;

FIG. 8A illustrates an exemplary cross-section of a cartridge and/or receptacle of a vaporizer device, consistent with implementations of the current subject matter;

FIG. 8B illustrates an exemplary cross-section of a cartridge and/or receptacle of a vaporizer device, consistent with implementations of the current subject matter;

FIG. 8C illustrates an exemplary cross-section of a cartridge and/or receptacle of a vaporizer device, consistent with implementations of the current subject matter;

FIG. 8D illustrates an exemplary cross-section of a cartridge and/or receptacle of a vaporizer device, consistent with implementations of the current subject matter;

FIG. 8E illustrates an exemplary cross-section of a cartridge and/or receptacle of a vaporizer device, consistent with implementations of the current subject matter;

FIG. 8F illustrates an exemplary cross-section of a cartridge and/or receptacle of a vaporizer device, consistent with implementations of the current subject matter;

FIG. 9A illustrates circuitry of a vaporizer device, consistent with implementations of the current subject matter;

FIG. 9B illustrates circuitry of a vaporizer device, consistent with implementations of the current subject matter;

FIG. 9C illustrates circuitry of a vaporizer device, consistent with implementations of the current subject matter;

FIG. 9D illustrates circuitry of a vaporizer device, consistent with implementations of the current subject matter;

FIG. 9E illustrates circuitry of a vaporizer device, consistent with implementations of the current subject matter;

FIG. 10A illustrates a perspective view of a vaporizer device, consistent with implementations of the current subject matter;

FIG. 10B illustrates a perspective view of a vaporizer device, consistent with implementations of the current subject matter;

FIG. 10C illustrates a perspective view of a vaporizer device, consistent with implementations of the current subject matter;

FIG. 10D illustrates a perspective view of a vaporizer device, consistent with implementations of the current subject matter;

FIG. 10E illustrates a perspective view of a vaporizer device, consistent with implementations of the current subject matter;

FIG. 11A illustrates a perspective view of a cartridge and inductors for use in a vaporizer device, consistent with implementations of the current subject matter;

FIG. 11B illustrates a perspective view of a cartridge and inductors for use in a vaporizer device, consistent with implementations of the current subject matter;

FIG. 11C illustrates a perspective view of a cartridge and inductors for use in a vaporizer device, consistent with implementations of the current subject matter;

FIG. 11D illustrates a perspective view of a holder assembly for use in a vaporizer device, consistent with implementations of the current subject matter;

FIG. 11E illustrates a perspective view of a holder assembly for use in a vaporizer device, consistent with implementations of the current subject matter;

FIG. 11F illustrates a perspective view of a holder assembly for use in a vaporizer device, consistent with implementations of the current subject matter;

FIG. 11G illustrates a perspective view of a holder assembly for use in a vaporizer device, consistent with implementations of the current subject matter;

FIG. 11H illustrates a top perspective view of a holder assembly for use in a vaporizer device, consistent with implementations of the current subject matter;

FIG. 11I illustrates a cross-sectional view of a holder assembly for use in a vaporizer device, consistent with implementations of the current subject matter;

FIG. 11J illustrates a perspective view of a holder assembly for use in a vaporizer device, consistent with implementations of the current subject matter;

FIG. 11K illustrates another perspective view of the holder assembly of FIG. 11J, consistent with implementations of the current subject matter;

FIG. 11L illustrates another perspective view of the holder assembly of FIG. 11J, consistent with implementations of the current subject matter;

FIG. 11M illustrates a cross-sectional view of the holder assembly of FIG. 11J, consistent with implementations of the current subject matter;

FIG. 11N illustrates additional cross-sectional views of the holder assembly of FIG. 11J, consistent with implementations of the current subject matter;

FIG. 11O illustrates a perspective view of a holder assembly for use in a vaporizer device, consistent with implementations of the current subject matter;

FIG. 11P illustrates a cross-sectional view of the holder assembly for use in a vaporizer device, consistent with implementations of the current subject matter;

FIG. 11Q illustrates a perspective view of the holder assembly of FIG. 11P, consistent with implementations of the current subject matter;

FIG. 12A illustrates a perspective view of a cartridge and inductors for use in a vaporizer device, consistent with implementations of the current subject matter;

FIG. 12B illustrates a perspective view of a cartridge and inductors for use in a vaporizer device, consistent with implementations of the current subject matter;

FIG. 12C illustrates a perspective view of a cartridge and inductors for use in a vaporizer device, consistent with implementations of the current subject matter;

FIG. 12D illustrates a perspective view of a cartridge and inductors for use in a vaporizer device, consistent with implementations of the current subject matter;

FIG. 12E illustrates a perspective view of a cartridge and inductors for use in a vaporizer device, consistent with implementations of the current subject matter;

FIG. 13A illustrates a block diagram of a heating element and inductor for use in a vaporizer device, consistent with implementations of the current subject matter;

FIG. 13B illustrates a block diagram of a heating element and inductors for use in a vaporizer device, consistent with implementations of the current subject matter;

FIG. 13C illustrates a block diagram of a heating element and inductors for use in a vaporizer device, consistent with implementations of the current subject matter;

FIG. 13D illustrates a block diagram of a heating element and inductors for use in a vaporizer device, consistent with implementations of the current subject matter;

FIG. 13E illustrates a block diagram of a heating element and inductors for use in a vaporizer device, consistent with implementations of the current subject matter;

FIG. 13F illustrates a block diagram of a heating element and inductors for use in a vaporizer device, consistent with implementations of the current subject matter;

FIG. 13G illustrates a block diagram of a heating element and inductors for use in a vaporizer device, consistent with implementations of the current subject matter;

FIG. 14A illustrates a perspective view and corresponding top view of a heating element and inductor for use in a vaporizer device, consistent with implementations of the current subject matter;

FIG. 14B illustrates a perspective view and corresponding top view of a heating element and inductor for use in a vaporizer device, consistent with implementations of the current subject matter;

FIG. 14C illustrates a perspective view and corresponding top view of a heating element and inductor for use in a vaporizer device, consistent with implementations of the current subject matter;

FIG. 15A illustrates a perspective view of a heating element for use in a vaporizer device, consistent with implementations of the current subject matter;

FIG. 15B illustrates a perspective view of a heating element for use in a vaporizer device, consistent with implementations of the current subject matter;

FIG. 15C illustrates a perspective view of a heating element for use in a vaporizer device, consistent with implementations of the current subject matter;

FIG. 15D illustrates a perspective view of a heating element for use in a vaporizer device, consistent with implementations of the current subject matter;

FIG. 15E illustrates a perspective view of a heating element for use in a vaporizer device, consistent with implementations of the current subject matter;

FIG. 15F illustrates a perspective view of a heating element for use in a vaporizer device, consistent with implementations of the current subject matter;

FIG. 15G illustrates a perspective view of a heating element for use in a vaporizer device, consistent with implementations of the current subject matter;

FIG. 15H illustrates a perspective view of a heating element for use in a vaporizer device, consistent with implementations of the current subject matter;

FIG. 15I illustrates perspective views of a heating element for use in a vaporizer device, consistent with implementations of the current subject matter;

FIG. 15J illustrates a perspective view of a heating element for use in a vaporizer device, consistent with implementations of the current subject matter;

FIG. 15K illustrates a top view of a heating element for use in a vaporizer device, consistent with implementations of the current subject matter;

FIG. 16A illustrates a cross-sectional view of a cartridge and vaporizer body for use in a vaporizer device, consistent with implementations of the current subject matter;

FIG. 16B illustrates a cross-sectional view of a cartridge and vaporizer body for use in a vaporizer device, consistent with implementations of the current subject matter;

FIG. 17A illustrates a block diagram of vaporizable material for use in a vaporizer device, consistent with implementations of the current subject matter;

FIG. 17B illustrates a block diagram of vaporizable material for use in a vaporizer device, consistent with implementations of the current subject matter;

FIG. 17C illustrates a block diagram of vaporizable material for use in a vaporizer device, consistent with implementations of the current subject matter;

FIG. 17D illustrates a block diagram of vaporizable material for use in a vaporizer device, consistent with implementations of the current subject matter;

FIG. 17E illustrates a block diagram of vaporizable material for use in a vaporizer device, consistent with implementations of the current subject matter;

FIG. 17F illustrates a block diagram of vaporizable material for use in a vaporizer device, consistent with implementations of the current subject matter;

FIG. 17G illustrates a block diagram of vaporizable material for use in a vaporizer device, consistent with implementations of the current subject matter;

FIG. 17H illustrates a block diagram of vaporizable material for use in a vaporizer device, consistent with implementations of the current subject matter;

FIG. 18A illustrates a perspective view of a vaporizer cartridge, consistent with implementations of the current subject matter;

FIG. 18B illustrates a cross-sectional view of the vaporizer cartridge of FIG. 18A;

FIG. 18C illustrates a partially transparent perspective view of the vaporizer cartridge of FIG. 18A;

FIG. 19A illustrates a perspective view of a vaporizer cartridge, consistent with implementations of the current subject matter;

FIG. 19B illustrates a perspective view of a vaporizer cartridge, consistent with implementations of the current subject matter;

FIG. 19C illustrates a perspective view of a vaporizer cartridge, consistent with implementations of the current subject matter;

FIG. 19D illustrates a perspective view of a vaporizer cartridge, consistent with implementations of the current subject matter;

FIG. 19E illustrates a perspective view of a vaporizer cartridge, consistent with implementations of the current subject matter;

FIG. 20 illustrates a cross-sectional view of a vaporizer device, consistent with implementations of the current subject matter;

FIG. 21A illustrates a perspective view of a vaporizer cartridge that includes a heating element, consistent with implementations of the current subject matter;

FIG. 21B illustrates a partially transparent view of the vaporizer cartridge of FIG. 21A with the heating element removed, consistent with implementations of the current subject matter;

FIG. 21C illustrates a perspective view of a vaporizer cartridge, consistent with implementations of the current subject matter;

FIG. 21D illustrates a perspective view of a vaporizer cartridge, consistent with implementations of the current subject matter;

FIG. 21E illustrates a perspective view of a vaporizer cartridge, consistent with implementations of the current subject matter;

FIG. 22 illustrates a cross-sectional view of a vaporizer device, consistent with implementations of the current subject matter;

FIG. 23A illustrates a cross-sectional view of a wrapper of a vaporizer cartridge, consistent with implementations of the current subject matter;

FIG. 23B illustrates a cross-sectional view of a wrapper of a vaporizer cartridge, consistent with implementations of the current subject matter;

FIG. 24A illustrates a cross-sectional view of a wrapper of a vaporizer cartridge, consistent with implementations of the current subject matter;

FIG. 24B illustrates a cross-sectional view of the wrapper of FIG. 24A with a plurality of rolls, consistent with implementations of the current subject matter;

FIG. 25A illustrates a cross-sectional view of a wrapper of a vaporizer cartridge, consistent with implementations of the current subject matter;

FIG. 25B illustrates a cross-sectional view of the wrapper of FIG. 25A with a plurality of rolls, consistent with implementations of the current subject matter;

FIG. 26A illustrates a cross-sectional view of a wrapper of a vaporizer cartridge, consistent with implementations of the current subject matter;

FIG. 26B illustrates a cross-sectional view of the wrapper of FIG. 26A with a plurality of rolls, consistent with implementations of the current subject matter;

FIG. 27 illustrates a cross-sectional view of a wrapper of a vaporizer cartridge, consistent with implementations of the current subject matter;

FIG. 28A illustrates a top cross-sectional view of a vaporizer device, consistent with implementations of the current subject matter;

FIG. 28B illustrates a cross-sectional view of the vaporizer device of FIG. 28A, consistent with implementations of the current subject matter;

FIG. 29A illustrates a top view of a vaporizer device, consistent with implementations of the current subject matter;

FIG. 29B illustrates a cross-sectional view of the vaporizer device of FIG. 29A, consistent with implementations of the current subject matter;

FIG. 30 illustrates a cross-sectional view of a vaporizer device, consistent with implementations of the current subject matter;

FIG. 31 illustrates a cross-sectional front view of a schematic of an inductor and flux concentrator, consistent with implementations of the current subject matter;

FIG. 32 illustrates another cross-sectional front view of a schematic of an inductor and flux concentrator, consistent with implementations of the current subject matter;

FIG. 33 illustrates another cross-sectional front view of a schematic of an inductor and flux concentrator, consistent with implementations of the current subject matter;

FIG. 34 illustrates another cross-sectional front view of a schematic of an inductor and flux concentrator, consistent with implementations of the current subject matter;

FIG. 35 illustrates another cross-sectional front view of a schematic of an inductor and flux concentrator, consistent with implementations of the current subject matter;

FIG. 36 illustrates another cross-sectional front view of a schematic of an inductor and flux concentrator, consistent with implementations of the current subject matter;

FIG. 37A illustrates a cross-sectional view of a vaporizer body, consistent with implementations of the current subject matter;

FIG. 37B illustrates a top view of the vaporizer body of FIG. 37A, consistent with implementations of the current subject matter;

FIG. 37C illustrates a cross-sectional front view of the vaporizer body from FIG. 37A, consistent with implementations of the current subject matter;

FIG. 38 illustrates a cross-sectional view of a vaporizer device, consistent with implementations of the current subject matter;

FIG. 39A illustrates a top view of a vaporizer device, consistent with implementations of the current subject matter;

FIG. 39B illustrates a cross-sectional view of the vaporizer device of FIG. 39A, consistent with implementations of the current subject matter;

FIG. 40 illustrates a partially transparent perspective view of a vaporizer cartridge, consistent with implementations of the current subject matter;

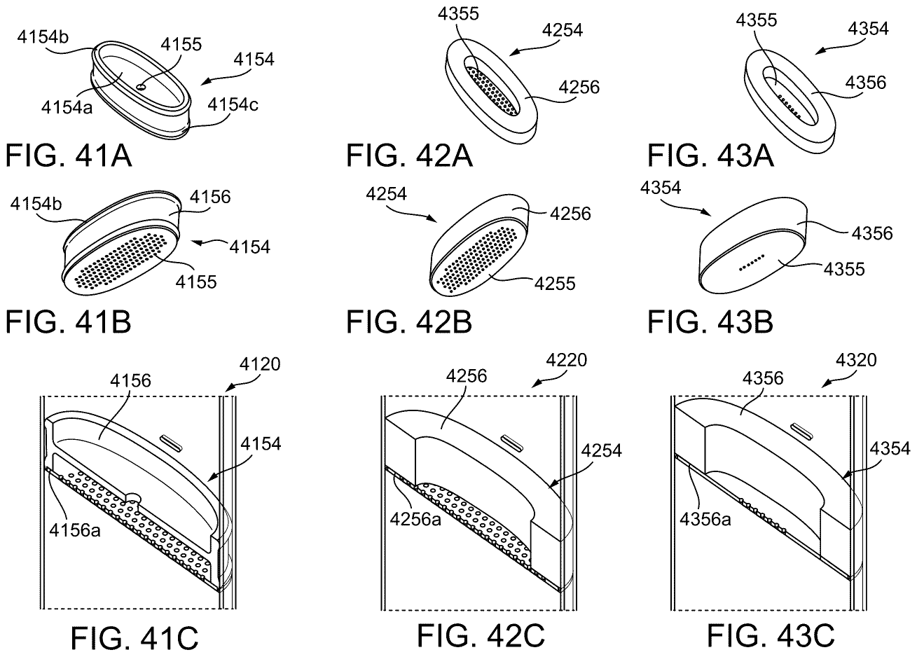

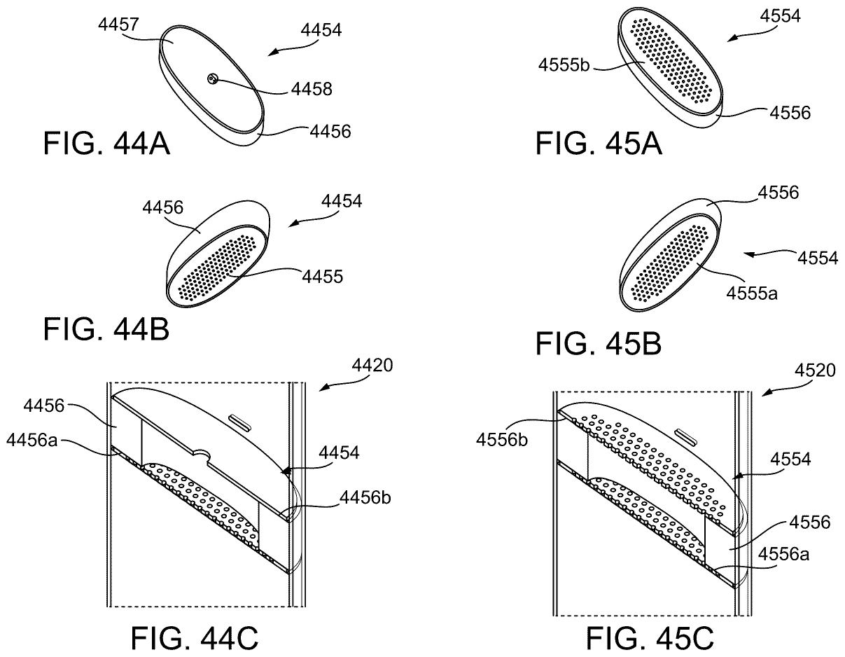

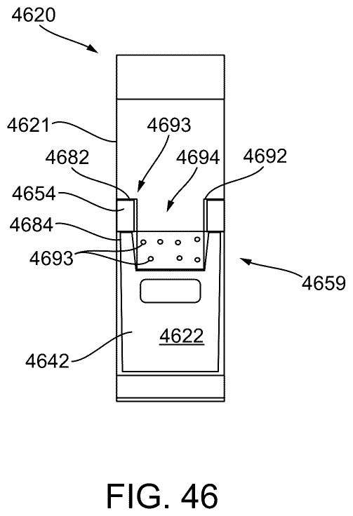

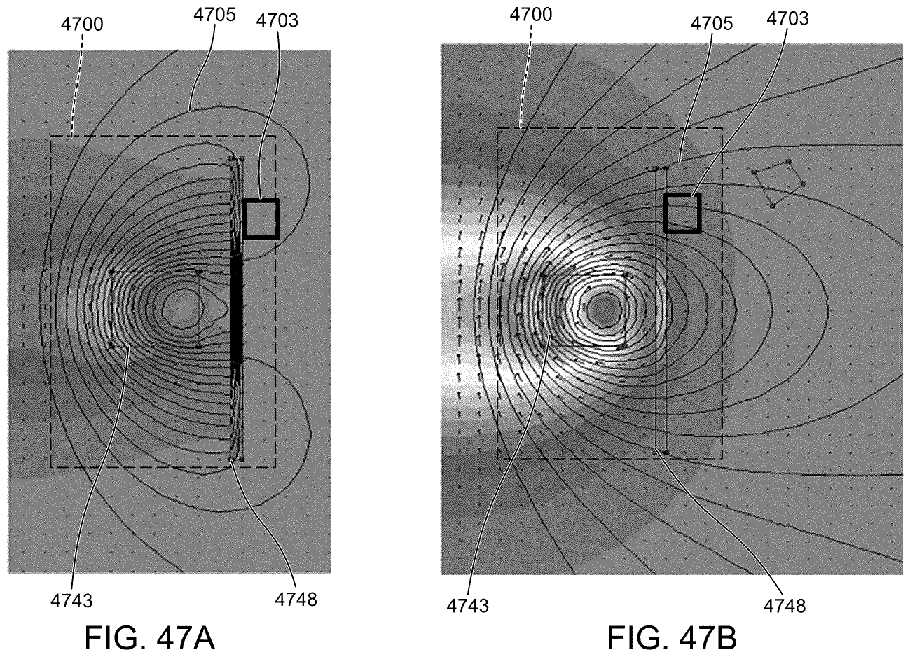

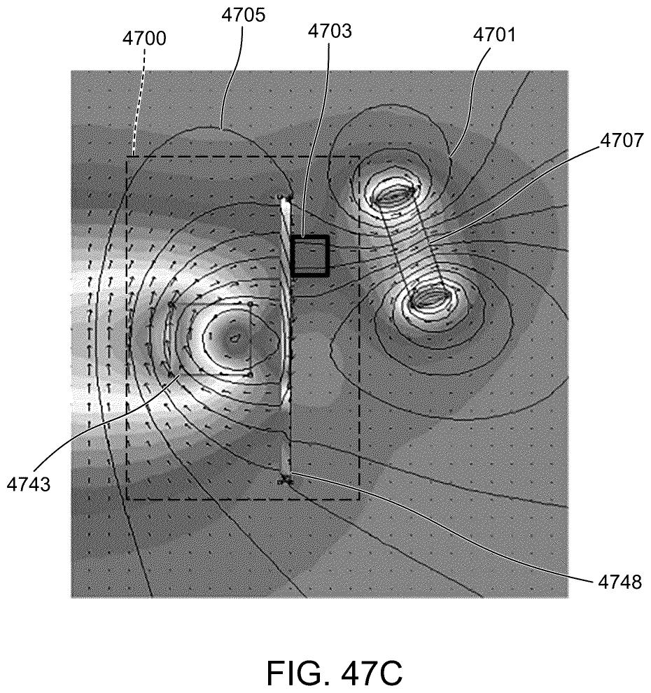

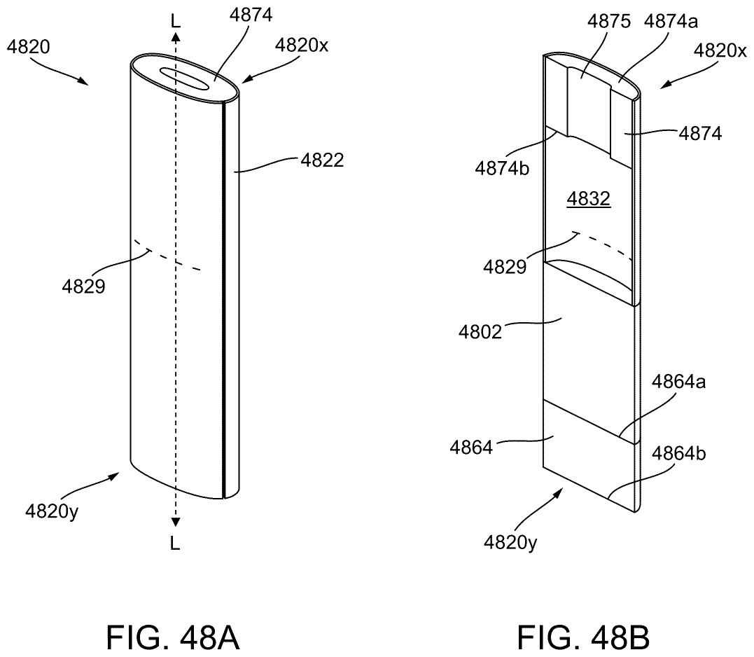

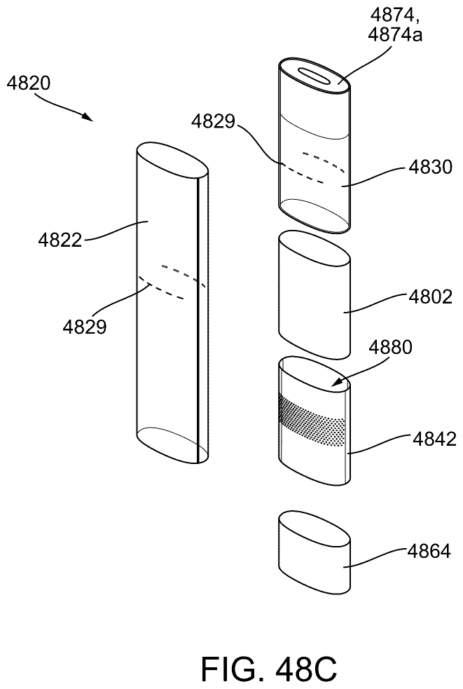

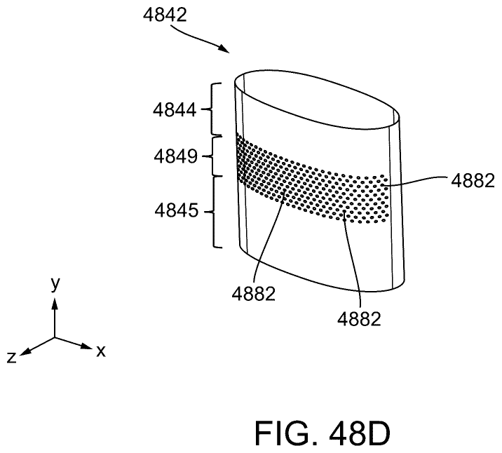

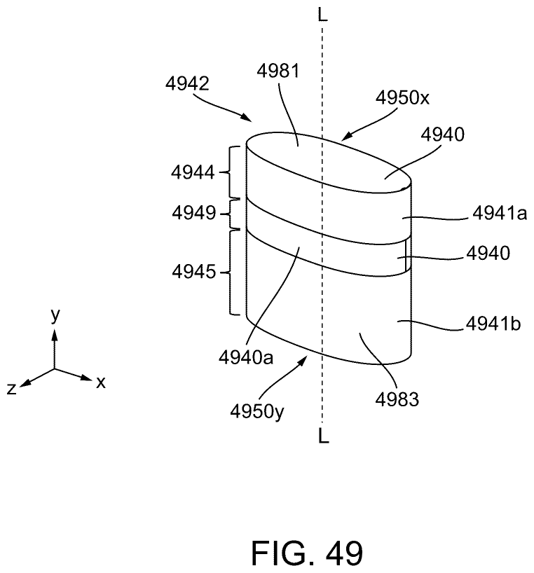

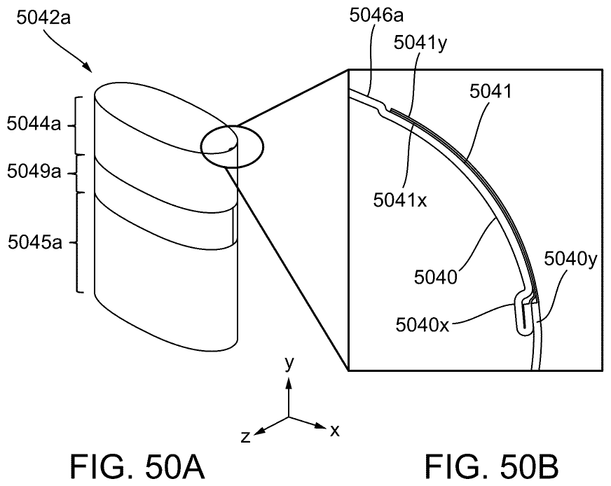

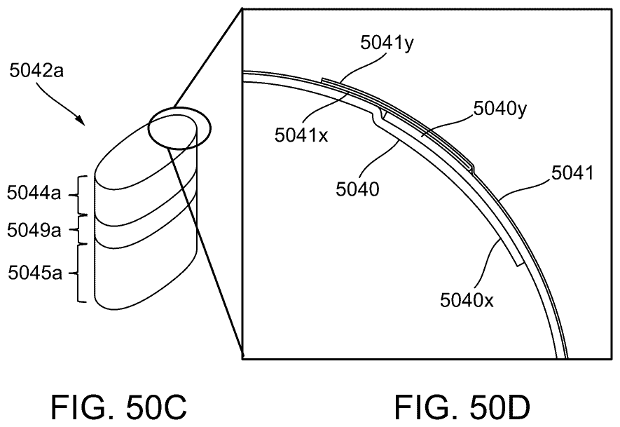

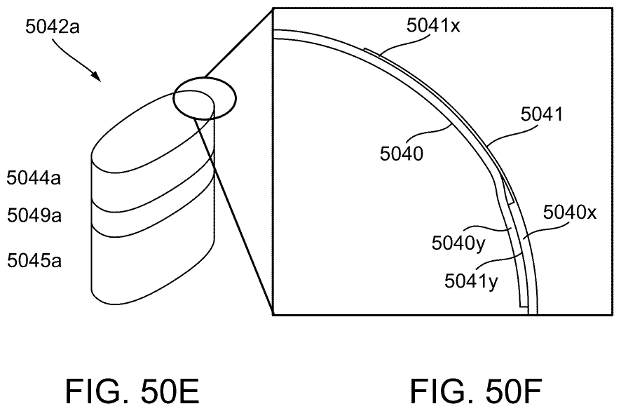

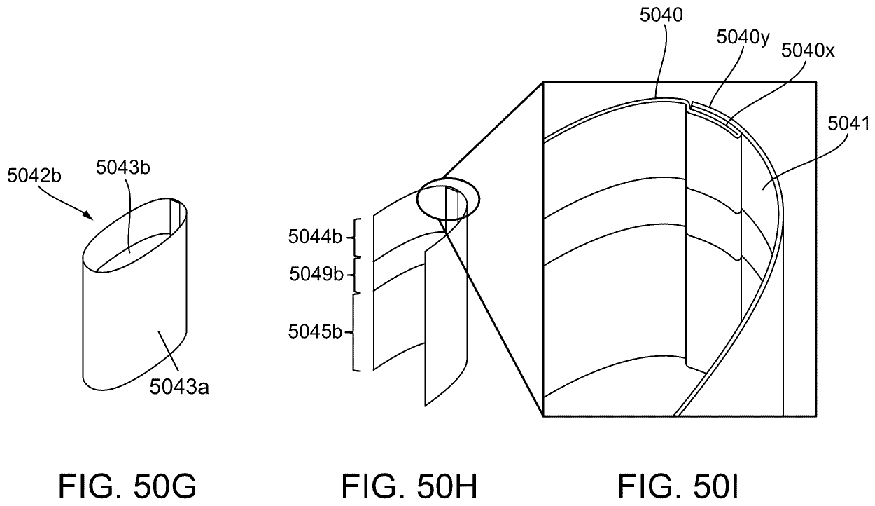

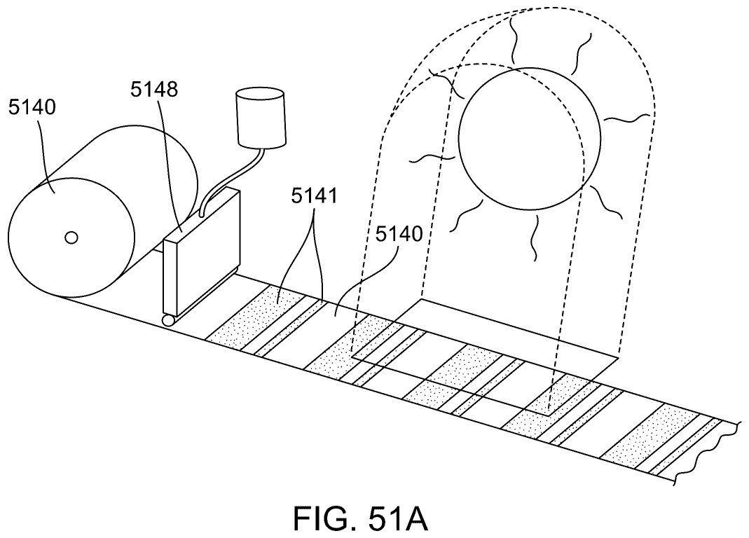

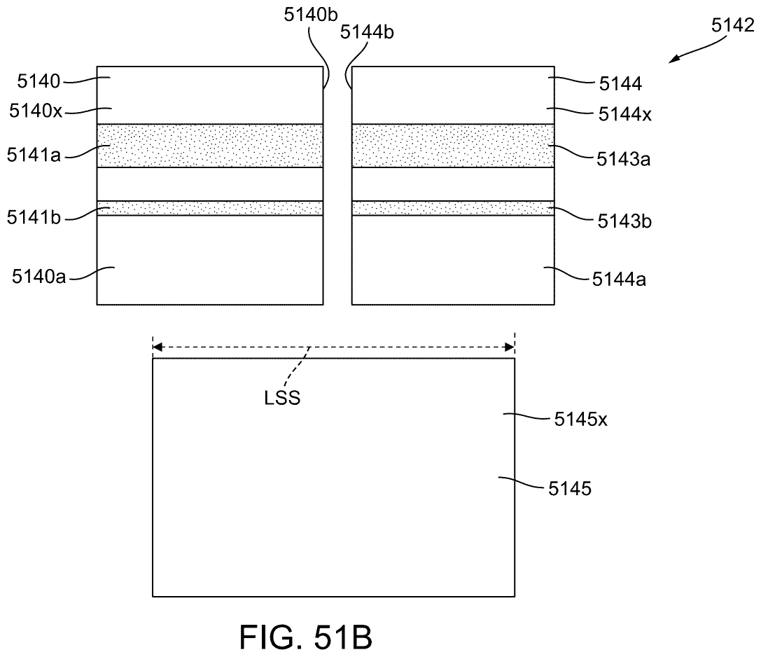

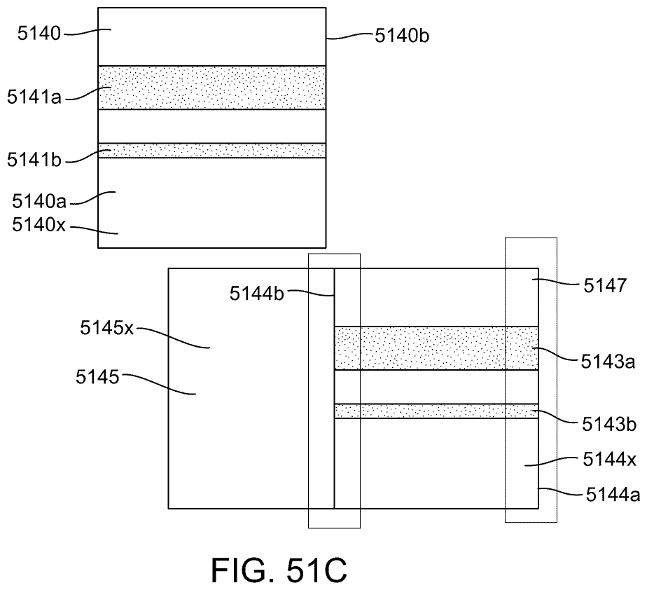

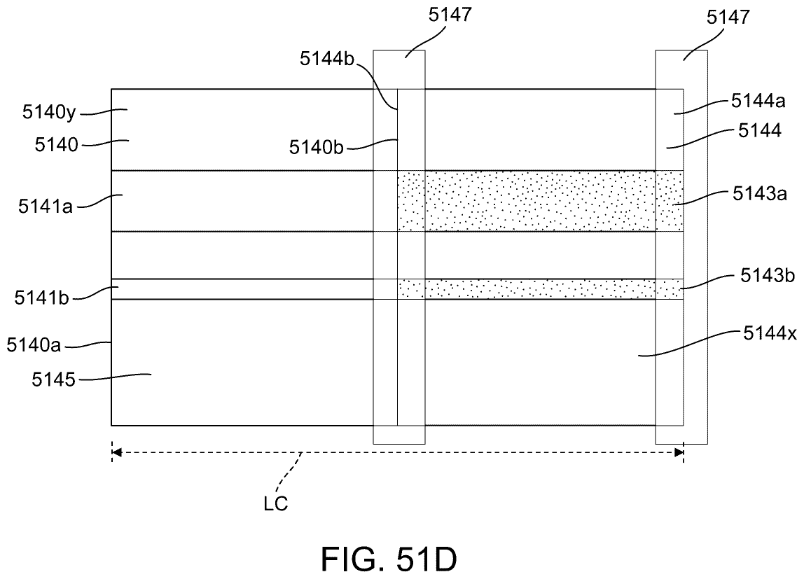

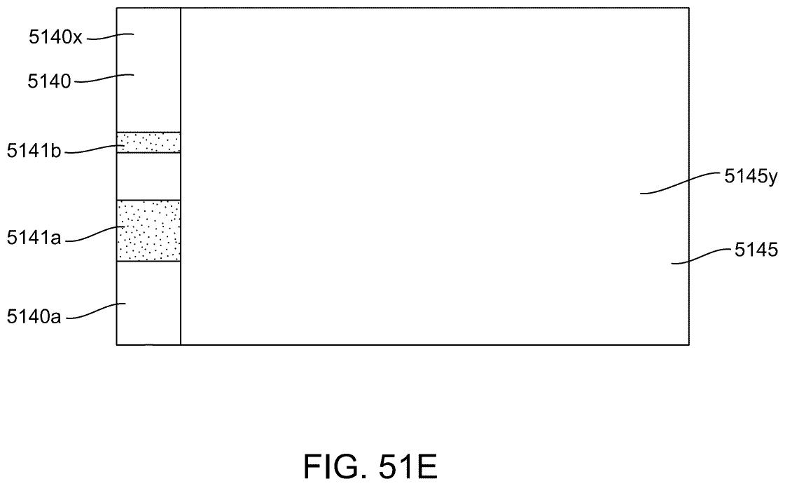

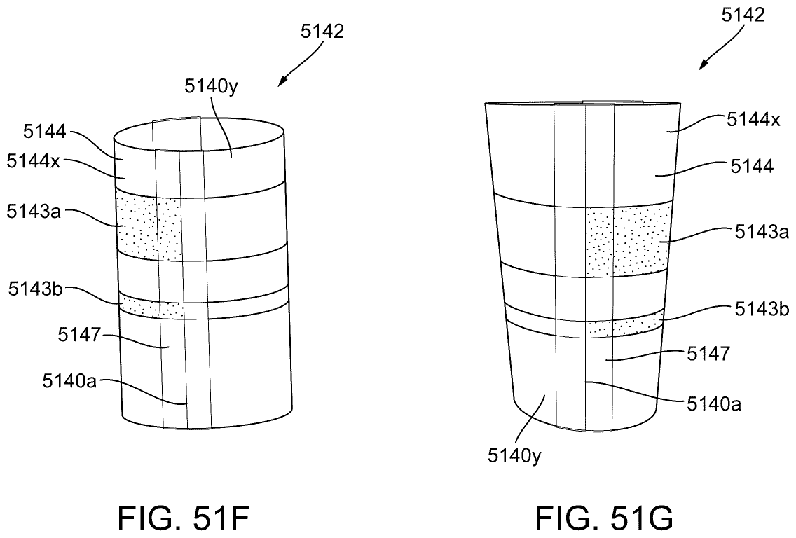

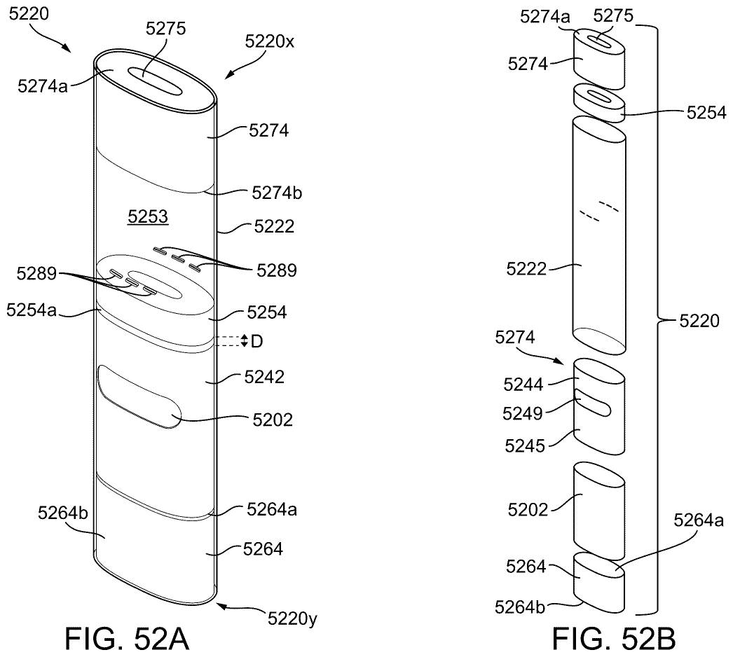

FIG. 41A illustrates a perspective view of a divider for use in a vaporizer cartridge, consistent with implementations of the current subject matter;

FIG. 41B illustrates another perspective view of the divider of FIG. 41A, consistent with implementations of the current subject matter;

FIG. 41C illustrates a perspective cross-sectional view of the divider of FIG. 41A within a vaporizer cartridge, consistent with implementations of the current subject matter;

FIG. 42A illustrates a perspective view of a divider for use in a vaporizer cartridge, consistent with implementations of the current subject matter;

FIG. 42B illustrates another perspective view of the divider of FIG. 42A, consistent with implementations of the current subject matter;

FIG. 42C illustrates a perspective cross-sectional view of the divider of FIG. 42A within a vaporizer cartridge, consistent with implementations of the current subject matter;

FIG. 43A illustrates a perspective view of a divider for use in a vaporizer cartridge, consistent with implementations of the current subject matter;

FIG. 43B illustrates another perspective view of the divider of FIG. 43A, consistent with implementations of the current subject matter;

FIG. 43C illustrates a perspective cross-sectional view of the divider of FIG. 43A within a vaporizer cartridge, consistent with implementations of the current subject matter;

FIG. 44A illustrates a perspective view of a divider for use in a vaporizer cartridge, consistent with implementations of the current subject matter;

FIG. 44B illustrates another perspective view of the divider of FIG. 44A, consistent with implementations of the current subject matter;

FIG. 44C illustrates a perspective cross-sectional view of the divider of FIG. 44A within a vaporizer cartridge, consistent with implementations of the current subject matter;

FIG. 45A illustrates a perspective view of a divider for use in a vaporizer cartridge, consistent with implementations of the current subject matter;

FIG. 45B illustrates another perspective view of the divider of FIG. 45A, consistent with implementations of the current subject matter;

FIG. 45C illustrates a perspective cross-sectional view of the divider of FIG. 45A within a vaporizer cartridge, consistent with implementations of the current subject matter;

FIG. 46 illustrates a cross-sectional view of a vaporizer cartridge, consistent with implementations of the current subject matter;

FIG. 47A illustrates normal operation of a vaporizer device, when no external magnetic field is present, consistent with implementations of the current subject matter;

FIG. 47B illustrates a saturation event that occurs when an external magnetic field interferes with operation of the vaporizer device of FIG. 47A, consistent with implementations of the current subject matter;

FIG. 47C illustrates an operation of the vaporizer device of FIG. 47A when an external magnetic field is applied, consistent with implementations of the current subject matter;

FIG. 48A illustrates a perspective view of a vaporizer device, consistent with implementations of the current subject matter;

FIG. 48B illustrates a cross-section view of the vaporizer device of FIG. 48A;

FIG. 48C illustrates an exploded perspective view of the vaporizer device of FIG. 48A;

FIG. 48D illustrates a perspective view of a heating element of the vaporizer device of FIG. 48A, consistent with implementations of the current subject matter;

FIG. 49 illustrates a perspective view of a heating element for a vaporizer device, consistent with implementations of the current subject matter;

FIG. 50A illustrates a perspective view of a heating element for a vaporizer device, consistent with implementations of the current subject matter;

FIG. 50B illustrates a close-up view of the heating element of FIG. 50A;

FIG. 50C illustrates a perspective view of a heating element for a vaporizer device, consistent with implementations of the current subject matter;

FIG. 50D illustrates a magnified view of a portion of the heating element of FIG. 50C;

FIG. 50E illustrates a perspective view of a heating element for a vaporizer device, consistent with implementations of the current subject matter;

FIG. 50F illustrates a magnified view of a portion of the heating element of FIG. 50E;

FIG. 50G illustrates a perspective view of a heating element for a vaporizer device, consistent with implementations of the current subject matter;

FIG. 50H illustrates a cross-section view of the heating element of FIG. 50G;

FIG. 50I illustrates a close-up view of the heating element of FIG. 50A;

FIG. 51A illustrates a production line for manufacturing a heating element for a vaporizer device, consistent with implementations of the current subject matter;

FIG. 51B illustrates components of a heating element for a vaporizer device, consistent with implementations of the current subject matter;

FIG. 51C illustrates a partially assembled heating element of FIG. 51B after coupling a first support structure to a substrate in step one of an assembling process;

FIG. 51D illustrates a further assembled heating element of FIG. 51B after coupling a second support structure to the substrate in step two of the assembling process;

FIG. 51E illustrates an opposite side of the further assembled heating element of FIG. 51D;

FIG. 51F illustrates a first side of an assembled heating element of FIG. 51B after folding the heating assembly into a tubular configuration in step three of the assembling process;

FIG. 51G illustrates a second side of an assembled heating element of FIG. 51B after folding the heating assembly into a tubular configuration in step three of the assembling process;

FIG. 52A illustrates a perspective view of a vaporizer device, consistent with implementations of the current subject matter; and

FIG. 52B illustrates an exploded perspective view of the vaporizer device of FIG. 48A.

When practical, similar reference numbers denote similar structures, features, or elements.

### DETAILED DESCRIPTION

Implementations of the current subject matter include methods, apparatuses, articles of manufacture, and systems relating to vaporization of one or more materials for inhalation by a user. For example, various implementations of vaporizer devices are described herein that provide a number of benefits, including improved generation of controlled energy transfer to inductively heated cartridges. For example, by providing multiple inductors, a singular wrapped susceptor, and/or feedback loops with sensors, localized heat transfer can be controlled over the course of use (e.g., each complete use of a cartridge, from start to finish, referred to herein a vaporizing session).

An additional benefit that can be provided by various implementations of vaporizer devices described herein is improving contact between a heating element and/or heated surface of a heating system and a cartridge containing vaporizable material to ensure efficient and effective thermal transfer between the heating element and vaporizable material. For example, by maintaining intimate contact between the cartridge and the heating element and/or heated surface, thermal losses (e.g., to a surrounding housing of the vaporizer device) can be reduced, and heating efficiency (e.g., per amount of power consumption) can be increased. An additional benefit that can be provided by various implementations of vaporizer devices described herein is increased user satisfaction. For example, in some implementations, the proper mixing of relatively cool air (e.g., ambient temperature air) and heated air containing vaporized material can improve the formation of sub-micron sized aerosol particles, thereby reducing condensation of one or more compounds released during heating of the vaporized material onto internal surfaces (e.g., inhalation tubes and/or mouthpiece components) of the vaporizer device. Such condensates can ultimately be drawn into the mouth of a user in liquid form, thereby leading to unpleasant taste sensations, and are not available for inhalation, thereby reducing an amount of available inhalable product. Accordingly, by ensuring proper mixing and aerosol generation, implementations of the current subject matter can increase user satisfaction.

In some implementations, the vaporizable material can be placed within a location that is in direct contact with and/or in close proximity to a heating element of a heating system to allow for efficient and effective heat transfer from the heating element to the vaporizable material. In some implementations, a cartridge comprising the heating element and the vaporizable material (e.g., vaporizable material contained within an appropriately configured structure) can be placed within a vaporizer device body that is configured to transfer energy to the heating element, such as by one or more inductors and/or completion of an electrical circuit that includes the heating element. In other implementations, a cartridge comprising the vaporizable material (e.g., vaporizable material contained within an appropriately configured structure) can be placed within a vaporization chamber, heater chamber, oven, or the like, in which case the area or volume in the vaporizer device body within which a heating element causes heating of at least a portion of a vaporizable material includes an internal area or volume of the cartridge. Characteristics of an appropriately configured structure include being formed at least partially of metal and/or some other material that is durable under heating and that has a sufficient thermal conductivity, one or more openings through which air can enter the cartridge to aid in heating the vaporizable material and/or transfer of the vaporizable material as it is vaporized, one or more openings through which ambient air mixes with the vaporized material to form at least a portion of an inhalable aerosol, conveyance of the inhalable aerosol out of the cartridge, and/or the like. As such, the vaporizer devices, heating systems, cartridges, and vaporizable material described herein can provide more efficient heating of vaporizable material and formation of inhalable aerosol compared to some currently available vaporizer devices. Other benefits are described herein and are within the scope of this disclosure. It will be appreciated that aerosol formation can occur concurrently with (e.g., immediately after) vaporization of the vaporizable material, such as based on air that is present within or near the vaporizable material, and that the provision of ambient air can accelerate the formation of the inhalable aerosol.

The term “vaporizer device” as used in the following description and claims refers to any of a self-contained apparatus, an apparatus that includes two or more separable parts (e.g., a vaporizer body that includes a battery and other hardware, a cartridge and/or insert that includes a vaporizable material, and/or a mouthpiece (including a mouthpiece portion of the cartridge) configured to deliver an inhalable aerosol to a user), and/or the like. A “vaporizer system,” as used herein, can include one or more components, such as a vaporizer device, a charger for charging the vaporizer device, a wired or wireless communication device in communication with the vaporizer device, a remote server in communication with the communication device, and/or the like. Examples of vaporizer devices consistent with implementations of the current subject matter include electronic vaporizers, electronic nicotine delivery systems (ENDS), and/or the like. Such vaporizer devices can be hand-held devices that heat (such as by convection, conduction, radiation, induction, and/or some combination thereof) a vaporizable material to provide an inhalable dose of the material to a user. Vaporizer devices can be regarded as “generating” inhalable aerosols, as they provide the capabilities and/or functionality required to convert vaporizable material into inhalable aerosols (e.g., heat, airflow path(s), condensation chambers, etc.).

The vaporizable material used with a vaporizer device can optionally be provided within a cartridge (e.g., an insertable and removable part of the vaporizer device that contains the vaporizable material) which can be refillable when empty, or disposable such that a new cartridge containing additional vaporizable material of a same or different type can be used. A vaporizer device can be a cartridge-using vaporizer device, a cartridge-less vaporizer device, or a multi-use vaporizer device capable of use with or without a cartridge. Some cartridge implementations can include a vaporizable material, which can be packed to an appropriate density, as described herein. In some implementations, a vaporizer device can include a compartment (e.g., a receptacle, heater chamber, and/or the like) configured to receive a cartridge directly therein and heat the vaporizable material for forming an inhalable aerosol.

In some implementations, a vaporizer device can be configured for use with a liquid vaporizable material (for example, a carrier solution in which an active and/or inactive ingredient(s) are suspended or held in solution, or a liquid form of the vaporizable material itself) and/or a non-liquid vaporizable material (e.g., a paste, a wax, a gel, a solid, a plant material, and/or the like). A non-liquid vaporizable material can include a plant material that emits some part of the plant material as the vaporizable material (for example, some part of the plant material remains as waste after the material is vaporized for inhalation by a user) or optionally can be a solid form of the vaporizable material itself, such that all of the solid material can eventually be vaporized for inhalation. A liquid vaporizable material can likewise be capable of being completely vaporized, or can include some portion of the liquid material that remains after all of the material suitable for inhalation has been vaporized.

Implementations of vaporizable material can be partially made of a non-liquid vaporizable material, such as tobacco (e.g., leaves, stems, and/or the like), other plant substances, and/or other solids such as cotton. In such implementations, the vaporizable material further includes a humectant or other aerosol forming material or carrier, such as propylene glycol, vegetable glycerin, an acid (e.g., organic acid such as benzoic acid, citric acid, etc.), and/or the like. As such, some implementations of the vaporizer device can be configured to use a vaporizable material that is at least partly made of one or more vaporizable materials (e.g., that includes one or more compounds that can be converted to the gas phase when the vaporizable material is heated to a sufficient temperature) for heating and forming an inhalable aerosol, as described in greater detail herein.

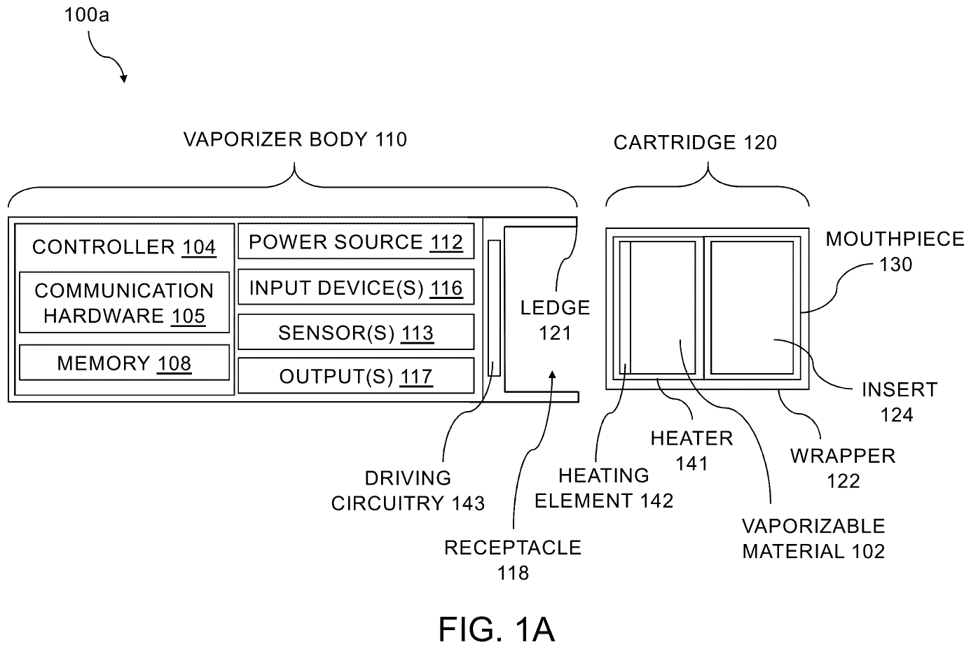

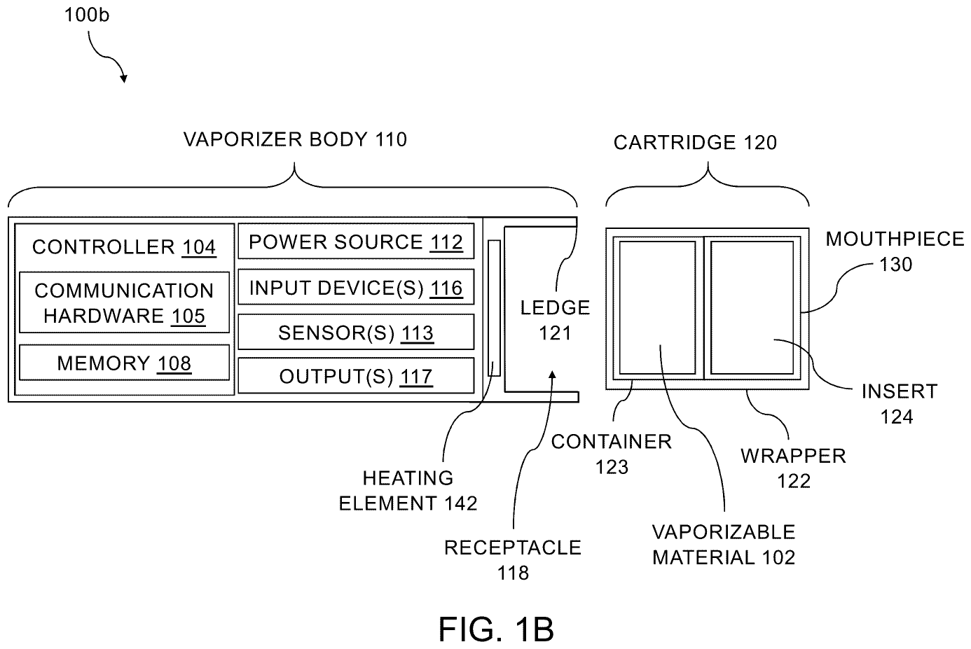

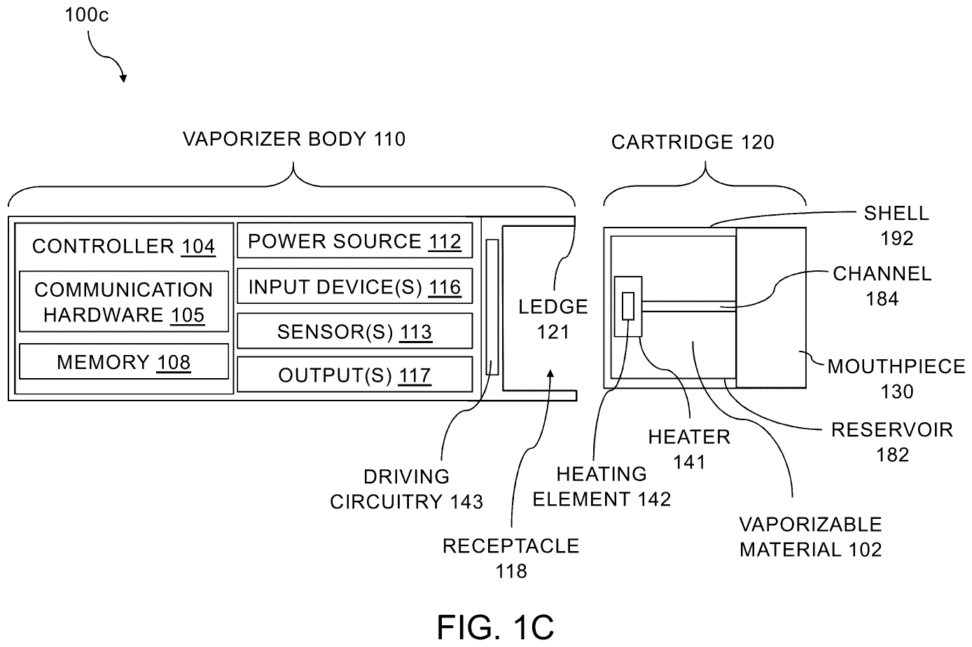

FIGS. 1A-1C depict block diagrams illustrating example vaporizer devices 100a, 100b, 100c (collectively referred to as vaporizer device 100) consistent with implementations of the current subject matter. The vaporizer device 100 can include a power source 112 (for example, a battery, which can be a rechargeable battery), and a controller 104 (for example, a processor, circuitry, etc. capable of executing logic) for controlling delivery of heat from one or more heating elements 142 (collectively referred to as heating element 142) to cause at least a portion of the vaporizable material 102 (such as a solid, a liquid, a solution, a suspension, a part of an at least partially unprocessed plant material, etc.) of a cartridge 120 to be converted to the gas-phase. The controller 104 can be part of one or more printed circuit boards (PCBs) consistent with certain implementations of the current subject matter.

After conversion of some amount of one or more compounds present in the vaporizable material 102 to the gas phase, at least some of those gas-phase compounds can condense to form particulate matter in at least a partial local equilibrium with the gas phase as part of an aerosol, which can form some or all of an inhalable dose provided by the vaporizer device 100 during a user's puff or draw on the vaporizer device 100. It should be appreciated that the interplay between gas and condensed phases in an aerosol generated by a vaporizer device 100 can be complex and dynamic, due to factors such as temperature (e.g., ambient or local at various points within the vaporizer device and/or cartridge), relative humidity, chemistry, vapor pressure of one or more vaporizable compounds, flow conditions in airflow paths (both inside the vaporizer device 100 and in the airways of a human or other animal), and/or mixing of the one or more compounds in the gas phase or in the aerosol phase with other air streams, which can affect one or more physical parameters of an aerosol. In some vaporizer devices, and particularly for vaporizer devices configured for delivery of relatively volatile compounds, the inhalable dose can exist predominantly in the gas phase (for example, formation of condensed phase particles can be very limited).

The heating element 142 can include one or more of a conductive heater, a radiative heater, inductive heater, and/or a convective heater. One type of heating element 142 is a resistive heating element, which can include a material (such as a metal or alloy, for example a nickel-chromium alloy, or a non-metallic resistor) configured to dissipate electrical power in the form of heat when electrical current is passed through one or more resistive segments of the resistive heating element. Another type of heating element 142 is a susceptor, which can include a material (such as a metal or alloy, for example an aluminum alloy and/or a ferritic material such as a stainless steel alloy) configured to absorb and convert energy into heat when magnetic and/or electromagnetic energy is radiated into one or more segments of the susceptor. In various implementations of the current subject matter, the heating element 142 (e.g., a resistive heating element, a susceptor, and/or the like) is configured to generate heat for converting, to the gas phase, one or more compounds present in the vaporizable material 102 to generate an inhalable dose of the one or more compounds present in the vaporizable material 102. As described herein, in some implementations, the vaporizable material 102 includes a non-liquid vaporizable material including, for example, a solid-phase material (such as a gel, a wax, or the like) or plant material (e.g., tobacco leaves and/or tobacco stems).

In some implementations, the heating element 142 can be a part of the cartridge 120 (e.g., part of the disposable part of the vaporizer 100), as shown in the vaporizer device 100a of FIG. 1A. As illustrated, the cartridge 120 can include a mouthpiece portion 130 that includes one or more inserts 124 (e.g., one or more filters, such as illustrated by way of an example implementation of the insert 124 in FIGS. 1A and 1B) and a heater portion 141 that includes vaporizable material 102 and one or more heating elements 142. In some implementations, the mouthpiece portion 130 can be releasably coupled to a part of the cartridge 120. In some implementations, the mouthpiece portion 130 can be integrated with the cartridge 120. In some implementations, the mouthpiece portion 130 can include one or more elements of the cartridge 120 (e.g., airflow pathway, insert, end cap, vaporizable material, etc.), such as described herein.

In some implementations, the cartridge 120 can include one or more inserts 124, and each insert 124 can include one or more filters and/or filter material. For example, the one or more inserts 124 can be made of material that is one or both of non-vapor permeable and moisture-resistant (e.g., resists damaging effects of water, at least to some extent). Such material can include one or more of metal, metal alloy, cotton, paper material such as cardstock, corrugated material such as cardboard or paper, tobacco paper, temperature-resistant plastic such as polyethylene terephthalate (PET), cellulose acetate, non-wood plant fibers such as flax, hemp, sisal, rice straw, and/or esparto, and/or the like. In some implementations, at least a part of the insert 124 can be inserted into and/or surrounded by one or more elements, including one or more elements associated with the cartridge 120 and/or vaporizer body 110. For example, one or more inserts 124 can be positioned adjacent to, in contact with and/or offset (e.g., along the length (as length is used and defined herein) of the cartridge 120) from one or more of a divider (e.g., divider 454 in FIG. 4G) and end cap (e.g., end cap 664 in FIG. 6B), as described herein. In some implementations, at least a part of the insert 124 can be exposed (e.g., not inserted into or surrounded by one or more elements), including an entire length (as length is used and defined herein) of the insert 124 can be exposed. As used herein, an “end cap” can refer to at least one of a variety of materials and/or elements that are positioned adjacent an end of the cartridge 120, such as a first end or a second end of the cartridge 120. In some implementations, the end cap can be positioned at an end of the cartridge 120. In some implementations, the end cap can be positioned offset (e.g., along the length of the cartridge 120) from an end of the cartridge 120, including not being a most distal or proximal element along an implementation of the cartridge 120. For example, the end cap can form a part of an outer surface of the cartridge 120 and/or the end cap can be fully contained within the outer surface of the cartridge 120.

In some implementations, the heater portion 141 can optionally include one or more inserts 124, such as at the end of the vaporizable material 102 (e.g., distal end of the cartridge 120) to help retain the vaporizable material 102 within the cartridge 120. The one or more inserts 124 can contain a plurality of openings, such as inlets, channels, and/or outlets. In some implementations, at least a portion of the one or more inserts 124 can be permeable, such that vapor and/or aerosol can pass through the inserts 124. In some implementations, the heater portion 141 can be releasably coupled to a part of the cartridge 120. In some implementations, the heater portion 141 can be integrated with the cartridge 120. In some implementations, the heater portion 141 can include one or more elements of the cartridge 120 (e.g., airflow pathway, insert, vaporizable material, etc.), such as described herein. In some implementations, the heater portion 141 can include more than one separable and/or releasably coupleable parts. For example, one part of the heating portion 141 can be integrated with the cartridge 120 and a second part of the heating portion 141 can be integrated with an element apart from and/or outside of the cartridge 120, such as integrated with the vaporizer body 110.

The mouthpiece portion 130 and the heater portion 141 can be joined together via an outer layer, such as one or more layers of material (e.g., wrappers 122 (as shown by way of example in FIGS. 1A and 1), shells, or other comparable structural material or materials). In some implementations, the heater portion 141 can be regarded as including at least a portion of the cartridge 120 that is insertably received in the receptacle 118 and the mouthpiece portion 130 can be regarded as at least some of a portion of the cartridge 120 that remains outside of the receptacle 118 when the cartridge 120 is insertably received in the receptacle 118. In some implementations, the receptacle 118 can be configured to insertably receive and couple to the cartridge 120 via a snap-fit, press-fit, friction fit, magnetic attachment, and/or the like. In some implementations, the vaporizer body 110 can include a ledge 121 that at least partially defines an opening into the receptacle 118. The ledge 121 can include features, such as a chamfered edge, that facilitate placement of the cartridge 120 into the receptacle 118. As the term is used herein, it is not required that the entirety of the mouthpiece portion 130 be designed for insertion into a user's mouth, only that the mouthpiece portion 130 is at or near the end of the cartridge 120 that is designed for the user to place into their mouth in use.

The heating element 142 can be wrapped around (at least in part), pressed into thermal contact with, or otherwise arranged to deliver heat directly to the vaporizable material 102 to cause release of one or more compounds into the gas phase. Within the vaporizer body, driving circuitry 143 (as shown in FIG. 1C) is provided for driving the heating element 142. For example, the driving circuitry 143 can include two or more electrical contacts (e.g., positioned at least partially within the receptacle 118) for providing an electrically conductive pathway between the power source 112 of the vaporizer body 110 and the heating element 142 of the cartridge 120, when the cartridge 120 is insertably received within the receptacle 118. In other implementations, the driving circuitry 143 can include one or more inductors, such as two or more inductive coils, configured to generate an electromagnetic field directed and positioned to affect the heating element 142, which can take the form of a susceptor, to cause the susceptor to generate heat.

In other implementations, the heating element 142 can be a part of the vaporizer body 110 (e.g., part of the durable or reusable part of the vaporizer 100), as shown in the vaporizer device 100b of FIG. 1B. As illustrated, the cartridge 120 can include a mouthpiece portion 130 that includes one or more inserts 124 and a container portion 123 that includes vaporizable material 102. The mouthpiece portion 130 and the container portion 123 can be joined together via an outer layer, such as one or more wrappers 122. The heating element 142 can be wrapped around (at least in part), pressed into thermal contact with, or otherwise arranged to deliver heat to the cartridge 120 containing the vaporizable material 102 to convert the one or more compounds from the vaporizable material 102 to the gas phase for subsequent inhalation by a user in a gas-phase and/or a condensed (for example, aerosol particles or droplets) phase. For example the heating element 142 can be positioned within the receptacle 118 and disposed to directly or indirectly heat the container portion 123 (e.g., by conductive or radiative, or convective heating), which in turn can heat the vaporizable material 102 contained therein. In related implementations, the heating element 142 can be positioned outside of the receptacle 118 and disposed to heat the receptacle 118 itself, so as to create an oven that provides convective and/or conductive heat. In either case, the heating element 142 can be at least partially or substantially wrapped around a perimeter of the receptacle 118. Such a heating element can be heated by one or more of a variety of mechanisms, such as for example electrical resistance, inductive heating, chemical or combustion-related heating (e.g., by burning or causing oxidation or other exothermic chemical conversion of a fuel material), thermal conduction from another heated element, radiative heating, convection, etc.

In other implementations, the heating element 142 can be a part of a cartridge 120 containing a liquid vaporizable material 102 in a liquid reservoir 182, as shown in the vaporizer device 100c of FIG. 1C. As illustrated, the cartridge 120 can include a mouthpiece portion 130 and a shell portion 192 containing a heater portion 141 and a reservoir 182 configured to hold a liquid vaporizable material 102. The mouthpiece portion 130 and the shell portion 192 can be integrally formed (e.g., manufactured as a single piece) or can be joined together via mechanical coupling means, such as snap fit, press fit, friction fit, adhesive, and/or the like. The heater portion 141 can include a heating element 142 and a wicking material (not shown) configured to transfer the liquid vaporizable material 102 from the reservoir 182 to be in contact with the heating element 142 via capillary action. In some implementations, the heating element 142 can be in direct contact with the wicking material, such as by being pressed against one or more sides of the wicking material, wrapped at least partially around the wicking material, and/or the like. The heating element 142 can be configured to generate heat to convert the one or more compounds from the vaporizable material 102 to the gas phase for subsequent inhalation by a user in a gas-phase and/or a condensed (for example, aerosol particles or droplets) phase. For example, the heater portion 141 can include circuitry configured to receive and/or convert an applied electromagnetic field into an electrical current that is used to power, and thereby heat, the heating element 142. In some implementations, the heating element 142 itself can be configured to generate heat based on having a structure (e.g., material and shape) configured to receive and convert an applied electromagnetic field into an electrical current that is used to power, and thereby heat, the heating element 142. Accordingly, the heater portion 141 and/or heating element 142 can be powered via the driving circuitry 143, as described herein.

Where the vaporizable material 102 includes a non-liquid vaporizable material, the heating element 142 can be part of, or otherwise incorporated into or in thermal contact with, the walls of a heating chamber or compartment (e.g., receptacle 118) into which the cartridge 120 and/or the vaporizable material 102 is placed. Additionally or alternatively, the heating element 142 can be used to heat air passing into, through, or past the cartridge 120, to cause convective heating of the vaporizable material 102 (e.g., within the cartridge 120). In still other examples, the heating element 142 can be disposed in intimate contact with the vaporizable material 102 such that direct conductive heating of the vaporizable material 102 of the cartridge 120 occurs from within a mass of the vaporizable material 102, as opposed to only by conduction inward from walls of the heating chamber (e.g., an oven and/or the like). Convective heating of air passing through or past the cartridge 120 can also occur in such configurations. Additionally, conductive heating can occur by means of inductively heating the heating element 142. That is, the heating element 142 can generate heat based on conversion of electromagnetic energy into heat, and this heat can be conducted to other parts of the cartridge 120, such as for example other parts of the heating element 142 that are not as directly affected by the electromagnetic energy, the vaporizable material 102, other thermally conductive parts of the cartridge 120 or the vaporizer body 110, etc. The vaporizable material 102 can be vaporized by this heat based in part on being in contact with one or more surfaces of the heating element 142 and/or other materials that are conductively heated by the heating element 142.

In some implementations, the vaporizable material 102 can be heated via one or more heating element 142 that is not in physical contact with the vaporizable material 102, such as by convective heating. In accordance with such implementations, a heating element 142 can be configured to heat air passing along, through, and/or near the heating element 142 such that a temperature of the air reaches a temperature sufficient to vaporize at least a portion of the vaporizable material 102. In some implementations, the vaporizable material 102 can be vaporized by both conductive heat from at least one heating element 142 and convective heat from at least one other heating element 142.

The heating element 142 can provide heat to convert, to the gas phase, one or more compounds present in the vaporizable material 102 in association with a user puffing (e.g., drawing, inhaling, etc.) on a mouthpiece portion 130 and/or end of the vaporizer device 100 to cause air to flow from an air inlet, along an airflow path for assisting with forming an aerosol that can be delivered out through an air outlet in the mouthpiece portion 130 and inhaled by a user. Incoming air moving along the airflow path moves past (e.g., around, over, etc.) and/or through the cartridge 120 and/or vaporizable material 102 where compounds released from the vaporizable material 102 into the gas-phase are entrained into the air. The heating element 142 can be activated via the controller 104, which can optionally be a part of the vaporizer body 110 as discussed herein, causing current to pass from the power source 112 through a circuit including or otherwise electromagnetically coupled to (e.g., as part of an inductor-susceptor pairing) the heating element 142, which can be part of the vaporizer body 110. As noted herein, at least some of the entrained one or more gas-phase compounds can condense while passing through the remainder of the airflow path such that an inhalable dose of the one or more compounds in an aerosol form can be delivered from the air outlet (e.g., via the mouthpiece portion 130) for inhalation by a user.

In some implementations, the heating element 142 can be activated in association with a user interacting with the vaporizer device 100. For example, activation of the heating element 142 can be caused by automatic detection of a puff or other user interaction based on one or more signals generated by one or more sensors 113. The one or more sensors 113 and/or the signals generated by the one or more sensors 113 can include one or more of: a pressure sensor or sensors disposed to detect pressure along the airflow path of the vaporizer device 100 relative to ambient pressure or optionally to measure changes in absolute pressure; a temperature sensor or sensors, such as a thermistor, a positive temperature coefficient (PTC) circuit such as a PTC thermistor, a negative temperature coefficient (NTC) circuit such as an NTC thermistor, a thermocouple, and/or the like disposed to measure the temperature of the receptacle 118, the heating element 142, and/or some other component of the vaporizer body 110 or the cartridge 120; one or more circuits configured to determine a temperature of the heating element 142, for example based on measuring or determining a resistance and/or inductance of the heating element 142 via comparison to one or more resistors with a known resistance and/or one or more inductors with a known inductance; a motion sensor or sensors, such as an accelerometer, a gyroscope, or the like, configured to detect movement, vibration, orientation, position, acceleration, etc. of the vaporizer device 100; a flow sensor or sensors configured to detect a flow rate of air, gas, or liquid within the vaporizer device 100; a capacitive sensor configured to detect touch, such as of a user's finger(s), palm(s), lip(s), etc. on some part of the vaporizer device 100; circuitry configured to detect interaction with the vaporizer device 100 via one or more input devices 116, such as buttons, other tactile control devices, or the like of the vaporizer device 100; circuitry configured to receive and process signals from a computing device in communication with the vaporizer device 100; and/or circuitry configured for determining that a puff is occurring or imminent.

In some implementations, the vaporizer device 100 can be configured to start a heating cycle that can include a period of heating the heating element 142, receptacle 118, cartridge 120, and/or vaporizable material 102 to an operating (e.g., pre-determined) temperature or temperature range (e.g., a temperature or range sufficient to convert, to the gas phase, one or more compounds present in the vaporizable material 102). Once the heating element 142, receptacle 118, cartridge 120, and/or vaporizable material 102 reach the operating temperature or temperature range, the vaporizer device 100 can be configured to maintain or otherwise regulate the application of heat such that the vaporizable material 102 can be vaporized without burning. In some implementations, additional heat can be provided via the heating element 142 upon detection of an event, such as a user placing their lips on the vaporizer device 100, the user taking a puff on the vaporizer device 100, and/or any of the signals (e.g., generated by the one or more sensors 113) described herein. The heating cycle can terminate upon detection of an additional interaction with the vaporizer device 100 via the one or more input devices 116, upon determining that a certain amount of time has elapsed since the start of the heating cycle, upon determining that a certain amount of time has elapsed since the last detection of a user puff, upon determining that a cartridge 120 is not present within the receptacle 118, as a result of other events, actions, detected durations of the same, and/or the like, consistent with implementations described herein.

As discussed herein, the vaporizer device 100 consistent with implementations of the current subject matter can be configured to connect (e.g., wirelessly or via a wired connection) to a computing device (or optionally two or more devices) in communication with the vaporizer device 100. To this end, the controller 104 can include communication hardware 105. The controller 104 can also include a memory 108. The communication hardware 105 can include firmware and/or can be controlled by software for executing one or more protocols for the communication.

A computing device can be a component of a vaporizer system that also includes the vaporizer device 100, and can include its own hardware for communication, which can establish a wireless communication channel with the communication hardware 105 of the vaporizer device 100. For example, a computing device used as part of a vaporizer system can include a general-purpose computing device (such as a smartphone, a tablet, a personal computer, some other portable device such as a smartwatch, or the like) that executes software to produce a user interface for enabling a user to interact with the vaporizer device 100. In other implementations of the current subject matter, such computing device used as part of a vaporizer system can be a dedicated piece of hardware such as a remote control or other wireless or wired device having one or more physical or soft (e.g., configurable on a screen or other display device and selectable via user interaction with a touch-sensitive screen or some other input device 116 like a mouse, pointer, trackball, cursor buttons, or the like) interface controls. The vaporizer device 100 can also include one or more outputs 117 or devices for providing information to the user. For example, the outputs 117 can include one or more light emitting diodes (LEDs) configured to provide feedback to a user based on a status and/or mode of operation of the vaporizer device 100. The one or more LEDs can be single-color LEDs and/or multicolored LEDs (e.g., both can be separately used).

In the example in which a computing device provides signals related to activation of the heating element 142, or in other examples of coupling of a computing device with the vaporizer device 100 for implementation of various control or other functions, the computing device executes one or more computer instruction sets to provide a user interface and underlying data handling. In one example, detection by the computing device of user interaction with one or more user interface elements can cause the computing device to signal the vaporizer device 100 to activate the heating element 142 to reach an operating temperature for creation of an inhalable dose of aerosol. Other functions of the vaporizer device 100 can be controlled by interaction of a user with a user interface on a computing device in communication with the vaporizer device 100.

The temperature of the heating element 142 of the vaporizer device 100 can depend on a number of factors, including an amount of power or energy delivered to the heating element 142, a voltage applied to the heating element 142 and/or driving circuitry 143, a duty cycle at which power or current is delivered, a frequency at which power is applied to the heating element 142 and/or driving circuitry 143, a time during which the power or current is delivered, an efficiency of the heating element 142 converting current to heat, a temperature coefficient of resistivity (TCR) of the heating element 142, the construction and geometry of the heating element 142 (e.g., thickness, number of layers, number of folds or bends, etc.), conductive and/or radiative heat transfer to other parts of the vaporizer device 100 (e.g., vaporizable material 102), and/or to the environment, latent heat losses due to vaporization of the vaporizable material 102, convective heat losses due to airflow (e.g., air moving across the heating element 142 and/or an area heated by the heating element 142 when a user puffs on the vaporizer device 100), and/or the like.

As noted herein, to reliably activate the heating element 142 and/or heat the heating element 142 to a desired temperature, in some implementations of the current subject matter the vaporizer device 100 can make use of signals from the one or more sensors 113. For example, the one or more sensors 113 can include a pressure sensor and/or airflow sensors, to determine when a user is inhaling. The one or more sensors 113 can optionally be positioned in the airflow path and/or can be connected (for example, by a passageway or other path) to an airflow path containing an airflow inlet for air to enter the vaporizer device 100 and an airflow outlet via which the user inhales the resulting aerosol such that the one or more sensors 113 experiences changes (for example, pressure changes) concurrently with air passing through the vaporizer device 100 from the airflow inlet to the airflow outlet. In some implementations of the current subject matter, the heating element 142 can be activated in association with a user's puff, for example by automatic detection of the puff, or by the one or more sensors 113 detecting a change (such as a pressure change or flow rate) in the airflow path.

Additionally or alternatively, to maintain the heating element 142 at a desired temperature, in some implementations of the current subject matter the vaporizer device 100 can make use of other signals from one or more sensors 113. For example, the one or more sensors 113 can include a capacitive, conductive, and/or electromagnetic sensor, to determine the inductance, resistance, and/or impedance of the heating element 142. The one or more sensors 113 can optionally be positioned in a location that is in physical contact with the heating element 142 (for example, within the receptacle 118) or in a location that is sufficiently close to the heating element 142 to measure the variations in an electromagnetic field affecting the heating element (e.g., within, touching, or proximate to at least some part of the receptacle 118). In some implementations, the one or more sensors 113 can be in electrical communication with an inductor configured to inductively heat the heating element 142 and/or configured to determine the inductance, resistance, and/or impedance of the inductor. Additionally or alternatively, the one or more sensors 113 can include a temperature sensor configured to sense a temperature of the inductor and/or heating element 142. Based on information derived from the one or more sensors 113, the controller 104 can be configured to estimate a temperature of the heating element 142, as described herein. In some implementations, the heating element 142 can be activated and/or power provided to the heating element 142 can be adapted in association with an estimated temperature of the heating element 142, for example by comparison of the detected inductance and/or resistance of the heating element 142 via the one or more sensors 113 with a suitable sensing circuit.

The one or more sensors 113 can be positioned on and/or coupled to (e.g., electrically or electronically connected, physically or via a wireless connection) the controller 104 (e.g., a printed circuit board assembly or other type of circuit board). To take measurements accurately and maintain durability of the vaporizer device 100, it can be beneficial to provide a seal that is sufficiently resilient to separate an airflow path from other parts of the vaporizer device 100. The seal, which can be a gasket, can be configured to at least partially surround the one or more sensors 113 such that connections of the one or more sensors 113 to the internal circuitry of the vaporizer device 100 are separated from a part of the one or more sensors 113 exposed to the airflow path. Such arrangements of the seal in the vaporizer device 100 can be helpful in mitigating against potentially disruptive impacts on vaporizer components resulting from interactions with environmental factors such as water in the vapor or liquid phases and/or to reduce the escape of air from the designated airflow path in the vaporizer device 100. Passage of air, liquid, or other fluid passing and/or contacting circuitry of the vaporizer device 100 can cause various unwanted effects, such as altered pressure readings, and/or can result in the buildup of material, such as moisture or residue, errant portions of the vaporizable material 102, etc., in parts of the vaporizer device 100 where they can result in poor pressure signal, degradation of the one or more sensors 113 or other components, and/or a shorter life of the vaporizer device 100. Leaks in the seal can also result in a user inhaling air that has passed over parts of the vaporizer device 100 containing, or constructed of, materials that can not be desirable to be inhaled, such as the controller 104, power source 112, and/or the like.

When the one or more sensors 113 includes an electrically conductive surface for measuring the resistance of the heating element 142, the one or more sensors 113 can additionally or alternatively be positioned on a surface that is biased against some part of the heating element 142. For example, the one or more sensors 113 can be disposed on a surface of a spring or other resiliently deformable structure, or otherwise biased by a spring or other resiliently deformable structure, such that the one or more sensors 113 remains in physical contact with a surface of the heating element 142. Such arrangements of a spring or other resiliently deformable structure in the vaporizer device 100 can be helpful in mitigating against potentially disruptive impacts on vaporizer components resulting from interactions with environmental factors such as those described herein.

In vaporizer devices in which the power source 112 is part of a vaporizer body 110 and the heating element 142 is disposed in the cartridge 120 configured to couple with the vaporizer body 110, the cartridge 120 and vaporizer device 100 can include electrical connection features (e.g., electrical contacts, conductors, and the like) for completing a physical circuit that includes the controller 104 (e.g., a printed circuit board, a microcontroller, or the like), the power source 112, and the heating element 142. The circuit completed by these electrical connections can allow delivery of electrical current to the heating element 142 (e.g., resistive heating element) and can further be used for additional functions, such as measuring a resistance of the heating element 142 for use in determining and/or controlling a temperature of the resistive heating element based on a thermal coefficient of resistivity of the resistive heating element. In some implementations, a different circuit can be provided for measuring a resistance of the heating element 142, compared to the circuit that allows for delivery of the electrical current to the heating element 142, such as a circuit that includes one or more sensors 113 and the heating element 142, as described herein.

Alternatively, the power source 112 can be part of a vaporizer body 110 and the heating element 142 can be disposed in the cartridge 120 and configured as a susceptor to be electromagnetically coupled with one or more inductor coils that are part of the driving circuitry 143 in the vaporizer body 110. A physical circuit in the vaporizer body 110 includes the controller 104 (e.g., a printed circuit board, a microcontroller, or the like), the power source 112, and the one or more inductor coils, which can be or form part of the driving circuitry 143. The physical circuit delivers electrical current to the one or more inductor coils and can further be used for additional functions, such as measuring inductance, resistance, and/or impedance of the heating element 142 for use in determining and/or controlling a temperature of the heating element 142 based on a thermal coefficient of resistivity of the heating element 142. In some implementations, a different circuit can be provided for measuring inductance, resistance, and/or impedance of the heating element 142, compared to the circuit that allows for delivery of the electrical current to the one or more inductor coils, such as a circuit that includes one or more sensors 113 as described herein.

In some implementations, the receptacle 118 can include all or part of the heating element 142 (e.g., a heating coil, resistive heating element, etc.) that is configured to conductively, radiatively, convectively, etc. heat the cartridge 120 received in the receptacle 118, such as for forming an aerosol to be inhaled by a user of the vaporizer device 100. For example, the receptacle 118 can include various implementations of the heating element 142 that are configured to receive and/or be placed in contact with the cartridge 120. Various implementations of the heating element 142, the receptacle 118, and the cartridge 120 are described herein for integration within and/or use with a variety of vaporizer bodies 110 for forming inhalable aerosol.

In some implementations, the cartridge 120 can be configured for insertion in the receptacle 118, such as for forming contact between an outer surface of the cartridge 120 and one or more inner walls of the receptacle 118. In some implementations, the cartridge 120 can have a same or a similar shape as the receptacle 118. In some implementations, the cartridge 120 can include a square or rectangular shape. In some implementations, the cartridge 120 can include a circular cross-section and/or a cylindrical shape. In some implementations, the cartridge 120 can have a non-circular cross-section transverse to the longitudinal axis along which the cartridge 120 is inserted into the receptacle 118. The non-circular cross-section(s) of the cartridge 120 and/or receptacle 118 can include two sets of parallel or approximately parallel opposing sides (e.g., having a parallelogram-like shape), or other shapes, including curved shapes, having rotational symmetry of at least order two. For example, FIGS. 8A-8F illustrate example cross-sections of the cartridge 120 and/or receptacle 118, including a rectangular shape (FIG. 8A), a rounded rectangular shape (FIG. 8B), an elliptical or oval shape (FIG. 8C), or other shapes that include corners, bends, edges, protrusions, recesses, and/or the like (FIGS. 8D-8F). In this context, approximate shape indicates that a basic likeness to the described shape is apparent, but that sides of the shape in question need not be completely linear and vertices need not be completely sharp. Rounding of both or either of the edges or the vertices of the cross-sectional shape is contemplated in the description of any non-circular cross-section referred to herein.

In some implementations, at least one of the one or more inner walls forming the receptacle 118 can include the heating element 142 and/or include thermally conductive material. For example, cartridge 120 configurations in which the cartridge 120 forms a sliding fit and/or forms close contact with the receptacle 118 can allow for efficient heat transfer between the heating element 142, the receptacle 118, and the cartridge 120, thereby causing efficient and effective heating of the vaporizable material 102 within the cartridge 120. In other implementations, at least one of the one or more inner walls forming the receptacle 118 can include ridges that only contact the cartridge 120 in specific locations, in order to minimize conductive heat losses from the cartridge due to physical contact with surfaces of the vaporizer body 110 that are not actively heated. For example, cartridge 120 configurations in which the heater portion 141 (or other thermally conductive parts) of the cartridge 120 only contacts the receptacle 118 in certain regions, such as regions distal to the heating element(s) 142, can allow for maintaining a higher temperature at the heating element 142, thereby causing efficient and effective heating of the vaporizable material 102 within the cartridge 120.

Furthermore, the cartridge 120 can include compressed and/or higher density configurations of non-liquid vaporizable material 102, which can further contribute to efficient and effective heating and converting, to the gas phase, one or more compounds present in the vaporizable material 102. For example, vaporizable material 102 in a compressed and/or high-density configuration can include a minimal amount of air or pockets of air in the vaporizable material 102 thereby increasing the efficiency and effectiveness of transferring heat within the vaporizable material 102. Such a configuration can allow for reduced power consumption at least because less heating power is needed to effectively heat the vaporizable material 102 to a temperature sufficient to cause release of inhalable substances. Additionally, lower temperatures (e.g., at a contact surface of an oven or heating element) can be used to heat the vaporizable material 102 at least because of the improved heating efficiency of the vaporizable material 102, which can also reduce power consumption and formation of hazardous byproducts resulting from heating the vaporizable material at higher temperatures. Various implementations of the cartridge 120 are described herein that include the vaporizable material formed in compressed and/or high-density configurations for achieving at least some of the benefits described above.

In some implementations, the vaporizer device 100 can include a heating system configured to receive and heat the vaporizable material 102 for generating an inhalable aerosol. For example, implementations of the heating system can include one or more heating elements 142 positioned at, against, near, within, outside, and/or along the walls of the receptacle 118 (e.g., extending along at least a portion of the wall(s) at the distal end (e.g., bottom) of the receptacle 118, extending along at least a portion of each of the distal wall(s) and/or side wall(s) of the receptacle 118, etc.). In some implementations, the one or more heating elements 142 can be configured to heat one or more of the walls of the receptacle 118 from the outside to the interior of the receptacle 118 (e.g., with the vaporizable material 102 being in the interior of the receptacle 118). In another example, implementations of the heating system can include one or more heating elements 142 positioned at, against, near, within, outside, and/or along the walls of the cartridge 120 (e.g., extending along at least a portion of the wall(s) at the distal end (e.g., bottom) of the cartridge 120, extending along at least a portion of each of the distal wall(s) and/or side wall(s) of the cartridge 120, etc.). In some implementations, the one or more heating elements 142 can form one or more of the walls of the cartridge 120 to heat from the outside to the interior of the cartridge 120 (e.g., with the vaporizable material 102 being in the interior of the cartridge 120 and optionally, in the interior of the heating element 142).

The heating system can also include at least one airflow pathway, which can be configured to move heated air through the vaporizable material 102. As will be described in greater detail below, the heating system can be configured to receive the cartridge 120 and heat the cartridge 120 using at least one heating element 142 to provide an inhalable aerosol via one or more airflow pathways for inhalation by a user.

Various implementations of such heating systems of vaporizer devices 100 are described herein that provide a number of benefits, including evenly distributing heat through the vaporizable material 102 of the cartridge 120. This can result in improved inhalable aerosol generation, less energy and/or lower average temperatures required to form inhalable aerosol, and increased user satisfaction with the device use and consumption of the vaporizable material 102.

In some implementations, the heating system of the vaporizer device 100 is configured to heat a non-liquid vaporizable material, such as a tobacco-based material. For example, the vaporizer body 110 can include one or more heater portions 141 or containers 123 that each accept and heat vaporizable material 102 via one or more heating elements 142, thereby generating an inhalable aerosol. In some implementations, the vaporizer device 100 can include one or more airflow pathways that extend through the cartridge 120 positioned within a respective receptacle 118, and out through a mouthpiece portion 130 to a user.

In some implementations, the cartridge 120 can include one or more barriers configured to contain vaporizable material 102 and/or hold the components of the cartridge 120 together. The one or more barriers can be provided by the heating element 142 itself, a container 123, an insert 124, an outer layer, such as one or more wrappers 122, and/or the like. The one or more barriers can be made of material that is one or both of non-vapor permeable and moisture-resistant (e.g., resists damaging effects of water, at least to some extent). Such material can include one or more of metal, metal alloy, paper material such as cardstock, corrugated material such as cardboard or paper, tobacco paper, temperature-resistant plastic such as polyethylene terephthalate (PET), cellulose acetate, non-wood plant fibers such as flax, hemp, sisal, rice straw, and/or esparto, and/or the like.

In some implementations, use of a metal such as aluminum in the heating element 142 and/or a container 123 can be advantageous where efficient heat transfer (e.g., requiring less energy to spread across a larger region) is required, which can be the case where a singular heat source is provided. In other implementations, a metal such as stainless steel in the heating element 142 and/or a container 123 can be advantageous where efficient heat transfer is of less concern, such as where multiple heat sources are disposed to heat different regions of the cartridge 120. Containing the vaporizable material 102 within a non-vapor permeable and/or moisture-resistant barrier can protect the receptacle 118 and/or other portions of the vaporizer device 100 from vapor deposits and/or remains of the vaporizable material 102, such that cleaning of the heating element 142, receptacle 118, and/or other portions of the vaporizer device 100 after use can not be required. Stated another way, one or more of the heating element 142, the container 123, the insert 124, and/or the outer layer (e.g., one or more wrappers 122) can provide a barrier between the vaporizable material 102 and the components of the vaporizer body 110, with the barrier optionally being non-vapor permeable and/or moisture-resistant.

The heater 141 of FIG. 1A and/or the container 123 of FIG. 1B cartridge 120 can be configured to hold the vaporizable material 102 with a lid, outer layer and/or inner layer(s) (e.g., wrapper(s) 122), insert 124, and/or other component configured to retain the vaporizable material 102 therein. Various implementations of a heating system and cartridge 120 are described in greater detail below.

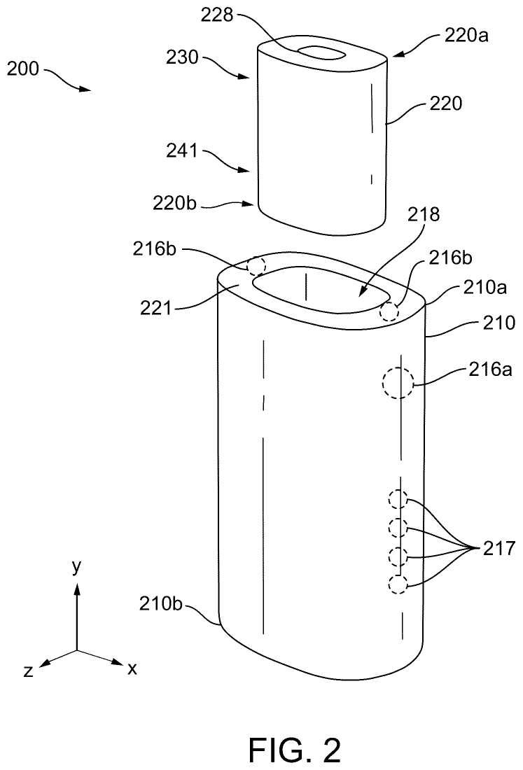

FIG. 2 illustrates a perspective view of an implementation of a vaporizer device 200, consistent with implementations of the current subject matter. The vaporizer device 200 can be an implementation of one or more components of the vaporizer device 100 of FIGS. 1A-1B. Separately, any of the structure of functionality described with respect to the vaporizer device 200 of FIG. 2 can be implemented in or by the vaporizer device 100 of FIGS. 1A-1B.

For example, as illustrated, the vaporizer device 200 can include a vaporizer body 210, a receptacle 218, and a ledge 221 outside of the receptacle 218. As described herein, a cartridge 220 containing vaporizable material 102 (including any implementation of the vaporizer material 102 of FIGS. 1A-1C) can be inserted into the receptacle 218, and at least a portion of the cartridge 220 can remain outside of the receptacle 218, such as at least part of the mouthpiece portion 230 that includes an airflow outlet 228. At least part of the heater portion 241 of the cartridge 220 can be inserted into and/or at least partially enclosed within the receptacle 218. Although the mouthpiece portion 230 and the heater portion 241 can be approximately the same size in length (e.g., 1:1) along the cartridge 220 length, other relative sizes are contemplated (e.g., approximately 1:2, 2:3, 3:4, 4:5, 5:4, and/or the like).

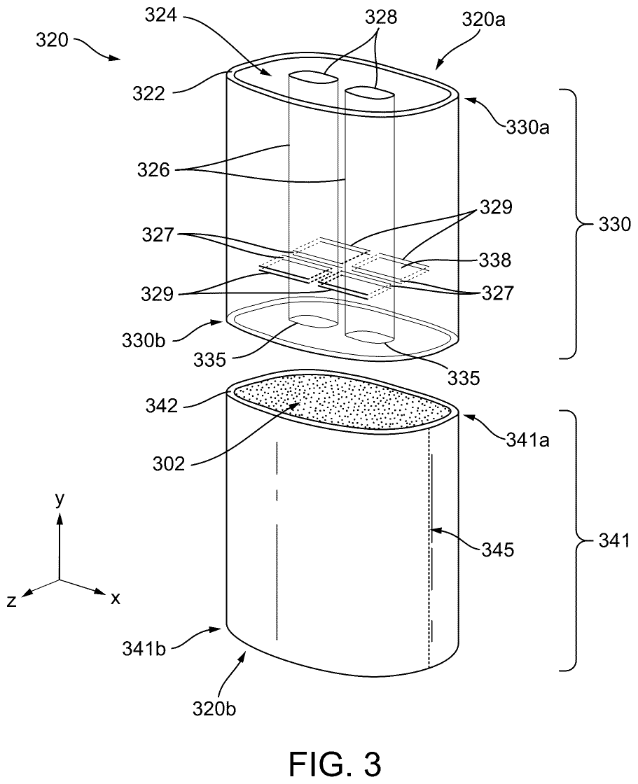

As illustrated, the cartridge 220 can extend from a cartridge proximal end 220a to a cartridge distal end 220b and contain two or more portions, such as a heater portion 241 and a mouthpiece portion 230. The total distance between the cartridge proximal end 220a and the cartridge distal end 220b can be regarded as the cartridge 220 length, for example, extending along the y-axis as illustrated in FIG. 2 (and as also illustrated in FIG. 3). Furthermore, any component of the cartridge 220 can be referred to as having a length as referenced by the y-axis in FIG. 2 (and as also illustrated in FIG. 3).

As also illustrated, the vaporizer body 210 can extend from a body proximal end 210a to a body distal end 210b. The total distance between the body proximal end 210a and the body distal end 210b can be regarded as the vaporizer body 210 length, for example, extending along the y-axis as illustrated in FIG. 2 (and as also illustrated in FIG. 5A). Furthermore, any component of the vaporizer body 210, as well as the vaporizer device 200, can be referred to as having a length as referenced by the y-axis in FIG. 2 (and as also illustrated in FIG. 5A with respect to components of the vaporizer body 210).

The cartridge 220 can be regarded as having two additional dimensions that are transverse to the cartridge 220 length, which are the depth and the width. As referred to herein, the cartridge 220 depth can be the distance between two points on opposing faces (e.g., surface areas, which can be substantially the same size and shape when rotated about a central longitudinal axis) of the exterior of the cartridge 220, in a dimension that is perpendicular to the cartridge 220 length, for example, extending along the z-axis as illustrated in FIG. 2 (and as also illustrated in FIG. 3). Furthermore, any component of the cartridge 220 can be referred to as having a depth as referenced by the z-axis in FIG. 2 (and as also illustrated in FIG. 3). In some implementations, the cartridge 220 depth can be understood as the greatest distance of the cartridge 220 along the z-axis and/or the distance between two opposing points on the exterior of the cartridge 220 (e.g., with the opposing points being opposite each other along an axis that is perpendicular to the center of the cartridge 220 width). As referred to herein, the cartridge 220 width can be the distance between two points on opposing faces of the exterior of the cartridge 220, in a dimension that is perpendicular to both the cartridge 220 length and the cartridge 220 depth, and is the longer of the two transverse dimensions, for example, extending along the x-axis as illustrated in FIG. 2 (and as also illustrated in FIG. 3). Furthermore, any component of the cartridge 220 can be referred to as having a width as referenced by the x-axis in FIG. 2 (and as also illustrated in FIG. 3). In some implementations, the cartridge 220 width can be understood as the greatest distance of the cartridge 220 along the x-axis and/or the distance between two opposing points on the exterior of the cartridge 220 (e.g., with the opposing points being opposite each other along an axis that is perpendicular to the center of the cartridge 220 depth). Accordingly, the axis along which the cartridge 220 width extends can be referred to as the first transverse axis and/or the cartridge long axis, and the axis along which the cartridge 220 depth extends can be referred to as the second transverse axis and/or the cartridge short axis.

A surface of the cartridge 220 extending primarily along the cartridge 220 width can be referred to as a long side of the cartridge 220 and/or as being on a long side of the cartridge 220, and a surface of the cartridge 220 extending primarily along the cartridge 220 depth can be referred to as a short side of the cartridge 220 and/or as being on a short side of the cartridge 220. Each of the referenced surfaces of the cartridge 220 can be a surface area on the exterior of the cartridge 220. In some implementations, the longer opposing faces can be regarded as being on the long/longer sides of the cartridge 220, offset along the cartridge 220 depth, and the smaller opposing faces can be regarded as being on the short/shorter sides of the cartridge 220, offset along the cartridge 220 width. It will be appreciated that this terminology can be applied to any implementation of a cartridge and its subcomponents described herein (e.g., heater portion, mouthpiece portion, heating element, layer of material, wrapper, insert and/or the like), and this terminology is not redefined with respect to each implementation or subcomponent for the sake of brevity.

The vaporizer body 210 can also be regarded as having two additional dimensions that are transverse to the vaporizer body 210 length, which are the depth and the width. As referred to herein, the vaporizer body 210 depth can be the distance between two points on opposing faces of the exterior of the vaporizer body 210, in a dimension that is perpendicular to the vaporizer body 210 length, for example, extending along the z-axis as illustrated in FIG. 2 (and as also illustrated in FIG. 5A). Furthermore, any component of the vaporizer body 210, as well as the vaporizer device 200, can be referred to as having a depth as referenced by the z-axis in FIG. 2 (and as also illustrated in FIG. 5A with respect to components of the vaporizer body 210). In some implementations, the vaporizer body 210 depth can be understood as the greatest distance of the vaporizer body 210 along the z-axis and/or the distance between two opposing points on the exterior of the vaporizer body 210 (e.g., with the opposing points being opposite each other along an axis that is perpendicular to the center of the vaporizer body 210 width). As referred to herein, the vaporizer body 210 width can be the distance between two points on opposing faces of the exterior of the vaporizer body 210, in a dimension that is perpendicular to both the vaporizer body 210 length and the vaporizer body 210 depth, and is the longer of the two transverse dimensions, for example, extending along the x-axis as illustrated in FIG. 2 (and as also illustrated in FIG. 5A). Furthermore, any component of the vaporizer body 210, as well as the vaporizer device 200, can be referred to as having a width as referenced by the x-axis in FIG. 2 (and as also illustrated in FIG. 5A with respect to components of the vaporizer body 210). In some implementations, the vaporizer body 210 width can be understood as the greatest distance of the vaporizer body 210 along the x-axis and/or the distance between two opposing points on the exterior of the vaporizer body 210 (e.g., with the opposing points being opposite each other along an axis that is perpendicular to the center of the vaporizer body 210 depth). Accordingly, the axis along which the vaporizer body 210 width extends can be referred to as the first transverse axis and/or the vaporizer body long axis, and the axis along which the vaporizer body 210 depth extends can be referred to as the second transverse axis and/or the vaporizer body short axis.

A surface of the vaporizer body 210 extending primarily along the vaporizer body 210 width can be referred to as a long side of the vaporizer body 210 and/or as being on a long side of the vaporizer body 210, and a surface of the vaporizer body 210 extending primarily along the vaporizer body 210 depth can be referred to as a short side of the vaporizer body 210 and/or as being on a short side of the vaporizer body 210. Each of the referenced surfaces of the vaporizer body 210 can be a surface area on the exterior of the vaporizer body 210. In some aspects, the longer opposing faces can be regarded as being on the long/longer sides of the vaporizer body 210, offset along the vaporizer body 210 depth, and the smaller opposing faces can be regarded as being on the short/shorter sides of the vaporizer body 210, offset along the vaporizer body 210 width. It will be appreciated that this terminology can be applied to any implementation of a vaporizer body and its subcomponents described herein (e.g., holder assembly, frame, inductor, flux concentrator, shell, and/or the like), and this terminology is not redefined with respect to each implementation or subcomponent for the sake of brevity.

It will be appreciated that elements described herein (e.g., vaporizer device, cartridge, vaporizer body, and component thereof) can have surfaces defined in Euclidean or non-Euclidean spaces. Dimensions of ends, sides, faces, and/or the like that exist in non-Euclidean spaces can be regarded as dimensions of the referenced ends, sides, faces and/or the like that exist in Euclidean spaces. The distance between any two ends, sides, faces, points, etc. can be equal to the shortest distance between two opposing points at the center of each identified structure, component, region, portion, etc. However, in the event a structure, component, region, portion, etc. is not uniform in shape (e.g., convex or concave ends of a cartridge 220 and/or vaporizer body 210), the distance can be equal to the longest distance along a plane or volume that intersects the identified ends, sides, points, etc., orthogonal to the identified ends, sides, points, etc.

The term “heater portion” as used herein can refer to a portion (e.g., region and/or subset of the components) of a cartridge that includes a heating element or is otherwise heated in use. The term “mouthpiece portion” as used herein can refer to a portion (e.g., region and/or subset of the components) of a cartridge that includes a mouthpiece or other component to which a user applies their mouth in use. Although the cartridges are generally described herein with respect to a heater portion and a mouthpiece portion for simplicity, it will be appreciated that additional portions can be provided within the cartridge, which can be at least partially upstream, between, downstream, adjacent, within and/or exterior to the heater portion and/or mouthpiece portion. For example, an external wrapper or shell can be exterior to both the heater portion and mouthpiece portion, a space or component(s) can be disposed between the heater portion and mouthpiece portion, the heater portion can include an insert and/or end cap upstream or at least partially within the heater portion, the mouthpiece portion can include an insert and/or end cap downstream or at least partially within the mouthpiece portion, and/or the like. Furthermore, it will be appreciated that although described at times as separable, the mouthpiece portion 230 and the heater portion 241 can simply regarded as general regions of a unitary body that is the cartridge 220.

As illustrated, the vaporizer device 200 can include one or more input devices 216a, 216b (collectively referred to as input devices 216), such as a pair of input devices 216a on opposing sides of the vaporizer body 210 and/or one or more input devices 216b on the ledge 221. In some implementations, the one or more input devices 216a, 216b can include a button (e.g., plastic, metal, elastomeric), a capacitive sensor, and/or the like. A controller (not illustrated) of the vaporizer device 200, similar to controller 104 of FIGS. 1A-1C, can be configured to detect actuation (e.g., touch or force) of the one or more input devices 216a, 216b based on signals or data provided by the one or more input devices 216a, 216b. In implementations where multiple input devices 216 are present, a controller 104 of the vaporizer device 200 can be configured to activate the vaporizer device 200 only in response to detecting actuation of all of the input devices 216 (e.g., two input devices 216a located at opposing sides of the vaporizer body 210). It can be beneficial to provide multiple input devices 216 in different locations that are less likely to each be activated accidentally (e.g., in locations most likely to be touched all at the same time only during active use of the vaporizer device 200). However, a simpler interface can be provided, such as by using an input device 216 in the form of a single push button or multiple push buttons.

In some implementations, the controller 104 of the vaporizer device 200 can be configured to select predetermined operating temperatures and/or heating profiles from among N temperatures or profiles. In accordance with these implementations, the controller 104 of the vaporizer device 200 can be configured (and thereby a user can be allowed) to select a temperature or profile based on detecting actuation of the one or more input devices 216. In some implementations, the input device(s) 216 (e.g., input devices 216a) can be used to increase and decrease the currently selected operating temperature (also referred to as target temperature) and/or profile between a range of zero (0) through N temperatures and/or profiles, where zero means the vaporizer device 200 is in an “off” state (e.g., not actively heating the receptacle 218 but otherwise configured to detect interactions with one or more components of the vaporizer device 200). Accordingly, an input device 216 can be actuated to increase the currently selected operating temperature and/or profile and the same or another input device 216 can be actuated to decrease the currently selected operating temperature and/or profile. The input device(s) 216 can be actuated to provide for switching between the “off” state and an “on” state (e.g., where the “on” state starts at the lowest pre-configured temperature and/or profile) when one or more input device 216 is actuated (e.g., held down or pressed) for a predetermined time. As described herein, the controller 104 can be configured to heat different regions of the heating element 143, optionally at different temperatures and/or times.

In some implementations, the controller 104 of the vaporizer device 200 can be configured to operate (e.g., power the heating element 142 as described herein) at one or more predetermined operating temperatures, such as based on a default or user-selected heating profile. For example, in some heating profiles, the controller of the vaporizer device 200 can be configured to power the heating element 142 at a first operating temperature for a first period of time, power the heating element 142 at a second operating temperature for a second period of time, power the heating element 142 at a third operating temperature for a third period of time, and/or the like. In some implementations, the controller 104 of the vaporizer device 200 can be configured to power the heating element 142 based on usage of the vaporizer device 200. For example, an operating temperature of the heating element 142 can be initially set to an initial operating temperature and/or the operating temperature can be dynamically changed depending on detected airflow, temperatures, heating time, power applied, estimated vaporizable material 102 used, estimated vaporizable material 102 remaining, and/or the like. Although heating of the vaporizable material 102 is at times described with respect to a singular heating element 142, it will be appreciated that multiple heating elements 142 and/or multiple regions of a singular heating element 142 can be implemented and/or controlled in the same or similar manner to provide more control over vaporization of the vaporizable material 102.

In some implementations, the controller 104 of the vaporizer device 200 can be configured to detect when the heater portion 241 is present within the receptacle 218 and/or for a sufficient duration of time. In response to determining that the heater portion 241 is present within the receptacle 218 and/or for a sufficient duration of time, the controller of the vaporizer device 200 can switch the vaporizer device 200 between the “off” state and the “on” state, increase the temperature to a range of zero (0) through N target temperatures, implement a predetermined (e.g., user-selected) profile from a plurality of zero (0) through N different profiles, and/or the like.

In some implementations, the controller 104 of the vaporizer device 200 can be configured to determine whether a cartridge 220 is spent and/or should be changed. This can occur when all, most, or an estimated threshold amount of one or more compound present in the vaporizable material 102 contained within the cartridge 220 has been converted to the gas phase, when an insufficient amount or quality of the vaporizable material 102 is present to provide an inhalable aerosol that would be satisfying to a user, and/or the like. For example, based on the length of time the cartridge 220 is heated, the temperatures at which the cartridge 220 is heated across the length of time or the temperatures at each of a plurality of time segments (which can be measured via the controller 104 of the vaporizer device 200 as described herein), and/or the like, the controller 104 of the vaporizer device 200 can be configured to determine that the cartridge 220 is spent and/or should be changed. Based on determining that the cartridge 220 is spent and/or should be changed, the controller 104 of the vaporizer device 200 can be figured to provide an indication that the cartridge 220 is spent and/or should be changed, switch the vaporizer device 200 into the “off” state, and/or the like. During operation, the controller 104 of the vaporizer device 200 can be configured to provide indications of an estimated amount of vaporizable material 102 left in the cartridge 220 and/or an estimated amount of time remaining in a vaporizing session during which the vaporizable material 102 can be used (e.g., a period of time starting when the vaporizer device 200 is heated or when the receptacle 218 reaches a predetermined operating temperature and ending when the cartridge 220 is spent and/or should be changed). In some implementations, the controller 104 can be contained in and/or in communication with the vaporizer body 210 and/or the cartridge 220.

The vaporizer device 200 can include a plurality of outputs 217 (e.g., LEDs) that can be similar to the output(s) 117 (e.g., vibration, sound, and/or the like), and the controller 104 of the vaporizer device 200 can be configured to illuminate one or more of the LED outputs 217 in response to detecting actuation of one or more of the input devices 216a, 216b, in response to detecting a cartridge 220 has been inserted into the receptacle 218, to indicate the currently selected operating temperature and/or temperature profile; to indicate the current temperature of the receptacle 218; to indicate the current temperature of the receptacle 218 relative to the currently selected operating temperature and/or temperature profile; to indicate the current temperature of the receptacle 218 has reached the currently selected operating temperature; to indicate an estimated amount of useable vaporizable material remaining in a cartridge 220 (e.g., by selectively illuminating more or less of the LED outputs 217); to indicate an estimated amount of time remaining in a vaporizing session (e.g., by selectively illuminating more or less of the LED outputs 217); to indicate an indication that the cartridge 220 is spent and/or should be changed; to indicate an amount of battery power remaining (e.g., voltage remaining within a power source 112), and/or the like. In some implementations, the one or more input devices 216a, 216b can include one or more of the LEDs described (additionally or alternatively to the LED outputs 217), be at least partially surrounded by the LEDs, and/or be positioned relative to the LEDs such that a perimeter (e.g., halo) of light at least partially surrounds a perimeter of the one or more input devices 216a, 216b.

The controller 104 of the vaporizer device 200 can be configured to illuminate the LEDs (e.g., the plurality of LED outputs 217 and/or LEDs proximate one or more of the input devices 216a, 216b) in one or more colors and/or according to one or more patterns. For example, the controller 104 of the vaporizer device 200 can be configured to illuminate the LEDs according to different colors to indicate a current temperature of the receptacle 218 (e.g., oven), blink one or more times to indicate the current temperature of the receptacle 218 has reached the currently selected operating temperature, and/or the like. Additionally or alternatively, the controller 104 can be configured to provide haptic feedback (e.g., via one or more outputs 217, such as a motor, a linear resonant actuator, and/or the like) to indicate the one or more input devices 216a, 216b have been pressed, whether the vaporizer device 200 has switched between the “off” state and/or the “on” state (e.g., that the receptacle 218 is heating up), a current temperature of the receptacle 218 (e.g., in a periodic pattern with increasing frequency), whether the current temperature of the receptacle 218 has reached the currently selected operating temperature, when threshold amounts of the estimated amount of useable vaporizable material remaining in a cartridge 220 are reached, when threshold amounts of estimated amounts of time remaining in the vaporizing session are reached, that the cartridge 220 is spent and/or should be changed, and/or the like. Although illustrated as a generally flattened cylindrical shape, a cross-section of the cartridge 220 and/or vaporizer body 210 can be a different shape. For example, in some implementations, a cross-section of the cartridge 220 and/or vaporizer body 210 can be similar to one or more of the cross-sections of FIGS. 8A-8F. The cross-section can be anywhere between the respective distal and proximal ends of each of the cartridge 220 and/or vaporizer body 210.

FIG. 3 illustrates a perspective view of an implementation of a cartridge 320 in an exploded schematic form, consistent with implementations of the current subject matter. The cartridge 320 can be an implementation of one or more components of the cartridges 120 of FIGS. 1A-1B and/or the cartridge 220 of FIG. 2, and/or can be configured for use within a vaporizer device such as the vaporizer devices 100a, 100b of FIGS. 1A-1B and/or the vaporizer device 200 of FIG. 2. As illustrated, the cartridge 320 can extend from a cartridge proximal end 320a to a cartridge distal end 320b and contain two or more portions, such as a heater portion 341 and a mouthpiece portion 330. As described herein, the total distance between the cartridge proximal end 320a and the cartridge distal end 320b can be regarded as the cartridge 320 length, and transverse to the cartridge 320 length are the width (longer dimension, x-axis) and the depth (shorter dimension, z-axis). As further described herein, cartridges 320 can have surfaces defined in Euclidean or non-Euclidean spaces.

As illustrated, the heater portion 341 can include a heating element 342 and vaporizable material 302. The heating element 342 and/or the vaporizable material 302 can extend between a heater portion proximal end 341a and a heater portion distal end 341b, and the total distance (dimension) between these two ends can be referred to as the heater portion 341 length. For convenience, the heater portion 341 length can be referred to with respect to the longitudinal axis (y-axis) along which the cartridge 320 is inserted into a receptacle (e.g., the receptacle 218 of FIG. 2). The heater portion 341 can also be regarded as having two additional dimensions that are transverse to the heater portion 341 length, which are the width (longer dimension, x-axis) and the depth (shorter dimension, z-axis).

In implementations where the heater portion 341 width is greater than the heater portion 341 depth and/or the vaporizable material 302 width is greater than the vaporizable material 302 depth (e.g., in a 3:2 ratio, 9:5 ratio, 2:1 ratio, 9:4 ratio, 5:2 ratio, or greater ratio), heat transfer can be more efficient. For example, relative to a cylindrical surface, a heating element 342 and/or vaporizable material 302 that includes two wider, opposing surface areas (e.g., faces) with a shorter distance between the two opposing surfaces can allow for a vaporizer device that only needs to actively heat from one or two of the opposing sides, as opposed to on all surfaces of a cylindrical surface. The remaining portions of the heating element 342 that are not actively heated can be configured to absorb and redistribute heat from the nearby regions that are actively heated, thereby providing heat to a much larger surface area of the vaporizable material 302 compared to a cylindrical surface. While this non-cylindrical structure (e.g., elliptical or oval) is harder to manufacture than a cylindrical structure, it provides benefits to the user by making the system easier and more comfortable to use (e.g., more ergonomic structure that fits the natural shape of a user's lips). Additionally, the use of less power due to increased efficiency allows for longer battery life and/or less spatial constraints on the vaporizer device (e.g., a smaller battery can be used). Ultimately, the manner in which the heating element 342 and/or vaporizable material 302 is heated can affect the temperature at which the vaporizable material 302 is heated and/or the rate at which one or more compounds present in the vaporizable material 302 are converted to the gas phase and/or otherwise released from the vaporizable material 302.

As discussed herein, the heating element 342 can be configured to convert electrical energy into heat (e.g., through inductive heating, resistive heating, etc.). However, in some implementations, the heating element 342 of FIG. 3 can instead be regarded as a container (e.g., similar to the container 123 of FIG. 1B) that receives heat from an external heat source and distributes it to the vaporizable material 302. In implementations in which inductive heating is used to heat the heating element 342, providing a wider surface area also has further benefits. For example, it is easier to generate eddy currents in wider and flatter surfaces as compared to a smaller or curved surface. Additionally, larger surface areas of a heating element 342 allow for more surface area of the heating element 342 to be in direct and thermal contact with a larger area of the vaporizable material 302. These eddy currents can be generated over a larger surface area using less energy and/or the larger surface area can provide multiple, smaller regions that can be selectively targeted using a plurality of smaller inductors. In this regard, use of susceptors that are inductively heated, at least primarily, via formation of eddy currents rather that via hysteresis (as is the case for susceptors comprising magnetic and/or ferritic materials) can be advantageous. In implementations where eddy currents are the primary (e.g., entire) form of heat generation, the inductive coil(s) can include or otherwise be formed of Litz wire. As used herein, Litz wire can refer to a wire formed from a plurality of strands of metal (e.g., 5 strands, 10 strands, 20 strands, 40 strand, etc.) that are twisted or braided together, and can optionally include an outer insulation material, an internal core of material, and/or the like.

In some implementations, a susceptor is provided that is non-ferritic and/or non-magnetically permeable. For example, aluminum can be considered as non-ferritic and non-magnetically permeable, and thereby substantially unaffected by hysteresis. With no or substantially no influence on temperature created via hysteresis, the temperature of non-ferritic and/or non-magnetically permeable susceptors can be derived based on the direct relationship of the temperature of the susceptor and eddy currents, as described herein. Although inductors and/or inductive coils can be referred to herein as “heating” susceptors and/or heating element, it will be appreciated by those of skill in the art that heating in this sense can be regarded as an inductor generating magnetic and/or electromagnetic energy that is radiated into and absorbed by one or more segments of a susceptor, which is in turn converted into heat via eddy currents and/or hysteresis.

At least a portion of the heater portion 341 can be contained within a wrapper 322. The wrapper 322 can be similar to the outer layer (e.g., wrapper(s) 122) of FIGS. 1A-1B. For example, the wrapper 322 can be made of material such as one or more of a paper material such as cardstock, corrugated material such as cardboard or paper, tobacco paper, temperature-resistant plastic (e.g., PET), non-wood plant fibers such as flax, hemp, sisal, rice straw, and/or esparto, and/or the like. The wrapper 322 can extend along all or at least some part of the heater portion 341 length, and define an interior volume between the heater portion 341 depth and width. The vaporizable material 302 can fill the majority of the volume, but other components can be present, such as an end cap and/or divider configured to at least partially enclose end(s) of the volume. In some implementations, the heating element 342 extends between all or at least some part of the heater portion 341 length and defines an interior volume between the heater portion 341 depth and width within which the vaporizable material 302 can be contained.

In some implementations, the vaporizable material 302 can be formed from tobacco leaves (e.g., dried, cut, shredded, and/or reconstituted), tobacco stems (dried, cut, shredded, and/or ground), a carrier, and/or an acid (e.g., an organic acid such as benzoic acid, citric acid, and/or the like). The ratio of tobacco leaves to tobacco stems can be based on the total desired amount of nicotine to be delivered, and can vary with the strain of tobacco used. Tobacco stems can provide a similar sensation to smoking when vaporized, but with a lower nicotine content. The carrier can be formed of vegetable glycerin, propylene glycol, and/or the like. In some implementations, the carrier can form 30-50% of the total weight of the vaporizable material 302. Because tobacco naturally includes some moisture, the percentage by weight of the carrier can be measured with respect to the dried weight of the vaporizable material (e.g., substantially free of water).

Including a carrier such as vegetable glycerin as at least 30% of the dried weight of the vaporizable material 302 can create a smoother inhalable aerosol and provide a unique experience to users that is more pleasant than smoking combustible cigarettes and other available heat-not-burn products. For example, cartridges 320 containing vaporizable material 302 with a carrier forming at least 30% of the dried weight of the vaporizable material 302 can allow for a lower temperature of vaporization (e.g., by as much as approximately 100 degrees Celsius), and therefore less odor, higher flavor extraction efficiency, net reduction in HPHCs (harmful and potentially harmful constituents) such as via less charring, a more tunable experience, a more uniform vaporization of nicotine from tobacco over time, a faster heat up time (e.g., 10-15 seconds compared to 20-30 seconds, or more), and/or the like. In example implementations of the vaporizable material 302, the tobacco leaves and tobacco stems are in an approximately 1:1, 1:2, 2:3, 3:4, or 4:5 ratio and vegetable glycerin forms at least 30% of the dried weight of the vaporizable material 302, such as approximately 30%, 35%, 40%, 45%, or less than 50%. For example, in some implementations, the vaporizable material 302 includes tobacco leaves and tobacco stems in an approximately 1:1 ratio, and approximately 35% by weight (dried) of vegetable glycerin. Having a carrier in higher quantities can result in degradation of components of the vaporizer body 110, 120, such as the receptacle 118, 218 if not properly compensated for.

In some implementations, a carrier (e.g., vegetable glycerin) can be added at multiple stages in the assembly of the cartridge 320. For example, as part of a first series of steps, tobacco material (e.g., tobacco leaves and/or stems) can be dried and mixed with a carrier to form a mixture in which the carrier forms at least 20%, at least 25%, at least 30%, or at least 35% of the dried weight of the vaporizable material 302. Prior to mixing the tobacco material with the carrier, the tobacco material can be cut, shredded, and/or the like. For example, the tobacco material can be formed as cut rag tobacco, such that it has a better ability to absorb the carrier. As part of a second series of steps, the resulting mixture can be formed into a shape (e.g., slug) that can be more easily incorporated into the cartridge 320, and additional carrier material can be applied to the shape and/or a portion of the cartridge 320. For example, in some implementations, an interior portion of the cartridge 320 (e.g., an interior of the heating element 342) can be sprayed with additional carrier material. Additionally or alternatively, additional carrier material can be applied to the formed shape of vaporizable material 302, such as by spraying and/or injection, before and/or after the vaporizable material is disposed within an interior volume of the heating element 342. Once the cartridge 320 is completely assembled, the carrier can form at least 30%, at least 35%, at least 40%, at least 45%, or at least 50% of the dried weight of the vaporizable material 302. Assembly in this manner can allow for the use of less complicated machinery for mixing tobacco material with a carrier, while also providing a cartridge 320 with a higher concentration of carrier in the vaporizable material 302. In some implementations, applying additional carrier to the exterior of the formed shape of vaporizable material 302 and/or interior of the heating element 342 can help to provide a more uniform vapor and aerosol over time, relative to vaporizable material 302 that is formed via a simple mixture of tobacco material and a carrier, as the heat generated by the heating element 342 is more likely to vaporize the carrier first.

In order to control the composition of the inhalable aerosol, it can be beneficial to separate the tobacco material and the carrier of the vaporizable material. For example, FIGS. 17A-17H illustrate block diagrams of various implementations of tobacco material 1798 and a carrier 1799 that can be combined into different forms of vaporizable material 1702a-1702h. As illustrated in FIG. 17A, the tobacco material 1798 and carrier 1799 can occupy approximately the same volume within the vaporizable material 1702a, and be positioned opposite each other relative to a cross-section defined by the length and width of the vaporizable material 1702a. As illustrated in FIG. 17B, the tobacco material 1798 can occupy a volume that is less than the volume occupied by carrier 1799a and 1799b within the vaporizable material 1702b (e.g., in a 1:2 ratio, a 1:3 ratio, and/or the like), and the tobacco material 1798 can be positioned upstream and off axis from a cross-section defined by the length and width of the vaporizable material 1702a. As illustrated in FIG. 17C, the tobacco material 1798 and carrier 1799 can occupy approximately the same volume within the vaporizable material 1702c, and be positioned opposite each other relative to a cross-section defined by the length and depth of the vaporizable material 1702c. As illustrated in FIG. 17D, the tobacco material 1798 can occupy a volume that is greater than the volume occupied by carrier 1799 within the vaporizable material 1702d (e.g., in a 2:1 ratio, a 3:1 ratio, and/or the like), and the volume occupied by carrier 1799 can surround the volume occupied by the tobacco material 1798. As illustrated in FIG. 17E, the tobacco material 1798 and carrier 1799 can occupy approximately the same volume within the vaporizable material 1702e, and be positioned on top of each other relative to a cross-section defined by the depth and width of the vaporizable material 1702e. As illustrated in FIG. 17F, the tobacco material 1798 and carrier 1799 can occupy different volumes within the vaporizable material 1702f, and be positioned on top of each other relative to a cross-section defined by the depth and width of the vaporizable material 1702f, with an air gap in between the tobacco material 1798 and carrier 1799. As illustrated in FIGS. 17G and 17H, the tobacco material 1798 and carrier 1799 can occupy different volumes within the vaporizable material 1702g, 1702 h and be positioned opposite each other relative to a cross-section defined by the length and width of the vaporizable material 1702g, 1702h.

In each of the implementations of FIGS. 17A-17H, vaporized material from heating the tobacco material 1798 and heating the carrier 1799 can be combined to form a combined vaporized material, such as at or near the intersection of the volumes occupied by the tobacco material 1798 and the carrier 1799. The volume in which the combined vaporized material is formed can be in fluid communication with a vapor inlet 1735, which can be similar to the vapor inlets 335, 435, 635 described herein. In some implementations, a separate heating element 342 and/or inductor can be included to heat the respective volumes of tobacco material 1798 and carrier 1799. Accordingly, different amounts of heat can be separately applied to the tobacco material 1798 (e.g., higher temperature) and the carrier 1799 (e.g., lower temperature) to optimize the user experience. In any of the implementations of FIGS. 17A-17H, a wicking material comprising the carrier 1799 can be included to retain the carrier 1799 within a desired volume.

In some implementations, the heating element 342 can be formed of metal, such as aluminum, an aluminum alloy, copper, brass, zirconium, stainless steel (ferritic or non-ferritic), nickel, and/or the like. As described herein, aluminum is beneficial for spreading heat and stainless steel is better for localized heat. For an inductive heating approach, use of a non-magnetic material, such as aluminum, allows the creation of eddy currents in the susceptor heater, while a magnetic material, such as ferritic stainless steel, is inductively heated by a hysteresis mechanism. Different inductor coil arrangements are generally needed for these two heating approaches, which can have different requirements such as an amount of power required to generate an electromagnetic field. However, in some implementations, the heating element 342 is non-ferritic and non-magnetically permeable, which can simplify the design of the vaporizer device 100, 200 and allow for tighter control in heating of the heating element 342.

The heating element 342 can be formed of one or more pieces, and can define all or substantially all of the walls (e.g., a bottom wall and perimeter along the longitudinal axis, either or both of which can have perforations or other openings) that define the volume into which the vaporizable material 302 can be inserted. However, for ease of manufacturability, the heating element 342 can be a single sheet of metal that is configured to wrap (at least partially) around the perimeter of the heater portion 341. The two ends of the heating element 342 sheet can meet or be in proximity to each other, at or near a joint location 345, as shown in FIG. 3, and optionally form a continuous loop. In some implementations, when assembled within the cartridge 320, a surface of the heating element 342 primarily facing towards and/or touching the vaporizable material 302 can be regarded as an interior face of the heating element 342 and a surface of the heating element 342 primarily facing away from and/or not touching the vaporizable material 302 can be regarded as an exterior face of the heating element 342. When the heating element 342 is formed of a paper-backed metal, the exposed surface of the metal material can be regarded as an interior face of the heating element 342 and the exposed surface of the paper material can be regarded as an exterior face of the heating element 342. In implementations where an assembled heating element 342 includes overlapping and/or intersecting portions, the interior face and the exterior face of the heating element 342 can be defined with respect to the heating element 342 prior to assembly. In some implementations, a joint location 345 can be regarded as a location or region, at or near an end of the heating element 342, such as where the end of the heating element 342 is at or near another end or another region of the heating element 342. When portions of the heating element 342 overlap, the joint location 345 can optionally be regarded as the overlapping portion, bounded in part by the ends of the heating element 342. Additionally or alternatively, in some implementations a joint location 345 can be regarded as a location or region, at or near where a joint is formed (e.g., via direct physical contact, welding, gluing, and/or the like) between two portions of the heating element 342.

Optional variants of the heating element 342 and joint location 345 are illustrated in FIGS. 15A-15K as heating elements 1542a-1542k (collectively, heating elements(s) 1542) and joint locations 1545. In some implementations, a portion of the heating element 342, 1542 proximate one end of the heating element 342, 1542 (e.g., relative to a sheet of material that forms the heating element 342, 1542) at least partially overlaps with a portion proximate another end of the heating element 1542, such as proximate the joint location 345, 1545. The overlapping portions can be welded, glued, crimped, interlocked, pressed, or otherwise connected together. For example, as illustrated in FIG. 15E and FIG. 15I, the overlapping portions of the heating element 1542e, 1542i can be connected together with the exterior face of the heating element 1542e, 1542i proximate one end of the heating element 1542e, 1542i contacting the interior face of the heating element 1542e, 1542i proximate another end. In another example, illustrated in FIG. 15F the overlapping portions of the heating element 1542f can be crimped or knurled together with the exterior face of the heating element 1542f proximate one end of the heating element 1542f connected to the interior face of the heating element 1542f proximate another end.

In other implementations, a portion of the heating element 342, 1542 proximate one end of the heating element 342, 1542 (e.g., relative to a sheet of material that forms the heating element) intersects with another portion of the heating element 1542, proximate the joint location 345, 1545, and the intersecting portions are welded, glued, crimped, interlocked, pressed, or otherwise connected together. For example, as illustrated in FIG. 15G the intersecting portions of the heating element 1542g can be crimped or knurled together with the interior regions of the heating element 1542g facing each other. In another example, as illustrated in FIGS. 15H and 15J, the intersecting portions of the heating element 1542h, 1542j can be folded or hemmed together with interior regions of the heating element 1542h, 1542j facing each other. When the heating element 1542h is provided within a cartridge 320, the capacitive region 1549 can be folded over such that it is adjacent to the exterior face of the heating element 1542h that does not form part of the capacitive region 1549. In some implementations, the folds of the heating element 1542j of FIG. 15J can be regarded as forming a volume configured to hold a vaporizable material 302, such as a bucket, basket, and/or the like. These folds can include a plurality of intersecting regions with regions of the interior face of the heating element 1542j contacting each other and a plurality of intersecting regions with regions of the exterior face of the heating element 1542j contacting each other. It will be appreciated that such implementations allow an electrical current to pass through the intersecting regions, regardless of whether the exterior face of the heating element 1542j is formed of non-conductive material.

The overlapping or intersecting portions of the heating element 1542 can be large enough that they form a capacitive region 1549, which can improve performance of the heating element 1542 by providing a path for electrical current to flow across or through the capacitive region 1549. In some implementations, the capacitive region 1549 can be regarded as the region between two adjacent joint locations 1545, as illustrated in FIG. 15F, 15G, 15I, 15J. In accordance with these implementations, the capacitive region 1549 can be regarded as including a first portion of the heating element 1542 near a first end of the heating element 1542 and an overlapping or intersecting second portion of heating element 1542 near a second end (e.g., opposing along a common axis) of the heating element 1542. Additionally or alternatively, the capacitive region 1549 can be regarded as (or at least including) a region of the heating element 1542 where a path for electrical current to flow is formed between overlapping, intersecting, or otherwise connected, adjacent portions of the heating element 1542.

In some implementations, the overlapping portions of the heating element 1542 in the joint location(s) 1545 and/or capacitive region 1549 can be connected together (e.g., welded, glued, crimped, interlocked) such that any intermediate non-metal or non-conductive portions of the heating element 1542 are sufficiently broken down or removed to provide a path for electrical current to flow between the overlapping portions. For example, if the heating element 1542 is formed from a paper-backed metal, the intermediate paper portion between the two overlapping metal portions of the heating element 1542 can be broken down or removed such that electrical current can flow between the metal portions.

In some implementations, an electrically conductive adhesive can be applied to the overlapping or intersecting portions (e.g., within the joint location(s) 1545 or capacitive region 1549), which can further improve the path for current flow. For example, the electrically conductive adhesive can include a glue or paste including silver, gold, copper, graphite, aluminum and/or other conductive materials.

In some implementations, the ends of the heating element 1542 are bent (e.g., both inward towards or both outward away from the vaporizable material 302, such as at approximately right angles), proximate the joint location 345, and the intersecting portions are welded, glued, crimped, interlocked, or otherwise connected together. For example, the heating element 1542g of FIG. 15G includes a capacitive region 1549 formed via interlocking the opposing ends of the heating element 1542g, between the two illustrated joint locations 1545. When the heating element 1542g is provided within a cartridge 320, the capacitive region 1549 can be folded over such that it is adjacent to the exterior face of the heating element 1542g that does not form part of the capacitive region 1549. In other implementations, the ends of the sheet can be formed into complementary shapes that are designed to mechanically interlock, such as with opposing tabs formed at opposing ends of the heating element 342, 1542 (e.g., relative to a sheet of material that forms the heating element), configured to secure to each other when the opposing ends of the heating element 342, 1542 are combined.

In other implementations, the heating element 1542 is made of sufficiently rigid material such that the ends do not need to be physically coupled to each other, but can be in contact with each other. In other implementations, the ends of the heating element 1542 are in close proximity to each other but do not physically touch (see e.g., FIG. 15B). For example, the heating element 1542 can be configured to wrap around between 95% to 99%, greater than 90%, and/or less than 100% of an interior perimeter of the cartridge 320 and/or an interior perimeter of the heater portion 341. In other implementations, the ends of the heating element 1542 are in close proximity to each other and one or more bridges (which can also form one or more capacitance regions 1549) between the heating element 1542 ends are formed via welding (e.g., laser welding, ultrasonic knurling, electron beam welding, gas flame welding, friction welding, etc.), and/or the like. For example, as illustrated in FIGS. 15C and 15D, bridges can be formed as the illustrated capacitive regions 1549. In other implementations, the heating element 1542 is formed as a single, continuous loop of material without a joint location 345, 1545 (see e.g., FIG. 15A).

As described herein, specific portions of the heating element 342, 1542 can be modified (e.g., during manufacture, during use, etc.) to provide particular electrical properties that allow for more control over the current flowing through heating element 342, 1542. For example, as shown in FIG. 15I, a heating element 1542i can include a top region 1559a and a bottom region 1559b, with one or more regions 1559c removed (e.g., cut out) between the top region 1559a and the bottom region 1559b. As described herein, current can be induced within the top region 1559a and/or the bottom region 1559b via induction. For example, current can be induced within the top region 1559a via an electromagnetic field generated from one or more inductors adjacent to the top region 1559a and current can be inducted within the bottom region 1559b via an electromagnetic field generated from one or more inductors adjacent to the bottom region 1559b. In certain implementations, it can be beneficial to heat the top region 1559a and the bottom region 1559b at different times, temperatures, frequencies, and/or the like. As such, it can be beneficial to provide a heating element 1542h that is made of a minimal number of materials (e.g., a single sheet of metal or a single sheet of paper-backed metal, with or without welding or gluing the opposing ends of the sheet together) and easy to manufacture, while still providing at least two regions that can be independently controlled.

In certain implementations of the heating element 1542i, the presence of the region 1559c (or absence of material within the region 1559c) can reduce or otherwise alter the flow of electrical current and/or heat between or among conductive regions of the heating element 1542i. For example, when current is induced in the top region 1559a of the heating element 1542i, the presence of region 1559c (e.g., absence of material) can keep the majority of the induced current and/or heat produced within the top region 1559a, and/or substantially reduce the amount of current induced and/or heat produced in the top region 1559a from flowing or passing to the bottom region 1559b. Similarly, when current is induced in the bottom region 1559b of the heating element 1542i, the presence of region 1559c (e.g., absence of material) can keep the majority of the induced current and/or heat produced within the bottom region 1559b, and/or substantially reduce the amount of current induced and/or heat produced in the bottom region 1559b from flowing or passing to the top region 1559a. In some implementations, keeping the majority of induced current within a particular region 1559a, 1559b can be regarded as less than 50% of the induced current passing through another region (or collective set of all other regions present) 1559b, 1559a, less than 40%, less than 30%, less than 20%, less than 10%, less than 5%, less than 2%, less than 1%, or the like. In some implementations, keeping the majority of heat produced within a particular region 1559a, 1559b can be regarded as less than 50% of the heat produced passing to another region (or collective set of all other regions present) 1559b, 1559a, less than 40%, less than 30%, less than 20%, less than 10%, less than 5%, less than 2%, less than 1%, or the like.

As described herein, the relative sizes of the regions 1559a, 1559b can be different. Although illustrated as including two regions 1559a, 1559b separated by a singular cut-out region (e.g., openings) 1559c on each of the long sides of the heating element 1542, additional regions are possible. For example, a heating element 342, 1542 can include three regions 1559 separated by two cut-out regions 1559 on each of the long sides of the heating element 342, 1542, four regions 1559 separated by three cut-out regions 1559 on each of the long sides of the heating element 342, 1542, and/or the like. As described herein, the relative size (e.g., length along the y-axis, width along the x-axis, and/or depth along the z-axis) of each region 1559 can correspond to one or more dimensions of an adjacent inductor. For example, the length of each region 1559a can be substantially the same as the length of an adjacent inductor, the length of each region 1559a can be between 100% to 110% of the length of an adjacent inductor, the length of each region 1559a can be between 90% to 100% of the length of an adjacent inductor, and/or the like. Additionally or alternatively, the width of each region 1559a can be substantially the same as the width of an adjacent inductor, the width of each region 1559a can be between 100% to 110% of the width of an adjacent inductor, the width of each region 1559a can be between 90% to 100% of the width of an adjacent inductor, and/or the like.

Other modifications can be made to specific portions of the heating element 342, 1542 (e.g., during manufacture, during use, etc.) to provide particular electrical properties that allow for more control over the current flowing through heating element 342, 1542. For example, as shown in FIGS. 15J and 15K, a heating element 1542j, 1542k can include a top region 1559a and a bottom region 1559b, with one or more regions 1559c removed (e.g., cut out). As illustrated in FIG. 15K, prior to final assembly of the heating element 1542k a plurality of regions 1559c can be removed from the heating element 1542k, such as from each of the four corners of the heating element 1542k (e.g., relative to a generally flat sheet of material that forms the heating element 1542k). Subsequently, opposing ends of the top region 1559a and opposing ends of the bottom region 1559b of the heating element 1542k can be folded upwards. The opposing ends of the bottom region 1559b can be further folded such that they form a plurality of intersecting regions, similar to the plurality of intersecting regions illustrated between the joint locations 1545 in the assembled heating element 1542j of FIG. 15J. As described herein, the plurality of intersecting regions can form a capacitive region 1549. In some implementations, a mandrel can be used to form the shape of the heating element 1542j of FIG. 15J from the heating element 1542k of FIG. 15K.

As described herein, current can be induced within the top region 1559a and/or the bottom region 1559b via induction. For example, current can be induced within the top region 1559a via an electromagnetic field generated from one or more inductors adjacent to the top region 1559a and current can be inducted within the bottom region 1559b via an electromagnetic field generated from one or more inductors adjacent to the bottom region 1559b. Similar to as described with respect to FIG. 15I, the presence of the cut-out regions 1559c (or absence of material within the region 1559c) can reduce or otherwise alter the flow of electrical current and/or heat between or among conductive regions of the heating element 1542j.

Although the terms “top” and “bottom” are used with respect to the regions 1559, in some implementations the top region 1559a can be closer to the distal end of the heating element 342, 1542 and/or cartridge 320, and the bottom region 1559b can be closer to the proximal end of the heating element 342, 1542 and/or cartridge 320. As illustrated in FIG. 15K, the heating element 342, 1542 can include an additional region 1559d that is removed (e.g., cut-out) from the heating element 342, 1542. When the additional removed region 1559d is closer to the distal end of the heating element 342, 1542 and/or cartridge 320, the region 1559d can provide an air inlet for air to enter the heating element 342, 1542 and/or cartridge 320, as described herein. When the additional removed region 1559d is closer to the proximal end of the heating element 342, 1542 and/or cartridge 320, the region 1559d can provide a vapor outlet for vaporized material to exit the heating element 342, 1542, exit the heater portion 341, and/or enter the mouthpiece portion 330, as described herein. In either scenario, the additional removed region 1559d can provide for better containment of the vaporizable material 302 within the cartridge 320 and/or simplified control of airflow through the cartridge 320 that requires less and/or smaller components.

In some implementations, other modifications to the heating element 1542 can be made to control the flow of current through different regions of the heating element 1542. For example, a specific pattern of perforations, holes, cuts, cutouts, and/or the like can be provided on the heating element 1542 such that current flows through the heating element 1542 in an identifiable manner. Accordingly, in related implementations, the controller 104 of the vaporizer body 110 can be configured to measure (e.g., via sensor(s) 113) and/or identify a cartridge 120, 220, 320 based on characteristics of the current flowing through the heating element 1542, as described herein.

Having a heating element 342 in the form of a continuous loop can create an electrically conductive path around the heating element 342. Being formed in the shape of continuous loop can increase the efficiency of the heating element 342 and thereby the efficiency of the vaporizer devices 100 utilizing such structures. However, such improvements in efficiency can be greater for systems where the heating element 342 is inductively heated via an inductor that is in the form of a coil wrapped, in a plurality of turns, around a region near the perimeter of the heating element 342 (see e.g., inductor 543 of FIG. 5D).

In other implementations, inductive coils that are not wrapped around an area near the perimeter of the heating element 342 can be utilized such that it is easier to manufacture each heating element 342 and/or cartridge 320. For example, inductive coils that are instead placed in, but not completely wrapped around, different regions near the perimeter of the heating element 342 can be implemented such that a complete, electrically conductive path around the heating element 342 is not required to achieve an efficient system (see e.g., FIGS. 5A-5C, FIGS. 11A-11O, 12A-12E, 13A-13G, 14A-14C). In accordance with such implementations, each heating element 342 and/or cartridge 320 can be manufactured such that the ends of the heating element 342 meet at the joint location 345 without interlocking or welding, which can make manufacturing more efficient and/or cheaper.

In this regard, non-cylindrical cartridges 320 and receptacles 118, 218 that are configured to receive the non-cylindrical cartridges 320 can have additional advantages that are not present in traditional, cylinder-based systems. For example, a non-cylindrical cartridge 320 that is configured to fit within a corresponding receptacle 118, 218 in only one or two orientations, can allow for certain components of the vaporizer body 110, 210 and cartridge 320 to be disposed at a particular orientation each time. As such, to benefit from the cheaper manufacturing without interlocking or welding while still increasing efficiency each heating element 342 and/or cartridge 320 can be manufactured such that the joint location 345 is disposed in a specific, known location, such as on one of the shorter sides of the cartridge 320, or one of the longer sides of the cartridge 320. The placement of the joint location 345 can be beneficial if the joint location 345 is disposed in a location that is away from the driving circuitry 143, such as inductive coils configured to generate an electromagnetic field. In some implementations, the joint location 345 can be regarded as being off-axis of the primary plane of electromagnetic fields generated by the inductive coils and/or in a location that is outside of a perimeter of each inductive coil. If the joint location 345 was instead disposed near the driving circuitry 143 (e.g., within the primary plane of an electromagnetic field generated by an inductive coil and/or in a location that is within a perimeter of an inductive coil), this would decrease the coupling efficiency between the inductive coil and the heating element 342, and thereby decrease the efficiency of the entire system.

In some implementations, the heating element 342 can be manufactured to include a structure that is optimized and/or tuned in a manner that results in the desired coupling with inductive coils. For example, it is possible to make a simple structure for the heating element 342 that couples very well with inductive coils but ultimately results in the heating element 342 reaching too high of a temperature, thereby burning the vaporizable material 302. In some implementations, this issue can be present only in certain regions of the vaporizer material 302, and thereby make it beneficial to more evenly absorb and/or distribute energy across the heating element 342. Accordingly, in some implementations, the heating element 342 can be perforated and/or cut (e.g., via a laser) to adjust its coupling efficiency, such as by making torturous paths for the eddy currents to flow through the heating element 342.

In example implementations, the heating element 342 is made to include an aluminum alloy or other metal, such as aluminum foil, which can be in a range of 50-150 μm thick, such as 50-100 μm thick, 60-80 μm thick, 70-90 μm thick, 75-85 μm thick, and optionally approximately 80 μm thick. In some implementations, the heating element 342 can include a paper-backed metal, which can increase the structural integrity and/or rigidity of a cartridge manufactured with such a structure, relative to the structural integrity of a shape formed with certain metals alone (e.g., aluminum). For example, the paper-backed metal can include a layer of metal disposed interior to at least one layer of paper such that the metal layer is in direct contact with and/or can provide better thermal transfer to the vaporizable material 302, and can optionally be disposed between (e.g., sandwiched) two layers of paper. In such implementations, the metal can be in a range of 3-15 μm thick, such as 5-10 μm thick, 6-8 μm thick, and optionally approximately 6.5 μm thick. In related implementations, the paper layer(s) and the metal layer can be sized such that the overall thickness of the heating element 342 is in a range of 50-150 μm thick, such as 50-100 μm thick, 60-80 μm thick, 70-90 μm thick, 75-85 μm thick, and optionally approximately 80 μm thick. Accordingly, the paper layer can be in a range of 35-145 μm thick, such as 40-100 μm thick, 50-70 μm thick, 55-75 μm thick, 60-80 μm thick, 65-75 μm thick, and optionally approximately 70 μm thick. The total thickness of the heating element 342 can be measured as either inclusive or exclusive of the thickness of any wrapper 322 that is wrapped around the heating element 342, as described herein. For example, a wrapper 322 that is exterior to and/or connecting the heater portion 341 and the mouthpiece portion 330 can be included within or excluded from the thickness measurements described herein. For example, the wrapper 322 can be made out of one or more of a cardstock, corrugated material such as cardboard or paper, tobacco paper, temperature-resistant plastic, non-wood plant fibers such as flax, hemp, sisal, rice straw, and/or esparto, and/or the like.

If a thinner metal is used, then increases in coupling efficiency and/or higher temperatures of the heating element 342 with lower total energy can be achieved. The metal can include an aluminum alloy, such as aluminum foil. In other implementations, the metal can include another alloy, such as invar. In some implementations, the heating element 342 can be formed of a cladded metal, which can take advantage of benefits of different metals. For example, the heating element 342 can comprise a cladding metal formed from an aluminum alloy and stainless steel, which could take advantage of the higher coupling efficiency of stainless steel and the higher heat transfer of aluminum.

In implementations where the heating element 342 comprises or is comprised within a paper-backed metal that includes an exterior paper layer and an interior metal layer, an additional material can be provided between the metal layer of the heating element 342 and the vaporizable material 302. For example, a layer of reconstituted tobacco can be disposed between the metal layer of the heating element 342 and the vaporizable material 302. Placing an additional layer of material between the heating element 342 and the vaporizable material 302 can provide a buffer for unwanted substances being vaporized and/or forming part of the aerosol that is inhaled by a user. Separately, the additional layer of material can absorb substances (e.g., liquid) from the vaporizable material 302 when the vaporizable material 302 is heated. For example, if glue is used to form the shape of the heating element 342, the additional material can provide a benefit of absorbing any glue or other materials from the metal layer and/or vaporizable material 302. In other implementations, an additional material (e.g., layer of reconstituted tobacco) can additionally or alternatively be provided between the metal layer of the heating element 342 and the exterior paper layer. Such implementations can also similarly provide a benefit of absorbing any glue or other materials, from the metal layer and/or the exterior paper layer. For example, if glue is applied to the exterior paper layer the additional layer of material can absorb any glue that comes off of the paper layer, provide a buffer that prevents the heat generated by the metal layer from causing any burning or degradation in the glue, and/or the like. In some implementations, multiple paper layers can be provided exterior and/or interior to the metal layer of the heating element 342.

In some implementations, one or more paper layers exterior and/or interior to the metal layer of the heating element 342 can be coated with and/or formed of material that is configured to absorb liquid from the vaporizable material 302 to reduce the occurrence of any liquid exiting the cartridge 320 (e.g., being left as residue in the vaporizer body 110, 210). For example, a layer of paper material external to the metal layer can be coated with a material that repels liquid and/or is non-liquid permeable (or at least has a lower liquid permeability than typical paper materials used in cigarettes) such that the direction of flow of any liquid from the vaporizable material 302 can be controlled (e.g., such that it does not leak out of a perimeter of the heating element 342 and/or cartridge 320). In such implementations, any liquid from the vaporizable material 302 can be retained within the cartridge 320 itself, such as through the use of inserts (e.g., filters) and/or end caps at or near the heater portion proximal end 341a and/or the heater portion distal end 341b, such as the inserts and end caps described herein.

Although the paper-backed metal is described as including paper or reconstituted tobacco, other materials can be implemented instead, such as one or more of corrugated material such as cardboard or paper, tobacco paper, temperature-resistant plastic (e.g., PET), cellulose acetate, non-wood plant fibers such as flax, hemp, sisal, rice straw, and/or esparto, and/or the like, and paper is only described herein for simplicity. Although various layers of materials are described as being internal or external, there can be additional materials that are internal or external to each of the described materials. For example, if the heating element 342 comprises or is comprised within a paper-backed metal that includes an exterior paper layer and an interior metal layer, an additional material can be provided on the exterior of the exterior paper layer when the cartridge 320 is finally assembled, such as an additional wrapper 122 and/or the wrapper 322 in the mouthpiece portion 330 extending to the exterior of the heater portion 341. In various implementations that include a heating element 342 formed as a metal susceptor, the heating element 342 can be configured to heat air passing at or near the exterior of the cartridge 320, prior to the air entering the cartridge 320 and passing through the vaporizable material 302.

As illustrated in FIG. 3, the mouthpiece portion 330 can include an insert 324 that is wrapped in a wrapper 322 or some other shell or layer of material. The wrapper 322 can be similar to the outer layer (e.g., wrapper(s) 122) of FIGS. 1A-1B. For example, the wrapper 322 can be made of material such as one or more of a paper material such as cardstock, corrugated material such as cardboard or paper, tobacco paper, temperature-resistant plastic (e.g., PET), non-wood plant fibers such as flax, hemp, sisal, rice straw, and/or esparto, and/or the like. The insert 324 can be similar to the insert(s) 124 of FIGS. 1A-1B. For example, the insert 324 can be made of material such as one or more of paper material such as cardstock, corrugated material such as cardboard or paper, tobacco paper, temperature-resistant plastic (e.g., PET), cellulose acetate, non-wood plant fibers such as flax, hemp, sisal, rice straw, and/or esparto, and/or the like.

The insert 324 and/or layer of material (e.g., wrapper 322) can extend between a mouthpiece portion proximal end 330a and a mouthpiece portion distal end 330b, and the total distance between these two ends can be referred to as the mouthpiece portion 330 length. Similar to the heater portion 341, the mouthpiece portion 330 can include a shorter mouthpiece portion 330 depth transverse to its length, and a longer mouthpiece portion 330 width that is transverse to both its length and depth. These dimensions can extend in the same axes as the heater portion 341.

As illustrated in FIG. 3, the insert 324 can include a plurality of airflow outlet channels 326 that extend from a plurality of corresponding vapor inlets 335 at the mouthpiece portion distal end 330b to a plurality of corresponding airflow outlets 328 at the mouthpiece portion proximal end 330a. The airflow outlet channels 326 thereby form a fluid connection between the heater portion 341 and the airflow outlets 328, such that vapor generated in the heater portion 341 can be drawn towards a user at the mouthpiece portion proximal end 330a, and ultimately out of the airflow outlets 328 as an inhalable aerosol. Proximate to the mouthpiece portion distal end 330b (at least more proximate than to the mouthpiece portion proximal end 330a), the insert 324 can further include a plurality of bypass channels 338 that each extend from a corresponding bypass air inlet to a corresponding bypass outlets, and thereby form a fluid connection between the airflow outlet channels 326 and ambient air. In some implementations, the airflow outlet channels 326 and/or the bypass channels 338 can be created via a laser-cutting operation through walls of the insert 324 during the manufacturing process. Although two airflow outlet channels 326 are illustrated, more or less airflow outlet channels 326 can be present. Although one insert 324 is illustrated as extending along a majority of the length of the mouthpiece portion 330, additional inserts 324 can be present and/or the insert(s) 324 can extend along less than half of the length of the mouthpiece portion 330.

The heater portion 341 can include one or more cartridge inlets (e.g., though-holes) at the heater portion distal end 341b configured to allow external air (i.e., external to the cartridge 320, such as ambient air) to enter the volume defined at least in part by the heating element 342. In some implementations, the volume defined at least in part by the heating element 342 can be referred to as a heater chamber, as it is a physically bound location in which heating is occurring. The heater chamber can be in fluid communication with the heater portion proximal end 341a, which can include one or more outlets. Accordingly, the one or more outlets at the heater portion proximal end 341a can be in fluid communication with the one or more cartridge inlets at the heater portion distal end 341b, via the heater chamber.

When a user draws on the mouthpiece portion 330 at the mouthpiece portion proximal end 330a, this can cause external air to enter one or more cartridge inlets (e.g., though-holes) at the heater portion distal end 341b and cause ambient air to enter the plurality of bypass air inlets 329 at approximately the same time. The external air that enters at the heater portion distal end 341b can subsequently pass through the vaporizable material 302 as it is heated to entrain the vaporized material (also referred to as “vapor”) generated within the heater chamber including the volume defined at least in part by the heating element 342. Meanwhile, the air that entered the plurality of bypass air inlets 329 can subsequently pass through the plurality of bypass channels 338 and out of their corresponding bypass outlets 327, entering their respective airflow outlet channels 326. The air that entrains the vaporized material 302 in the heater chamber (including the volume defined at least in part by the heating element 342) can subsequently pass through one or more outlets at the heater portion proximal end 341a and into the plurality of vapor inlets 335 at the mouthpiece portion distal end 330b, entering the plurality of airflow outlet channels 326. As the vapor and air from the heater portion 341 traverse the plurality of airflow outlet channels 326, they mix with the ambient air that entered through the plurality of bypass air inlets 329 to form an inhalable aerosol. The area in which the mixing and/or condensation occurs can be referred to as a condensation chamber. Accordingly, each of the plurality of airflow outlet channels 326 can include one or more condensation chambers configured to condense the entrained vapor with the ambient air to form at least a portion of the inhalable aerosol. For example, at least a part of one or more airflow outlet channels can include one or more condensation chambers. In some implementations, the entirety or majority of an airflow outlet channel 326 of the plurality of airflow outlet channels 326 can include one or more condensation chambers. As such, in some implementations, a part of at least one airflow outlet channel 326 can not include at least one condensation chamber. In some implementations, the condensation chamber (e.g., area in which the mixing and/or condensation occurs) can be a part of an element and/or space that is separate from and/or outside of the airflow outlet channel 326. The inhalable aerosol ultimately travels out of the plurality of airflow outlets 328 at the mouthpiece portion proximal end 330a and into the mouth of a user. Accordingly, the plurality of airflow outlets 328 can be in fluid communication with the at least one condensation chamber in a corresponding one of the plurality of airflow outlets 328, and/or configured to deliver the inhalable aerosol to a user. Collectively, the path of air, vapor, and inhalable aerosol within the cartridge 320 can be referred to as the airflow path of the cartridge 320. The overall airflow path of a vaporizer device that includes the cartridge 320 is further defined by the vaporizer body, which is described in greater detail below. Although the flow of “air” is described herein, depending on the location within or even outside of the cartridge 320, the “air” can contain other matter, such as gas-phase and/or condensed-phase material suspended in a stationary or moving mass of air or some other gas carrier (e.g., an aerosol), a liquid or solid at least partially transitioned to the gas phase (e.g., a vaporizable material), and/or the like.

Generating an inhalable aerosol in this manner can be beneficial, as it provides a larger fluid volume within which the aerosol can be formed and cool. For example, compared to a singular airflow outlet channel, providing two independent airflow outlet channels 326 within the mouthpiece portion 330 can increase the total fluid volume within which the aerosol can be formed and cooled, while still providing smaller fluid volumes that are easier to control, provide a better restriction to draw, and in which a larger overall portion of the vapor is able to independently mix with ambient air.

Although illustrated as a generally flattened cylindrical shape, a cross-section of the mouthpiece portion 330 and/or the heater portion 341 can be a different shape. For example, in some implementations, a cross-section of the mouthpiece portion 330 and/or the heater portion 341 can be similar to one or more of the cross-sections of FIGS. 8A-8F. The cross-section can be anywhere between the respective distal and proximal ends of each of the mouthpiece portion 330 and/or the heater portion 341.

Although the heater portion 341 and the mouthpiece portion 330 are illustrated separately in FIG. 3, they can be combined, such as by one or more external layers (e.g., similar to the wrappers 122 of FIGS. 1A-1B). For example, the layer(s)/wrapper(s) can be made of material such as one or more of a paper material such as cardstock, corrugated material such as cardboard or paper, tobacco paper, temperature-resistant plastic (e.g., PET), non-wood plant fibers such as flax, hemp, sisal, rice straw, and/or esparto, and/or the like. Separately, in some implementations, more or less components and/or features can exist in the heater portion 341 and/or the mouthpiece portion 330, the components and/or features of the heater portion 341 and/or the mouthpiece portion 330 can be disposed in different locations and/or take different physical forms, and/or components of the heater portion 341 and the mouthpiece portion 330 can be swapped.

Although the various airflow pathways are all illustrated as being formed through a singular insert 324, there can be more than one insert 324 and/or additional or alternative components within the mouthpiece portion 330 through which the airflow pathways are defined. Additionally, although multiple instances or singular instances of the various features and components are described, more or less instances can be provided. Further, although the various features and components that define the airflow path have been illustrated and described as being at specific locations and taking specific shapes, other locations and/or shapes are contemplated. For example, although the bypass channels 338 are illustrated as being defined in a direction that is approximately parallel to the mouthpiece portion 330 depth in some implementations the bypass channels 338 can be angled downward (i.e., forming an angle below the first transverse axis). For example, the bypass channels 38 can be angled, such as angled upward and/or downward with respect to the cartridge 120 width and/or towards at least one vapor inlet 335. This can introduce more turbulence into the airflow path and promote better mixing of air and vapor. Various implementations of these alternative cartridge configurations are described in greater detail below.

FIGS. 4A-4X illustrate cross-sectional schematics of various implementations of a vaporizer device 400a-q consistent with implementations of the current subject matter. For purposes of simplicity only, certain components of the vaporizer devices 400a-q are not illustrated. Further, these vaporizer devices 400a-q can be implementations of one or more components of the vaporizer devices 100a, 100b of FIGS. 1A-1B, the vaporizer device 200 of FIG. 2, and/or the cartridge 320 of FIG. 3.

As illustrated in FIGS. 4A-4B, the vaporizer device 400, 400a can include a vaporizer body 410 and a cartridge 420 containing a vaporizable material 402. The vaporizer device 400, 400a illustrated in FIG. 4B is taken along cross-section A-A from FIG. 4A. As illustrated, the vaporizer body 410 can include a holder assembly 458 and one or more sensors 413. The holder assembly 458 can include a frame 447 defining a receptacle 418, and can optionally include a plurality of ridges 446 within the receptacle. As illustrated in FIG. 4A, external to the frame 447 and the receptacle 418, the holder assembly 458 can include or otherwise be coupled to one or more inductors 443 and/or one or more flux concentrators 448. In some implementations, each of the one or more inductors 443 can include an inductive coil configured to generate an electromagnetic field. In some implementations, each of the one or more flux concentrators 448 can include a magnetic material (e.g., ferritic material) configured to control and/or direct an electromagnetic field, generated by a respective inductor 443, such as by changing magnetic properties of the field. In some implementations, each of the one or more flux concentrators 448 can include a nanocrystal material, a nanometal material, and/or the like. Although various implementations are described with the holder assembly 458 including inductor(s) 443 and/or flux concentrator(s) 448, it will be appreciated that such configurations of the holder assembly 458 are not required. In some implementations the inductor(s) 443 and/or flux concentrator(s) 448 can be secured to or within other components of the vaporizer body 410 that do not define the receptacle 418. For example, the inductor(s) 443 can be secured to or within a holder assembly 458 and the flux concentrator(s) 448 can be secured to or within other component(s) of the vaporizer body 410 that are external to the holder assembly 458 (e.g., component(s) that are further away from the receptacle 418 and closer to the external shell of the vaporizer body 410). Alternatively, the inductor(s) 443 and the flux concentrator(s) 448 can be secured to or within other component(s) of the vaporizer body 410 that are external to the holder assembly 458.

In some implementations, the plurality of ridges 446 can be configured to retain the cartridge 420 within the receptacle 418, such as by applying force against the heater portion 441 of the cartridge 420. In some implementations, the cartridge 420 can be large enough to apply force in a direction that is opposite the force of the plurality of ridges 446, potentially resulting in a slight deformation of the heater portion 441. As illustrated, the plurality of ridges 446 can be positioned on one or both of the longitudinal walls and the lateral walls of the cartridge receptacle 418. Although the plurality of ridges are illustrated as bulges, other geometries can be used.

As illustrated, the cartridge 420 can include a mouthpiece portion 430 and a heater portion 441 within one or more layers of material (illustrated as wrapper(s) 422). The cartridge 420 can extend between a cartridge proximal end 420a and a cartridge distal end 420b, with the dimension between the two being the cartridge 420 length. Transverse to the cartridge 420 length and illustrated in FIG. 4A (from the left to the right) is the cartridge 420 depth. Transverse to both the cartridge 420 length and depth, and as illustrated in FIG. 4B (from the left to the right) is the cartridge 420 width.

The heater portion 441 can include one or more heating element(s) 442, which at least partially defines a volume within which the vaporizable material 402 is held. The heating element(s) 442 can be configured to heat the vaporizable material 402 to generate a vapor. As described herein, the heat can be generated through inductive means, although conductive and/or convective heating can also be provided. For example, eddy currents can be induced in the heating element(s) 442 via induction, which in turn cause the heating element(s) 442 to heat up. If the vaporizable material 402 is in direct contact with the heating element(s) 442, then the vaporizable material 402 can be heated via conductive heating at the points of direct contact. Additionally and/or alternatively, the heat produced by the heating element(s) 442 can be picked up by air passing along or near the heating element(s) 442 and distribute the heat to portions of the vaporizable material 402 that are not in physical contact with the heating element(s) 442, thereby heating the vaporizable material 402 via convective heating. The volume within which the vaporizable material 402 is held can be regarded as a heater chamber. For example, the volume defined at least in part by the heating element 442 can be referred to as a heater chamber. Accordingly, the heating element(s) 442 can define at least a portion of a perimeter of a heater chamber containing the vaporizable material, and in some implementations define substantially all of the perimeter. Arrows shown extending from the heating element 442 can indicate a direction of heat flow and/or heat transfer from the heating element 442, such as the opposing sets of horizontal arrows extending from the heating element 442 and directed towards a center of the heating chamber defined by the heating element 442 and/or towards a center of the vaporizable material 402, as shown in FIGS. 4A-4Q. As shown in FIG. 4P, arrows are also shown extending from the heating element 442 extending along an end of the cartridge 420 and indicate a direction of heat flow and/or heat transfer from the heating element 442 and directed towards a center of the heating chamber defined by the heating element 442 and/or towards a center of the vaporizable material 402. As shown in FIGS. 4A-4Q, arrows that are not extending from the heating element 442 can indicate a direction of fluid flow (e.g., airflow, inhalable aerosol, etc.) and/or a fluid pathway (e.g., airflow pathway, inhalable aerosol pathway, etc.).

The heater portion 441 can include an end cap at the cartridge distal end 420b to hold the vaporizable material 402 therein and/or define a lower boundary of the volume (e.g., heater chamber). However, in some implementations, the vaporizable material 402 can be formed with sufficient rigidity (e.g., in the form of a puck or another pre-formed shape) that an end cap is not necessary. In the event an end cap is included, it can include one or more cartridge inlets (e.g., though-holes) such that ambient air can enter the heater chamber. Additionally or alternatively, the end cap can include an air-permeable material such that air can enter the heater chamber through the material. The end cap can be regarded as a filter end cap (see FIG. 4H), and/or include material such as one or more of paper material such as cardstock, corrugated material such as cardboard or paper, tobacco paper, temperature-resistant plastic (e.g., PET), cellulose acetate, non-wood plant fibers such as flax, hemp, sisal, rice straw, and/or esparto, and/or the like. For example, the end cap can include corrugated paper material that is pressed or formed to fit within a region at the cartridge distal end 420b.

In some implementations, the material forming the one or more heating elements 442 can be further extended to enclose the cartridge distal end 420b and help retain the vaporizable material 402 (see e.g., FIG. 4N). Accordingly, the one or more heating elements 442 can include a plurality of cartridge inlets such that external air (i.e., external to the cartridge 420, such as the air within the receptacle 418) can enter the heater chamber. The plurality of cartridge inlets in the one or more heating elements 442 can be through-holes formed in the direction of the cartridge 420 longitudinal dimension. Additionally or alternatively, the plurality of cartridge inlets in the one or more heating elements 442 can be through-holes formed in one or more directions that are perpendicular to the cartridge 420 longitudinal dimension, such as around a perimeter of the one or more heating elements 442 and/or proximate the cartridge distal end 420b. In the event the vaporizable material 402 is exposed at the cartridge distal end 420b (e.g., no end cap can be used), the boundary formed by the distal ends of the one or more heating elements 442 and/or the one or more layers of material (e.g., wrapper(s) 422) can form one cartridge inlet such that ambient air can enter the heater chamber.

As illustrated between FIGS. 4A-4B, the mouthpiece portion 430 can include one or more inserts 424. The one or more inserts 424 can include first and second airflow outlet channels 426a, 426b that extend from corresponding first and second vapor inlets 435a, 435b, proximate the intersection of the mouthpiece portion 430 and the heater portion 441, to corresponding first and second airflow outlets 428a, 428b at the cartridge proximal end 420a. The first and second airflow outlet channels 426a, 426b thereby form a fluid connection between the heater portion 441 and the first and second airflow outlets 428a, 428b, such that vapor generated in the heater portion 441 can be drawn towards a user at the cartridge proximal end 420a, and ultimately out of the first and second airflow outlets 428a, 428b as an inhalable aerosol. Proximate to the intersection of the mouthpiece portion 430 and the heater portion 441, the insert 424 can further include first and second bypass channels 438a, 438b that each extend from corresponding first and second bypass air inlets 429a, 429b to corresponding first and second bypass outlets 427a, 427b, and thereby form a fluid connection between the first and second airflow outlet channels 426a, 426b and ambient air. In some implementations, the airflow outlet channels 426 and/or the bypass channels 438 can be created via a laser-cutting operation through walls of the insert 424 during the manufacturing process. It will be appreciated that the cross-sectional views of FIGS. 4B-4P can be regarded as illustrating the bypass air inlets 429, a portion of the bypass channels 438, and the airflow outlets 428 in the locations labeled as the bypass air inlets 429. However, the bypass air inlets 429 are illustrated and described for convenience.

It will be appreciated that the cross-sections are limited, and do not illustrate the fact that there are, for example, four bypass channels 438 (each with corresponding air inlets and outlets) in accordance with the implementation of FIGS. 4A-4B. However, as described herein, there can be more or less bypass channels 438, and the bypass channels 438 can take a different shape than what is illustrated. For example, each of the illustrated rectangular (cuboid) bypass channels 438 can be replaced with more and/or differently sized rectangular (cuboid) bypass channels 438 (see e.g., FIGS. 4C, 4G, 4I). In other implementations, the illustrated rectangular (cuboid) bypass channels 438 can be replaced with a plurality of circular (cylindrical) bypass channels 438, such as two, three, four, etc. circular (cylindrical) bypass channels 438. In such implementations, if there are two airflow outlet channels 426, each will have two sets of bypass channels 438, and the cartridge 420 could therefore include eight, twelve, sixteen, etc. bypass channels 438. Instead of the rectangular (cuboid) or circular (cylindrical) bypass channels 438, other geometries of the bypass channels 438 can be created.

When a user draws on the mouthpiece portion 430 at the cartridge proximal end 420a, this can cause ambient air to enter the receptacle 418 of the device body 410 at the airflow inlets 434, cause the air residing in the receptacle 418 to enter one or more inlets at the cartridge distal end 420b, and cause ambient air to enter the bypass air inlet(s) 429 at the same time. The air that enters the receptacle 418 from the airflow inlets 434 can travel along the airflow inlet path 432 to the cartridge distal end 420a, where it can continually flow into the one or more cartridge inlets located there. In some implementations, the plurality of ridges 446 can define the shape and size of the airflow inlets 434 into the receptacle 418, as described in greater detail below.

The air that enters at the cartridge distal end 420b can subsequently pass through the vaporizable material 402 as it is heated to entrain the vaporized material generated within the heater chamber. Meanwhile, the air that entered the bypass air inlet(s) 429 can subsequently pass through the bypass channels 438 and out of their corresponding bypass outlets 427, entering their respective airflow outlet channels 426. The air that entrains the vaporized material in the heater chamber can subsequently pass into the vapor inlets 435, entering the airflow outlet channels 426. As the vapor and air from the heater portion 441 traverse the airflow outlet channels 426, they mix with the ambient air that entered through the bypass air inlet(s) 429 to form an inhalable aerosol. The area in which the mixing and/or condensation occurs can be referred to as a condensation chamber. Accordingly, each of the airflow outlet channels 426 can include one or more condensation chambers configured to condense the entrained vapor with the ambient air to form at least a portion of the inhalable aerosol. This inhalable aerosol ultimately travels out of the airflow outlets 428 at the cartridge proximal end 420a and into the mouth of a user. Accordingly, the plurality of airflow outlets 328 can be in fluid communication with the at least one condensation chamber in a corresponding one of the plurality of airflow outlets 328, and/or configured to deliver the inhalable aerosol to a user. Collectively, the path of air, vapor, and inhalable aerosol through the vaporizer device 400 can be referred to as the airflow path of the vaporizer device 400.

The one or more sensors 413 can include a pressure sensor, an accelerometer, a temperature sensor, measurement circuitry configured to measure properties of the various components of the vaporizer body 410 and/or cartridge 420, and/or the like. In some implementations, the pressure sensor can be configured to detect changes in pressure that occur along the airflow path of the vaporizer device 400. Detected pressure drops can be used to determine when a user is inhaling, which can in turn be used to increase the power applied to the heating element(s) 442 to maintain or increase the temperature of the heating element(s) 442. Additionally or alternatively, the detected pressure drops can be used to count the number of puffs taken, which can in turn be used for other operations, such as stopping the application of power to the heating element(s) 442 (e.g., placing the vaporizer device 400 in a sleep or off state).

In some implementations, the one or more sensors 413 can include measurement circuitry configured to derive one or more properties of the heating element(s) 442 and/or inductor(s) 443, such as resistance, inductance, and/or temperature. In some implementations, the measurement circuitry can include circuitry configured to directly measure the one or more properties and/or circuitry configured to estimate the one or more properties based on other data (e.g., obtained via direct measurement, obtained processed and/or filtered measurement data, obtained from memory, and/or the like). The resistance and/or inductance of the heating element(s) 442, for example, can be used to estimate the temperature of the heating element(s). The resistance, inductance, and/or temperature can be used to maintain and/or alter the application of power to the heating element(s) 442, such as to achieve a target temperature. For example, altering the application of power can include increasing or decreasing the total power applied to the inductor(s) 443 and/or heating element(s) 442, adjusting a duty cycle of power applied to the inductor(s) 443 and/or heating element(s) 442, and/or the like. A duty cycle of power applied to the heating element(s) 442 can include a defined (e.g., predetermined and/or dynamically determined) period of time during which power is applied and a defined (e.g., predetermined and/or dynamically determined) period of time during which power is not applied during a given cycle of time. In some implementations, a default duty cycle can include 48 milliseconds (ms) of applying power and 2 ms of not applying power, every 50 ms.

Within the period of time during which power is not applied, the resistance and/or inductance of the heating element(s) 442 can be derived. If the derived resistance, inductance, and/or temperature are above a respective threshold (e.g., target temperature), the period of time during which power is applied can be decreased and/or the period of time during which power is not applied can be increased, in order to maintain a stable temperature at the heating element(s) 442 (e.g., target temperature). If the derived resistance, inductance, and/or temperature are below the same or a different respective threshold (e.g., target temperature), the period of time during which power is applied can be increased (up to a maximum value, which can be the same as the default value) and/or the period of time during which power is not applied can be decreased (down to a minimum value, which can be the same as the default value). For example, the same period of time (e.g., the last 2 ms) in each duty cycle (50 ms) can always be dedicated to deriving the resistance and/or inductance of the heating element(s) 442, regardless of the resistance, inductance, and/or temperature, and even if power is not being applied for a longer period of time.

However, in some implementations, the default duty cycle can be defined to apply power during the entire cycle of time (e.g., 50 ms out of each 50 ms), with measurements being taken at predetermined intervals (e.g., at the beginning or end of each duty cycle) regardless of whether power is being applied to the heating element(s) 442. The default duty cycle can be adjusted to include a period of time during which power is not applied during the duty cycle, based on the measured or derived value(s). This can be achieved, for example, by providing separate driving circuitry (e.g., including one or more inductors 443) and measurement circuitry (e.g., including a sensor 413), as described herein. Although temperature control can be achieved based on controlling the application of power to the heating element(s) 442 according to duty cycles as described herein, additionally or alternatively temperature control can be achieved based on controlling the voltage applied to the inductor(s) 443 and/or heating element(s) 442.

Implementations in which eddy currents are used to heat the vaporizable material 402, such as by use of heating element(s) 442 comprising a susceptor formed from aluminum and/or another non-ferritic metal, closed loop temperature control can be implemented with greater accuracy. For example, in implementations where the heating element(s) 442 are in direct contact with the vaporizable material 402, more accurate estimations of the current temperature of the vaporizable material 402 can be obtained and used in feedback loop temperature control, such as in accordance with the temperature control methodologies, components, circuitry, and/or the like described herein.

In some implementations, the measurement circuitry can be similar to the circuitry 973a-e illustrated in FIGS. 9A-9E. As illustrated in FIG. 9A, the circuitry 973a can include a power source AC (alternating current) (grounded) connected to a capacitor C, which is coupled with the inductive coil(s) 943 (LCOIL). As illustrated, the inductive coil(s) 943 can include an inductive component L and a resistive component R, although not necessarily physically formed from an inductor and a resistor (see FIGS. 5A-5J for examples of the physical construction of LCOIL). The inductive coil(s) 943 can be coupled in series or in parallel with the capacitor C, depending on whether the power source simulates an AC voltage or an AC current. The end of the inductive coil(s) 943 that is not coupled with the capacitor C and/or power source can be coupled to ground. Sense circuit 913 can be coupled to each end of the inductive coil(s) 943 to measure the inductance L and the resistance R of the inductive coil(s) 943, for use in the temperature control processes described herein.

In some implementations, temperature control can be implemented based on comparing derived (e.g., measured) inductive and/or restive values at different points in time and/or at different frequencies. For example, in some implementations the sense circuit 913 can be configured to measure or derive a first inductance L_{A} and/or a first resistance R_{A} of the inductive coil(s) 943 when power is not applied to the inductive coil(s) 943 by the power source AC, which can be referred to as measuring the inductance and/or resistance of the inductive coil(s) 943 at DC (direct current) (e.g., 0 Hz). Measuring at DC can reduce or eliminate the impact that the heating element(s) 442 have on the inductive coil(s) 943. The sense circuit 913 can be further configured to measure a second inductance L_{B} and a second resistance R_{B} of the inductive coil(s) 943 at a time while power is being applied by the power source AC, such as when heating a heating element(s) 442 (not shown). These measurements can be taken to determine the effect that the heating element(s) 442 has on the inductive coil(s) 943. These measurements can be taken at a specific frequency, such as within a range of 100 kHz to 1 MHz. Based on these measured values, the sense circuit 913 and/or other circuitry (e.g., a controller 104 in communication with the sense circuit 913) can be configured to derive (e.g., estimate) the temperature of the heating element(s) 442. For example, the ratio of resistance over inductance (e.g., R_{C}/L_{C}) caused by the heating element(s) 442 can be estimated based on the equation (R_{A}−R_{B})/(L_{A}−L_{B}). Because the inductance of the heating element(s) 442 generally does not change with temperature, the result of this equation (R_{C}/L_{C}) can be used with other information about the heating element(s) 442 and/or inductive coil(s) 943 to derive the temperature of the heating element(s) 442 at the time the measurements were taken. As described herein, the derived temperature of the heating element(s) 442 can be used to regulate the temperature of the heating element(s) 442, such as by providing the same, more, or less power and/or for the same, longer, or shorter durations of time, which can be implemented to heat the heating element(s) 442 at or near a target temperature.

For example, in some implementations, the result of the equation (R_{C}/L_{C}) and a thermal coefficient of resistance (TCR) of the heating element(s) 442 can be combined to derive an estimated temperature of the heating element(s) 442. The heating element(s) 442 can be manufactured such that it has a specific TCR, optionally with some level of tolerance. This specific TCR value and/or the tolerance can be stored in the vaporizer device 420, such as in memory 108, in the sense circuit 913, and/or the like. In other implementations, the TCR of the heating element(s) 442 can be measured periodically and/or upon the occurrence of specific events, such as upon insertion of the heating element(s) 442 in the vaporizer body 410, based on predetermined criteria such as a change of inductance and/or resistance over time or rate of change of inductance and/or resistance over time, before and/or after heating the heating element(s) 442, at set intervals of time before and/or after heating the heating element(s) 442, and/or the like.

In some implementations, a Curie temperature of the heating element(s) 442 can be utilized to maintain heat applied to the vaporizable material 402 in a particular range. A Curie temperature of an object can be regarded as a temperature at which particles of the object are substantially non-magnetic. For example, in implementations where the heating element(s) 442 is made of a nickel and iron alloy (e.g., Invar), the heating element 442 can be configured such that it does not reach higher than a known temperature (e.g., 240° C.). As such, the heating element(s) 442 can be regarded as self-regulating. Otherwise, the existence of metals with a known Curie temperature can be factored into the heater control methodologies described herein. For example, in some implementations, a controller 104 and/or other circuitry can be configured to monitor the heating element(s) 442 magnetic properties as it is transitioning to its Curie temperature, and regulate the heating element(s) 442 such that it stays at or near its Curie temperature. For example, the controller 104 can be configured to decrease the application of power and/or energy to the heating element(s) 442 when it is at or near its Curie temperature such that additional power and/or energy is not wasted.

In various implementations, depending on the shape of the heating element(s) 442, multiple inductive coils 943 can be used to heat the heating element(s) 442. For example, one inductive coil 943 can be used to generate an electromagnetic field to heat each of two opposing long sides of the heating element(s) 442. In other implementations, sets of two, three, four, five, six, or more inductive coils 943 can be used to generate electromagnetic fields to each heat two opposing long sides of the heating element(s) 442 (see FIGS. 5A-5J for examples of the physical construction and/or locations of the inductive coils 943).

When multiple inductive coils 943 are implemented, each can be configured to operate at the same frequency and/or different frequencies. For example, in some implementations all of the inductive coils 943 can be configured, via their structure and/or corresponding circuitry such as a controller 104, to operate at substantially the same operating frequency, which can change over time. All of the inductive coils 943 can be configured to operate at a first frequency when power is not being applied to heat the heating element(s) 442 (which can be 0 Hz), at a second frequency when power is being applied to heat the heating element(s) 442 in a first heating mode (e.g., during a pre-heating mode, a standby mode, a normal power mode, and/or the like), and/or at a third frequency when power is being applied to heat the heating element(s) 442 in a second heating mode (e.g., where more power is applied relative to the first heating mode, such as in a normal power mode, a boost power mode, and/or the like).

In other implementations, one or more of the inductive coils 943 can be configured to operate at a different frequency or frequencies from the remaining inductive coils 943. In accordance with these implementations, the inductive coils 943 can be configured to operate at substantially the same frequency during certain times or modes while also being configured to operate at different frequencies during certain times or modes. For example, in implementations where sets of two or more inductive coils 943 are provided to respectively heat opposing sides of the heating element(s) 442, one of the inductive coils 943 or one of the inductive coils 943 from each set can be configured to operate at a different frequency while the remaining inductive coils 943 operate at the same frequency. With each of the inductive coils 943 being positioned near different portions of the heating element(s) 442, information derived from the inductive coil 943 (or coils) operating at a different frequency can be used to derive additional information about the heating element(s) 442.

In implementations where one inductive coil 943 is used to heat each of the long sides of the heating element(s) 442, each of the inductive coils 943 can be configured to operate at substantially the same frequency (F_{A}) during certain modes and/or times, and each of the inductive coils 943 can be further configured to operate at a different frequency (F_{B}) during other modes and/or times. For example, a first inductive coil 943 LCOIL_{A} that is near side “A” of the heating element(s) 442 and a second inductive coil 943 LCOIL_{B} that is near side “B” of the heating element(s) 442 can, during a first Mode/Time₁ be configured to both operate at frequency F_{A}. During a second Mode/Time₂ the first inductive coil 943 LCOIL_{A} can be configured to operate at frequency F_{B} while the second inductive coil 943 LCOIL_{B} can be configured to remain operating at frequency F_{A}. During a third Mode/Time₃ the first inductive coil 943 LCOIL_{A} can be configured to operate at frequency F_{A} while the second inductive coil 943 LCOIL_{B} can be configured to operate at frequency F_{B}. During each of the Modes/Times, measurements of the properties of the inductive coils 943 can be taken, such as inductance and/or resistance measurements. These measurements can be compared against expected values for the measurements to derive additional information about the heating element 442, such as whether the heating element 442 is deformed. For example, if some combination of the inductance and/or resistance measurements taken during the second Mode/Time₂ differ from the same combination of the inductance and/or resistance measurements taken during the third Mode/Time₃, then it can be concluded that the heating element 442 is deformed on side A or side B of the heating element 442. Although two Frequencies F_{A,B} are discussed, additional frequencies can be applied during heating and/or measurement of the heating element(s) 442, such as Frequencies F_{A-N}.

Frequency F_{A} can be a frequency at which the heating element(s) 442 is heated to vaporize the vaporizable material 402. However, frequency F_{A} can alternatively be a frequency at which the heating element(s) 442 is not heated to vaporize the vaporizable material 402. For example, frequency F_{A} can be a frequency that is lower than the frequency at which the heating element(s) 442 is heated. Frequencies F_{B-N} can additionally or alternatively include a frequency at which the heating element(s) 442 is heated, a frequency at which the heating element(s) 442 is not heated (e.g., lower or higher frequencies than the frequency at which the heating element(s) 442 is heated), and/or can be adjusted dynamically based on measurements of the heating element(s) 442 and/or the like. In various implementations, Frequencies F_{A}, F_{B}, etc. are within a range of 0 Hz to 1 MHz. In order to derive more information about the heating element(s) 442, additional distinct frequencies can be used. For example, measurements can be taken while operating one or more of the inductive coils 943 at approximately 50 kHz, 100 kHz, 150 kHz, 200 kHz, 250 kHz, 300 kHz, 350 kHz, 400 kHz, 500 kHz, etc. (e.g., in ranges of ±5 kHz, ±10 kHz, ±15 kHz, etc.).

In some implementations, multiple inductive coils 943 can be disposed near each of side A and/or side B of the heating element(s) 442. For example, in accordance with TABLES 1-3 below, LCOIL_{A1} and LCOIL_{A2} can be disposed near side A and LCOIL_{B1} and LCOIL_{B2} can be disposed near side B. In accordance with these example implementations, each of the inductive coils 943 can be driven at different frequencies and/or at different times. At some of all of the time frames and/or frequencies, the inductive coils 943 can be used to derive information about the heating element(s) 442, as described herein.

As shown in TABLE 1, all of the inductive coils 943 can be configured to start in mode/time₁ at Frequency F_{A}, and sequentially for each mode/time₂₋₅ thereafter, only one of the inductive coils 943 operates at Frequency F_{B} while the remainder operate at the original F_{A}. In some implementations, the pattern of sequential changing frequencies can be repeated with F_{B} being a different value, such as by cycling through a repeating sequence of frequencies F_{B-N}.

TABLE 1

| Inductive | Mode/ | Mode/ | Mode/ | Mode/ | Mode/ |
|---|---|---|---|---|---|
| Coil 943 | Time₁ | Time₂ | Time₃ | Time₄ | Time₅ |
| LCOIL_{A1} | F_{A} | F_{B} | F_{A} | F_{A} | F_{A} |
| LCOIL_{A2} | F_{A} | F_{A} | F_{B} | F_{A} | F_{A} |
| LCOIL_{B1} | F_{A} | F_{A} | F_{A} | F_{B} | F_{A} |
| LCOIL_{B2} | F_{A} | F_{A} | F_{A} | F_{A} | F_{B} |

As shown in TABLE 2, all of the inductive coils 943 can be configured to start in mode/time₁ at Frequency F_{A}, and sequentially for each mode/time₂₋₅ thereafter, only one of the inductive coils 943 operates at a different frequency while the remainder operate at the original F_{A}. In accordance with the implementation in TABLE 2, each of the inductive coils 943 sequentially operate across a plurality of Frequencies F_{B-N}.

TABLE 2

| Inductive | Mode/ | Mode/ | Mode/ | Mode/ | Mode/ |
|---|---|---|---|---|---|
| Coil 943 | Time₁ | Time₂ | Time₃ | Time₄ | Time₅ |
| LCOIL_{A1} | F_{A} | F_{B-N} | F_{A} | F_{A} | F_{A} |
| LCOIL_{A2} | F_{A} | F_{A} | F_{B-N} | F_{A} | F_{A} |
| LCOIL_{B1} | F_{A} | F_{A} | F_{A} | F_{B-N} | F_{A} |
| LCOIL_{B2} | F_{A} | F_{A} | F_{A} | F_{A} | F_{B-N} |

As shown in TABLE 3, all of the inductive coils 943 can be configured to start in mode/time₁ at Frequency F_{A}, and sequentially for each mode/time₂₋₅ thereafter, a plurality of the inductive coils 943 operate at a different frequency F_{B} while the remainder operate at the original F_{A}. In accordance with the implementation in TABLE 3, each of the inductive coils 943 can operate at Frequency F_{B} at the same time as an inductive coil 943 on the same side or an opposite side therefrom. It will be appreciated that a larger number of inductive coils 943 and/or measurements taken at different frequencies can increase the accuracy of the system, such as by making more precise determinations as to the location of a deformation, for example.

TABLE 3

| Inductive | Mode/ | Mode/ | Mode/ | Mode/ | Mode/ |
|---|---|---|---|---|---|
| Coil 943 | Time₁ | Time₂ | Time₃ | Time₄ | Time₅ |
| LCOIL_{A1} | F_{A} | F_{B} | F_{A} | F_{B} | F_{A} |
| LCOIL_{A2} | F_{A} | F_{A} | F_{B} | F_{B} | F_{A} |
| LCOIL_{B1} | F_{A} | F_{B} | F_{A} | F_{A} | F_{B} |
| LCOIL_{B2} | F_{A} | F_{A} | F_{B} | F_{A} | F_{B} |

As such, various measurements of the heating element(s) 442 can be taken while the heating element(s) 442 is being actively heated and/or while the heating element(s) 442 is not actively heated. Measurements of the heating element(s) 442 can be taken while the heating element(s) 442 is actively heated in a normal power mode, a boost power mode, and/or the like. In some implementations, an inductive coil that is actively heating the heating element(s) 442 to vaporize the vaporizable material 402 in a normal power mode can be configured to operate in a frequency range of 100 kHz to 200 kHz or 250 kHz to 350 kHz. An inductive coil that is actively heating the heating element(s) 442 to vaporize the vaporizable material 402 in a boost power mode can be configured to operate in a frequency range that higher than the frequency range in the normal power mode, such as greater than 200 kHz or greater than 350 kHz, and optionally less than 500 kHz. Measurements of the heating element(s) 442 can be taken while the heating element(s) 442 can or can not be actively heated, such as in a cartridge detection mode, a pre-heating mode, a measurement mode, a standby mode, and/or the like.

In some implementations, an inductive coil 943 that is operating in a measurement mode can be configured to operate at a plurality of different frequencies and/or frequency ranges while not actively heating the heating element(s) 442 to vaporize the vaporizable material 402. Information sensed or measured through the inductive coil 943 in this mode can be used to determine whether there are any irregularities and/or deformations in the heating element(s) 442. In various implementations, only a portion of the inductive coils 943 can be operating in the measurement mode while the remainder of the inductive coils 943 are operating in a normal power mode or boost power mode. Depending on a level and/or location of deformation detected, the vaporizer device 400 (e.g., via the controller 104) can be configured to compensate for the deformation, prevent activation of the inductive coils 943, provide an indication to the user that a deformed heating element 442 and/or cartridge 420 has been detected (e.g., via one or more outputs 117, such as one or more LEDs), and/or the like. In some implementations, compensating for the deformation can include applying more or less power to the area of the heating element 442 that has been determined to be deformed.

In some implementations, an inductive coil 943 that is operating in a cartridge detection mode can be configured to operate at a plurality of different frequencies and/or frequency ranges while not actively heating the heating element(s) 442 to vaporize the vaporizable material 402. Information sensed or measured through the inductive coil 943 in this mode can be used to determine whether an object present in the vaporizer device 420, such as heating element(s) 442, have certain defined properties of an object designed for use with the vaporizer device 420. If and when heating element(s) 442 having the correct properties are detected, the vaporizer device 420 can be configured to allow the inductive coils 943 to operating in a normal power mode and/or boost power mode. If an object is detected but does not have one or more of the defined properties, then the inductive coil 943 can be disabled from heating. In some implementations, a defined property of the heating element(s) 442 can be an inductance measurement and/or resistance measurement.

In some implementations, an inductive coil 943 that is operating in a pre-heating mode can be configured to operate at one or a plurality of different frequencies to bring the heating element(s) 442 to a temperature that is suitable for vaporization. Additionally or alternatively, the pre-heating mode can include selectively heating different portions of the heating element(s) 442 to drive off at least a portion of the water vapor in the vaporizable material 402. If a user inhales on the vaporizer device 420 when the aerosol has a higher water vapor content, such as in the first few inhalations, the user can experience a taste that is less pleasant. Accordingly, it can be beneficial to drive off as much of the water vapor content as possible, prior to a user inhaling on the vaporizer device 400. In some implementations, user activation of the pre-heating mode can automatically occur when a user activates the device, such that the pre-heating mode is always executed prior to a normal power mode or a boost power mode.

Although various frequencies and modes are discussed with respect to the inductive coils 943 specifically, it is contemplated that other measurement circuitry, such as one or more of the sensing coils 513 discussed with respect to FIGS. 5A-5J, can optionally be provided and configured to additionally or alternatively measure the heating element(s) 442. For example, the measurement circuitry can be configured to measure information about the heating element(s) 442 during a normal power mode, boost power mode, measurement mode, cartridge detection mode, pre-heating mode, standby mode, and/or the like. In implementations where such measurement circuitry is present (e.g., one or more sensing coils 513), the measurement circuitry can be configured such that it measures the restiveness, inductance, temperature, and/or other properties of the heating element(s) 442, such as at one or a plurality of different frequencies, does not generate an electromagnetic field for heating the heating element(s) 442, operates while the inductive coils 943 are heating the heating element(s) 442, operates while the inductive coils 943 are not heating the heating element(s) 442, and/or the like.

In some implementations, information about the inductive coils 943, such as their inductance, resistance, temperature, and/or the like can be measured in one or more of the described modes and used to control the power or voltage applied, such as to heat the heating element(s) 442 at different temperatures (e.g., target temperatures), as described herein. Although reference is made to the long sides of the heating element(s) 442, other configurations are contemplated depending on the shape and/or position of the heating element(s) 442.

Other implementations exist where additional or alternative information about the inductive coil(s) 943 can be measured and/or used to estimate the temperature of the heating element(s) 442, such as via the circuitry 973b illustrated in FIG. 9B. In such implementations, the temperature and/or other properties of the inductive coil(s) 943 can be measured by a coil temperature sensor 983 in close proximity to the inductive coil(s) 943. In some implementations, the coil temperature sensor can include a thermistor, a PTC circuit such as a PTC thermistor, an NTC circuit such as an NTC thermistor, a thermocouple, and/or the like. In accordance with such implementations, the sense circuitry 913 and/or other circuitry can be configured to regulate the application of power to the heating element(s) 442, based on a detected temperature of the inductive coil(s) 943, in addition to or alternatively from the measured inductance and resistance. For example, a specific, detected rise in temperature of the inductive coil(s) 943 can be correlated to a rise in temperature of the heating element(s) 442, such that the power and/or energy applied to the heating element(s) 442 can be reduced and/or maintained.

Other implementations exist where information about the inductive coil(s) 943 can be measured and/or used to estimate the temperature of the heating element(s) 442 in a different manner, such as via the circuitry 973c illustrated in FIG. 9C. In such implementations, the inductive coil(s) 943 can be part of the driving circuitry (for heating the heating element(s) 442)) and the sense circuit 913 is part of a different circuit. In operation, the sense circuit 913 is instead configured to measure properties of the inductive coil(s) 943 and/or heating element(s) 442 wirelessly (e.g., without direct, wired connection), such as through a connected sense coil. Additionally or alternatively, the implementations of FIG. 9C can be configured to operate with the use of a coil temperature sensor 983 as described herein, such as via the circuitry 973d illustrated in FIG. 9D.

In some implementations, the sense circuit 913 can be configured to communicate wirelessly with the driving circuitry such that it does not impact performance of the inductive coil(s) 943, such as via the circuitry 973e illustrated in FIG. 9E. For example, a resonant circuit formed of the capacitor C and connected inductive coil(s) 943 can operate in accordance with a known or measurable resonant frequency, and can be used to wirelessly power the heating element(s) 442 and/or measure information about the heating element(s) 442, such as inductance and/or resistance. In some implementations, the inductance and/or resistance of the heating element(s) 442 can be determined based on measuring the resonant frequency of the inductive coil(s) 943 and comparing the measurements against the known resonant frequency of the inductive coil(s) 943 (e.g., without the presence of the heating element(s) 442). For example, the measurements can be implemented via monitoring and/or measuring the ringing of the inductive coil(s) 943. In some implementations, information about the heating element(s) 442 can be measured and/or determined based on the time and/or speed at which the oscillation of an alternating current (e.g., sine wave) used to power the heating element(s) 442 stops (e.g., returns to zero). Such techniques can be beneficial by providing much faster measurements (e.g., in the order of microseconds) compared with determinations that require more direct measurements of the inductance and/or resistance of the heating element(s) 442.

In some implementations, the inductive coils 943 can be configured to measure information from something other than the heating element 442, such as for the purposes of calibration and/or estimation. For example, an inductive coil 943 that is operating in a calibration mode can be configured to operate at a plurality of different frequencies and/or frequency ranges when a heating element(s) 442 is not present. Information sensed or measured through the inductive coils 943 in this mode can be used to determine an expected change in inductance and/or resistance, which can be stored in a look-up table for use in monitoring the inductive coils when a heating element(s) 442 is present. The sensed information can come from operation of another inductive coil 943, such as one or more inductive coils 943 on an opposing side of the vaporizer device 420. For example, in some implementations, one or more of the inductive coils 943 (e.g., all) can be configured to heat each other up to a predetermined temperature and/or for a predetermined amount of time, and the inductance and/or resistance can be measured and/or stored for each of the one or more inductive coils 943. The data derived from this monitoring can be used to define one or more parameters of each inductive coil(s) 943, which can be factored into the temperature control methodologies described herein. In some implementations, this calibration mode can be implemented as part of a manufacturing process and/or periodically after the device has been sold (e.g., be a recommended user-selectable mode).

Returning to FIG. 4A, the one or more inductors 443 can be configured to generate an electromagnetic field, and the one or more flux concentrators 448 can be configured to direct the electromagnetic field towards the one or more heating elements 442, as described in greater detail below. When the one or more heating elements 442 receive the electromagnetic field, they can be configured to convert the current to heat, in order to heat the vaporizable material 402.

The one or more inductors of the vaporizer devices descried herein can be driven at a variety of frequencies. For example, in some aspects, one or more inductors of a vaporizer device can be driven at a frequency less than 1 megahertz (MHz) (e.g., at a low frequency). In such instances, the frequency can be in a range of 100 kilohertz (kHz) to 600 kilohertz (kHz), 200 kHz to 600 kHz, 200 kHz to 500 kHz, 200 kHz to 400 kHz, 150 kHz to 350 kHz, or 200 kHz to 300 kHz. By contrast, in other aspects, the one or more inductors of a vaporizer device can be driven at a frequency that is equal to or greater than 1 megahertz (MHz) (e.g., at a high frequency). In such instances, the frequency can be in a range of 1 MHz to 50 MHz or 1 MHz to 30 MHz.

Driving the one or more inductors at a high frequency can increase the efficiency of the vaporizer device. Device efficiency can be determined from a ratio between an amount of metal present in the heating element (e.g., susceptor or infrared (IR) reflective material) of the vaporizer device and an amount of metal present in the one or more inductors. When the one or more inductors are driven at a high frequency, in some implementations, the vaporizer device can achieve greater than 90% coupling efficiency. The improved coupling efficiency can reduce the required size of a battery powering the vaporizer device, making the vaporizer device cheaper to build.

The one or more inductive coils can have a variety of configurations. In some implementations, the at least one inductor can be in the form of an inductive coil on a flexible substrate (“flex coils”, e.g., inductive material etched on a printed circuit board (PCB)) in instances where high-frequency operation is desired. Flex coils can be easy to manufacture and/or assemble, further reducing the cost of manufacturing the device. These coils can be smaller (e.g., two millimeters (mm) thick), allowing for a larger air gap in the vaporizer device. Increasing the size of the air gap increases insulation in the device, thereby reducing heat loss and further improving efficiency. For example, an increase in a size of the air gap by two to three millimeters can result in a 50% increase in insulation. When compared to other types of inductors (e.g., Litz wire coils), a flex coil can use less metal, e.g., copper, and therefore can have a lower resistance. The lower resistance of the flex coil means that less energy is required to heat the heating element and also that the energy loss is less than that of an inductor driven at a lower frequency.

Using flex coils also provides process improvements applicable to vaporizer device manufacturing. As a flex coil is made from a flat sheet (e.g., copper sheet), it has less ability to deform mechanically when heated, when compared to a Litz wire coil. Also, etching copper onto a PCB to generate a flex coil is more easily reproducible, controllable, and scalable than wrapping a Litz wire to make a coil. And using a flex coil can lessen a proximity effect associated with using a wire coil, as photochemical etching can be used to control the spacing of the wires in a PCB in order to lower the series resistance of the coil.

FIG. 38 illustrates an exemplary vaporizer device 3800 that includes a vaporizer body 3810 and a cartridge 3820 insertable received within a receptacle 3818 defined by a frame 3847 of the vaporizer body. The vaporizer body includes one or more inductors 3843a, 3843b in the form of one or more flex coils. While the number of flex coils can vary, in this illustrated implementation, there are two flex coils 3843a, 3843b. As shown in FIG. 38, the two flex coils 3843a, 3843b are each positioned on and around a respective portion of the outer surface 3847b of the frame 3847. The vaporizer body 3810 also includes a flux concentrator 3848 that is positioned about the flex coils 3843a, 3843b such that the flex coils 3843a, 3843b are interposed between the frame 3847 and the flux concentrator 3848. As discussed above and in more detail below, the flux concentrator 3848 can be configured to direct the magnetic and/or electromagnetic field generated by the two flex coils 3843a, 3843b towards a heating element 3842 of the cartridge 3820. As further shown, a gap 3897 is present between the frame 3847 and the cartridge 3842, which in this implementation, air is present within the gap.

Driving the coils at a high frequency can allow for a cartridge design that eliminates a need for a welded seam or a slot. For example, a rolled tobacco slug can be wrapped with a thin material (e.g., a foil). The foil can provide an infrared (IR) reflective surface. The foil can include a resistive metal (e.g., aluminum). The foil can also include paper. The rolled tobacco slug wrapped with the thin material can be inserted into a tube, which can be shaped into a cylindrical or rectangular shape. Such a device can remove a requirement for an electrical connection of the weld, and hence not need the inductive coil to be electrically connected to the susceptor.

Eliminating the need for welding the heating element can reduce the cost of the vaporizer, as welding a heating element (e.g., welding of a susceptor) can be difficult to perform cheaply at scale. One way of eliminating this need could be effected by using a rolling technique where a round slug of vaporizable material could be rolled with a heating element such that the heating element is inside out so as to provide a built-in infrared reflecting surface. As shown in FIGS. 39A-39B, the heating element 3942 with the vaporizable material 3902 can then be inserted into the wrapper 2922 to produce a cartridge 3910. In this illustrated implementation, gaps 3987a, 3987b are created between the heating element and the wrapper, which can improve insulation from conductive losses. In other implementations, the distance of the gaps can be minimized (e.g., by implementing, e.g., a larger slug of vaporizable material, thereby inhibit air from passing through the gaps and thus around the vaporizable material.

In implementations where only one airflow outlet channel 426 is included, such as through the insert 424 in the mouthpiece portion 430 as illustrated in the vaporizer device 400c of FIG. 4C, the airflow outlet channel 426 can be longer along the cartridge 420 width compared to each individual airflow outlet channel 426 if two or more airflow outlet channels 426 are included. Providing a singular airflow outlet channel 426 can provide an aerosol that is more homogenous compared to two separate airflow outlet channels 426. Separately, providing a larger airflow outlet channel 426 and/or a larger mixing chamber or a greater degree or tortuosity in the aerosol outlet path can increase the residence time the vapor and air spend within the airflow outlet channel 426, as well as increase contact with cooler surfaces, which can help to cool the resulting aerosol to an even lower temperature and promoting proper aerosol formation (e.g., nucleation). As used to herein, proper aerosol formation can refer to formation of an aerosol that is desirable to a user (e.g., is not too hot, does not include larger particles, provides a particular sensation in the mouth, etc.).

As with the vaporizer device 400a of FIG. 4A, bypass air inlet(s) 429 can be disposed on both major faces of the cartridge 420 (i.e., the faces separated by the cartridge 420 depth) that are in fluid communication with the singular airflow outlet channel 426 of FIG. 4C. Each of the two sets of bypass channels 438 can include one or more rectangular (cuboid) bypass channels 438, one or more circular (cylindrical) bypass channels 438, and/or one or more bypass channels 438 of other geometries. In some implementations, the bypass channels 438 can be offset from each other along the cartridge 420 length and the cartridge 420 width to generate turbulence within the airflow outlet channel (see FIG. 4I). Such turbulence can further promote mixing of air and vapor in the generation of the inhalable aerosol. The vaporizer device 400, 400c can include at least some of the same components of, and otherwise operate in the same or similar manner as, the vaporizer device 400a of FIGS. 4A-4B, except as noted. Separately, the components of vaporizer device 400, 400c identified and discussed herein can be combined into any of the other vaporizer devices 400 described with respect to FIGS. 4A-4B and/or 4D-4X, except as noted or where impractical.

In implementations where differently shaped airflow outlet channels 426 are included, such as through one or more inserts 424 in the mouthpiece portion 430 as illustrated in the vaporizer device 400d of FIG. 4D, the airflow outlet channels 426 can be different distances along the cartridge 420 width. For example, as illustrated first and second airflow outlet channels 426a, 426b can be disposed in a lower region of the mouthpiece portion 430 (e.g., closer to the cartridge distal end 420b and further from the cartridge proximal end 420a, along the cartridge 420 length) and a third airflow outlet channel 426c can be disposed in an upper region of the mouthpiece portion 430 (e.g., closer to the cartridge proximal end 420a and further from the cartridge distal end 420b, along the cartridge 420 length).

Advantages with this configuration exist compared to using the two independent airflow outlet channels 426 in the vaporizer device 400a of FIGS. 4A-4B or the individual airflow outlet channel 426 in the vaporizer device 400c of FIG. 4C. For example, the individual benefits of each can be attained together. When the air and vapor from the heater portion 441 enter the independent first and second airflow outlet channels 426a, 426b and mix with ambient air from their respective bypass air inlet(s) 429, the smaller fluid volumes provide a better restriction to draw and spaces in which a larger overall portion of the vapor is able to independently mix with ambient air, helping to cool the air and vapor faster. Thereafter, when the air and vapor enter the larger third airflow outlet channel 426c, aerosol generation can benefit from the increased residence time within the third airflow outlet channel 426c, helping the air and vapor to cool for longer, and provide for better mixing that results in a more homogenous aerosol. Further, the change in size between the smaller and larger airflow outlet channels 426 can introduce turbulence to help promote mixing, provide a longer and/or more tortuous airflow path to increase cooling time, and therefore promote proper aerosol formation.

In some implementations, the first and second airflow outlet channels 426a, 426b can be channels within a first insert 424 and the third airflow outlet channel 426c can be a channel within a second insert 424. The first insert 424 can be stacked on top of the second insert 424, along the cartridge 420 length in a direction from the cartridge distal end 420b to the cartridge proximal end 420a. The first and second inserts 424 can also be held together to form the mouthpiece portion 430 (e.g., held within a layer of material, wrapped together within a wrapper 422, and/or the like), and an additional layer of material (e.g., wrapper 422) can be included that holds the mouthpiece portion 430 together with the heater portion 441. The vaporizer device 400, 400d can include at least some of the same components of, and otherwise operate in the same or similar manner as, the vaporizer device 400a of FIGS. 4A-4B, except as noted. Separately, the components of vaporizer device 400, 400d identified and discussed herein can be combined into any of the other vaporizer devices 400 described with respect to FIGS. 4A-4C and/or 4E-4X, except as noted or where impractical.

Although the first and second outlet channels 426a, 426b are illustrated in FIG. 4D as being in fluid communication with a singular, larger third airflow outlet channel 426c, each of the first and second outlet channels 426a, 426b can alternatively be in fluid communication with their own, separate and respective larger third and fourth airflow outlet channels 426c, 426d as illustrated in FIG. 4Q. As such, various implementations of the cartridges 420 described herein can include more controlled regions in which the vaporized material mixes with ambient air for cooling and/or promotion of proper aerosol formation. As further illustrated in FIG. 4Q, each of the first and second outlet channels 426a, 426b can be provided with two bypass air inlets 429 each, resulting in a cartridge 420 with eight bypass air inlets 429 total.

Other implementations exist where differently shaped airflow outlet channels 426 are included, such as through one or more inserts 424 in the mouthpiece portion 430 as illustrated in the vaporizer device 400e of FIG. 4E. For example, as illustrated a first airflow outlet channel 426a can be disposed in a lower region of the mouthpiece portion 430 (e.g., closer to the cartridge distal end 420b and further from the cartridge proximal end 420a, along the cartridge 420 length) and second and third airflow outlet channels 426b, 426c can be disposed in an upper region of the mouthpiece portion 430 (e.g., closer to the cartridge proximal end 420a and further from the cartridge distal end 420b, along the cartridge 420 length).

Advantages with this configuration exist compared to using the two independent airflow outlet channels 426 in the vaporizer device 400a of FIGS. 4A-4B or the individual airflow outlet channel 426 in the vaporizer device 400c of FIG. 4C. For example, the individual benefits of each can be attained together. When the air and vapor from the heater portion 441 enter the first airflow outlet channel 426a and mix with ambient air from the bypass air inlet(s) 429, aerosol generation can benefit from the increased residence time within the first airflow outlet channel 426a, helping the air and vapor to cool for longer, and provide for better mixing that results in a more homogenous aerosol. Thereafter, when the air and vapor enter the smaller, independent second and third airflow outlet channels 426b, 426c, the smaller fluid volumes provide a better restriction to draw and are easier to control. Separately, the presence of the two smaller volumes after the larger volume can help to introduce turbulence to help promote mixing, provide a longer and/or more tortuous airflow path to increase cooling time, and therefore promote proper aerosol formation.

In some implementations, the first airflow outlet channel 426a can be a channel within a first insert 424 and the second and third airflow outlet channels 426b, 426c can be channels within a second insert 424. The first insert 424 can be stacked on top of the second insert 424, along the cartridge 420 length in a direction from the cartridge distal end 420b to the cartridge proximal end 420a. The first and second insert 424 can also be held (e.g., wrapped) together within a layer of material (e.g., wrapper 422) so that they can form the mouthpiece portion 430 (e.g., held within a layer of material, wrapped together within a wrapper 422, and/or the like), and an additional layer of material (e.g., wrapper 422) can be included that holds the mouthpiece portion 430 together with the heater portion 441. The vaporizer device 400, 400e can include at least some of the same components of, and otherwise operate in the same or similar manner as, the vaporizer device 400a of FIGS. 4A-4B, except as noted. Separately, the components of vaporizer device 400, 400e identified and discussed herein can be combined into any of the other vaporizer devices 400 described with respect to FIGS. 4A-4D and/or 4F-4Q, except as noted or where impractical.

Other implementations exist where additional and/or different inserts 424 are included, such as the first and second inserts 424a, 424b in the mouthpiece portion 430 as illustrated in the vaporizer device 400f of FIG. 4F. For example, as illustrated first insert 424a can be disposed in a lower region of the mouthpiece portion 430 (e.g., closer to the cartridge distal end 420b and further from the cartridge proximal end 420a, along the cartridge 420 length) and the second insert 424b can be disposed in an upper region of the mouthpiece portion 430 (e.g., closer to the cartridge proximal end 420a and further from the cartridge distal end 420b, along the cartridge 420 length).

The first and second airflow outlet channels 426a, 426b can be channels within a first insert 424a and a second insert 424b can be positioned downstream of the airflow outlet channels 426. The second insert 424b can be stacked on top of the first insert 424a, along the cartridge 420 length in a direction from the cartridge distal end 420b to the cartridge proximal end 420a. The first and second inserts 424a, 424b can also be held together to form the mouthpiece portion 430 (e.g., held within a layer of material, wrapped together within a wrapper 422, and/or the like), and an additional layer of material (e.g., wrapper 422) can be included that holds the mouthpiece portion 430 together with the heater portion 441.

In some implementations, the second insert 424b can include an air-permeable material such that aerosol can exit the mouthpiece portion 430 and be inhaled by a user, but can provide additional filtration (e.g., active filtration to remove constituent parts of the aerosol). The second insert 424b can include material such as one or more of paper material such as cardstock, corrugated material such as cardboard or paper, tobacco paper, temperature-resistant plastic (e.g., PET), cellulose acetate, non-wood plant fibers such as flax, hemp, sisal, rice straw, and/or esparto, and/or the like. The vaporizer device 400, 400f can include at least some of the same components of, and otherwise operate in the same or similar manner as, the vaporizer device 400a of FIGS. 4A-4B, except as noted. Separately, the components of vaporizer device 400, 400f identified and discussed herein can be combined into any of the other vaporizer devices 400 described with respect to FIGS. 4A-4E and/or 4G-4X, except as noted or where impractical.

Other implementations exist where the insert(s) 424 take up a smaller percentage of the volume in the mouthpiece portion 430 and/or other components are used instead as illustrated in the vaporizer device 400g of FIG. 4G. For example, one or more inserts 424 can be disposed in an upper region of the mouthpiece portion 430 (e.g., closer to the cartridge proximal end 420a and further from the cartridge distal end 420b, along the cartridge 420 length) and a divider 454 can be disposed in a lower region of the mouthpiece portion 430 (e.g., closer to the cartridge distal end 420b and further from the cartridge proximal end 420a, along the cartridge 420 length). As described herein, the divider 454 can be regarded as part of the mouthpiece portion 430 or part of a separate divider portion. In some implementations, at least a portion of the divider portion can be disposed within the receptacle 418 when the cartridge 420 is inserted into the vaporizer body 410 and/or at least a portion of the divider portion can be disposed outside of the receptacle 418 when the cartridge 420 is inserted into the vaporizer body 410. As illustrated, one or more walls 433 can be provided within the mouthpiece portion 430 to maintain the rigidity of the mouthpiece portion 430 so that it is resistant to deformation under force (e.g., crumpling, breaking, etc.) and/or easier to manufacture. As illustrated, the wall(s) 433 can extend along the cartridge 420 length, between the insert(s) 424 and the divider 454 (e.g., in the region downstream of the divider 454 and upstream of the insert 424). The wall(s) 433 define at least a portion of a perimeter of the airflow outlet channel 426, and in some implementations, the wall(s) 433 define substantially all of the perimeter of the airflow outlet channel 426. In some implementations, the airflow outlet channel 426 can be formed between and/or defined by the wall(s) 433 and the insert(s) 424, and optionally by the divider 454 in implementations where the wall(s) 433 form a hollow shape (e.g., a hollow, flattened cylinder).

In some implementations, the divider 454 can include a solid end, define an open end opposite the solid end, and include a solid boundary that extends between the two ends (e.g., along a perimeter of the divider 454, where the perimeter can be substantially the same at the solid end and the open end). As illustrated, the divider 454 can be disposed within the mouthpiece portion 430 with the solid end more proximate the cartridge proximal end 420a and the open end more proximate the cartridge distal end 420b, facing the heater chamber in the heater portion 441. In some implementations, the divider 454 can be regarded as having an upside-down cup shape (relative to the cartridge distal end 420b being considered the ground). A plurality of vapor inlets 435 can be formed through the solid end of the divider 454, such that the vaporized material and external air from the heater chamber can enter the airflow outlet chamber 426.

In some implementations, the walls 433 can similarly include a solid end, define an open end opposite the solid end, and include a solid boundary that extends between the two ends (e.g., along a perimeter of the walls 433, where the perimeter can be substantially the same at the solid end and the open end). As illustrated, the divider 454 can be disposed within the mouthpiece portion 430, with the open end more proximate the cartridge proximal end 420a and the closed end more proximate the cartridge distal end 420b. In some implementations, the walls 433 can be regarded as having a cup shape. A plurality of bypass air inlets 429 can formed through the solid boundary of the walls 433, such that ambient air can enter the airflow outlet chamber 426. Further, a plurality of vapor inlets 435 can be formed through the solid end of the walls 433, such that the vaporized material and external air from the heater chamber, and more immediately, from the vapor inlets 435 of the divider 454, can enter the airflow outlet chamber 426.

In some implementations the solid end of the walls 433 can abut (e.g., physically touch and/or in proximity to) the solid end of the divider 454, which can help to simplify the manufacturing process. In some implementations, the vapor inlets 435 and the bypass air inlets 429 formed in the divider 454 and the walls 433 can be sized to create a jet-stream effect. For example, in some implementations, each of the vapor inlets 435 and the bypass air inlets 429 can be circular holes that are less than 1 mm in diameter, less than 0.5 mm in diameter, or less than 0.25 mm in diameter. In some implementations, each of the vapor inlets 435 and the bypass air inlets 429 are the same size. However, in other implementations, the vapor inlets 435 are larger than the bypass outlets 427, such that the jet stream effect from the ambient air has a stronger effect on the slower-moving air passing through the vapor inlets 435. The vapor inlets 435 and the bypass air inlets 429 can be created via a laser-cutting operation during the manufacturing process.

In some implementations, the divider 454 can extend out of the distal end of the mouthpiece portion 430 such that it can couple with, be inserted within, and/or touch the exterior of the heater portion 441. In accordance with these implementations, the divider 454 can be regarded as part of the mouthpiece portion 430 only, as part of both the mouthpiece portion 430 and the heater portion 441, or can be regarded as an intermediate portion disposed between the mouthpiece portion 430 and the heater portion 441. For example, in some implementations the insert(s) 424, wall(s) 433, and the divider 454 can all be held (e.g., wrapped) together in a first layer of material (e.g., wrapper 422) to form the mouthpiece portion 430, the heating element(s) 442 can be disposed around the vaporizable material 402 to form the heater portion 441, and an additional layer of material (e.g., wrapper 422) can hold the mouthpiece portion 430 and the heater portion 441 together to form the cartridge 420.

The insert 424 can include an air-permeable material such that aerosol can exit the mouthpiece portion 430 and be inhaled by a user, but can provide additional filtration (e.g., active filtration to remove constituent parts of the aerosol). The insert 424 can include material such as one or more of paper material such as cardstock, corrugated material such as cardboard or paper, tobacco paper, temperature-resistant plastic (e.g., PET), cellulose acetate, non-wood plant fibers such as flax, hemp, sisal, rice straw, and/or esparto, and/or the like.

The vaporizer device 400, 400g can include the at least some of the same components of, and otherwise operate in the same or similar manner as, the vaporizer device 400a of FIGS. 4A-4B, except as noted. Separately, the components of vaporizer device 400, 400g identified and discussed herein can be combined into any of the other vaporizer devices 400 described with respect to FIGS. 4A-4F and/or 4H-4X, except as noted or where impractical.

Other implementations exist where one or more insert(s) 424 can be disposed within the heater portion 441, as illustrated in the vaporizer device 400h of FIG. 4H. For example, one or more first inserts 424a can be disposed in a lower region of the heater portion 441 (e.g., proximate and/or forming at least a portion of the cartridge distal end 420b). The first insert(s) 424a can include material that is air-permeable so that air can enter the heater chamber through the material, such as one or more of paper material such as cardstock, corrugated material such as cardboard or paper, tobacco paper, temperature-resistant plastic (e.g., PET), cellulose acetate, non-wood plant fibers such as flax, hemp, sisal, rice straw, and/or esparto, and/or the like.

In some implementations, an end cap can instead be disposed in the location of the first insert(s) 424a, and can comprise one or more cartridge inlets (e.g., as discussed with respect to FIG. 4A). As disclosed above, the end cap can refer to at least one of a variety of materials and/or elements that are positioned adjacent a side of vaporizable material and/or a container for containing vaporizable material within any implementation of the cartridge disclosed herein. In some implementations, the end cap can be positioned at an end of the cartridge. In some implementations, the end cap can be positioned offset (e.g., along the length of the cartridge) from an end of the cartridge, including not being a most distal or proximal element along an implementation of the cartridge. For example, the end cap can form a part of an outer surface of the cartridge and/or the end cap can be fully contained within the outer surface of the cartridge. The vaporizer device 400, 400h can include at least some of the same components of, and otherwise operate in the same or similar manner as, the vaporizer device 400a of FIGS. 4A-4B, except as noted. Separately, the components of vaporizer device 400, 400h identified and discussed herein can be combined into any of the other vaporizer devices 400 described with respect to FIGS. 4A-4G and/or 4I-4X, except as noted or where impractical.

Other implementations exist where multiple bypass air inlets 429 are offset from each other to create a turbulent airflow, such as those illustrated in the vaporizer device 400i of FIG. 4I. As described herein, the cartridge 420 can include one or more airflow outlet channels 426 in fluid communication with ambient air through at least one bypass air inlet 429 formed on each of the long sides of the cartridge 420. As illustrated, the cartridge 420 can include first and second airflow outlet channels 426a, 426b, each with their own respective set of first and second bypass air inlets 429a, 429b, on a first long side of the cartridge 402. As illustrated, each subsequent bypass air inlet 429, in the direction of the cartridge airflow, can be offset from the prior bypass air inlet 429 (on an exterior face of the cartridge 420) along the cartridge 420 length and/or the cartridge 420 width. Stated another way, as the external air and vapor pass through each airflow outlet channel 426, they can be joined and/or disrupted by a sequence of ambient air streams that are sequentially offset from each other by an angle formed between the cartridge 420 length and the cartridge 420 width (e.g., other than 90 degrees, such as between 50 degrees and 40 degrees, between 60 degrees and 30 degrees, between 70 degrees and 20 degrees, between 80 degrees and 10 degrees, and/or the like). It will be appreciated that such placement of the bypass air inlets 429 can introduce turbulence into the cartridge airflow path and/or within the one or more condensations chambers, which can promote cooling and/or condensation of the vapor into the inhalable aerosol.

Matching sets of bypass air inlets 429 can exist on the second long side of the cartridge 402 (not shown), however other patterns can exist between the first and second sides of the cartridge 420. For example, while one side of the cartridge can include the three bypass air inlets 429 shown, the other side of the cartridge can include only two bypass air inlets that are staggered and/or disposed within the spaces between the illustrated three bypass air inlets 429, offset along the cartridge 420 depth, or four bypass air inlets 429 that are offset in a similar manner. In other implementations, the number of bypass air inlets 429 on each side can be the same, and the pattern can be the same or different. For example, while the subsequent bypass air inlets (along the direction of the cartridge airflow) of the sets of first and second bypass air inlets 429a, 429b are illustrated as alternating between being closer to the center of the long sides and further from the center of the long sides (but still bounded by the locations of the respective first and second airflow outlet channels 426a, 426b), the pattern of the bypass air inlets 429 on the opposite side can alternate between being further from the center of the long sides and closer to the center of the long sides. In some implementations the two sets of bypass air inlets 429 can function independently (e.g., have little to no effect on the airflow outlet channel 426 with which they are in fluid communication).

As discussed above, the smaller individual airflow outlet channels 426 provide fluid volumes that can be more easily controlled while also exposing a larger overall volume of vapor to ambient air. The ability to introduce a large amount of turbulence into the airflow outlet channels 426 as described herein can be one implementation of such control. Nevertheless, the geometry and/or locations of the bypass air inlets 429 can be implemented in a manner that still increases the turbulence within a singular, larger airflow outlet channel 426. As described herein, each of the rectangular (cuboid) bypass channels 438 defined in part by the bypass air inlets 429 can be replaced with more and/or differently sized rectangular (cuboid) bypass channels 438, a plurality of circular (cylindrical) bypass channels 438, and/or other geometries. The vaporizer device 400, 400i can include at least some of the same components of, and otherwise operate in the same or similar manner as, the vaporizer device 400a of FIGS. 4A-4B, except as noted. Separately, the components of vaporizer device 400, 400i identified and discussed herein can be combined into any of the other vaporizer devices 400 described with respect to FIGS. 4A-4H and/or 4J-4X, except as noted or where impractical.

Other implementations exist where the vaporizable material 402 can have different geometries, such as illustrated in the vaporizer device 400j of FIG. 4J. For example, in some implementations a space can be provided between the vaporizable material 402 and the mouthpiece portion 430, such as within the proximal end of the heater portion 441. Additionally or alternatively, the vaporizable material 402 can include a plurality of cartridge inlets 425, such as at the cartridge distal end 420a. The vaporizer device 400, 400j can include at least some of the same components of, and otherwise operate in the same or similar manner as, the vaporizer device 400a of FIGS. 4A-4B, except as noted. Separately, the components of vaporizer device 400, 400j identified and discussed herein can be combined into any of the other vaporizer devices 400 described with respect to FIGS. 4A-4I and/or 4K-4X, except as noted or where impractical.

Other implementations exist where additional structures can be present within and/or between the heater portion 441 and/or the mouthpiece portion 430, such as those illustrated in the vaporizer devices 400g, 400k, 400l, 400m, 400r, 400t, and 400v of FIGS. 4G, 4K-M and 4R-W. As illustrated in FIG. 4K, the cartridge 420 can further comprise a divider 454 comprising a plurality of bypass air inlets 429. The divider 454 can be implemented as component that is in the shape of a ring or donut, which can include a cross-section that takes the form of the cross-section of the cartridge (e.g., elliptical or oval). In some implementations, the internal space formed by the divider 454 can be generally hollow. To prevent the vaporizable material 402 from entering the divider 454, where it can block one or more of the bypass air inlet(s) 429, the divider 454 can include one or more standoffs that at least partially close the bypass air inlet(s) 429 from the upstream end of the cartridge 420 (e.g., cartridge distal end 420b) while keeping the bypass air inlet(s) 429 open to the downstream end of the cartridge (e.g., cartridge proximal end 420a). In some implementations the divider 454 can include a solid or partially solid end (e.g., floor) at the upstream end of the divider 454. For example, the divider 454 can include grates, a mesh material, and/or the like at the upstream end of the divider 454. The benefits of such implementations can be similar to those of FIG. 4E discussed herein, with the additional benefit that multiple different airflow outlet channels 426 do not need to be made within the same insert 424 or some combination of two or more different inserts 424. Instead, the divider 454 can be implemented as a simpler component that is held (e.g., wrapped or inserted) within a layer of material (e.g., wrapper 422), together with the heater portion 441 and the mouthpiece portion 430, and through which the bypass air inlet(s) 429 are created (e.g., by laser-cutting, molding, pre-formed holes, and/or the like, as described herein).

The vaporizer device 400, 400k can include at least some of the same components of, and otherwise operate in the same or similar manner as, the vaporizer device 400a of FIGS. 4A-4B, except as noted. Separately, the components of vaporizer device 400, 400k identified and discussed herein can be combined into any of the other vaporizer devices 400 described with respect to FIGS. 4A-4J and/or 4L-4X, except as noted or where impractical.

Other implementations exist where additional or alternative structures can be present within the mouthpiece portion 430 that lengthen the distance air must travel before reaching the airflow outlet(s) 428, such as those illustrated in the vaporizer device 400l of FIG. 4L. For example, as illustrated the mouthpiece portion 430 can include a plurality of baffles 455 that divert airflow within the airflow outlet channel 426. In some implementations, the baffles 455 can extend across a majority of the cartridge 420 width, covering one end of the cartridge 420 width and leaving open a space at the opposite end of the cartridge 420 width. Each, subsequent baffle 455, along the direction of the cartridge airflow path, can be disposed to leave open a space at a different end from the immediately preceding baffle 455. For example, if a first baffle 455 is disposed to leave open a space at a first side of the cartridge 420 (e.g., a first short side), then a subsequent second baffle 455 is disposed to leave open a space at a second side of the cartridge 420 (e.g., a second short side, opposite the first short side along the cartridge 420 width), and this alternating pattern can continue for each subsequent baffle 455. In various implementations, the cartridge 420 can include one baffles 455, two baffles 455 (see FIG. 4M), three baffles 455, four baffles 455 (see FIG. 4L), five baffles 455 (see FIG. 6F), etc. The open spaces can form part of the airflow path along which the external air and vapor can travel, providing an airflow path with a longer, overall distance compared to an airflow path that travels straight through the mouthpiece portion along the cartridge 420 length. Further, the multiple changes in direction of the airflow path can introduce turbulence to help promote mixing, provide a longer and/or more tortuous airflow path to increase cooling time, and therefore promote proper aerosol formation.

In some implementations, the airflow outlet channel 426 can include a larger, open volume (e.g., condensation chamber) downstream of the baffles 455 and upstream of the airflow outlet(s) 428 (e.g., proximate the cartridge proximal end 420a), such as what is illustrated in the vaporizer device 400m of FIG. 4M. Including the larger, open volume can promote the production of an aerosol that is more homogenous and/or can increase the residence time the vapor and air spend within the airflow outlet channel 426, helping to cool the resulting aerosol to an even lower temperature and promoting proper aerosol formation. Further, the change in size between the smaller and larger portions of the airflow outlet channels 426 can introduce turbulence to help promote mixing, provide a longer and/or more tortuous airflow path to increase cooling time, and therefore promote proper aerosol formation.

The vaporizer devices 400, 400l, 400m can include at least some the same components of, and otherwise operate in the same or similar manner as, the vaporizer device 400a of FIGS. 4A-4B, except as noted. Separately, the components of vaporizer devices 400, 400l, 400m identified and discussed herein can be combined into any of the other vaporizer devices 400 described with respect to FIGS. 4A-4K and/or 4N-4X, except as noted or where impractical.

Other implementations exist where additional or alternative structures can be present within the cartridge 420 that provide more control of the airflow path through cartridge 420, such as those illustrated in the vaporizer device 400r of FIGS. 4R-4S. For example, as illustrated in FIGS. 4R-4S, the mouthpiece portion 430 can include a divider 454 that includes a plurality of stand-offs 477 extending in the longitudinal axis from the downstream end of the divider 454 towards the vaporizable material 402. The plurality of stand-offs 477 can be spaced apart from each other such that a plurality of trenches 476 are formed within the space between each adjacent stand-off 477. For example, a first set of stand-offs 477a can extend between opposing short sides of the cartridge 420, proximate a first long side of the cartridge 420, and a second set of stand-offs 477b can also extend between the opposing short sides of the cartridge 420, proximate a second long side of the cartridge 420 that is opposite the first long side of the cartridge 420. As illustrated in FIG. 4R, a trench 476 can be formed between each pair of adjacent first stand-offs 477a as a generally hollow volume defined in part by opposing walls of the adjacent first stand-offs 477a and an upstream-facing wall of the divider 454 between the opposing walls. A trench 476 can also be formed between each pair of adjacent second stand-offs 477b as a generally hollow volume defined in part by opposing walls of the adjacent second stand-offs 477b and an upstream-facing wall of the divider 454 between the opposing walls. As illustrated, the upstream-facing walls of the divider 454 that at least partially define the trenches 476 can be angled with respect to the longitudinal axis of the cartridge 420 or approximately perpendicular to the longitudinal axis of the cartridge 420.

The first set of stand-offs 477a and the second set of stand-offs 477b can be at least partially separated from each other by a middle trench 476 extending between the opposing short sides of the cartridge 420. The separation between the sets of stand-offs 477a, 477b created by the presence of the middle trench 476 can be proximate the distal end of the divider 454, and the separation can optionally extend from the distal end of the divider 454 to a first airflow outlet channel 426a of the divider. In some implementations, the sets of stand-offs 477a, 477b are opposite each other and do not touch, but are formed as part of a singular divider 454 component. The central axis of the middle trench 476 can be approximately parallel to the opposing long sides of the cartridge 420 as illustrated in FIG. 4S. At a location that is approximately central to the middle trench 476 (e.g., central to a cross-section of the divider 454 that is perpendicular to the longitudinal axis of the cartridge 420), the middle trench can include an outlet that is in fluid communication with a first airflow outlet channel 426a. However, the first airflow outlet channel 426a is not required to be central to a cross-section of the divider 454 that is perpendicular to the longitudinal axis of the cartridge 420, and more than one first airflow outlet channel 426a can be included to further divide the stream of vaporized material to promote cooling. As illustrated in FIG. 4S, downstream of the outlet of the middle trench 476, the first airflow outlet channel 426a can be in fluid communication with ambient air through a bypass air inlet 429, bypass channel 438, and bypass outlet 427. The first airflow outlet channel 426a, bypass air inlet 429, bypass channel 438, and bypass outlet 427 can be sized and configured to provide a jet-stream effect, as described herein, to rapidly cool the vaporized material passing through the first airflow outlet channel 426a. The first airflow outlet channel 426a can include an outlet that is in fluid communication with a second airflow outlet channel 426b, downstream of the first airflow outlet channel 426a. As illustrated in FIG. 4S, the second airflow outlet channel 426b includes a larger volume of space compared to the first airflow outlet channel 426a, which can promote nucleation and aerosol formation in a manner similar to the vaporizer devices 400d, 400q of FIGS. 4D, 4Q.

In some implementations, the divider 454 can be defined in part by an outer perimeter, a proximal end (or upstream end), a distal end (or downstream end), and one or more outer walls extending between the proximal end and the distal end. The outer perimeter of the divider 454 can be disposed along an interior perimeter of the wrapper(s) 422 holding the divider 454 and other components of the cartridge 420 in place. As illustrated, the outer walls of the divider 454 can extend around the outer perimeter of the divider 454 and/or form an interior perimeter of the divider 454. The interior perimeter of the divider 454 can at least partially define an interior volume of the divider 454 that is proximate the proximal end of the divider 454. In some implementations, the second airflow outlet channel 426b can be defined in part by this interior volume of the divider 454. For example, as illustrated, the second airflow outlet channel 426b is defined in part by this interior volume of the divider 454 and is further defined by an interior volume of the mouthpiece portion 430 that is downstream of the proximal end of the divider 454. This interior volume of the mouthpiece portion 430 can be defined as a space between the second filter 424b and the proximal end of the divider 454, within the interior perimeter of the wrapper 422. In some implementations, the second airflow outlet channel 426b can include a larger, open volume (e.g., condensation chamber) downstream of the first airflow outlet channel 426b and upstream of the second airflow outlet(s) 428b (e.g., proximate the cartridge proximal end 420a),

The outer walls of the divider 454, parallel to the longitudinal axis of the cartridge 420, are illustrated as only extending partially within the mouthpiece portion 430 (e.g., spaced apart from the second filter 424b). However, in some implementations the outer walls of the divider 454 can extend along a majority of the mouthpiece portion 430 (e.g., with the second filter 424b disposed at the proximal end of the divider 454 and the vaporizable material 402 disposed at the distal end of the divider 454). The outer walls of the divider 454 can increase the overall durability and rigidity of the cartridge 420, especially in the region proximate the divider 454, which can be partially inserted into the receptacle 418 and/or in contact with one or more of the ridges 446 in some implementations. It will be appreciated that a divider 454 extending from the second filter 424b to the vaporizable material 402 can provide greater durability and rigidity to the cartridge 420. However, a divider 454 that does not extend all the way from the second filter 424b to the vaporizable material 402 can provide sufficient durability and rigidity to the cartridge 420 while also saving on manufacturing costs and complexity. Accordingly, in some implementations, the divider 454 can extend less than 50% of the distance between the second filter 424b and the vaporizable material 402 along the longitudinal axis of the cartridge 420, less than 40% of the same distance, less than 30% of the same distance, and/or the like.

As illustrated in FIGS. 4R-4S, the divider 454 can include an interior bulge 479 or region that at least partially extends between the proximal and distal ends of the divider 454. The first set of stand-offs 477a, the second set of stand-offs 477b, and the trenches 476 of the divider 454 can be formed within an interior of the bulge 479 that is upstream of the proximal end of the divider 454. For example, the upstream-facing walls of the divider 454 that at least partially define the trenches 476 can be surfaces of the bulge 479 that are within the interior of the bulge 479. The interior volume of the divider 454 proximate the proximal end of the divider 454 that at least partially defines the second airflow outlet channel 426b can be bounded by an exterior surface of the bulge 479 (e.g., downstream of the distal end of the divider 454). For example, this interior volume of the divider 454 can be defined as a space between the downstream surface(s) of the bulge 479 and the proximal end of the divider 454, within the interior perimeter of the outer walls of the divider 454. In some implementations, the first airflow outlet channel 426a and/or the bypass channel(s) 438 can be regarded as part of the bulge 479. In some implementations, the bulge 479 can be regarded as having a shape that is similar to a dome, pyramid, and/or the like. For example, a cross-section of the bulge 479 taken along the longitudinal axis of the cartridge 420 can be generally triangular (e.g., with rounded edges). Although the term bulge is used to define the region of the divider 454 that includes the stand-offs 477, 477a, 477b, the trenches 476, the bypass channel(s) 438, and/or the first airflow outlet channel 426, the term bulge is not intended to exclude other shapes or structures of regions that include these features.

In use, vaporized material can be generated within the heater portion 441 by heating the vaporizable material 402, and air that enters through the cartridge distal end 420b can pass through the vaporizable material 402 to move the vaporized material to the vapor inlet(s) 435 and into the divider 454. The vaporized material can enter the trenches 476 of the divider 454 formed between the first stand-offs 477a, the trenches 476 of the divider formed between the second stand-offs 477b, and/or a middle trench 476 that at least partially separates the first stand-offs 477a and the second stand-offs 477b. The vaporized material can then pass from the middle trench 476 into the first airflow outlet channel 426a. Ambient air can enter the cartridge 420 through the bypass air inlet(s) 429, travel through the bypass channel(s) 438, and enter the first airflow outlet channel 426a through the bypass outlet(s) 427. Within the first airflow outlet channel 426a, the vaporized material can mix with the ambient air to form an aerosol. It will be appreciated that aerosol formation can occur prior to the vaporized material and ambient air mixing in the first airflow outlet channel, such as within the bulge and/or trenches 476 of the divider 454. However, the configuration of the bypass channel 438 and first airflow outlet channel 426a can be provided such that rapid aerosol formation (e.g., nucleation) can occur within and downstream of the first airflow outlet channel 426a. The vaporized material and ambient air can then pass out of the first airflow outlet channel 426a and into the second airflow outlet channel 426b. The aerosol can continue to cool and form within the second airflow outlet channel 426b, and then pass through the second filter 424b, out of the cartridge 420 where it is inhaled by a user.

Each of the plurality of stand-offs 477 can include an upstream-facing wall configured to contact a downstream area of the vaporizable material 402 to prevent the vaporizable material 402 from entering the divider 454 and/or leaving the heater portion 441. In some implementations, when the divider 454 is placed within the cartridge 420 during assembly, the divider 454 can be pressed against the vaporizable material 402 to increase the packing density of the vaporizable material 402 within the cartridge 420. However, in order to avoid over-packing the vaporizable material 402 in a manner that reduces or prevents airflow through the vaporizable material 402, in some implementations the divider 454 can be disposed at a location within the cartridge 420 during manufacture that provides a space between the downstream end of the vaporizable material 402 and the upstream end of the divider 454.

In some implementations, it can be beneficial to provide additional or alternative structures to help prevent the vaporizable material 402 from entering the divider 454. For example, as illustrated in FIGS. 4T-4U, the divider 454 of the cartridge 420 in the vaporizer device 400t can include one or more baffles 455 upstream of the first airflow outlet channel 426a. Providing a smaller (e.g., more narrow) inlet into the first airflow outlet channel 426a can allow for better control of aerosol generation, but introduces a greater risk that the inlet can become blocked (e.g., by the vaporizable material 402). Accordingly, including one or more baffles 455 aligned with the first airflow outlet channel 426a along the longitudinal dimension of the cartridge 420 can help prevent the vaporizable material 402 from blocking the first airflow outlet channel 426a. As illustrated, the baffle 455 can extend between the first set of stand-offs 477a and the second set of stand-offs 477b. Compared with the middle trench 476 in the vaporizer device 400r of FIGS. 4R-4S, the baffle 455 in the vaporizer device 400t can divide a region of the middle trench 476 such that airflow is diverted around the baffle 455. In some implementations, the middle trench 476 in the vaporizer device 400t can be regarded as including a first region that is proximate a first short side of the cartridge 420, a second region that is proximate a second short side of the cartridge 420 opposite the first short side of the cartridge 420, and one or more connecting regions that are between and in fluid communication with both the first region and the second regions. For example, as illustrated in FIG. 4U, two connecting regions of the middle trench 476 are disposed on opposite sides of the baffle 455, with each of the connecting regions being closer to their respective, opposing long sides of the cartridge 420. As illustrated in FIG. 4T, one or both of the two connecting regions can be in communication with the first airflow outlet channel 426a via fluid connection(s) that flow around the baffle 455, such as on opposite sides of the baffle 455 closer to their respective, opposing short sides of the cartridge 420. The middle trench 476 can still at least partially separate the first stand-offs 477a and the second stand-offs 477b in regions that do not include a baffle, such as in the first and second regions of the middle trench 476.

The airflow and aerosol generation within the vaporizer device 400t can operate in the same or similar manner as the airflow and aerosol generation within the vaporizer device 400r. However, when the vaporized material passes from the middle trench 476 to the first airflow outlet channel 426a, the vaporized material passes around the baffle 455. For example, the vaporized material flowing out of the heater portion 441 can enter the trenches 476 of the divider 454 formed between the first stand-offs 477a, the trenches 476 of the divider formed between the second stand-offs 477b, the first region of the middle trench 476 that is proximate a first short side of the cartridge 420, the second region of the middle trench 476 that is proximate a second short side of the cartridge 420 opposite the first short side of the cartridge 420, and/or the one or more connecting regions of the middle trench 476 that are between and in fluid communication with both the first region and the second regions. The vaporized material can then pass around the baffle 455, through the fluid connection(s), and into the first airflow outlet channel 426a.

The vaporizer devices 400, 400r, 400t, can include at least some of the same components of, and otherwise operate in the same or similar manner as, the vaporizer device 400a of FIGS. 4A-4B, except as noted. Separately, the components of vaporizer devices 400, 400r, 400t identified and discussed herein can be combined into any of the other vaporizer devices 400 described with respect to FIGS. 4A-4Q, except as noted or where impractical.

Other implementations of a divider 454 are contemplated, such as the divider 454 in the vaporizer device 400v of FIGS. 4V-W. As illustrated, relative to the vaporizer devices 400r, 400t of FIGS. 4R-U, the divider 454 of the vaporizer device 400v can include less stand-offs 477 with larger upstream-facing walls, and thereby include less trenches 476 defined between adjacent stand-offs 477. For example, the divider 454 of the vaporizer device 400v can include four stand-offs 477 that collectively define two trenches 476. A first trench 476a can extend between opposing long sides of the cartridge 420 and a second trench 476b can extend between opposing short sides of the cartridge 420. The first trench 476a and the second trench 476b can intersect (e.g., equally bisect) each other and/or form a unitary trench in the shape of a cross, plus sign, and/or the like. The opposing ends of the first trench 476a can be in fluid communication with respective, first airflow outlet channels 426a proximate each of the opposing long sides of the cartridge 420. As illustrated, the divider 454 can include one or more conduits 478 that each at least partially define respective first airflow outlet channels 426a. For example, each first airflow outlet channel 426a can be defined between a conduit 478 of the divider 454 and the wrapper(s) 422, extending from the ends of the first trench 476a to their respective first airflow outlets 428a.

Downstream of each first airflow outlet 428a ambient air can be introduced to mix with the vaporized material passing out of the airflow outlet 428a. For example, a bypass air inlet 429, bypass channel 438, and bypass outlet 427 can provide ambient air into the second airflow outlet channel 426b, downstream of each airflow outlet 428a. Accordingly, ambient air and the vaporized material passing out of each airflow outlet 428a can mix within the second airflow outlet channel 426b, prior to exiting the cartridge 420 through the second filter(s) 424b. However, in some implementations the bypass air inlets 429, bypass channels 438, and bypass outlets 427 can be upstream of their respective first airflow outlets 428a, such as parallel with the conduits 478 along an axis of the cartridge 420 that is perpendicular to the longitudinal axis of the cartridge 420. In accordance with these implementations, ambient air can begin mixing with the vaporized material within each first airflow outlet channel 426a, pass out of each airflow outlet 428a, and continue to mix within the second airflow outlet channel 426b prior to exiting the cartridge 420.

As illustrated, the divider 454 can include a cut-out region proximate each bypass air inlet 429. The cut-out region can include an area proximate to each bypass air inlet 429 where the walls of the divider 454 are spaced away from the bypass air inlet 429 to provide an open space for ambient air to enter and direct the vaporized material towards the center of the second airflow outlet channel 426b. In some implementations, the walls of the divider 454 forming the cut-out region can be spaced away from the bypass air inlets 429 by a distance that is greater than or equal to the largest dimension (e.g., diameter, length, or width in a two-dimensional plane) of the bypass air inlet(s) 429. Additionally or alternatively, the cut-out region (e.g., the proximal end of the conduit 478) can extend to a length, in the direction of the distal end to the proximal end of the cartridge 420, that is less than the length of the bypass air inlet(s) 429. For example, the bypass air inlets 429, bypass channels 438, and bypass outlets 427 can be disposed at a length that is greater than a length of the respective proximal ends of the conduit 478. The bypass air inlets 429, bypass channels 438, and bypass outlets 427 can be parallel along an axis of the cartridge 420 that is perpendicular to the longitudinal axis of the cartridge 420. Although the term cut-out is used to describe certain regions of the divider 454, no cutting process is required during manufacturing, as these regions can be provided within the divider by other means (e.g., molding).

Similar to the vaporizer devices 400r, 400t of FIGS. 4R-4U, the divider 454 of the vaporizer device 400v of FIGS. 4V-4W can include an outer perimeter that is aligned with the interior perimeter of the wrapper 422, a proximal end, a distal end, outer walls extending between the proximal end and the distal end, an interior perimeter formed in part by the outer walls, a bulge 479 that includes or otherwise defines the stand-offs 477, an interior volume between the proximal-facing wall(s) of the bulge 479 and the proximal end (e.g., at least partially defining the second airflow outlet channel), and/or the like.

The vaporizer device 400v can include at least some of the same components of, and otherwise operate in the same or similar manner as, the vaporizer devices 400r, 400t of FIGS. 4R-4U, except as noted. Separately, the components of vaporizer devices 400, 400v identified and discussed herein can be combined into any of the other vaporizer devices 400 described with respect to FIGS. 4A-4Q, except as noted or where impractical.

Other implementations of a divider 454 are contemplated, such as the divider 454 in the vaporizer device 400x of FIG. 4X. As illustrated, the divider 454 of the vaporizer device 400x can include a series of trenches 476 through which air can pass. The trenches 476 can be defined in part through the presence of stand-offs 477, which can be sinusoidal or otherwise vary in location along one or more axis of the divider 454. In some implementations, the divider 454 can be regarded as corrugated material and/or the stand-offs 477 can be regarded as flutes. The divider 454 can include a first airflow outlet channel that is central to the divider 454, and includes a first airflow outlet 428a into a downstream second airflow outlet channel 426b. A bypass air inlet 429 can be disposed and configured to allow ambient air to enter the first airflow outlet channel 454. Additionally or alternatively, bypass air inlet 429 can be disposed and configured to allow ambient air to enter the trenches 476 formed within the divider 454. The divider 454 can be implemented in multiple layers of trenches 476 (e.g., each separated by intermediate layers) or as multiple dividers 454 stacked on top of each other along the length of the cartridge 420. Providing multiple layers of trenches 476 and/or dividers 454 between the vaporizable material 402 and the bypass air inlet 429 can provide more thermal isolation. For example, the vaporizable material 402 and/or heater 442 can be isolated from the second airflow outlet channel 426b such that a higher temperature can be maintained within the vaporizable material 402 and/or heater 442 and a lower temperature can be achieved within the second airflow outlet channel 426b. The relative lengths of each layer of trenches 476 and/or divider 454 can be the same, or the length of the upstream layer(s) of trenches 476 and/or divider(s) 454 can be greater to provide more thermal isolation.

Although the dividers 454 of FIGS. 4R-4X are illustrated and described as being within the mouthpiece portion 430, in some implementations the divider 454 can be at least partially within the heater portion 441 or within a divider portion that is between the mouthpiece portion 430 and the heater portion 441. For example, the divider 454 can be within a divider portion that is downstream of the heater portion 441, upstream of the mouthpiece portion 430, and/or configured to be at least partially disposed within the receptacle 418.

Other implementations exist where the one or more heating element(s) 442 can have different geometries, such as illustrated in the vaporizer device 400n of FIG. 4N. For example, the material forming the one or more heating elements 442 can be further extended to enclose and/or form at least a portion of the cartridge distal end 420b. Such a configuration can help retain the vaporizable material 402 within the cartridge 420. In accordance with such implementations, the one or more heating elements 442 can include a plurality of cartridge inlets 425 such that external air (i.e., external to the cartridge 420, such as the air within the receptacle 418) can enter the heater chamber formed at least in part by the heating element(s) 442. The plurality of cartridge inlets 425 can be through-holes formed in the direction of the cartridge 420 longitudinal dimension. Additionally or alternatively, the plurality of cartridge inlets 425 can be through-holes formed through the heating elements 442 in one or more directions that are perpendicular to the cartridge 420 longitudinal dimension, such as around a perimeter of the one or more heating elements 442 and/or proximate the cartridge distal end 420b, illustrated by the dashed boxes.

As illustrated, the bottom of the heating element(s) 442 that form and/or are proximate the cartridge distal end 420b can include a plurality of cartridge inlets 425 configured to allow external air to enter the heater chamber within the heating element(s) 442. As illustrated, the heating elements 442 can heat the vaporizable material from a direction that is approximately perpendicular to the cartridge 420 length and from a direction that is approximately parallel to the cartridge 420 length. The vaporizer device 400, 400n can include at least some the same components of, and otherwise operate in the same or similar manner as, the vaporizer device 400a of FIGS. 4A-4B, except as noted. Separately, the components of vaporizer device 400, 400n identified and discussed herein can be combined into any of the other vaporizer devices 400 described with respect to FIGS. 4A-4M and/or 4O-4W, except as noted or where impractical.

Other implementations exist where the cartridge 420 can be heated externally by conductive and/or convective heat, such as illustrated in the vaporizer device 400o of FIG. 4O. For example, rather than the heater portion 441 of the cartridge including the heating element(s) 442, the heater portion 441 can instead include a container 423 configured to hold the vaporizable material 402. The container 423 can take the form (e.g., material and/or geometry) of any of the heating elements described herein, but is instead configured to receive heat from one or more external heating elements 442 (e.g., external to the cartridge 420, such as within the receptacle 418 or otherwise configured to heat the receptacle 418 itself) and redistribute the heat to the vaporizable material 402, rather than generate heat independently (such as with inductive heating). As illustrated the bottom of the container 423, that forms and/or is proximate the cartridge distal end 420b, can include a plurality of cartridge inlets 425 configured to allow external air to enter the heater chamber within the container 423. As illustrated, the heating elements 442 can heat the container 423 from a direction that is approximately perpendicular to the cartridge 420 length. However, other implementations exist where the heating elements 442 also heat the container 423 from a direction that is approximately parallel to the cartridge 420 length, such as illustrated in the vaporizer device 400p of FIG. 4Q.

The vaporizer devices 400, 400o, 400p can include at least some of the same components of, and otherwise operate in the same or similar manner as, the vaporizer device 400a of FIGS. 4A-4B, except as noted. Separately, the components of vaporizer devices 400, 400o, 400p identified and discussed herein can be combined into any of the other vaporizer devices 400 described with respect to FIGS. 4A-4N, except as noted or where impractical.

In order to control the thermal efficiency of the vaporizer devices described herein, it can be beneficial to provide an air gap between portions of the cartridge 420 and the receptacle 418 into which the cartridge is received, while still keeping the cartridge 420 secure within the receptacle 418. For example, FIGS. 16A and 16B illustrates cross-sectional views of a cartridges 1620 and vaporizer bodies 1610 for use in a vaporizer device. As illustrated, each of the cartridges 1620 include a heating element 1642, and the vaporizer bodies 1610 include airflow inlet(s) 1634, airflow inlet path(s) 1632, ridges 1646, inductors 1643, flux concentrators 1648, and frames 1647, which can be implemented similar to the corresponding components of vaporizer devices 400 of FIGS. 4A-4W. As can be seen by comparison of the temperatures gradients of the heating element 1642 in FIGS. 16A and 16B, having components of the vaporizer body 1610 closer to the heating element 1642 can decrease the thermal efficiency of the system. This is due in part to heat lost into components of the vaporizer body 1610, such as the frame 1647. Accordingly, in some implementations, an air gap can be provided between the heating element 1642 and other components of the vaporizer body 1610, such as an interior perimeter of the receptacle 1618. As shown in FIG. 16B, ridges 1646 can be provided to secure portions of the cartridge 1620 other than the heating element 1642, such as at a mouthpiece portion of the cartridge 1620 and/or an end cap in the heater portion of the cartridge 1620 (which does not contain the heating element 1642). In some implementations, the air gap is defined in part by a distance between the exterior of the cartridge 1620, proximate the heating element 1642, and the interior walls of the receptacle 1618. For example, this length can be between approximately one half and one third the depth of the cartridge 1620.

FIGS. 5A-5J illustrate different schematics and views of various implementations of a holder assembly 558, 558a-d consistent with implementations of the current subject matter. These holders 558, 558a-d can be implementations of one or more components of the vaporizer body 110 of FIGS. 1A-1B, the vaporizer body 210 of FIG. 2, and/or the vaporizer bodies 410 of FIGS. 4A-4W, such as the holder assembly 458.

As illustrated in FIG. 5A, the holder assembly 558, 558a can include a frame 547 defining a receptacle 518 for insertion of a cartridge. The frame 547 can include two long sides and two short sides, similar to the cartridges described herein. For example, the long sides of the frame 547 can be configured to align with the long sides of the cartridge and the short sides of the frame 547 can be configured to align with the short sides of the cartridge when the cartridge is insertably received within the receptacle 518. As disclosed above, a surface of the cartridge (e.g., cartridge 220) extending primarily along the cartridge width can be referred to as a long side of the cartridge and/or as being on a long side of the cartridge, which can align with the long side of the frame 547. Additionally, a surface of the cartridge (e.g., cartridge 220) extending primarily along the cartridge depth can be referred to as a short side of the cartridge and/or as being on a short side of the cartridge 220, which can align with the short side of the frame 547. It will be appreciated that this terminology can be applied to any implementation of a cartridge (including its subcomponents described herein) and frame 547, and this terminology is not redefined with respect to each implementation for the sake of brevity. As illustrated, the frame 547 can include an inductor 543 formed as a spiral coil on a long side of the frame 547. Inductor 543 coils depicted and/or described as spiral coils herein can take the form of parallel or anti-parallel pancake or Helmholtz structures, although other structures are contemplated. The electrical leads 544a that power the inductor 543 can be disposed on a short side of the frame. The electrical leads 544a that power the inductor 543 can be electrically coupled with a controller and/or driving circuit for powering the inductor 543 as described herein. As described herein, the inductor 543 can be configured to generate an electromagnetic field for generating heat in a heating element of the cartridge, which can take the form of a susceptor.

As described herein, it can be desirable to measure an inductance, resistance, and/or impedance of the heating element for use in determining and/or controlling a temperature of the heating element, such as based on a thermal coefficient of resistivity of the heating element. Various circuit can be provided for measuring the inductance, resistance, and/or impedance of the heating element, such as the sensing coil 513. In some implementations, the sensing coil 513 can be disposed in an open center region 562 of the inductor 543 and/or on a long side of the frame 547, such as illustrated in FIG. 5A. In such implementations, the sensing coil 513 can be in the form of a spiral coil. As illustrated, the electrical leads 544b the power the sensing coil 513 can be disposed at the distal end 561 of the frame 547. In some implementations, the illustrated and described sensing coils 513 can be inductors 543 configured to generate an electromagnetic field for generating heat in a heating element (e.g., susceptor) of the cartridge. In accordance with these implementations, one or more (e.g., all) of the inductors 543 can be configured to measure the inductance, resistance, and/or impedance of the heating element as described herein.

In some implementations, the open center region 562 in the middle of the inductor 543 can be increased in size, which can lead to an increased efficiency in delivering energy to the heating element of the cartridge in the receptacle 518. For example, in a circular region defined by a radius that extends from the center of the inductor 543 to the outer-most turn of the inductor 543, the open center region 562 in which turns of the inductor 543 are not present can occupy 20-50% of the surface area of the circular region. In some implementations, the open center region 562 can take up 30-40% of the circular region. In some implementations, having a larger open center region 562 can result in increased efficiency in delivering energy from the inductor 543 into the heating element to be heated via the magnetic or electromagnetic field. In implementations where the illustrated and described sensing coils 513 are additionally or alternatively configured as inductors 543, the collective set of inductors 543 can be configured to heat separate regions of the heating element. For example, a first region of the heating element adjacent the illustrated sensing coils 513 can be heated independently from a second region of the heating element adjacent the illustrated inductors 543. In this manner, greater control over aerosol production over the life of a cartridge can be provided.

As illustrated in FIGS. 5B-5D, the sensing coil 513 can be disposed within a region near a proximal end 560 of the frame 547. The sensing coil 513 can be wrapped around the frame 547 a plurality of times, so that the sensing coil 513 is capable of measuring inductance, resistance, and/or impedance of the heating element. Within this region, the sensing coil 513 can still be disposed in sufficiently close proximity to the heating element of the cartridge, which can be configured to extend up to or proximate the opening of the receptacle 518 when the cartridge is inserted within the receptacle 518. In accordance with these implementations, the inductor 543 can not include an open center region 562. Other locations and/or configurations for the sensing coil 513 are contemplated, as described herein (see e.g., FIG. 5I), including selectively powering one or more of the inductors 543 off to use the inductor 543 as a sensing coil, without the presence of a separate sensing coil 513. Alternatively, the illustrated and described sensing coils 513 can be inductors 543 configured to generate an electromagnetic field for generating heat in a heating element (e.g., susceptor) of the cartridge. In accordance with these implementations, one or more (e.g., all) of the inductors 543 can be configured to measure the inductance, resistance, and/or impedance of the heating element as described herein.

As illustrated in FIG. 5C, a long side of the frame 547 can include a plurality of inductors 543a-d, which can be in the form of spiral coils, and each have their own, independent sets of electrical leads 544a-d that can be coupled to a controller and/or driving circuit. As described herein, each of the plurality of inductors 543a-d can be powered off and on independently, such that different regions of a heating element can be selectively heated. For example, all of the inductors 543a-d can be powered at the same time and with the same amount of power, all or some of the inductors 543a-d can be powered at the same time and but with differing amounts of power, and/or only a portion of the inductors 543a-d can be powered at the same time and with the same or different amounts of power.

Although one set of four inductors 543a-d are illustrated and an additional set of inductors on the opposing long side are described, other numbers of inductors 534 are contemplated. For example, sets of two inductors 543 on each of the opposing long sides are contemplated, which can be spaced apart from each other along the longitudinal dimension or transverse to the longitudinal dimension. Separately, sets of three, five, six, or more inductors 543 are contemplated, and it is not required that the same number of inductors 543 be implemented on each of the long sides. Other implementations exist in which the inductor(s) 543 do not take the shape of a spiral coil, such as the inductor 543 of FIG. 5D, wrapped around the short and long sides of the frame 547 multiple times. In some implementations, a plurality of inductors 543 can be disposed in series along the frame 547 (e.g., between the proximal end 560 and the distal end 561 of the frame 547), such as two, three, or more inductors 543. For example, the plurality of inductors 543 can be formed as solenoid coils, with a space along the frame 547 between each inductor 543.

In some implementations, the long and short side of the frame 547 that are shown can be the same or similar to the long and/or short side of the frame 547 that are not shown. For example, the long side of the frame 547 that is not shown in FIGS. 5A and 5B can also include an inductor 543, such that the receptacle 518 is between two opposing inductors 543. Such a configuration can provide benefits, such as by heating a wider surface area of the heating element, into which it is easier to generate eddy currents using less energy. The long side of the frame 547 that is not shown in FIG. 5C can similarly also include a plurality of inductors 543, such that more control can be provided over how and where heat is generated.

In some implementations, the various configurations and positions of the illustrated and described inductors 543 and/or sensing coils 513 (additionally or alternatively configured as inductors) of FIGS. 5A-5D can be at least partially combined. For example, in some implementations, the illustrated inductor 543 of FIG. 5B can be substituted with the illustrated inductor 543 and sensing coil 513 of FIG. 5A (on both opposing long sides of the frame 547). Additionally or alternatively, the illustrated sensing coil 513 in FIG. 5B can be implemented at each of the proximal end and the distal end of the frame 547 (and each be implemented as sensing coils and/or inductors). Accordingly, separate regions of the heating element adjacent the illustrated inductors 543 and/or sensing coils 513 can be heated independently to provide greater control over aerosol production, as described herein. It will be appreciated that the ability to heat the heating element in as many independent regions is desirable, but that the implementation of more inductors 543 and/or sensing coils 513 is more expensive and more complicated (e.g., in order to properly account for mutual inductance).

In various implementations, the shape and/or structure of the inductors 543 can be varied to increase and/or tune their efficiency, such as based on their coupling efficiency with a heating element of a cartridge in the receptacle 518. For example, one or more of the inductors 543 can include varying numbers of cross-sections, shapes, strand counts, strand gauges, and/or the like of coils. The coils could also be bent to have the same general curvature as the heating element to improve performance, or could be straightened (e.g., along the cartridge width) to limit the coupling efficiency to a specific degree. In some implementations, a flex coil can be used to decrease manufacturing costs of the device and the consumables, such as by only requiring a relatively thin aluminum layer.

In some implementations, a cartridge for use with a holder assembly 558 that includes multiple inductors 543 can include regions with different susceptibilities. For example, a cartridge can be manufactured to include different materials and/or thicknesses in certain regions depending on each region's intended proximity to an inductor 543. In some implementations, a cartridge can be manufactured to include a first material and/or material of a first thickness in a first region (or set of first regions) that is disposed at or near a first inductor 543 (or set of first inductors 543), and a second material and/or material of a second thickness in a second region (or set of second regions) that is disposed away from the first inductor 543 (or set of first inductors 543). In some implementations, if multiple inductors 543 are used, the regions of the cartridge that are between the set of first regions can include the second region(s).

As illustrated in FIG. 5E, the heating element 542 that forms part of the cartridge containing vaporizable material can be sized and configured to fit within the receptacle 518 of the holder assembly 558e. As described herein, the heating element 542 can be configured as a susceptor to be electromagnetically coupled with one or more inductor coils. Within the receptacle 518, there can be a plurality of ridges 546 configured to retain the cartridge, and thereby the heating element 542 within the receptacle 518. The holder assembly 558e can include a ledge 590 that at least partially defines an opening into the receptacle 518. The ledge 590 can include features, such as a chamfered edge, that facilitate placement of the cartridge into the receptacle 518. When the holder assembly 558e is within a fully assembled vaporizer body 110, 210, 410, 1610, the ledge 590 of the holder assembly 558e can form at least a portion of a proximal end of the vaporizer body 110, 210, 410, 1610 (e.g., ledge 121, 221) or the ledge 590 of the holder assembly 558e can be recessed from the proximal end of the vaporizer body 110, 210, 410, 1610.

As illustrated, in FIGS. 5E-5G, taken along cross-section B-B of FIG. 5F, the holder assembly 558e can include a pair of inductors 543a, 543b on the long sides of the frame 547, each with a corresponding flux concentrator 548a, 548b disposed against the exterior face of the inductors 543. That is, each of the pair of inductors 543a, 543b can be disposed (e.g., sandwiched) between a corresponding flux concentrator 548a, 548b and long sides of the frame 547. As described herein, each of the flux concentrators 548 can be configured to direct the electromagnetic fields generated by each of the inductors 543, towards the one or more heating elements 542 when it is disposed within the receptacle, to generate heat in a more concentrated manner. That is, the electromagnetic fields generated by each of the inductors 543 that would otherwise be directed outside of the direction of the receptacle 518 can instead be directed towards the receptacle 518, further optimizing the heating process and/or requiring less energy to operate.

For example, as illustrated in FIG. 5H, the plurality of ridges 546 can be disposed around an inner perimeter of the receptacle 518. As illustrated in FIGS. 5I and 5J, taken along cross-section C-C of FIG. 5H, the ridges 546 can take different forms. For example, as illustrated in FIG. 5I, one or more of the ridges 546 can take the form of a bar that extends along a longitudinal dimension of the receptacle 518, such as between a proximal end and a distal end of the receptacle 518. In some implementations, a sensing circuit 513 can be included on a surface of at least one of the ridges 546. Such a sensing circuit 513 can be configured to physically contact the heating element 542 to measure the resistance of the heating element 542 at any point in time. As illustrated in FIG. 5J, one or more of the ridges 546 can be separated into two portions, such as a portion that is proximate the distal end and another portion that is proximate the proximal end of the receptacle. To minimize potentially damaging the cartridge and/or heating element 542, the ridges 546 can include angled surfaces that better guide the cartridge into the receptacle 518. In some implementations, the different forms of the ridges 546 discussed with respect to FIGS. 5I-5J can each be implemented within the same receptacle.

Other configurations of the inductors 543 and holder assembly 558 are contemplated, such as the inductors and/or holder assemblies illustrated in FIGS. 11A-11Q, 12A-12E, and 13A-13G. For example, FIGS. 11A-11C illustrate perspective views of a cartridge 1120 and various configurations of inductors 1143a, 1143b (collectively referred to as inductor(s) 1143) for use in a vaporizer device, consistent with implementations of the current subject matter. As illustrated in FIG. 11A, a center of each inductor 1143a, 1143b can be configured to be disposed at or near separate, respective short sides of the cartridge 1120 when the cartridge 1120 is inserted and/or each inductor 1143a, 1143b can take the shape of a c-shaped or oblong coil. A c-shaped coil can refer to an inductor 1143a, 1143b with two opposing ends that are in the shape of the letter “C”, and approximately parallel edges between the opposing ends. An oblong coil can refer to an inductor 1143a, 1143b having a generally rectangular shape with two opposing ends that are rounded. The opposing ends of each inductor 1143a, 1143b can be defined by a location of the outer-most turn of a wire defining the inductor 1143a, 1143b. The center of each inductor 1143a, 1143b can be regarded as a point or line that is central to the length, width, and/or depth of the inductor 1143a, 1143b, such as from the perspective of the inductor 1143a, 1143b when it is flattened. The center of each inductor 1143a, 1143b can be configured to be disposed proximate a center of the heating element 1142 of the cartridge 1120 on each short side of the heating element 1142 (e.g., central point or cross-section along the length of the heating element 1142), when the cartridge 1120 is inserted. The inductors 1143a, 1143b can form part of a holder assembly 1158a which defines a receptacle (not shown) configured to receive the cartridge 1120, with the heating element 1142 disposed substantially within the receptacle when the cartridge 1120 is inserted.

As illustrated in FIG. 11B, a center of each inductor 1143a, 1143b can instead be configured to be disposed at or near separate, respective long sides of the cartridge 1120 when the cartridge 1120 is inserted and/or each inductor 1143a, 1143b can take the shape of a flattened circular, oval, c-shaped or oblong coil. The center of each inductor 1143a, 1143b can be configured to be disposed proximate a center of the heating element 1142 of the cartridge 1120 on each long side of the heating element 1142 (e.g., central point or cross-section along the length of the heating element 1142), when the cartridge 1120 is inserted. The inductors 1143a, 1143b can form part of a holder assembly 1158b which defines a receptacle (not shown) configured to receive the cartridge 1120, with the heating element 1142 disposed substantially within the receptacle when the cartridge 1120 is inserted.

As illustrated in FIG. 11C, a center of each inductor 1143a, 1143b can instead be configured to be disposed at or near the same short side of the cartridge 1120 when the cartridge 1120 is inserted and/or each inductor 1143a, 1143b can take the shape of a c-shaped or oblong coil. The center of each inductor 1143a, 1143b can be configured to be disposed away from a center of the heating element 1142 of the cartridge 1120 on the short side of the heating element 1142 (e.g., central point or cross-section along the length of the heating element 1142), when the cartridge 1120 is inserted. For example, the heating element 1142 can be regarded as having two sections, divided by a cross-section along the length of the heating element 1142 (e.g., with the cross-section central to the length of the heating element 1142), with a top section that is closer to the mouthpiece of the cartridge 1120 and/or higher along the length when the cartridge 1120 is placed on a flat surface with the heating element 1142 proximate the flat surface, and a bottom section that is further from the mouthpiece of the cartridge 1120 and/or lower along the length when the cartridge 1120 is placed on a flat surface with the heating element 1142 proximate the flat surface. Accordingly, the center of the first inductor 1143a can be configured to be disposed proximate a center of the top section of the heating element 1142 on the short side of the heating element 1142 (e.g., central point or cross-section along the length of the top section of the heating element 1142) and the center of the second inductor 1143b can be configured to be disposed proximate a center of the bottom section of the heating element 1142 on the short side of the heating element 1142 (e.g., central point or cross-section along the length of the bottom section of the heating element 1142), when the cartridge 1120 is inserted. The inductors 1143a, 1143b can form part of a holder assembly 1158c which defines a receptacle (not shown) configured to receive the cartridge 1120, with the heating element 1142 disposed substantially within the receptacle when the cartridge 1120 is inserted. In alternative implementations, the inductors 1143a, 1143b can instead be configured to be disposed proximate centers of the top section and the bottom section of the heating element 1142 on the long side of the heating element 1142 (e.g., central point or cross-section along the respective lengths of each of the top section and the bottom section of the heating element 1142), when the cartridge 1120 is inserted.

As described herein with respect to at least FIGS. 12A-12E and 13A-13G, more or less inductors 1143a, 1143b can be present and/or be positioned in different locations relative to the locations illustrated in FIGS. 11A-11C. Although not illustrated, one or more flux concentrators can be configured to direct the electromagnetic field of each of the inductors 1143a, 1143b in a direction of the heating element 1142, similar to flux concentrators 448, 548 described herein.

FIGS. 11D-11I illustrate perspective views of additional various configurations of inductors 1143 for use in a vaporizer device, consistent with implementations of the current subject matter. As illustrated in FIG. 11D, a center of each of two inductors 1143a, 1143b can be configured to be disposed at or near separate, respective short sides of the heating element 1142 of a cartridge when the heating element 1142 is inserted into a receptacle of a holder assembly 1158d. The center of each inductor 1143a, 1143b can be regarded as a point or line that is central to the length, width, and/or depth of the inductor 1143a, 1143b, such as from the perspective of the inductor 1143a, 1143b when it is flattened. Each inductor 1143a, 1143b can optionally take the shape of a c-shaped or oblong coil. The center of each inductor 1143a, 1143b can be configured to be disposed proximate a center of the heating element 1142 on each short side of the heating element 1142 (e.g., central point or cross-section along the length of the heating element 1142), when the heating element 1142 is inserted into the holder assembly 1158d.

As illustrated, each of the inductors 1143a, 1143b can include an open center region 1162 in a center of the respective inductor 1143a, 1143b. In some implementations, the open center regions 1162 in the centers of the inductors 1143a, 1143b can provide an increased efficiency in delivering energy to the heating element 1142. For example, the open center regions 1162 can occupy a region that is 15-50% or 20-40% of the total surface area of the inductors 1143a, 1143b, with the total surface area of the inductors 1143a, 1143b being defined by the area bounded by the outer-most turns of the wire defining the inductor 1143a, 1143b and inclusive of the area of the open center regions 1162. In some implementations, having a larger open center region 1162 can result in increased efficiency in delivering energy from the inductors 1143a, 1143b into the heating element 1142. The size and shape of the open center region 1162 can be dependent on the size and shape of the respective inductor 1143a, 1143b. For example, the open center region 1162 can be c-shaped or oblong based on the inductors 1143a, 1143b being c-shaped or oblong.

As illustrated, one or more flux concentrators 1148 can be disposed proximate and exterior to the inductors 1143a, 1143b (e.g., between the inductors 1143a, 1143b and an external shell of the vaporizer body that includes the inductors 1143a, 1143b and one or more flux concentrators 1148). The one or more flux concentrators can be configured to direct the electromagnetic field of each of the inductors 1143a, 1143b in a direction of the heating element 1142, similar to flux concentrators 448, 548 described herein. As illustrated, a separate flux concentrator 1148 can be disposed proximate each respective inductor 1143a, 1143b and separated by a gap between the flux concentrators 1148 that is proximate the long side of the holder assembly 1158d. However, in some implementations a single flux concentrator 1148 can be disposed substantially around a perimeter of the holder assembly 1158d. The holder assembly 1158d can include or be in close proximity to the inductors 1143a, 1143b and the flux concentrator(s) 1148. The holder assembly 1158d can define a receptacle (not shown) configured to receive the heating element 1142.

As illustrated, the first inductor 1143a can be electrically coupled to first electrical leads 1144a that are configured to power the first inductor 1143a and the second inductor 1143b can be electrically coupled to second electrical leads 1144b that are configured to power the second inductor 1143b. The electrical leads 1144a, 1144b can be electrically coupled with a controller and/or driving circuit for powering the respective inductors 1143a, 1143b as described herein.

As illustrated, in FIG. 11E, the first inductor 1143a described with respect to FIG. 11D can be replaced with first inductor 1143a and third inductor 1143c, and the second inductor 1143b described with respect to FIG. 11D can be replaced with second inductor 1143b and fourth inductor 1143d. The inductors 1143a-1143d (collectively referred to as inductor(s) 1143) can be disposed on, within, or proximate holder assembly 1158e. Each of the inductors 1143a-1143d can respectively be electrically coupled to their own electrical leads 1144a-1144d. If two flux concentrators 1148 are included, then a first flux concentrator 1148 can be disposed proximate and exterior to the first and third inductors 1143a, 1143c, and a second flux concentrator 1148 can be disposed proximate and exterior to the second and fourth inductors 1143b, 1143d. Implementations of FIG. 11E can otherwise be the same or similar to the implementations described with respect to FIG. 11D.

As illustrated, in FIG. 11F, the center of each of the two inductors 1143a, 1143b described with respect to FIG. 11D can instead be configured to be disposed at or near separate, respective long sides of the heating element 1142 of a cartridge (not illustrated) when the heating element 1142 is inserted into a receptacle of a holder assembly 1158f. Implementations of FIG. 11F can otherwise be the same or similar to the implementations described with respect to FIG. 11D.

As illustrated, in FIG. 11G, the first inductor 1143a described with respect to FIG. 11F can be replaced with first inductor 1143a and third inductor 1143c, and the second inductor 1143b described with respect to FIG. 11F can be replaced with second inductor 1143b and fourth inductor 1143d. The inductors 1143a-1143d can be disposed on, within, or proximate holder assembly 1158g. Each of the inductors 1143a-1143d can be respectively electrically coupled to their own electrical leads 1144a-1144d. If two flux concentrators 1148 are included, then a first flux concentrator 1148 can be disposed proximate and exterior to the first and third inductors 1143a, 1143c, and a second flux concentrator 1148 can be disposed proximate and exterior to the second and fourth inductors 1143b, 1143d. Implementations of FIG. 11G can otherwise be the same or similar to the implementations described with respect to FIG. 11F (and thereby, FIG. 11D).

As illustrated, in FIG. 11H, the heating element 1142 and its respective cartridge can be formed to have a cylindrical shape (along the cartridge length). As such, the heating element 1142 can not be considered as having long sides and short sides. Accordingly, three inductors 1143a, 1143b, 1143c can be configured to be disposed at or near a perimeter of the heating element 1142 of the cartridge when the heating element 1142 is inserted into a receptacle of a holder assembly 1158h. In some implementations, each of the three inductors 1143a, 1143b, 1143c are equally spaced apart from each other, around a perimeter of the holder assembly 1158h. Each of the inductors 1143a-1143c can be respectively electrically coupled to their own electrical leads 1144a-1144c. Three flux concentrators 1148 can be included, with each flux concentrator 1148 disposed proximate and exterior to a respective inductor 1143a, 1143b, 1143c. In some implementations, other numbers of inductors 1143 can be present, such as two inductors 1143, three inductors 1143, four inductors 1143, six inductors 1143, or the single inductor 1143 illustrated in FIG. 11I. Implementations of FIGS. 11H and 11I can otherwise be the same or similar to the implementations described with respect to FIG. 11D.

In operation, each of the inductors 1143a-1143d can be configured to generate an electromagnetic field to heat the heating element 1142, derive characteristics about the heating element 1142, and/or operate similar to the inductors 443, 543, 943 described herein. It will be appreciated that the cartridge 1120 is intended to be inserted by a user and can be manufactured to have different geometries within a tolerable range of geometries. Accordingly, with each use of a cartridge 1120, the heating elements 1142 thereof can be placed in slightly different locations relative to the inductors 1143a, 1143b. As such, the use of terms like “center” can be regarded as covering use-case scenarios within a tolerable range, such as within 1%, within 2%, within 3%, within 5%, or within 10% of the defined “center.”

FIGS. 11J-11N illustrate various views of additional configurations of inductors 1143 for use in a vaporizer device, consistent with implementations of the current subject matter. As illustrated in FIG. 11J-11N, a vaporizer body 1110 or portion thereof (e.g., illustrated as holder assembly 1158j) can include two or more sets of inductors 1143 with one or more inductor 1143 extending in a plane that is parallel to the longitudinal axis of the vaporizer body 1110 and one or more inductor 1143 extending in a plane that is perpendicular to the longitudinal axis of the vaporizer body 1110. The vaporizer body 1110 can be similar to the vaporizer bodies 110, 210, 410, 1610 described herein, except where noted or impractical. As illustrated in FIGS. 11J-11K, a first inductor 1143a and a second inductor 1143b can extend in a plane that is parallel to the longitudinal axis of the holder assembly 1158j and a third inductor 1143c can extend in a plane that is perpendicular to the longitudinal axis of the holder assembly 1158j. Although the first inductor 1143a and second inductor 1143b are illustrated as being disposed closer to the proximal end of the holder assembly 1158j and the third inductor 1143c is illustrated as being disposed closer to the distal end of the holder assembly 1158j, in some implementations the first inductor 1143a and second inductor 1143b can be disposed closer to the distal end of the holder assembly 1158j and the third inductor 1143c can be disposed closer to the proximal end of the holder assembly 1158j.

The first inductor 1143a can be electrically coupled to first electrical leads 1144a that are configured to power the first inductor 1143a, the second inductor 1143b can be electrically coupled to second electrical leads 1144b that are configured to power the second inductor 1143b, and the third inductor 1143c can be electrically coupled to third electrical leads 1144c that are configured to power the third inductor 1143b. The electrical leads 1144a, 1144b, 1144c can be electrically coupled with a controller and/or driving circuit for powering the respective inductors 1143a, 1143b, 1143c as described herein.

The holder assembly 1158j can include a frame 1147 configured to hold each of the inductors 1143a, 1143b, 1143c and their associated electrical leads 1144a, 1144b, 1144c in place. The holder assembly 1158j can include a ledge 1190 that at least partially defines an opening into the receptacle 1118 (illustrated in the cross-sections of FIGS. 11M-11N). The ledge 1190 can include features, such as a chamfered edge, that facilitate placement of the cartridge into the receptacle 1118. When the holder assembly 1158e is within a fully assembled vaporizer body 1110 (illustrated transparently in FIG. 11N), the ledge 1190 of the holder assembly 1158j can form at least a portion of a proximal end of the vaporizer body 1110 or the ledge 1190 of the holder assembly 1158j can be recessed from the proximal end of the vaporizer body 1110. When the cartridge 1120 is inserted into the cartridge receptacle 1118, one or more bypass air inlets 1129 of the cartridge 1120 can be disposed proximate the ledge 1190. For example, in some implementations the bypass air inlet(s) 1129 can be configured to be disposed within or proximate a cross-sectional plane that is perpendicular to the vaporizer body 1110 and at the proximal edge of the ledge 1190.

As illustrated, the first inductor 1143a can include an open center region 1162a in a center of the first inductor 1143a and the second inductor 1143b can include an open center region 1162b in a center of the second inductor 1143b. A sensor 1113a can be disposed at least partially within one or both of the open center regions 1162a, 1162b of the first inductor 1143a and the second inductor 1143b. In some implementations, the sensor 1113a can include a temperature sensor or sensors, such as a thermistor, a PTC circuit such as a PTC thermistor, an NTC circuit such as an NTC thermistor, a thermocouple, and/or the like. The sensor 1113a can be disposed and configured to measure the temperature of the nearby inductor 1143a, 1143b, a heating element of the cartridge 1120, and/or some other component of the vaporizer body 1110 or the cartridge 1120.

A center of each of the first inductor 1143a and the second inductor 1143b can be configured to be disposed at or near separate, respective long sides of the vaporizer body 1110, long sides of the frame 1147, and/or long sides of the cartridge 1120 when the cartridge 1120 is inserted into the receptacle 1118. The center of each inductor 1143a, 1143b can be regarded as a point, line, area, or volume that is central to the length, width, and/or depth of the inductor 1143a, 1143b, such as from the perspective of the inductor 1143a, 1143b when it is flattened. Although illustrated as generally circular or oval coils (e.g., rectangular coils with rounded edges), each of the first inductor 1143a and the second inductor 1143b can optionally take another shape, as described herein. The third inductor 1143c can be configured as a helical coil that is wrapped around the frame 1147. Accordingly, a center of the third inductor 1143c can be disposed within the cartridge receptacle 1118. The center of the third inductor 1143c can be regarded as a point, line, area, or volume that is central to the length, width, and/or depth of the third inductor 1143c. In some implementations, the third inductor 1143c can be formed in a shape that is substantially the same as the frame 1147 along a cross-section that is perpendicular to the longitudinal axis of the frame 1147, holder assembly 1158j, and/or vaporizer body 1110. Although illustrated and described as a singular coil, the third inductor 1143c can be formed of two or more helical coils.

The length of each of the inductors 1143a, 1143b, 1143c can be regarded as the distance between opposing ends of the inductor 1143 along an axis that is parallel to the longitudinal axis of the frame 1147, holder assembly 1158j, and/or vaporizer body 1110. The width of each of the inductors 1143a, 1143b, 1143c can be regarded as the distance between opposing ends of the inductor 1143 along an axis that is parallel to the long sides of the frame 1147, holder assembly 1158j, and/or vaporizer body 1110. The depth of each of the inductors 1143a, 1143b, 1143c can be regarded as the distance between opposing ends of the inductor 1143 along an axis that is parallel to the short sides of the frame 1147, holder assembly 1158j, and/or vaporizer body 1110. As illustrated, the length of each of the first inductor 1143a and the second inductor 1143b can be in a ratio compared to the length of the third inductor 1143c that is approximately 7:3. However, in some implementations the ratio can be approximately 3:2, approximately 1:1, and/or the like.

As illustrated in FIG. 11L, one or more flux concentrators 1148 can be disposed proximate and exterior to the inductors 1143a, 1143b, 1143c (e.g., between the inductors 1143a, 1143b, 1143c and an external shell of the vaporizer body 1110). For example, a first flux concentrator 1148 can be disposed around the first inductor 1143a and the second inductor 1143b, and a second flux concentrator 1148 can be disposed around the third inductor 1143c. Each of the first and second flux concentrators can be disposed substantially around a perimeter of the holder assembly 1158j and can optionally include a break or space in its perimeter (e.g., a space between adjacent ends of the flux concentrators 1148). Although illustrated and described as separate flux concentrators 1148, a singular flux concentrator 1148 can be disposed around all of the inductors 1143a, 1143b, 1143c. Although each flux concentrator 1148 is illustrated and described as a unitary shape, one or more (e.g., all) of the flux concentrators 1148 can be formed of multiple segments of material (e.g., nanometal). The one or more flux concentrators 1148 can be configured to direct the electromagnetic field of each of the inductors 1143a, 1143b, 1143c in a direction of the heating element 1142, as described herein.

As illustrated in FIG. 11M, the holder assembly 1158j (e.g., the frame 1147) can include one or more ridges 1146 configured to hold the cartridge 1120 within the receptacle 1118. The ridges 1146 can extend from one or more interior surfaces of the cartridge receptacle 1118 to contact the cartridge 1120 and hold the cartridge 1120 in place via a friction fit, similar to the ridges 446, 546, 1646 of FIGS. 4A-4W, FIGS. 5E-5J, and FIGS. 16A-16B. As illustrated, the ridges 1146 can include a first set of ridges 1146a proximate the proximal end of the frame 1147 and a second set of ridges 1146b proximate the distal end of the frame 1147.

The first set of ridges 1146a can be configured to leave open a space (e.g., form a space between adjacent ridges 1146) for air to enter the receptacle 1118 when the cartridge 1120 is inserted, forming one or more airflow inlets 1134. The one or more airflow inlets 1134 can be similar to the airflow inlets 434 of FIGS. 4A-4W. In some implementations, the first set of ridges 1146a can include a singular ridge that extends around a majority of an interior perimeter of the receptacle 1118. The open space can be proximate the one or more bypass air inlets 1129 of the cartridge when the cartridge 1120 is inserted. To allow the cartridge 1120 to be reversibly inserted, the first set of ridges 1146a can include two or more ridges that extends around a portion of the interior perimeter of the receptacle 1118, with a space formed near each of the opposing long sides of the receptacle 1118.

The second set of ridges 1146b can be configured to leave open a space (e.g., form a space between adjacent ridges 1146) for air to enter the distal end of the cartridge 1120 when the cartridge 1120 is inserted. However, as illustrated in FIGS. 11M-11N, in some implementations the second set of ridges 1146b can be disposed to prevent airflow between the second set of ridges 1146b and the cartridge 1120. Instead, airflow can be directed away from the cartridge 1120, into an airflow sensor path 1189. Within the airflow sensor path 1189, one or more second sensors 1113b can be disposed and configured to measure one or more properties of the air passing through the airflow sensor path 1189. In some implementations, the one or more second sensors 1113b can include one or more pressure sensors configured to measure the pressure at one or more locations along the airflow sensor path 1189.

An airflow inlet path 1132 can be formed at least partially between the first set of ridges 1146a and the second set of ridges 1146b, between an exterior surface of the cartridge 1120 and an internal surface of the receptacle 1118. For example, the airflow inlet path 1132 can include the one or more airflow inlets 1134, extend between the first set of ridges 1146a and the second set of ridges 1146b, and continue to the distal end of the cartridge 1120 where air can enter the cartridge 1120. Upon reaching the second set of ridges 1146b and prior to entering the distal end of the cartridge 1120, air can optionally flow through the airflow sensor path 1189 and towards the distal end of the receptacle 1118, which can be spaced apart from the distal end of the cartridge 1120 to prevent the cartridge 1120 from blocking the airflow inlet path 1132.

Providing the first inductor 1143a and the second inductor 1143b (which can have substantially the same shape) with different shapes, with different configurations, in a different location, and/or in a different orientation compared with the third inductor 1143c can provide advantages that allow for efficiently heating different heating elements 1142 or different regions of the same heating element 1142. For example, as illustrated the first inductor 1143a and the second inductor 1143b can be generally rectangular coils (e.g., with rounded edges) oriented parallel to the longitudinal axis of the frame 1147 and facing each other, while the third inductor 1143c can be a generally helical coil oriented perpendicular to the longitudinal axis of the frame 1147. With this configuration, the first inductor 1143a and the second inductor 1143b can generate electromagnetic field(s) that are orthogonal to the electromagnetic field generated by the third inductor 1143c. When the electromagnetic field generated by an inductor 1143 is orthogonal to the orientation of a nearby inductor 1143, mutual inductance is reduced such that nearby inductors 1143 can be selectively operated more efficiently. For example, if the first inductor 1143a or the second inductor 1143b were to generate an electromagnetic field that induces current within the third inductor 1143c while the third inductor 1143c is not actively powered, the coupling efficiency of the first inductor 1143a or the second inductor 1143b to the heating element 1142 is reduced.

As described herein, the inductors 1143 can be selectively powered to heat different regions of the heating element 1142. For example, a first region of the heating element 1142 can be actively heated by one or more inductors 1143 while a second region of the heating element 1142 is not actively heated by an inductor 1143. In some implementations, the different regions of the heating element 1142 can be defined relative to their position with respect to the inductors 1143 adjacent the heating element 1142 when the cartridge 1120 is inserted. For example, a first region of the heating element 1142 can be disposed within a first volume formed within the interior of the third inductor 1143c and a second region of the heating element 1142 can be disposed within a second volume formed between the first inductor 1143a and the second inductor 1143b. In operation, current can flow through a region of the heating element 1142 that is outside of the defined volume, such as along a perimeter of the heating element 1142. For example, when current is induced at opposing long sides of the heating element 1142, current can flow across the intermediate short sides of the heating element 1142 such that a larger surface area and/or volume of the underlying vaporizable material 1102 is exposed to heat and vaporized.

In some implementations, a humectant (e.g., vegetable glycerin) within the vaporizable material 1102 can have a higher boiling point than an active ingredient (e.g., nicotine) within the vaporizable material 1102. In order to deliver a more uniform amount of active ingredient over the course of a session (e.g., 10 to 20 user puffs of a cartridge 1120), different temperatures can be applied to different regions of the heating element 1142 (and thereby different regions of the vaporizable material 1102) at different times during the course of a session.

For example, control algorithms can be implemented that selectively power a first set of inductors 1143 (e.g., the third inductor 1143c) and a second set of inductors 1143 (e.g., the first inductor 1143a and the second inductor 1143b). Such control algorithms can be configured to selectively power the first set of inductors 1143 and the second set of inductors 1143, and thereby the heating element 1142, at different times, temperatures, frequencies, and/or the like. In some implementations, during a first time period the first set of inductors 1143 are powered according to a first set of parameters such that the first region of the heating element 1142 is heated at a first temperature and the second set of inductors 1143 are not powered (e.g., the second region of the heating element 1142 remains at an ambient temperature). The first temperature can be sufficient to vaporize both the humectant and the active ingredient, such as at or above the boiling point of the humectant. During this first time period, both the humectant and the active ingredient can be vaporized within the first region of the heating element 1142 while the humectant and the active ingredient within the second region of the heating element 1142 are not vaporized. It will be appreciated that the proximity of the regions of the heating element 1142 are close enough that an incidental amount of vaporized material is produced within the second region of the heating element 1142 at this time, but the incidental amount is relatively small compared to the vaporized material produced within the first region of the heating element 1142 (e.g., less than 15% by weight of the total vapor produced).

At a subsequent, second time period the first set of inductors 1143 are powered according to a second set of parameters such that the first region of the heating element 1142 is heated at a second temperature and the second set of inductors 1143 are powered according to a third set of parameters such that the second region of the heating element 1142 is heated at a third temperature. The second temperature can be the same or higher than the first temperature, sufficient to vaporize the humectant. The third temperature can be lower than the first temperature, sufficient to vaporize the active ingredient but not sufficient to vaporize the humectant. During this second time period, the primary source of the active ingredient in the vapor can come from within the second region of the heating element 1142 while the primary source of the humectant in the vapor can come from within the first region of the heating element 1142.

Optionally, at a subsequent, third time period the first set of inductors 1143 are powered according to a fourth set of parameters such that the first region of the heating element 1142 is heated at a fourth temperature and the second set of inductors 1143 are powered according to a fifth set of parameters such that the second region of the heating element 1142 is heated at a fifth temperature. The fourth temperature can be the same or lower than the first temperature and/or the second temperature, and can not be sufficient to vaporize the humectant. Instead, the fourth temperature can be sufficient to heat the first region of the heating element 1142 such that vapor generated within the second region of the heating element 1142 is not inhibited from flowing through the first region of the heating element 1142. The fifth temperature can be approximately the same as the first temperature or the second temperature.

In some implementations, the first set of inductors 1143 and the second set of inductors 1143 can both be powered during an initial pre-heating mode to a pre-heating temperature, after which the first and subsequent time periods are implemented. In some implementations, the pre-heating temperature is lower than the first temperature, lower than the second temperature, lower than the third temperature, lower than the fourth temperature, and/or lower than the fifth temperature. In related implementations, the second set of inductors 1143 is powered according to a set of pre-heating parameters such that the second region of the heating element 1142 is heated to the pre-heating temperature during the first time period.

In some implementations, the applied temperatures at each section of the heating element 1142 between each successive periods can include a transition period. For example, each of the pre-heating temperature, the first temperature, the second temperature, the third temperature, the fourth temperature, and/or the fifth temperature can be implemented as maximum temperatures, and the control algorithm can be configured to begin gradually increasing or decreasing the temperature of the heating element 1142 at the start of each time period. For example, the control algorithm can be configured to increase or decrease the current temperature of the heating element 1142 to the new temperature over the course of the transition period (e.g., 5 seconds, 10 seconds, and/or the like).

In operation, the direction of current through the first inductor 1143a (e.g., clockwise) can be the opposite of the direction of current through the second inductor 1143b (e.g., counter-clockwise). When the first inductor 1143a and the second inductor 1143b induce current into the heating element 1142 in this manner, current can be directed within the heating element 1142 (e.g., within the second region) in a more uniform manner, such as by providing a more complete path around the perimeter of the heating element 1142. Although generally illustrated and described as a singular coil, in some implementations the third inductor 1143c can be formed of two or more helical coils (see e.g., the third inductor 1143c and the fourth inductor 1143d of FIG. 11O). In accordance with these implementations, the direction of current through one of the third inductors 1143c (e.g., clockwise) can be the opposite of the direction of current through another of the third inductors 1143c (e.g., counter-clockwise). Although two sets of inductors 1143 and two regions for heating the heating element 1142 are illustrated and described, more or less regions can be implemented, as described herein. For example, a third region of the heating element 1142 can be provided proximate the distal end of the heating element 1142 and/or the cartridge 1120, with each of the third, second, and first regions of the heating element 1142 sequentially disposed between the distal end of the heating element 1142 and the proximal end of the heating element 1142. A third set of inductors 1143 can be included in a location that is proximate the third region of the heating element 1142 when the cartridge 1120 is inserted. In some implementations, the third set of inductors 1143 includes one or more helical coils, similar to the one or more helical coils of the first set of inductors 1143 (e.g., the third inductor 1143c and/or the fourth inductor 1143d of FIGS. 11J-11O). If the third set of inductors 1143 includes one or more inductors that are configured to generate an electromagnetic field with different characteristics (e.g., orthogonal) to the electromagnetic field generated by the adjacent second set of inductors 1143, greater control of heating the heating element 1142 in different regions and/or at different temperatures can be provided, as described herein.

The coupling efficiency between the inductors 1143 and the heating element 1142 can also be improved if the heating element 1142 has a structure that compliments the shapes, configurations, locations, and/or orientations of the inductors 1143. For example, as illustrated in FIG. 11N, the heating element 1142 can include a top region 1159a that is configured to be disposed proximate the third inductor 1143c when the cartridge 1120 is inserted and a bottom region 1159b that is configured to be disposed proximate the first inductor 1143a and the second inductor 1143b when the cartridge 1120 is inserted. One or more regions 1159c can be removed (e.g., cut out) between the top region 1159a and the bottom region 1159b. When the cartridge 1120 is inserted, the removed region(s) 1159c can be disposed off-axis from all of the inductors 1143a, 1143b, 1143c. For example, the removed region(s) 1159c can be disposed outside of a top volume (e.g., first volume) formed within the interior of the third inductor 1143c, and also disposed outside of a bottom volume (e.g., second volume) formed between the first inductor 1143a and the second inductor 1143b. The heating element 1142 can be similar to the heating element 1542i of FIG. 15I and/or the cartridge 1120 can be similar to any of the cartridges 420, 620a-m of FIGS. 4A-4W and 6A-6N. As described with respect to FIG. 15I, the one or more removed regions 1159 can enable the current passing within the top region 1159a of the heating element 1142 to remain (at least primarily) within the top region 1159a and the current passing within the bottom region 1159b of the heating element 1142 to remain (at least primarily) within the bottom region 1159b. Alternatively, the heating element 1542j of FIG. 15J can be implemented, with the orientation of the top and bottom regions 1159 as described (e.g., as illustrated or reversed).

In some implementations, the center of each of the first inductor 1143a and the second inductor 1143b can be configured to be disposed proximate a center of the bottom region 1159b of the heating element 1142, on each short side of the heating element 1142 (e.g., central point or cross-section along the length of the bottom region 1159b), when the heating element 1142 is inserted into the holder assembly 1158d.

In related implementations, the locations of the inductors 1143 and/or construction of the cartridge 1142 can be different. For example, although the first inductor 1143a and the second inductor 1143b are illustrated as being disposed proximate the bottom region 1159b of the heating element 1142 in FIGS. 11J-11N, as illustrated in FIG. 11O, the first inductor 1143a and the second inductor 1143b can instead be disposed proximate the top region 1159a of the heating element 1142 (e.g., when the cartridge 1120 is inserted). As further illustrated in FIG. 11O, the heating element 1142 can be similar to the heating element 1542j of FIG. 15J and/or the cartridge 1120 can be similar to any of the cartridges 420, 620a-m of FIGS. 4A-4W and 6A-6N. As described with respect to FIG. 15J, the one or more removed regions 1159c can enable the current passing within the top region 1159a of the heating element 1142 to remain (at least primarily) within the top region 1159a and the current passing within the bottom region 1159b of the heating element 1142 to remain (at least primarily) within the bottom region 1159b. Alternatively, the heating element 1542i of FIG. 15I can be implemented, with the orientation of the top and bottom regions 1159 reversed.

FIGS. 11P and 11Q illustrate a cross-sectional and perspective view of an additional configuration of inductors 1143 for use in a vaporizer device, consistent with implementations of the current subject matter. As illustrated in FIGS. 11P and 11Q, the holder assembly 1158p can include a frame 1147 configured to hold each of the inductors 1143a, 1143b. The holder assembly 1158p can include a ledge 1190 that at least partially defines an opening into the receptacle 1118 (illustrated in the cross-sections of FIG. 11P). The ledge 1190 can include features, such as a chamfered edge, that facilitate placement of the cartridge into the receptacle 1118. When the holder assembly 1158p is within a fully assembled vaporizer body 1110, the ledge 1190 of the holder assembly 1158p can form at least a portion of a proximal end of the vaporizer body 1110 or the ledge 1190 of the holder assembly 1158p can be recessed from the proximal end of the vaporizer body 1110.

As illustrated in FIGS. 11P and 11Q, a vaporizer body 1110 or portion thereof (e.g., illustrated as holder assembly 1158p) can include at least one set of helical coils where inductors 1143 extend around an outer surface of the frame 1147 where the outer surface of the frame 1147 faces an internal surface of the chamber. The vaporizer body 1110 can be similar to the vaporizer bodies 110, 210, 410, 1610 described herein, except where noted or impractical. As shown, a first inductor 1143a and a second inductor 1143b can each extend in a plane that is parallel to the longitudinal axis “L” of the holder assembly 1158p. The first inductor 1143a and second inductor 1143b can be spaced apart with one disposed towards the proximal end 1160 of the holder assembly 1158p and one disposed towards the distal end 1161 of the holder assembly 1158p. In some implementations, the first inductor 1143a and second inductor 1143b can be disposed closer together or disposed closer to either the proximal end 1160 or the distal end 1161 of the holder assembly 1158p. As such, a person skilled in the art will appreciate that the positions of the first inductor and the second inductor are not limited to what is shown in the figures.

As illustrated in FIGS. 11P and 11Q, the first inductor 1143a can be disposed proximate the distal end 1161 of the holder assembly 1158p. The first inductor 1143a can extend around an outer surface of the holder assembly 1158p. The second inductor 1143b can be disposed proximate the proximal end 1160 of the holder assembly 1158p. The second inductor 1143b can extend around an outer surface of the holder assembly 1158p, mirroring that of the first inductor 1143a. Between the first inductor 1143a and the second inductor 1143b, there can be a space in the frame filled with insulation. In some implementations, the space between the inductors 1143a, 1143b can be air.

While not shown, the first inductor 1143a can be electrically coupled to first electrical leads that are configured to power the first inductor 1143a, the second inductor 1143b can be electrically coupled to second electrical leads that are configured to power the second inductor 1143b. The electrical leads can be electrically coupled with a controller and/or driving circuit for powering the respective inductors as described herein.

Further, at least one sensor (not shown) can be disposed proximate the first inductor 1143a and/or the second inductor 1143b. In some implementations, the sensor can include a temperature sensor or sensors, such as a thermistor, a PTC circuit such as a PTC thermistor, an NTC circuit such as an NTC thermistor, a thermocouple, and/or the like. The sensor can be disposed and configured to measure the temperature of the nearby inductor 1143a, 1143b, a heating element of the cartridge 1120, and/or some other component of the vaporizer body 1110 or the cartridge 1120.

As illustrated, the first and second inductors 1143a, 1143b can be configured as helical coils extending around the frame 1147. The inductors 1143a, 1143b can be formed in a shape that is substantially the same as the frame 1147 along a cross-section that is perpendicular to the longitudinal axis of the frame 1147, holder assembly 1158p, and/or vaporizer body 1110. Although illustrated and described as a singular coil, each of the inductors 1143a, 1143b can be formed of two or more helical coils.

As previously described herein, the vaporizer body 1110 and inductors 1143a, 1143b can be regarded as having two additional dimensions that are transverse to the length, L, which are the depth and the width. As referred to herein, the vaporizer body 1110 depth can be the distance between two points on opposing faces (e.g., surface areas, which can be substantially the same size and shape when rotated about a central longitudinal axis, L) of the exterior of the vaporizer body 1110, in a dimension that is perpendicular to the vaporizer body 1110 length, for example, extending along the z-axis as illustrated. Furthermore, any component of the vaporizer body 1110 can be referred to as having a depth as referenced by the z-axis as illustrated in FIGS. 11P and 11Q. In some implementations, the vaporizer body 1110 depth can be understood as the greatest distance of the vaporizer body 1110 along the z-axis and/or the distance between two opposing points on the exterior of the vaporizer body 1110 (e.g., with the opposing points being opposite each other along an axis that is perpendicular to the center of the vaporizer body 1110 width). As referred to herein, the vaporizer body 1110 width can be the distance between two points on opposing faces of the exterior of the vaporizer body 1110, in a dimension that is perpendicular to both the vaporizer body 1110 length and the vaporizer body 1110 depth, and is the longer of the two transverse dimensions, for example, extending along the x-axis. Furthermore, any component of the vaporizer body 1110 can be referred to as having a width as referenced by the x-axis in FIG. 11P. In some implementations, the vaporizer body 1110 width can be understood as the greatest distance of the vaporizer body 1110 along the x-axis and/or the distance between two opposing points on the exterior of the vaporizer body 1110 (e.g., with the opposing points being opposite each other along an axis that is perpendicular to the center of the vaporizer body 1110 depth). Accordingly, the axis along which the vaporizer body 1110 width extends can be referred to as the first transverse axis and/or the cartridge long axis, and the axis along which the vaporizer body 1110 depth extends can be referred to as the second transverse axis and/or the cartridge short axis.

As previously described, e.g., with respect to FIGS. 11J-11N, one or more flux concentrators can be disposed proximate and exterior to the inductors 1143a, 1143b (e.g., between the inductors 1143a, 1143b and an external shell of the vaporizer body 1110) in FIGS. 11P and 11Q. For example, a first flux concentrator can be disposed around the first inductor 1143a and the second inductor 1143b. Additional flux concentrators can be positioned above and/or below the first and/or second inductor. The flux concentrator(s) can be positioned substantially around an outer surface of the holder assembly 1158p and can optionally include a break or space in its perimeter (e.g., a space between adjacent ends of the flux concentrators). The frame of the vaporizer body 1110 can have shoulders extending radially outward wherein adjacent shoulders define a channel therebetween. Each shoulder can have a top surface and a bottom surface where a flux concentrator can be positioned. The one or more flux concentrators is illustrated and described as a unitary shape, one or more (e.g., all) of the flux concentrators can be formed of multiple segments of material (e.g., nanometal). The one or more flux concentrators can be configured to direct the electromagnetic field of each of the inductors 1143a, 1143b, in a direction of the heating element 1142, as described herein.

As previously described, the holder assembly 1158p (e.g., the frame 1147) can include one or more ridges 1146 configured to hold the cartridge 1120 within the receptacle 1118. The ridges 1146 can extend from one or more interior surfaces of the cartridge receptacle 1118 to contact the cartridge 1120 and hold the cartridge 1120 in place via a friction fit, similar to the ridges 446, 546, 1646 of FIGS. 4A-4W, FIGS. 5E-5J, and FIGS. 16A-16B. The ridges can be configured, as previously described, to leave open a space for air to enter the cartridge 1120. In some implementations, the ridges can be configured to prevent airflow between the ridges 1146 and the cartridge 1120.

As previously described herein, the inductors 1143 can be selectively powered to heat different regions of the heating element 1142. For example, a first region of the heating element 1142 can be actively heated by one or more inductors 1143 while a second region of the heating element 1142 is not actively heated by an inductor 1143. In some implementations, the different regions of the heating element 1142 can be defined relative to their position with respect to the inductors 1143 adjacent the heating element 1142 when the cartridge 1120 is inserted.

Control algorithms can be implemented that selectively power a first set of inductors (e.g., the first inductor 1143a) and a second set of inductors (e.g., the second inductor 1143b), as described in more detail above with respect to FIGS. 11M and 11N. Such control algorithms can be configured to selectively power the first set of inductors and the second set of inductors, and thereby the heating element, at different times, temperatures, frequencies, and/or the like. In some implementations, during a first time period the first set of inductors are powered according to a first set of parameters such that the first region of the heating element is heated at a first temperature and the second set of inductors are not powered (e.g., the second region of the heating element remains at an ambient temperature). The first temperature can be sufficient to vaporize both the humectant and the active ingredient, such as at or above the boiling point of the humectant. During this first time period, both the humectant and the active ingredient can be vaporized within the first region of the heating element while the humectant and the active ingredient within the second region of the heating element are not vaporized. It will be appreciated that the proximity of the regions of the heating element are close enough that an incidental amount of vaporized material is produced within the second region of the heating element at this time, but the incidental amount is relatively small compared to the vaporized material produced within the first region of the heating element (e.g., less than 15% by weight of the total vapor produced).

At a subsequent, second time period the first set of inductors are powered according to a second set of parameters such that the first region of the heating element is heated at a second temperature and the second set of inductors are powered according to a third set of parameters such that the second region of the heating element is heated at a third temperature. The second temperature can be the same or higher than the first temperature, sufficient to vaporize the humectant. The third temperature can be lower than the first temperature, sufficient to vaporize the active ingredient but not sufficient to vaporize the humectant. During this second time period, the primary source of the active ingredient in the vapor can come from within the second region of the heating element while the primary source of the humectant in the vapor can come from within the first region of the heating element.

Optionally, at a subsequent, third time period the first set of inductors are powered according to a fourth set of parameters such that the first region of the heating element is heated at a fourth temperature and the second set of inductors are powered according to a fifth set of parameters such that the second region of the heating element is heated at a fifth temperature. The fourth temperature can be the same or lower than the first temperature and/or the second temperature, and can not be sufficient to vaporize the humectant. Instead, the fourth temperature can be sufficient to heat the first region of the heating element such that vapor generated within the second region of the heating element is not inhibited from flowing through the first region of the heating element. The fifth temperature can be approximately the same as the first temperature or the second temperature.

In some implementations, the first set of inductors and the second set of inductors can both be powered during an initial pre-heating mode to a pre-heating temperature, after which the first and subsequent time periods are implemented. In some implementations, the pre-heating temperature is lower than the first temperature, lower than the second temperature, lower than the third temperature, lower than the fourth temperature, and/or lower than the fifth temperature. In related implementations, the second set of inductors is powered according to a set of pre-heating parameters such that the second region of the heating element is heated to the pre-heating temperature during the first time period.

In some implementations, the applied temperatures at each section of the heating element between each successive period can include a transition period. For example, each of the pre-heating temperature, the first temperature, the second temperature, the third temperature, the fourth temperature, and/or the fifth temperature can be implemented as maximum temperatures, and the control algorithm can be configured to begin gradually increasing or decreasing the temperature of the heating element at the start of each time period. For example, the control algorithm can be configured to increase or decrease the current temperature of the heating element to the new temperature over the course of the transition period (e.g., 5 seconds, 10 seconds, and/or the like).

In operation, the direction of current through the first inductor 1143a (e.g., clockwise) can be the opposite of the direction of current through the second inductor 1143b (e.g., counter-clockwise). When the first inductor 1143a and the second inductor 1143b induce current into the heating element 1142 in this manner, current can be directed within the heating element 1142 (e.g., within the second region) in a more uniform manner, such as by providing a more complete path around the perimeter of the heating element 1142. Although two sets of inductors and two regions for heating the heating element are illustrated and described, more or less regions can be implemented, as described herein. For example, a third region of the heating element can be provided proximate the distal end of the heating element and/or the cartridge 1120, with each of the third, second, and first regions of the heating element sequentially disposed between the distal end of the heating element and the proximal end of the heating element.

As previously described, the coupling efficiency between the helical inductors (e.g., first inductor 1143a, second inductor 1143b) and the heating element can also be improved if the heating element has a structure that compliments the shapes, configurations, locations, and/or orientations of the inductors 1143. For example, as illustrated in FIG. 11P, the heating element 1142 can include a top region 1159a that is configured to be disposed proximate the second inductor 1143b when the cartridge 1120 is inserted and a bottom region 1159b that is configured to be disposed proximate the first inductor 1143a when the cartridge 1120 is inserted. One or more regions (not shown) can be removed (e.g., cut out) between the top region 1159a and the bottom region 1159b. When the cartridge 1120 is inserted, the removed region(s) can be disposed off-axis from all of the inductors 1143a, 1143b. The heating element 1142 can be similar to the heating element 1542i of FIG. 15I and/or the cartridge 1120 can be similar to any of the cartridges 420, 620a-m of FIGS. 4A-4W and 6A-6N.

In order to form one or more of the inductors described in FIGS. 11D-11Q, a wire (e.g., multi-strand, copper, and/or Litz wire) can be wound into a desired geometry, such as a geometry that includes a circular or non-circular cross-section. FIGS. 8A-8F illustrate example cross-sections that can be used for the geometry of the inductors 1143a, 1143b, etc., including but not limited to rectangular cross-sections, rounded rectangular cross-sections, elliptical or oval cross-sections, oblong cross-sections, c-shaped cross-sections, or other cross-sections that include corners, bends, edges, protrusions, recesses, and/or the like. In various implementations, the inductors 1143 can include two or more layers of wire, with the layers disposed on top of one another from the perspective of the vaporizer device width or depth. For example, the inductors 1143 can include a first layer of turns that is closer to and/or on a holder assembly 1158 of the vaporizer device, and a second layer of turns that is further from the holder assembly 1158 and/or closer to the external shell of the vaporizer body that includes the holder assembly 1158. If the holder assembly 1158 or the vaporizer device are defined in part by a circular cross-section, the layers of wire can be regarded as being disposed on top of one another from the perspective a radius of the holder assembly 1158 and/or vaporizer device.

Although the inductors 1143 and other components of FIGS. 11A-11N, 11P, and 11Q are illustrated and described as being in certain locations, alternate locations are contemplated. For example, FIGS. 12A-12E illustrate example relative positions of inductors 1243a, 1243b, including on top of each other along the length of the cartridge 1220 and on the same side of the heating element 1242, but disposed or wrapped around less than half of the perimeter of the heating element 1242 (FIG. 12A), higher and lower than each other along the length of the cartridge 1220 but on opposing sides of the heating element 1242 and without overlap in any cross section taken along the length of the heating element 1242 (FIG. 12B), higher and lower than each other along the length of the cartridge 1220 but on opposing sides of the heating element 1242 and with a partial overlap in a cross section taken along the length of heating element 1242 (FIG. 12C), on top of each other along the length of the cartridge 1220 and on opposite sides of the heating element 1242 for a total of four inductors 1143 with each respectively disposed or wrapped around less than half of the perimeter of the heating element 1242 (FIG. 12D), on top of each other along the length of the cartridge 1220 and on the same side of the heating element 1242 but disposed or wrapped around a majority of the perimeter of the heating element 1242 (FIG. 12E), and/or the like. In some implementations, the inductors 1243 can instead take the form of solenoid coils that are formed from a wire wrapped a plurality of times around the perimeter of the heating element 1242. Although the cartridges 1220 and heating elements 1242 of FIG. 12A-12E are illustrated as being cylindrical, the relative positions of the inductors 1243a, 1243b can be applied to implementations with cartridges 1220 and heating elements 1242 having different cross-sections. For example, any of the inductors 1143 of FIGS. 11A-11G can be modified such that they are positioned relative to each other as illustrated and described with respect to FIGS. 12A-12E.

Additionally or alternatively, relative positions of the inductors 1143 and other components of FIGS. 11A-11I around a perimeter of the heating element 1142 and/or holder assemblies 1158a-1158i are contemplated. For example, FIGS. 13A-13G illustrate example relative positions of inductors 1343 around a perimeter of heating element 1342, including one inductor 1343 or set of inductors 1343 disposed on one side of the perimeter of a circular heating element 1342 (FIG. 12A), two inductors 1343 or two sets of inductors 1343 disposed at opposing sides of the perimeter of a circular heating element 1342 (FIG. 12B), three inductors 1343 or three sets of inductors 1343 disposed approximately equally around a perimeter of a circular heating element 1342 (FIG. 12C), four inductors 1343 or four sets of inductors 1343 disposed approximately equally around a perimeter of a circular heating element 1342 (FIG. 12D), two inductors 1343 or two sets of inductors 1343 disposed at opposing sides (long sides or short sides) of the perimeter of a non-circular heating element 1342 (FIG. 12E), three inductors 1343 or three sets of inductors 1343 disposed around a perimeter of a non-circular heating element 1342 (FIG. 12F), four inductors 1343 or four sets of inductors 1343 disposed around a perimeter of a non-circular heating element 1342 (FIG. 12G), and/or the like. Although each inductor 1343 is illustrated as having a flat rectangular cross-section, the inductors 1343 can instead be curved and/or wrapped around a portion of the perimeter of the heating element 1342 that is at or near each inductor 1343. Any of the inductors 1143 of FIGS. 11A-11I can be modified such that they are positioned relative to each other as illustrated and described with respect to FIGS. 13A-13G. FIGs.

FIGS. 6A-6J illustrate cross-sectional schematics of various implementations of a vaporizer cartridge 620a-j consistent with implementations of the current subject matter. Further, these vaporizer cartridges 620a-j can be implementations of one or more components of the vaporizer cartridges 120 of FIGS. 1A-1, the vaporizer cartridge 220 of FIG. 2, the cartridge 320 of FIG. 3, and/or the cartridges 400, 400a-q of FIGS. 4A-4Q.

As illustrated in FIG. 6A, the cartridge 620, 620a can include a mouthpiece portion 630 and a heater portion 641 within one or more layers of material (illustrated as wrapper(s) 622). The cartridge 620 can extend between a cartridge proximal end 620x and a cartridge distal end 620y, with the dimension between the two being the cartridge 620 length. Transverse to the cartridge 620 length (from the front to the back) is the cartridge 620 depth. Transverse to both the cartridge 620 length and depth (from the left to the right) is the cartridge 620 width. The heater portion 641 can extend from a heater portion distal end 641b to a heater portion proximal end 641a and the mouthpiece portion 630 can extend from a mouthpiece portion distal end 630b to a mouthpiece portion proximal end 630a.

The heater portion 641 can include one or more heating element 642, which at least partially defines a volume within which the vaporizable material 602 is held. The heating element(s) 642 can be configured to heat the vaporizable material 602 to generate a vapor. As described herein, the heat can be generated through inductive means, although conductive and/or convective heating can also be provided. The volume within which the vaporizable material 602 is held can be regarded as a heater chamber. Accordingly, the heating element(s) 642 can define at least a portion of a perimeter of a heater chamber containing the vaporizable material 602, and in some implementations define substantially all of the perimeter.

As illustrated in FIG. 6B, the heater portion 641 can include or be proximate to an end cap 664 at the cartridge distal end 620y to hold the vaporizable material 602 within the defined internal volume of the heater portion 641 and/or define a lower boundary of the volume (e.g., heater chamber). The end cap 664 can include one or more cartridge inlets (e.g., though-holes) such that ambient air can enter the heater chamber. Additionally or alternatively, the end cap 664 can include an air-permeable material such, such as a filter, configured to allow air to enter the heater chamber through the material. The end cap 664 (e.g., filter) can include material such as one or more of paper material such as cardstock, corrugated material such as cardboard or paper, tobacco paper, temperature-resistant plastic (e.g., PET), cellulose acetate, non-wood plant fibers such as flax, hemp, sisal, rice straw, and/or esparto, and/or the like. In some implementations, the end cap 664 can be considered separate from the heater portion 641, and the end cap 664 and heater portion 641 are be considered to be separate components of the cartridge 620, held together within a layer of material (e.g., wrapped in the wrapper(s) during manufacture). However, as illustrated in FIG. 6A, in some implementations an end cap 664 is not included. For example, in such implementations the vaporizable material 602 can be formed with sufficient rigidity (e.g., in the form of a puck or another pre-formed shape) that an end cap 664 is not required. In accordance with such implementations, the vaporizable material 602 itself can include one or more cartridge inlets (e.g., though-holes), although the inlets are not required if the vaporizable material 602 is manufactured with sufficient porosity. In the event the vaporizable material 602 is exposed (e.g., no end cap 664 is used), the boundary formed by the heating element(s) 642 and/or the layers of material (e.g., wrapper(s) 622) at the cartridge distal end 620y can form a cartridge inlet, such that ambient air can enter the heater chamber. In some implementations, the end cap 664 can be positioned at an end of the cartridge 620. In some implementations, the end cap 664 can be positioned offset (e.g., along the length of the cartridge 620) from an end of the cartridge 620, including not being a most distal or proximal element along an implementation of the cartridge 620. For example, the end cap 664 can form a part of an outer surface of the cartridge 620 and/or the end cap 664 can be fully contained within the outer surface of the cartridge 620. In some implementations, the cartridge 620 can include one or more end caps 664 that can be positioned in a variety of positions and configurations along the cartridge 620.

In some implementations, the material forming the one or more heating elements 642 can be further extended to enclose the cartridge distal end 620y and help retain the vaporizable material 602. The one or more heating elements 642 can include a plurality of cartridge inlets such that external air can enter the heater chamber, with the plurality of cartridge inlets being through-holes formed in the direction of the cartridge 620 longitudinal dimension and/or perpendicular to the direction of the cartridge 620 longitudinal dimension (e.g., around a perimeter of the one or more heating elements 642 and/or proximate the cartridge distal end 620y).

The mouthpiece portion 630 can include one or more insert 624. The insert(s) 624 can include airflow outlet channels 626 that extend from corresponding vapor inlets 635 proximate the mouthpiece portion distal end 630b (which can be proximate the heater portion proximal end 641a), to corresponding airflow outlets 628 at the cartridge proximal end 620x. The airflow outlet channels 626 form a fluid connection between the heater portion 641 and the airflow outlets 628, through the vapor inlets 635, such that vapor generated in the heater portion 641 can be drawn towards the cartridge proximal end 620x, and ultimately out of the airflow outlets 628 as an inhalable aerosol that can be inhaled by a user. Proximate to the mouthpiece portion distal end 630b, the insert(s) 624 can further include bypass outlets 627, that form a fluid connection between the respective airflow outlet channels 626 and ambient air, such as through corresponding bypass channels that are formed through the insert(s) (not illustrated) and bypass air inlets formed through the wrapper(s) (not illustrated). The airflow outlet channels 626 can each include one or more condensation chamber configured to condense the vapor from the heater chamber with the ambient air received through the bypass channels to form at least a portion of the inhalable aerosol. The bypass outlets 627 (as well as the corresponding airflow outlet channels and the bypass air inlets) and/or the bypass channels 638 can be formed via a laser-cutting operation through walls of the insert 624 during manufacturing.

In some implementations, the illustrated cross-section of the cartridge 620 can be a symmetrical half of the cartridge 620, such as the cartridge 620i illustrated in FIG. 6I. Accordingly, the cartridge 620 can include at least four bypass outlets 627 and corresponding bypass channels and bypass air inlets. In some implementations, more bypass outlets 627 and corresponding bypass channels and bypass air inlets are present, such as two on each side of each airflow outlet channels 626 (e.g., eight total), three on each side of each airflow outlet channels 626 (e.g., twelve total), four on each side of each airflow outlet channels 626 (e.g., sixteen total), etc. In related implementations, there can only be one airflow outlet channel 626, which can similarly include one bypass outlet 627 and corresponding bypass channel and bypass air inlet on each side of each airflow outlet channel 626 (e.g., two total), two on each side of each airflow outlet channels 626 (e.g., four total), three on each side of each airflow outlet channels 626 (e.g., six total), four on each side of each airflow outlet channels 626 (e.g., eight total), etc.

Additionally or alternatively, the bypass outlets 627 and corresponding bypass channels and bypass air inlets can be formed of a different geometry. For example, each bypass outlet 627 and corresponding bypass channel and bypass air inlet can each collectively form a rectangular (cuboid) bypass channel that is in fluid communication with (e.g., between) a respective airflow outlet channel 626 and ambient air, a circular (cylindrical) bypass channel, and/or the like. Where circular (cylindrical) bypass channels are included, each of the rectangular (cuboid) bypass channels can be replaced with a plurality of circular (cylindrical) bypass channels that are separated from each other and formed in a line along the cartridge 620 width, such as along the same lines illustrated for the rectangular bypass outlets 627.

As illustrated in FIG. 6C, the mouthpiece portion 630 can include or be proximate an end cap 674, which forms at least a portion of the cartridge proximal end 620x. The end cap 674 can close the airflow outlets 628 such that the airflow outlet channels 626 are not openly exposed and/or such that the end cap 674 forms an upper boundary of the airflow outlet channels 626 (e.g., one or more condensation chambers).

The end cap 674 can include one or more airflow outlets such that the inhalable aerosol can exit the one or more condensation chambers, and thereby exit cartridge 620. Additionally or alternatively, the end cap 674 can include an air-permeable material such, such as a filter, configured to allow air to exit the one or more condensation chambers through the material. The end cap 674 (e.g., filter) can include material such as one or more of paper material such as cardstock, corrugated material such as cardboard or paper, tobacco paper, temperature-resistant plastic, cellulose acetate, non-wood plant fibers such as flax, hemp, sisal, rice straw, and/or esparto, and/or the like. In some implementations, the end cap 674 can be considered separate from the mouthpiece portion 630, and the end cap 674 and mouthpiece portion 630 are be considered separate components of the cartridge 620, held (e.g., wrapped or inserted) within a layer of material (e.g., wrapper(s)) during manufacture. However, as illustrated in FIG. 6A, in some implementations an end cap 674 is not included. In some implementations, the cartridge 620 can include both the end cap 674 proximate and/or as part of the mouthpiece portion 630, and the end cap 664 proximate and/or as part of the heater portion 664, as illustrated in FIG. 6D.

As illustrated in FIG. 6A, a space can exist at or between the intersection of the mouthpiece portion 630 and the heater portion 641. In some implementations, this space can be intentional, or can be a natural byproduct of the composition of the vaporizable material 602 (e.g., relatively lose and not packed at manufacture). For example, this space can be surrounded by the heating element(s) 642, a layer of material (e.g., wrapper 622 (e.g., where a relatively rigid layer of material is used)), a divider (such as the dividers 454 of FIG. 4G, 4K, 4L, or 4M) other walls (such as the walls 433 of FIG. 4G), and/or the like. In an example implementation, the bypass outlets 627 and corresponding bypass channels and bypass air inlets can not be present in the filter, and can instead be present in this space, such as through a ring or donut-shaped divider.

Other implementations exist where differently shaped airflow outlet channels 626 are included, such as through one or more filters 624 in the mouthpiece portion 630 as illustrated in the vaporizer cartridge 620e of FIG. 6E. As illustrated first and second airflow outlet channels 626a, 626b can be formed within a first filter 624a disposed in a lower region of the mouthpiece portion 630 (e.g., closer to the mouthpiece portion distal end 630b) and a third airflow outlet channel 626c can be formed within a second filter 624b disposed in an upper region of the mouthpiece portion 430 (e.g., closer to the mouthpiece portion proximal end 630a). Each of the filters 624, and thereby the airflow outlet channels 626 formed therein, can be positioned at different locations along the cartridge 620 length, and the locations of the filters 624a, 624b can be swapped. As illustrated, each of the first and second airflow outlet channels 626a, 626b include bypass outlets 627, and thereby corresponding bypass channels and bypass air inlets as described herein. In implementations where the locations of the filters 624a, 624b are be swapped, then a plurality of airflow outlet channels 626 can be included in the second filter 646b instead.

Each of the airflow outlet channels 626 can be of different dimensions, the same dimensions, or some mixture thereof. For example, the first and second airflow outlet channels 626a, 626b can be of the same dimensions, whereas the third airflow outlet channel 626c can be of different dimensions. As illustrated, the first and second airflow outlet channels 626a, 626b can be smaller along the cartridge 620 width compared to the third airflow outlet channel 626c.

Advantages with this configuration exist compared to using only one or two airflow outlet channels 626. For example, when the air and vapor from the heater portion 641 (e.g., heater chamber) enters the independent first and second airflow outlet channels 626a, 626b and mix with ambient air from the bypass channels, the smaller fluid volumes provide a better restriction to draw and spaces in which a larger overall portion of the vapor is able to independently mix with ambient air, helping to cool and condense the vapor faster. Thereafter, when the air and vapor enter the larger third airflow outlet channel 626c, aerosol generation can benefit from the increased residence time within the third airflow outlet channel 626c, helping the air and vapor to cool for longer, and provide for better mixing that results in a more homogenous aerosol.

The first and second filter 624 can be wrapped together with the end cap 674, when present, within a layer of material (e.g., wrapper 622) so that they can be held together to form the mouthpiece portion 630, and an additional layer of material (e.g., wrapper 622) can be included that holds the mouthpiece portion 630 together with the heater portion 641 to form the cartridge 620. In other implementations, the first and second filter 624 can be wrapped together within a layer of material (e.g., wrapper 622) so that they can be held together to form the mouthpiece portion 630, and an additional layer of material (e.g., wrapper 622) can be included that holds the mouthpiece portion 630 and the end cap 674 together with the heater portion 641 to form the cartridge 620. The vaporizer cartridge 620, 620e can include the same components of, and otherwise operate in the same manner as, the vaporizer cartridge 620a of FIG. 6A, except as noted. Separately, the components of vaporizer cartridge 620, 620e identified and discussed herein can be combined into any of the other vaporizer cartridges 620 described with respect to FIGS. 6A-6D and/or 6F-6J, except as noted or where impractical.

Other implementations exist where additional structures can be present within the mouthpiece portion 630 that lengthen the distance air must travel before reaching the airflow outlet(s) 628, such as those illustrated in the vaporizer cartridge 620f of FIG. 6F. For example, as illustrated the mouthpiece portion 630 can include a plurality of baffles 655 that divert airflow within the airflow outlet channel 626. In some implementations, the baffles 655 can extend across a majority of the cartridge 620 width (e.g., at least half), covering one end of the cartridge 620 width and leaving open a space proximate the opposite end of the cartridge 620 width. Each, subsequent baffle 655, along the direction of the cartridge airflow path, can be disposed to leave open a space proximate a different end compared to the immediately preceding baffle 655. For example, if a first baffle 655 is disposed to leave open a space proximate a first side of the cartridge 620 (e.g., a first short side), then a subsequent second baffle 655 is disposed to leave open a space proximate a second side of the cartridge 620 (e.g., a second short side, opposite the first short side along the cartridge 620 width), and this alternating pattern can continue for each subsequent baffle 655. The open spaces can form part of the airflow path along which the external air and vapor can travel, providing an airflow path with a longer, overall distance compared to an airflow path that travels straight through the mouthpiece portion along the cartridge 620 length.

As illustrated, the cartridge 620 can include a divider 654 within one, both, or between the mouthpiece portion 620 and the heater portion 641. As illustrated, the divider 654 can take the form of an upside-down cup, with the solid end proximate the heater portion distal end 641a and including vapor inlets 635. The open end of the divider 654 can face towards the heater portion distal end 641b. As illustrated, the perimeter of the divider 654 can include bypass channels 638, in fluid communication with ambient air. However, instead of being in direct communication with the airflow outlet channel 626, the bypass channels 638 can be in fluid communication with part of the heater portion 641, such as the heater chamber.

In various implementations, the cartridge 620 can include one or more baffles 655 formed as part of one or more filters 624, which can be stacked on top of each other along the cartridge 620 length. In some implementations, a plurality of filters 624 including baffles 655 can be wrapped together with the end cap 674, when present, within a layer of material (e.g., wrapper 622) so that they can be held together to form the mouthpiece portion 630, and an additional layer of material (e.g., wrapper 622) can be included that holds the mouthpiece portion 630 together with the heater portion 641 to form the cartridge 620. In other implementations, the plurality of filters 624 including baffles 655 can be wrapped together within a layer of material (e.g., wrapper 622) so that they can be held together to form the mouthpiece portion 630, and an additional layer of material (e.g., wrapper 622) can be included that holds the mouthpiece portion 630, the end cap 674 (when present), the heater portion 641, and the end cap 664 (when present) together to form the cartridge 620. In either of these sets of implementations, the divider 654 can be included within a layer of material (e.g., wrapper 622) that forms the mouthpiece portion 620 or can be separate from the mouthpiece portion 620. The baffles 655 and the open space in each of the filters 624 can be created via a laser-cutting operation through walls of the filters 624 during the manufacturing process.

In some implementations, instead of the baffles 655 being formed in the illustrated plurality of filters 624, the baffles 655 or a similar structure can be formed by a material that includes pre-cut holes and is folded and/or pressed into the mouthpiece portion 630. For example, similar to the manner in which cardboard is manufactured, the structure can be a singular piece of material that is easy to manufacture and has a predefined pattern.

The vaporizer cartridge 620, 620f can include the same components of, and otherwise operate in the same manner as, the vaporizer cartridge 620a of FIG. 6A, except as noted. Separately, the components of vaporizer cartridge 620, 620f identified and discussed herein can be combined into any of the other vaporizer cartridges 620 described with respect to FIGS. 6A-6E and/or 6G-6J, except as noted or where impractical.

Other implementations exist where the filter(s) 624 take up a smaller percentage of the volume in the mouthpiece portion 630 and/or other components are used instead as illustrated in the vaporizer cartridge 620g of FIG. 6G. For example, one or more filters 624 can be disposed within or proximate to an upper region of the mouthpiece portion 630 (e.g., proximate and/or forming at least a portion of the cartridge proximal end 620x) and a divider 654 can be disposed in a lower region of the mouthpiece portion 630 (e.g., proximate and/or forming at least a portion of the mouthpiece portion distal end 630b). As illustrated, one or more walls 633 can be provided within the mouthpiece portion 630 to maintain the rigidity of the mouthpiece portion 630 so that it is resistant to deformation under force and/or easier to manufacture. As illustrated, the wall(s) 633 can extend along the cartridge 620 length, between the filter(s) 624 and the divider 654. The wall(s) 633 define at least a portion of a perimeter of the airflow outlet channel 626 (e.g., substantially all of the perimeter). In some implementations, the airflow outlet channel 626 can be formed between and/or defined by the wall(s) 633 and the filter(s) 624, and optionally by the divider 654 in implementations where the wall(s) 633 form a hollow shape (e.g., a hollow, flattened cylinder, having an elliptical or oval cross-section).

In some implementations, the divider 654 can include a solid end, define an open end opposite the solid end, and include a solid boundary that extends between the two ends (e.g., along a perimeter of the divider 654, where the perimeter can be substantially the same at the solid end and the open end). As illustrated, the divider 654 can be disposed within the mouthpiece portion 630 with the solid end more proximate the cartridge proximal end 620x and the open end more proximate and facing the cartridge distal end 620y, open to and in fluid communication with the heater chamber in the heater portion 641 (e.g., having an upside-down cup shape). A plurality of vapor inlets 635 can be formed through the solid end of the divider 654, such that the vaporized material and external air from the heater chamber can enter the airflow outlet chamber 626.

In some implementations, the walls 633 can similarly include a solid end, define an open end opposite the solid end, and include a solid boundary that extends between the two ends (e.g., along a perimeter of the walls 633, where the perimeter can be substantially the same at the solid end and the open end). As illustrated, the divider 654 can be disposed within the mouthpiece portion 630, with the open end more proximate the cartridge proximal end 620x and the closed end more proximate the cartridge distal end 620y. In some implementations, the walls 633 can be regarded as having a cup shape. A plurality of bypass outlets 627, and thereby a plurality of corresponding bypass channels 638 and bypass air inlets 629, can formed through the solid boundary of the walls 633 (e.g., proximate the solid end), such that ambient air can enter the airflow outlet chamber 626. Further, a plurality of vapor inlets 635 can be formed through the solid end of the walls 633, such that the vaporized material and external air from the heater chamber, and more immediately, from the vapor inlets 635 of the divider 654, can enter the airflow outlet chamber 626.

In some implementations the solid end of the walls 633 can abut the solid end of the divider 654. In some implementations, the vapor inlets 635 and the bypass outlets 627 formed in the divider 654 and the walls 633 can be sized to created a jet-stream effect. For example, in some implementations, each of the vapor inlets 635 and the bypass outlets 627 can be circular holes that are less than 1 mm in diameter, less than 0.5 mm in diameter, or less than 0.25 mm in diameter. In some implementations, each of the vapor inlets 635 and the bypass outlets 627 are the same size. However, in other implementations, the vapor inlets 635 are larger than the bypass outlets 627, such that the jet stream effect from the ambient air has a stronger effect on the slower-moving air passing through the vapor inlets 635. The vapor inlets 635 and the bypass outlets 627 can be created via a laser-cutting operation during the manufacturing process.

The divider 654 and/or wall(s) 633 can take other forms, such as those illustrated in FIG. 6H. For example, as illustrated, the wall(s) 633 can form a shape around the interior perimeter of the mouthpiece section 630 and/or cartridge 630, that is open on both ends (e.g., proximate each of the mouthpiece portion distal end 630b and the mouthpiece portion proximal end 630a), as mentioned above. Separately, the divider 654 can include a boundary wall 656 extending parallel to the cartridge 620 length and around an internal perimeter of the divider 654 and/or cartridge. The boundary wall 656 can include or be formed of a series of bends 657 that successively extend towards and away from the internal perimeter of the divider 654 and/or cartridge 620. The regions formed where the boundary wall 656 is spaced apart from the internal perimeter of the divider 654 and/or cartridge 620 can be vapor inlets 635, and the regions where the boundary wall 656 abuts the internal perimeter of the divider 654 and/or cartridge 620 can separate the vapor inlets 635 from each other. As illustrated, the vapor inlets 635 formed by the divider 654 are larger than the adjacent bypass outlets 627, which can allow the jet-stream effect of ambient air entering the bypass outlets 627 to have a greater effect on the vapor, from the heater chamber, passing through the vapor inlets 635.

In some implementations, the divider 654 in either of the cartridges 620g, 620 h of FIGS. 6G-6H can extend out of the distal end of the mouthpiece portion 630 such that it can couple with, be inserted within, and/or touch the exterior of the heater portion 641. In accordance with these implementations, the divider 654 can be regarded as part of the mouthpiece portion 630 only, as part of both the mouthpiece portion 630 and the heater portion 641, or can be regarded as an intermediate portion disposed between the mouthpiece portion 630 and the heater portion 641. For example, in some implementations the filter(s) 624, wall(s) 633, and the divider 654 can all be wrapped together in a first wrapper 622 to form the mouthpiece portion 630, the heating element(s) 642 can be wrapped around the vaporizable material 602 to form the heater portion 641, and a second wrapper 622 can be wrapped around the mouthpiece portion 630 and the heater portion 641 to form the cartridge 420.

The filter 624 can include an air-permeable material such that aerosol can exit the mouthpiece portion 630 and be inhaled by a user, but can provide additional filtration (e.g., active filtration to remove constituent parts of the aerosol). The filter 624 can include material such as one or more of paper material such as cardstock, corrugated material such as cardboard or paper, tobacco paper, temperature-resistant plastic, cellulose acetate, non-wood plant fibers such as flax, hemp, sisal, rice straw, and/or esparto, and/or the like. The vaporizer cartridges 620, 620g, 620h can include the same components of, and otherwise operate in the same manner as, the vaporizer cartridge 620a of FIG. 6A, except as noted. Separately, the components of vaporizer cartridge 620, 620g, 620 h identified and discussed herein can be combined into any of the other vaporizer cartridges 620 described with respect to FIGS. 6A-6F, 6I, and/or 6J, except as noted or where impractical.

Other implementations exist where additional or alternative structures can be present that provide more control of the airflow path, such as those illustrated in the cartridges 620k, 6201, 620m of FIGS. 6K-6N. For example, as illustrated in FIGS. 6K-6N, the mouthpiece portion 630 can include a divider 654 that includes a plurality of stand-offs 677 extending in the longitudinal axis from the downstream end of the divider 654 towards the vaporizable material 602. The plurality of stand-offs 677 can be spaced apart from each other such that a plurality of trenches 676 are formed within the space between each adjacent stand-off 677. For example, a first set of stand-offs 677a can extend between opposing short sides of the cartridge 620k, proximate a first long side of the cartridge 620k, and a second set of stand-offs 677b can also extend between the opposing short sides of the cartridge 620k, proximate a second long side of the cartridge 620k that is opposite the first long side of the cartridge 620k. As illustrated in FIG. 6K, a trench 676 can be formed between each pair of adjacent first stand-offs 677a as a generally hollow volume defined in part by opposing walls of the adjacent first stand-offs 677a and an upstream-facing wall of the divider 654 between the opposing walls. A trench 676 can also be formed between each pair of adjacent second stand-offs 677b as a generally hollow volume defined in part by opposing walls of the adjacent second stand-offs 677b and an upstream-facing wall of the divider 654 between the opposing walls. As illustrated, the upstream-facing walls of the divider 654 that at least partially define the trenches 676 can be angled with respect to the longitudinal axis of the cartridge 620k (e.g., between at least a portion of the first stand-offs 677a) or approximately perpendicular to the longitudinal axis of the cartridge 620k (e.g., between at least a portion of the second stand-offs 677b).

The first set of stand-offs 677a and the second set of stand-offs 677b can be at least partially separated from each other by a middle trench 676 extending between the opposing short sides of the cartridge 620k. The separation between the sets of stand-offs 677a, 677b created by the presence of the middle trench 676 can be proximate the distal end of the divider 654, and the separation can optionally extend from the distal end of the divider 654 to a first airflow outlet channel 626a of the divider. In some implementations, the sets of stand-offs 677a, 677b are opposite each other and do not touch, but are formed as part of a singular divider 654 component. The central axis of the middle trench 676 can be approximately parallel to the opposing long sides of the cartridge 620k as illustrated in FIG. 6K. At a location that is approximately central to the middle trench 676 (e.g., central to a cross-section of the divider 654 that is perpendicular to the longitudinal axis of the cartridge 620k), the middle trench can include an outlet that is in fluid communication with a first airflow outlet channel 626a. However, the first airflow outlet channel 626a is not required to be central to a cross-section of the divider 654 that is perpendicular to the longitudinal axis of the cartridge 620k, and more than one first airflow outlet channel 626a can be included to further divide the stream of vaporized material to promote cooling. As illustrated in FIG. 6K, downstream of the outlet of the middle trench 676, the first airflow outlet channel 626a can be in fluid communication with ambient air through a bypass air inlet 629, bypass channel 638, and bypass outlet 627. The first airflow outlet channel 626a, bypass air inlet 629, bypass channel 638, and bypass outlet 627 can be sized and configured to provide a jet-stream effect, as described herein, to rapidly cool the vaporized material passing through the first airflow outlet channel 626a. The first airflow outlet channel 626a can include an outlet that is in fluid communication with a second airflow outlet channel 626b, downstream of the first airflow outlet channel 626a. For example, the divider 654 can include a conduit 678 that includes the first airflow outlet channel 626a, an inlet to the first airflow outlet channel 626a at a distal end of the conduit 678, and/or an outlet of the first airflow outlet channel 626a at a proximal end of the conduit 678. As illustrated in FIG. 6K, the second airflow outlet channel 626b includes a larger volume of space compared to the first airflow outlet channel 626a, which can promote nucleation and aerosol formation.

In some implementations, the divider 654 can be defined in part by an outer perimeter, a proximal end (or upstream end), a distal end (or downstream end), and one or more outer walls extending between the proximal end and the distal end. The outer perimeter of the divider 654 can be disposed along an interior perimeter of the wrapper(s) 622 holding the divider 654 and other components of the cartridge 620k in place. As illustrated, the outer walls of the divider 654 can extend around the outer perimeter of the divider 654 and/or form an interior perimeter of the divider 654. The interior perimeter of the divider 654 can at least partially define an interior volume of the divider 654 that is proximate the proximal end of the divider 654. In some implementations, the second airflow outlet channel 626b can be defined in part by this interior volume of the divider 654. For example, as illustrated, the second airflow outlet channel 626b is defined in part by this interior volume of the divider 654 and is further defined by an interior volume of the mouthpiece portion 630 that is downstream of the proximal end of the divider 654. This interior volume of the mouthpiece portion 630 can be defined as a space between the end cap 674 and the proximal end of the divider 654, within the interior perimeter of the wrapper 622. In some implementations, the second airflow outlet channel 626b can include a larger, open volume (e.g., condensation chamber) downstream of the first airflow outlet channel 626b and upstream of the airflow outlet(s) 628 (e.g., proximate the cartridge proximal end 620x),

The outer walls of the divider 654, parallel to the longitudinal axis of the cartridge 620k, are illustrated as only extending partially within the mouthpiece portion 630 (e.g., spaced apart from the end cap 674). However, in some implementations the outer walls of the divider 654 can extend along a majority of the mouthpiece portion 630 (e.g., with the end cap 674 disposed at the proximal end of the divider 654 and the vaporizable material 602 disposed at the distal end of the divider 654). The outer walls of the divider 654 can increase the overall durability and rigidity of the cartridge 620k, especially in the region proximate the divider 654, which can be partially inserted into a receptacle and/or in contact with one or more of ridges or coupling features inside of the vaporizer body. It will be appreciated that a divider 654 extending from the end cap 674 to the vaporizable material 602 can provide greater durability and rigidity to the cartridge 620k. However, a divider 654 that does not extend all the way from the end cap 674 to the vaporizable material 602 can provide sufficient durability and rigidity to the cartridge 620k while also saving on manufacturing costs and complexity. Accordingly, in some implementations, the divider 654 can extend less than 50% of the distance between the end cap 674 and the vaporizable material 602 along the longitudinal axis of the cartridge 620k, less than 40% of the same distance, less than 30% of the same distance, and/or the like.

As illustrated in FIG. 6K, the divider 654 can include an interior bulge 679 or region that at least partially extends between the proximal and distal ends of the divider 654. The first set of stand-offs 677a, the second set of stand-offs 677b, and the trenches 676 of the divider 654 can be formed within an interior of the bulge 679 that is upstream of the proximal end of the divider 654. For example, the upstream-facing walls of the divider 654 that at least partially define the trenches 676 can be surfaces of the bulge 679 that are within the interior of the bulge 679. The interior volume of the divider 654 proximate the proximal end of the divider 654 that at least partially defines the second airflow outlet channel 626b can be bounded by a upstream-facing exterior surface(s) of the bulge 679 (e.g., downstream of the distal end of the divider 654). For example, this interior volume of the divider 654 can be defined as a space between the downstream surface(s) of the bulge 679 and the proximal end of the divider 654, within the interior perimeter of the outer walls of the divider 654. In some implementations, the first airflow outlet channel 626a and/or the bypass channel(s) 638 can be regarded as part of the bulge 679. In some implementations, the bulge 679 can be regarded as having a shape that is similar to a dome, pyramid, and/or the like. For example, a cross-section of the bulge 679 taken along the longitudinal axis of the cartridge 620k can be generally triangular (e.g., with rounded edges). Although the term bulge is used to define the region of the divider 654 that includes the stand-offs 677, 677a, 677b, the trenches 676, the bypass channel(s) 638, and/or the first airflow outlet channel 626, the term bulge is not intended to exclude other shapes or structures of regions that include these features.

The end cap 674 can include an air-permeable material such that aerosol can exist the mouthpiece portion 630 and be inhaled by a user, but can provide additional filtration (e.g., active filtration to remove constituent parts of the aerosol). The end cap 674 can include material such as one or more of paper material such as cardstock, corrugated material such as cardboard or paper, tobacco paper, temperature-resistant plastic (e.g., PET), cellulose acetate, non-wood plant fibers such as flax, hemp, sisal, rice straw, and/or esparto, and/or the like.

In use, vaporized material can be generated within the heater portion 641 by heating the vaporizable material 602, and air that enters through the cartridge distal end 620y can pass through the vaporizable material 602 to move the vaporized material to the vapor inlet(s) 635 and into the divider 654. The vaporized material can enter the trenches 676 of the divider 654 formed between the first stand-offs 677a, the trenches 676 of the divider formed between the second stand-offs 677b, and/or a middle trench 676 that at least partially separates the first stand-offs 677a and the second stand-offs 677b. The vaporized material can then pass from the middle trench 676 into the first airflow outlet channel 626a. Ambient air can enter the cartridge 620k through the bypass air inlet(s) 629, travel through the bypass channel(s) 638, and enter the first airflow outlet channel 626a through the bypass outlet(s) 627. Within the first airflow outlet channel 626a, the vaporized material can mix with the ambient air to form an aerosol. It will be appreciated that aerosol formation can occur prior to the vaporized material and ambient air mixing in the first airflow outlet channel, such as within the bulge and/or trenches 676 of the divider 654. However, the configuration of the bypass channel 638 and first airflow outlet channel 626a can be provided such that the majority of aerosol formation can occur within and downstream of the first airflow outlet channel 626a. The vaporized material and ambient air can then pass out of the first airflow outlet channel 626a and into the second airflow outlet channel 626b. The aerosol can continue to cool and form within the second airflow outlet channel 626b, and then pass through the end cap 674, out of the cartridge 620k where it is inhaled by a user.

Each of the plurality of stand-offs 677 can include an upstream-facing wall configured to contact a downstream area of the vaporizable material 602 to prevent the vaporizable material 602 from entering the divider 654 and/or leaving the heater portion 641. In some implementations, when the divider 654 is placed within the cartridge 620k during assembly, the divider 654 can be pressed against the vaporizable material 602 to increase the packing density of the vaporizable material 602 within the cartridge 620k. However, in order to avoid over-packing the vaporizable material 602 in a manner that reduces or prevents airflow through the vaporizable material 602, in some implementations the divider 654 can be disposed at a location within the cartridge 620k during manufacture that provides a space between the downstream end of the vaporizable material 602 and the upstream end of the divider 654.

In some implementations, it can be beneficial to provide additional or alternative structures to help prevent the vaporizable material 602 from entering the divider 654. For example, as illustrated in FIG. 6L, the divider 654 of the cartridge 620l can include one or more baffles 655 upstream of the first airflow outlet channel 626a. Providing a smaller (e.g., more narrow) inlet into the first airflow outlet channel 626a can allow for better control of aerosol generation, but introduces a greater risk that the inlet can become blocked (e.g., by the vaporizable material 602). Accordingly, including one or more baffles 655 aligned with the first airflow outlet channel 626a along the longitudinal dimension of the cartridge 620l can help prevent the vaporizable material 602 from blocking the first airflow outlet channel 626a. As illustrated, the baffle 655 can extend between the first set of stand-offs 677a and the second set of stand-offs 677b. Compared with the middle trench 676 in the cartridge 620k of FIG. 6K, the baffle 655 in the cartridge 620l can divide a region of the middle trench 676 such that airflow is diverted around the baffle 655. In some implementations, the middle trench 676 in the cartridge 620l can be regarded as including a first region that is proximate a first short side of the cartridge 620l, a second region that is proximate a second short side of the cartridge 620l opposite the first short side of the cartridge 620l, and one or more connecting regions that are between and in fluid communication with both the first region and the second regions. For example, as illustrated in FIG. 6L, two connecting regions of the middle trench 676 are disposed on opposite sides of the baffle 655, with each of the connecting regions being closer to their respective, opposing long sides of the cartridge 620l. As illustrated in FIG. 6L, one or both of the two connecting regions can be in communication with the first airflow outlet channel 626a via fluid connection(s) that flow around the baffle 655, such as on opposite sides of the baffle 655 closer to their respective, opposing short sides of the cartridge 620l. The middle trench 676 can still at least partially separate the first stand-offs 677a and the second stand-offs 677b in regions that do not include a baffle, such as in the first and second regions of the middle trench 676.

The airflow and aerosol generation within the cartridge 620l can operate in the same or similar manner as the airflow and aerosol generation within the cartridge 620k. However, when the vaporized material passes from the middle trench 676 to the first airflow outlet channel 626a, the vaporized material passes around the baffle 655. For example, the vaporized material flowing out of the heater portion 641 can enter the trenches 676 of the divider 654 formed between the first stand-offs 677a, the trenches 676 of the divider formed between the second stand-offs 677b, the first region of the middle trench 676 that is proximate a first short side of the cartridge 620l, the second region of the middle trench 676 that is proximate a second short side of the cartridge 620l opposite the first short side of the cartridge 620l, and/or the one or more connecting regions of the middle trench 676 that are between and in fluid communication with both the first region and the second regions. The vaporized material can then pass around the baffle 655, through the fluid connection(s), and into the first airflow outlet channel 626a.

The vaporizer cartridges 620k, 6201 can include at least some of the same components of, and otherwise operate in the same or similar manner as, the vaporizer cartridge 620a of FIG. 6A, except as noted. Separately, the components of vaporizer cartridges 620k, 6201 identified and discussed herein can be combined into any of the other vaporizer cartridges 620 described with respect to FIGS. 6A-6J, except as noted or where impractical.

Other implementations of a divider 654 are contemplated, such as the divider 654 in the cartridge 620m of FIG. 6M. As illustrated, relative to the cartridges 620k, 6201 of FIGS. 6K-6L, the divider 654 of the cartridge 620m can include less stand-offs 677 with larger upstream-facing walls, and thereby include less trenches 676 defined between adjacent stand-offs 677. For example, the divider 654 of the cartridge 620m can include four stand-offs 677 that collectively define two trenches 676. A first trench 676a can extend between opposing long sides of the cartridge 620m and a second trench 676b can extend between opposing short sides of the cartridge 620m. The first trench 676a and the second trench 676b can intersect (e.g., equally bisect) each other and/or form a unitary trench in the shape of a cross, plus sign, and/or the like. The opposing ends of the first trench 676a can be in fluid communication with respective, first airflow outlet channels 626a proximate each of the opposing long sides of the cartridge 620m. As illustrated, the divider 654 can include one or more conduits 678 that each at least partially define respective first airflow outlet channels 626a. For example, each first airflow outlet channel 626a can be defined between a conduit 678 of the divider 654 and the wrapper(s) 622, extending from the ends of the first trench 676a to their respective first airflow outlets 628a.

Downstream of each first airflow outlet 628a ambient air can be introduced to mix with the vaporized material passing out of the airflow outlet 628a. For example, a bypass air inlet 629, bypass channel 638, and bypass outlet 627 can provide ambient air into the second airflow outlet channel 626b, downstream of each airflow outlet 628a. Accordingly, ambient air and the vaporized material passing out of each airflow outlet 628a can mix within the second airflow outlet channel 626b, prior to exiting the cartridge 620m through the end cap 674. However, in some implementations the bypass air inlets 629, bypass channels 638, and bypass outlets 627 can be upstream of their respective first airflow outlets 628a, such as parallel with the conduits 678 along an axis of the cartridge 620m that is perpendicular to the longitudinal axis of the cartridge 620m. In accordance with these implementations, ambient air can begin mixing with the vaporized material within each first airflow outlet channel 626a, pass out of each airflow outlet 628a, and continue to mix within the second airflow outlet channel 626b prior to exiting the cartridge 620m.

As illustrated, the divider 654 can include a cut-out region proximate each bypass air inlet 629. The cut-out region can include an area proximate to each bypass air inlet 629 where the walls of the divider 654 are spaced away from the bypass air inlet 629 to provide an open space for ambient air to enter and direct the vaporized material towards the center of the second airflow outlet channel 626b. In some implementations, the walls of the divider 654 forming the cut-out region can be spaced away from the bypass air inlets 629 by a distance that is greater than or equal to the largest dimension (e.g., diameter, length, or width in a two-dimensional plane) of the bypass air inlet(s) 629. Additionally or alternatively, the cut-out region (e.g., the proximal end of the conduit 678) can extend to a length, in the direction of the distal end to the proximal end of the cartridge 620m, that is less than the length of the bypass air inlet(s) 629. For example, the bypass air inlets 629, bypass channels 638, and bypass outlets 627 can be disposed at a length that is greater than a length of the respective proximal ends of the conduit 678. The bypass air inlets 629, bypass channels 638, and bypass outlets 627 can be parallel along an axis of the cartridge 620m that is perpendicular to the longitudinal axis of the cartridge 620m. Although the term cut-out is used to describe certain regions of the divider 654, no cutting process is required during manufacturing, as these regions can be provided within the divider by other means (e.g., molding).

Similar to the cartridges 620k, 6201 of FIGS. 6K-6L, the divider 654 of the cartridge 620m of FIG. 6M can include an outer perimeter that is aligned with the interior perimeter of the wrapper 622, a proximal end, a distal end, outer walls extending between the proximal end and the distal end, an interior perimeter formed in part by the outer walls, a bulge 679 that includes or otherwise defines the stand-offs 677, an interior volume between the proximal-facing wall(s) of the bulge 679 and the proximal end (e.g., at least partially defining the second airflow outlet channel), and/or the like.

In some implementations, air can pass through unintended pathways between the divider and the wrapper. To help minimize this, the divider can includes at least one seal positioned proximate to the one or more conduits of the divider. The at least one seal can be configured to create a seal between the wrapper about the one or more conduit thereby inhibiting air leakage around the divider. FIG. 40 illustrates a portion of a cartridge 4020 having a divider 4054. Aside from the differences discussed below, the cartridge 4020 and the divider 4054 can be similar to cartridge 620m and divider 654 in FIG. 6M and therefore common features are not described in detail herein. In FIG. 40, the wrapper 4022 is illustrated as transparent to show the divider positioned therein.

As shown, the divider 4054 includes a body 4054a, a first set of seals 4088a, 4088b, and a second set of seals 4088c, 4088d. The first set of seals 4088a, 4088b extends from a first side 4054b of the body 4054a and the second set of seals 4088c, 4088d extends from a second side 4054c of the body 4054a. While the first set of seals 4088a, 4088b and the second set of seals 4088c, 4088d can have a variety of configurations, in this illustrated implementation, the first set of seals 4088a, 4088b and the second set of seals 4088c, 4088d are substantially identical to each other, and therefore for sake of simplicity, the following description is with respect to the first set of seals 4088a, 4088b. A person skilled in the art will understand, however, that the following discussion is also applicable to the second set of seals 4088c, 4088d.

As shown in FIG. 40, the first set of seals 4088a, 4088b is positioned proximate to the first conduit 4078, wherein the first seal 4088a of the first set of seals is positioned on a first side 4078a of the conduit 4078 and the second seal 4088b of the first set of seals is positioned on a second side 4078b of the conduit 4078. Since the first set of seals 4088a, 4088b extend outward and away from the body 4054a of the divider 4054, the first set of seals 4088a, 4088b create a seal with the wrapper via an interference fit.

The cartridge 620m can include at least some of the same components of, and otherwise operate in the same or similar manner as, the cartridges 620k, 6201 of FIGS. 6K-6L, except as noted. Separately, the components of vaporizer cartridge 620m identified and discussed herein can be combined into any of the other vaporizer cartridges 620 described with respect to FIGS. 6A-6J, except as noted or where impractical.

Other implementations of a divider 654 are contemplated, such as the divider 654 in the cartridge 620n of FIG. 6N. As illustrated, the divider 654 of the cartridge 620n can include a series of trenches 676 through which air can pass. The trenches 676 can be defined in part through the presence of stand-offs 677, which can be sinusoidal or otherwise vary in location along one or more axis of the divider 654. In some implementations, the divider 654 can be regarded as corrugated material and/or the stand-offs 677 can be regarded as flutes. The divider 654 can include a first airflow outlet channel that is central to the divider 654, and includes a first airflow outlet 628a into a downstream second airflow outlet channel 626b. A bypass air inlet 629 can be disposed and configured to allow ambient air to enter the first airflow outlet channel 654. Additionally or alternatively, bypass air inlet 629 can be disposed and configured to allow ambient air to enter the trenches 676 formed within the divider 654. The divider 654 can be implemented in multiple layers of trenches 676 (e.g., each separated by intermediate layers) or as multiple dividers 654 stacked on top of each other along the length of the cartridge 620. Providing multiple layers of trenches 676 and/or dividers 654 between the vaporizable material 602 and the bypass air inlet 629 can provide more thermal isolation. For example, the vaporizable material 602 and/or heater 642 can be isolated from the second airflow outlet channel 626b such that a higher temperature can be maintained within the vaporizable material 602 and/or heater 642 and a lower temperature can be achieved within the second airflow outlet channel 626b. The relative lengths of each layer of trenches 676 and/or divider 654 can be the same, or the length of the upstream layer(s) of trenches 676 and/or divider(s) 654 can be greater to provide more thermal isolation.

The cartridge 620n can include at least some of the same components of, and otherwise operate in the same or similar manner as, the cartridges 620k-620m of FIGS. 6K-6M, except as noted. Separately, the components of vaporizer cartridge 620n identified and discussed herein can be combined into any of the other vaporizer cartridges 620 described with respect to FIGS. 6A-6J, except as noted or where impractical.

Although the dividers 654 of FIGS. 6K-6N are illustrated and described as being within the mouthpiece portion 630, in some implementations the divider 654 can be at least partially within the heater portion 641 or within a divider portion that is between the mouthpiece portion 630 and the heater portion 641. For example, the divider 654 can be within a divider portion that is downstream of the heater portion 641, upstream of the mouthpiece portion 630, and/or configured to be at least partially disposed within the receptacle 618.

As illustrated in each of FIGS. 6K-6N, the heating element 642 can include a top region and a bottom region, with one or more removed regions 659 (e.g., cut out) between the top region and the bottom region, similar to the heating element 1542f of FIG. 15F. As described in greater detail with respect to FIGS. 11J-11N, the vaporizer body configured to receive a cartridge 620 can include two or more inductors configured to separately heat the heating element 642 in the top region and the bottom region. The one or more removed regions 659 can enable the current passing within the top region of the heating element 642 to remain (at least primarily) within the top region and the current passing within the bottom region of the heating element 642 to remain (at least primarily) within the bottom region.

Although non-cylindrical cartridges 220, 320, 420, 620a-i and components of corresponding vaporizer bodies for use with non-cylindrical cartridges are illustrated and described with respect to FIGS. 2, 3, 4A-4W, 5A-5G, 6A-6I, cylindrical cartridges such as the cartridge 620j of FIG. 6J can be utilized. FIG. 6J illustrates multiple views of the cartridge 620j, including a perspective view of the exterior, a partially transparent view into the interior, and a cross-sectional view taken along section D-D of the perspective view. As illustrated, the cartridge 620j extends from a cartridge proximal end 620x to a cartridge distal end 620y, and includes a heater portion 641 and mouthpiece portion 630. The heater portion 641 extends from a heater portion proximal end 641a to a heater portion distal end 641b and includes vaporizable material 602 surrounded by a heating element 642 and an end cap 664 (e.g., filter, insert). The mouthpiece portion 630 extends from a mouthpiece portion proximal end 630a to a mouthpiece portion distal end 630b and includes a filter 624. Optionally, the heater portion 641 and mouthpiece portion 630 can be individually wrapped with one or more layer of material (e.g., wrappers 622) and/or a coupled together with an exterior layer of material (e.g., wrapper 622), as described herein.

As illustrated, the filter 624 includes a plurality of bypass channels 638 extending between respective bypass air inlets 629 and bypass outlets 627. Each bypass channel 638 is illustrated as being in fluid communication with a singular airflow outlet channel 626, extending between a vapor inlet 635 at or near the mouthpiece portion distal end 630b (and/or the heater portion proximal end 641a) and an airflow outlet 628 at or near the mouthpiece portion proximal end 630a. Although two bypass channels 638 are illustrated at opposing sides of the filter 624, in series along the length of the mouthpiece portion 630 for a total of four bypass channels 638, different numbers of bypass channels 638 can be present at different locations, such as two total, six total, eight total, etc. bypass channels 638, which can optionally be positioned off-axis from each other along the length of the mouthpiece portion 630. Although a singular airflow outlet channel 626 is illustrated, two or more airflow outlet channels 626 can be present.

Use of a cylindrical cartridge 620 can simplify manufacture relative to a non-cylindrical cartridge. Accordingly, to take advantages of this simplified manufacture while still achieving the benefits of non-cylindrical cartridges described herein, in some implementations the cartridge 620 can be first manufactured as a cylinder and then flattened to some degree to form a non-cylindrical cartridge 620. In some implementations, a cylindrical cartridge can be formed with a diameter of 5 mm to 6 mm, and optionally approximately 5.5 mm. A diameter within this range can be advantageous, as it minimizes the distance between the heating element 642 and a center of vaporizable material 602, while still providing space for a volume of vaporizable material 602 that is sufficient to deliver an amount of an active substance (e.g., nicotine) desirable to a user (e.g., a user of combustible cigarettes). In some implementations, if a non-cylindrical cartridge 620 is used, the cartridge can be formed as a cylinder with a diameter of 6 mm to 8 mm, and optionally approximately 7 mm. Subsequently, the cylinder can be pressed and/or flattened into a non-cylindrical shape having a width of 8 mm to 10 mm (e.g., approximately 8.75 mm) and a depth of 5 mm to 6 mm (e.g., approximately 5.5 mm). In some implementations, a non-cylindrical cartridge 620 can be manufactured, without pressing and/or flattening, with a width of 8 mm to 10 mm (e.g., approximately 8.75 mm) and a depth of 5 mm to 6 mm (e.g., approximately 5.5 mm). In each implementation, the diameter, width, and depth can be regarded as measurements of a cross-section of the cartridge 620, which can optionally be substantially the same for all cross-sections between the cartridge proximal end 620x and the cartridge distal end 620y.

The vaporizer cartridge 620, 620j can include similar components to, and otherwise operate in the same manner as, the vaporizer cartridge 620a of FIG. 6A, except as noted. Separately, the components of vaporizer cartridge 620, 620j identified and discussed herein can be combined with any of the components of the other vaporizer cartridges 620 described with respect to FIGS. 6A-6I, except as noted or where impractical.

Further, alternative divider designs can be implemented to improve performance of the cartridge by quick and consistent heating. When components of the core are not heated quickly and efficiently, the tobacco remains too cool for vaporizing. In instances where the core is cooler than the tobacco, the core can undesirably remove heat from the tobacco as the device operates. In these instances, when the user draws on the device, they can not receive vaporized material until all the components reach temperature, resulting in a delayed and undesirable smoking experience. Furthermore, when the components of the cartridge are unevenly heated, vapor can condense within the cartridge causing greater variation within the device. The implementations described herein are designed to overcome these issues.

As illustrated in FIG. 6O, a perspective view of a corrugated divider 654 can be implemented to improve heating efficiency and consistency. Corrugated divider 654 can have a lower thermal mass compared to molded components. The lower thermal mass improves heating efficiency within the cartridge. The divider 654 can be comprised of one or more layers of corrugated material. As shown, the divider 654 can have a first layer 681a, second layer 681b, and third layer 681c. As the corrugated layers heat during the initial draws on the device, condensation exits the device faster, reducing variation within the device. With a layered, corrugated divider 654, the device can run at lower temperatures resulting in saved energy. As depicted, the divider 654 can have a first surface 682 and an opposing, second surface 683. The divider 654 can comprise a body 684 extending between the first surface 682 and the second surface 683 of the divider 654. The divider 654 can be comprised of paper or cardboard.

In some implementations as illustrated in FIG. 6P, the divider 654 can alternatively or additionally include an infrared reflective material 685 on one or more of the surfaces. The infrared reflective material 685 can be positioned on the first surface 682 of the divider 654. Alternatively, or additionally, the infrared reflective material 685 can be on the second surface 683 of the divider 654. The infrared reflective material 685 can be aluminized paper on the surface that that faces the tobacco. Other types of infrared reflective material can be implemented. The infrared reflective material can transfer heat faster than traditional paper designs as the infrared reflective material pulls heat from the outer edges of the cartridge into the center of the divider, reducing the time required to heat the cartridge.

Due to location of the divider within the wrapper, e.g., downstream of the vaporizable material, the vaporizable material (e.g., plant material such as tobacco leaves and/or parts of tobacco leaves) can clog the vapor inlet(s) of the divider, thereby inhibiting the device's ability to generate aerosol to be inhaled by a user. In an effort to minimize the clogging of the vapor inlet(s) of the divider, the divider can include one or more perforated layers (e.g., a screen) configured to substantially prevent, if not completely prevent, the vaporizable material from entering the vapor inlet(s) of the divider.

In some implementations, the one or more perforated layers can include a first perforated layer positioned on a bottom surface of the body of the divider. Alternatively, or in addition, the one or more perforated layers can include a second perforated layer positioned on a top surface of the body. Alternatively, in some implementation, the divider can include a layer positioned on a top surface of the body, where the layer has at least one through-hole extending therethrough. In some implementations, the divider can include a first perforated layer positioned on a bottom surface of the body and a second perforated layer on the top surface of the body. In other implementations, the divider can include a first perforated layer on a bottom surface of the body, and a layer on a top surface of the body that includes at least one through-hole. In some implementations, the divider only has a single perforated layer, for example, a single perforated layer positioned on the bottom surface of the body.

In instances where the divider includes a first perforated layer on the bottom surface of the body and a second perforated layer on a top surface of the body, the first perforated layer and the second perforated layer can have the same perforation pattern. In other implementations, the first perforated layer and the second perforated layer can have different perforation patterns relative to each other.

The one or more perforated layers or a layer (e.g., a layer with at least one through-hole extending therethrough) can include a variety of materials. Non-limiting examples of suitable materials include paper, aluminum, or a combination thereof. The body of the divider can include a variety of materials, for example, silicone, LCP, or PET, or any combination thereof.

Further, the body of the divider can have a variety of configurations. In some implementations, the body can include a base with a first base surface and an opposing, second base surface, a first rib extending outward from the first surface of the base in a first direction, and a second rib extending outward from the second surface in a second direction. In such implementations, the first rib can define at least a portion of a perimeter of the base, and the second rib can define the same or different portion of the perimeter of the base. Alternatively, or in addition, the base can include at least one through-hole extending therethough. In certain implementations, the divider can have a H-shaped cross-section.

Various implementations of exemplary dividers 4154, 4254, 4354, 4454, 4554 with at least one perforated layer are illustrated in FIGS. 41A-45C. Perspective views of the exemplary dividers 4154, 4254, 4354, 4454, 4554 are illustrated in FIGS. 41A-41B, 42-42B, 43A-43B, 44A-44B, and 45A-45B, respectively. Further, cartridges 4120, 4220, 4320, 4420, 4520 that include respective dividers 4154, 4254, 4354, 4454, 4554 are illustrated in FIGS. 41C, 42C, 43C, 44C, and 45C.

As shown in FIGS. 41A-41C, the divider 4154 includes a base 4154a, a first rib 4154b extending outward from the base in a first direction, and a second rib 4154c extending outward from the base 4154a in a second direction. As further shown, the divider 4154 includes a perforated layer 4155 coupled to the bottom surface 4156a of the body 4156 of the divider 4154, and the base 4154a includes at least one through-hole 4155 extending therethrough. While the perforation pattern of the perforated layer 4155 can have a variety of configurations, as shown, the perforation pattern includes a plurality of rows of perforations.

As shown in FIGS. 42A-42C, the divider 4254 includes a body 4256 with a perforated layer 4255 coupled to the bottom surface 4256a of the body 4256. In this illustrated implementation, the body 4256 has a tubular configuration. Further, the perforation pattern of the perforated layer 4255, e.g., a plurality of rows of perforations, is similar to the perforation pattern of the perforated layer 4155 in FIGS. 41A-41C.

As shown in FIGS. 43A-43C, the divider 4354 includes a body 4356 with a perforated layer 4355 coupled to the bottom surface 4356a of the body 4356. In this illustrated implementation, the body 4356 has a tubular configuration. Further, in this illustrated implementation, the perforation pattern of the perforated layer 4355 includes a single row of perforations.

As shown in FIGS. 44A-44C, the divider 4454 includes a body 4456 with a perforated layer 4455 coupled to the bottom surface 4456a of the body 4456. In this illustrated implementation, as shown in FIG. 44C, the body 4356 has a tubular configuration. The divider 4454 also includes a layer 4457 coupled to the top surface 4456b of the body 4456, where the layer 4457 includes at least one through-hole 4458 extending therethrough. Further, the perforation pattern of the perforated layer 4455, e.g., a plurality of rows of perforations, is similar to the perforation pattern of the perforated layer 4155 in FIGS. 41A-41C.

As shown in FIGS. 45A-45C, the divider 4554 includes a body 4556 with a first perforated layer 4555a coupled to the bottom surface 4556a of the body 4556, and a second perforated layer 4555b coupled to the top surface 4556b of the body 4556. In this illustrated implementation, as shown in FIG. 45C, the body 4356 has a tubular configuration. Further, the perforation pattern of the first and second perforated layers 4555a, 4555b, e.g., a plurality of rows of perforations, are identical.

FIGS. 52A and 52B illustrate a perspective view and a partially exploded view, respectively, of a vaporizer cartridge 5220 that includes a divider 5254, in which the divider 5254 is similar to 4254 shown in FIGS. 42A and 42B and therefore operates in the same manner. The vaporizer cartridge 5220 disclosed herein can include similar components to, and otherwise operate in the same manner as the other vaporizer cartridges discussed, for example, the vaporizer cartridges 620 of FIG. 6A-6N, except as noted. Separately, the components of vaporizer cartridge 5220 identified and discussed herein can be combined with any of the components of the other vaporizer cartridges 620 described with respect to FIGS. 6A-6I, except as noted or where impractical. Further, while not shown, in use the vaporizer cartridge 5220 is at least partially inserted into a vaporizer body as disclosed herein. The vaporizer body can include at least one inductor, e.g., a first inductor and a second inductor, both of which can be in the form of a helical coil, configured to generate a magnetic and/or electromagnetic field to heat the heating element of the vaporizer cartridge as discussed herein.

With reference to FIGS. 52A-52B, the vaporizer cartridge 5220 can extend from a first cartridge end 5220x to a second cartridge end 5220y. The vaporizer cartridge 5220 can include a wrapper 5222 configured to hold a vaporizable material 5202 disposed therein. The vaporizable material 5202 can include a tobacco material. The tobacco material can be cut, shredded, and/or the like. For example, in some implementations, the vaporizable material 5202 can be cut rag tobacco, such that it has a better ability to absorb a carrier material.

The wrapper can have a variety of configurations. For example, as shown in FIGS. 52A and 52B, the wrapper 5222 has a tubular configuration. In other implementations, the wrapper can have other suitable configurations and therefore is not limited to the structural configuration illustrated in the figures. In some implementations, the wrapper can have a thickness in the range of about 0.02 mm to about 0.07 mm, about 0.03 mm to about 0.06 mm. In certain implementations, the wrapper can have a thickness of about 0.05 mm. The wrapper can be formed of a variety of suitable materials. In some implementations, the wrapper can be formed of paper. The paper can have an overlap region that is attached together, e.g., by PVA glue. In certain implementations, the wrapper can have a basis weight from about 25 gsm to about 75 gsm or from about 30 gsm to about 50 gsm.

In some implementations, the wrapper 5222 can extend from the first cartridge end 5220x to the second cartridge end 5220y. The vaporizer cartridge 5220 can include a mouthpiece insert 5274 positioned proximate to the first cartridge end 5220x. In some implementations, the mouthpiece insert 5274, once inserted, can extend from the first cartridge end 5220x towards the second cartridge end 5220y. In other words, a first end 5274a of the mouthpiece insert 5274 can be flush with the first cartridge end 5220x, whereas in other implementations, the first end 5274a of the mouthpiece insert 5274 can be spaced a distance away from the first cartridge end 5220x.

The mouthpiece insert 5274 can have a variety of configurations. In some implementations, the mouthpiece insert 5274 can be formed of a vapor-permeable material (e.g., cellulose acetate) that is configured to allow the inhalable aerosol to pass therethrough. In some implementations, the mouthpiece insert can have a height in the range from about 5 mm to about 10 mm or from about 7 mm to about 9 mm. In one implementation, the mouthpiece insert can have a heigh of about 8 mm. In some implementations, the density of the mouthpiece insert 5274 can be at least about 150 g/100 rod or higher. In certain limitations, the density of the mouthpiece insert 5274 can be from about 150 g/100 rod to about 300 g/100 rod or from about 150 g/100 rod to about 200 g/100 rod. In one implementation, the density of the mouthpiece insert 5274 can be about 184 g/100 rod.

In some implementations, the mouthpiece insert 5274 can have one or more channels defined therein that can serve as an airflow path for the inhalable aerosol generated in the cartridge. For example, as shown in FIG. 52B, the mouthpiece insert 5274 can include an outlet channel 5275 through which the inhalable aerosol formed in the condensation chamber 5253 can exit and be inhaled by a user. While the outlet channel can have a variety of configurations, as shown in FIG. 52B, the outlet channel 5275 extends from a first end 5274a of the mouthpiece insert 5274 to a second end 5274b of the mouthpiece insert 5274. In other implementations, the mouthpiece insert can include two or more outlet channels.

As shown in FIG. 52A, at least a portion of the wrapper can define a condensation chamber 5253 that extends at least between the mouthpiece insert 5274 and the divider 5254 for a vapor generated from the vaporizable material 5202 to condense and form an inhalable aerosol.

The divider 5254 can be formed of any suitable material, e.g., polyethylene terephthalate (PET). Further, as shown, the divider can be positioned proximate to the vaporizable material. In some implementations, the distance D between a bottom surface 5254a of the divider 5254 and the tobacco can be less than 1 mm, e.g., about 0.2 mm or about 0.4 mm. This distance inhibits carrier condensation from occurring between the divider 5254 and the tobacco. The divider includes a body 5256 with a perforated layer (obstructed, see the perforated layer 4255 in FIGS. 42A-42C) coupled to the bottom surface (obstructed) of the body 5256. In this illustrated implementation, the body 5256 has a tubular configuration. As shown, the body has a channel extending therethrough. While only one channel is shown, in other implementations, the body can more than one channel extending therethrough. Further, while not shown, the perforation pattern of the perforated layer, e.g., a plurality of rows of perforations, is similar to the perforation pattern of the perforated layer 4255 in FIGS. 42A-42C. The perforated layer (e.g., screen) can help minimize vaporizable material (e.g., tobacco) from clogging the divider, which could change the effective bypass air ratio and could reduce the power needed for a session thereby increasing battery life.

The vaporizable cartridge 5220 can include one or more bypass air inlets 5289 that are configured to allow ambient air to enter the cartridge. As shown, the one or more bypass air inlets 5289 extend through the wrapper 5222 to allow ambient air to pass through the one or more bypass air inlets 5289 and into the condensation chamber 5253. In other words, condensation chamber 5253 is in fluidic communication with ambient air through the one or more bypass air inlets. In some implementations, the vaporizer cartridge can include one bypass air inlet, whereas in other implementations, the vaporizer cartridge can include two or more bypass air inlets. For example, as shown in FIGS. 52A-52B, the vaporizer cartridge 5220 includes two sets of three bypass air inlets. A person skilled in the art will appreciate that the number, position, and size of the one or more bypass air inlets can be changed to effect desired airflow characteristics (e.g., the amount of air, air flow speed, by-pass ratio such as about 60% or 65%, and the like) into the condensation chamber 5253 to thereby tailor the condensation environment to generate an inhalable aerosol.

In some implementations, the vaporizer cartridge 5220 can include an insert 5264 positioned proximate to the second cartridge end 5220y. In some implementations, the insert 5264, once inserted, can extend from the second cartridge end 5220y towards the first cartridge end 5220x. In other words, a first end 5264a of the insert 5264 can be flush with the second cartridge end 5220y, whereas in other implementations, the first end 5264a of the insert 5274 can be spaced a distance away from the second cartridge end 5220y.

The insert 5264 can include one or more air inlets (not shown) that allow ambient air to enter a heater chamber defined by the heating element 5242. The insert can be formed of one or more materials. In some implementations, the insert 5264 can be formed of polyethylene terephthalate (PET).

In some implementations, the insert 5264 and the divider 5254 can be formed of the same material. In some implementations, the insert 5264 can have a density that is greater than the density of the divider 5254. In other words the porosity of the perforated layer of the divider 5254 can be greater that the porosity of the insert 5264. In such instances, this would result in more flow restriction through the insert 5264 compared to the divider 5254, which alone or in combination with the 2 sets of bypass inlets can minimize variability in the amount of inhalable aerosol being produced during use. In certain implementations, the density of the insert can be about 340D.

In some implementations, the vaporizer cartridge 5220 can include a heating element 5242 configured to heat the vaporizable material 5202. The heating element 5242 can be disposed within the wrapper (e.g., the wrapper can be wrapped about the heating element or inserted into a preformed wrapper during manufacturing of the vaporizer cartridge.)

The heating element 5242 can include similar components to, and otherwise operate in the same manner as the other heating elements discussed, for example, the heating elements of FIG. 13A-15K, except as noted. Separately, the components of the heating element identified and discussed in FIGS. 52A and 52B can be combined with any of the components of the other heating elements described with respect to FIG. 13A-15K, except as noted or where impractical.

The heating element 5242 can have a variety of configurations, the heating element 5242 can include a top region 5244, a bottom region 5245, one or more cut-out regions 5249 between the top region 5244 and the bottom region 5245. As such, the heating element 5242 can be similar to heating element 1542i shown in FIG. 15I.

In some implementations, the heating element 5242 can include one or more metals, such as aluminum, an aluminum alloy, copper, brass, zirconium, stainless steel (ferritic or non-ferritic), nickel, the like, or any combination thereof. As described herein, aluminum is beneficial for spreading heat and stainless steel is better for localized heat.

In some implementations, the heating element 5242 can be in the form of a foil sheet (e.g., 1000, 8000, or 8011 series aluminum sheet). The heating element 5242 can have a thickness in the range from about 10 μm to about 35 μm, or from about 10 μm to about 35 μm, or from about 12 μm to about 20 μm. In one implementation, the heating element 5242 can have a thickness of about 20 μm.

FIGS. 7A-7D illustrate a process for manufacturing a vaporizer cartridge 720, as perspective views of the vaporizer cartridge 720 and/or its components. As illustrated in FIG. 7A, a vaporizable material 702 can be formed into specific shape, such as a shape that has a cross-section similar to one or more of the cross-sections of FIGS. 8A-8F. As illustrated in FIG. 7B, a heating element 742 can be wrapped around the vaporizable material 702 to form a heater portion 741 that has the same specific shape. However, in some implementations the heating element is first formed into a shape that is configured to receive the vaporizable material 702, and the vaporizable material 702 is subsequently fit into this shape.

As described herein, the heating element 742 can be a single sheet of metal that is wrapped around the perimeter of the heater portion 741, with the ends of the sheet meeting in a joint location (not illustrated). The ends of the sheet can placed on top of each other and glued together, bent inwards towards the vaporizable material 702 (e.g., at approximately right angles) and glued together, formed into complementary shapes that are designed to interlock, and/or the like.

Although not illustrated, the process for manufacturing the vaporizer cartridge 720 can include forming a mouthpiece portion 730, such as by laser-cutting one or more airflow outlet channels through a inserts 742a, as described herein. However, other implementations are described herein that do not include airflow outlet channels through a filter, and manufacturing the differently-designed mouthpiece portions 730 as part of the process of manufacturing the cartridge 720 is within the scope of this disclosure.

As illustrated in FIG. 7C, the heater portion 741 and the mouthpiece portion 730 can be held (e.g., wrapped) together in a layer of material (e.g., wrapper 722). In some implementations, a second filter 724b can be disposed at a cartridge distal end 720b and/or a third filter 724c can be disposed at a cartridge proximal end 720a. Although implementations are described herein that include only one or neither of the second and third filters 724b, 724c, as illustrated, the second filter 724b can be held (e.g., wrapped) within the layer of material (e.g., wrapper 722) at the cartridge distal end 720b and the third filter 724c can be held (e.g., wrapped) within the layer of material (e.g., wrapper 722) at the cartridge proximal end 720a.

Whatever components are assembled within the cartridge 720, as illustrated in FIG. 7D, a plurality of vapor inlets 735 can be formed within the mouthpiece portion 730, through the layer of material (e.g., wrapper 722). As described herein, these vapor inlets 735 can be in fluid communication with one or more condensation chambers, such as through bypass channels, and configured to allow passage of ambient air into the one or more condensation chambers.

Alternative processes for manufacturing a vaporizer cartridge 720, are contemplated, such as the process of manufacturing the vaporizer cartridge 720e illustrated in FIG. 7E. As illustrated, the mouthpiece portion 730 can be formed by wrapping a first filter 724a, a third filter 724c, and/or a fourth filter 724d within a first wrapper 722a. The first filter 724a can be the same or similar to the first filter 624a of FIG. 6E, the third filter 724c can be the same or similar to the end cap 674 of FIG. 6E, and/or the fourth filter 724d can be the same or similar to the second filter 624b of FIG. 6E. The heater portion 741 can be formed by wrapping vaporizable material 702 within a heating element 742 and/or wrapping a second filter 724b within a second wrapper 722b. For example, the second filter 724b can not be wrapped with its own wrapper 722 and/or can have a cross-section that is substantially the same size as the cross-section of the heating element 742 when it is wrapped around the vaporizable material 702. The second filter 724b can be the same or similar to the end cap 664 of FIG. 6D. As illustrated, the second filter 724b can optionally include a plurality of cartridge inlets 725 (e.g., two, three, four, five, etc. through-holes) extending through the second filter 724b, from an exterior of the cartridge 720e to the vaporizable material 702. The mouthpiece portion 730 and the heater portion 741 can be wrapped with a third wrapper 772c to form the cartridge 720e. After the mouthpiece portion 730 and the heater portion 741 are wrapped together, a plurality of vapor inlets 735 can be formed within the mouthpiece portion 730, through the third wrapper 722c, the first wrapper 722a, and/or the fourth filter 724d, such as by laser cutting.

The process of manufacturing the cartridge 720e can be otherwise the same or similar to the manufacturing of the cartridge 720 illustrated and described with respect to FIGS. 7A-7D. Additionally or alternatively, the vaporizer cartridges 720, 720e of FIGS. 7A-7E can include similar components to, and otherwise operate in the same manner as, the vaporizer cartridges 620 described with respect to FIGS. 6A-6J, except as noted or where impractical.

Additional implementations exist where additional or alternative structures can be present that provide a more simplified vaporizer cartridge, e.g., a vaporizer cartridge without a divider. Further, such vaporizer cartridges can be formed using a more simplified manufacturing process.

FIGS. 48A-48C illustrate an exemplary vaporizer cartridge 4820 for a vaporizer device that does include a divider. The vaporizer cartridge 4820 disclosed herein can include similar components to, and otherwise operate in the same manner as the other vaporizer cartridges discussed, for example, the vaporizer cartridges 620 of FIG. 6A-6N, except as noted. Separately, the components of vaporizer cartridge 4820 identified and discussed herein can be combined with any of the components of the other vaporizer cartridges 620 described with respect to FIGS. 6A-6I, except as noted or where impractical. Further, while not shown, in use the vaporizer cartridge 4820 is at least partially inserted into a vaporizer body as disclosed herein. The vaporizer body can include at least one inductor configured to generate a magnetic and/or electromagnetic field to heat the heating element of the vaporizer cartridge as discussed herein.

With reference to FIGS. 48A-48C, the vaporizer cartridge 4820 can extend from a first cartridge end 4820x to a second cartridge end 4820y. The vaporizer cartridge 4820 can include a wrapper 4822 configured to hold a vaporizable material 4802 disposed therein. The vaporizable material 4802 can include a tobacco material. The tobacco material can be cut, shredded, and/or the like. For example, in some implementations, the vaporizable material 4802 can be cut rag tobacco, such that it has a better ability to absorb the carrier.

The wrapper can have a variety of configurations. In some implementations, the wrapper can have a thickness in the range of about 0.02 mm to about 0.07 mm, about 0.03 mm to about 0.06 mm. In certain implementations, the wrapper can have a thickness of about 0.05 mm. The wrapper can be formed of a variety of suitable materials. In some implementations, the wrapper includes paper that is formed into a tubular configuration. The paper can have an overlap region that is attached together, e.g., by PVA glue. In certain implementations, the wrapper can have a basis weight from about 25 gsm to about 75 gsm or from about 30 gsm to about 50 gsm.

In some implementations, the wrapper 4822 can extend from the first cartridge end 4820x to the second cartridge end 4820y. The vaporizer cartridge 4820 can include a mouthpiece insert 4874 positioned proximate to the first cartridge end 4820x. In some implementations, the mouthpiece insert 4874, once inserted, can extend from the first cartridge end 4820x towards the second cartridge end 4820y. In other words, a first end 4874a of the mouthpiece insert 4874 can be flush with the first cartridge end 4820x, whereas in other implementations, the first end 4874a of the mouthpiece insert 4874 can be spaced a distance away from the first cartridge end 4820x.

The mouthpiece insert 4874 can have a variety of configurations. In some implementations, the mouthpiece insert 4874 can be formed of a vapor-permeable material (e.g., cellulose acetate) that is configured to allow the inhalable aerosol to pass therethrough. In some implementations, the mouthpiece insert can have a height in the range from about 5 mm to about 10 mm or from about 7 mm to about 9 mm. In one implementation, the mouthpiece insert can have a heigh of about 8 mm. In some implementations, the density of the mouthpiece insert 4874 can be at least about 150 g/100 rod or higher. In certain limitations, the density of the mouthpiece insert 4874 can be from about 150 g/100 rod to about 300 g/100 rod or from about 150 g/100 rod to about 200 g/100 rod. In one implementation, the density of the mouthpiece insert 4874 can be about 184 g/100 rod.

In some implementations, the mouthpiece insert 4874 can have one or more channels defined therein that can serve as an airflow path for the inhalable aerosol generated in the cartridge. For example, as shown in FIG. 48B, the mouthpiece insert 4874 can include an outlet channel 4875 through which the inhalable aerosol formed in the condensation chamber can exit and be inhaled by a user. While the outlet channel can have a variety of configurations, as shown in FIG. 48B, the outlet channel 4875 extends from a first end 4874a of the mouthpiece insert 4874 to a second end 4874b of the mouthpiece insert 4874. In other implementations, the mouthpiece insert can include two or more outlet channels.

In some implementations, the vaporizer cartridge 4820 can include a support structure 4830 configured to receive the mouthpiece insert 4874. In certain implementations, the support structure 4830 can have a height in a range from about 20 mm to about 30 mm or from about 22 mm to about 28 mm. In one implementation, the support structure 4830 can have a height of about 24 mm. A person skilled in the art would appreciate that during manufacturing, the height of the support structure can be higher, and the support structure can then be cut to a desired height, such as those mentioned above prior to being incorporated into the vaporizer cartridge 4820. In some implementations, the support structure 4830 can have a thickness from about 0.1 mm to about 1 mm, from about 0.1 mm to about 0.5 mm, or from about 0.2 mm to about 0.3 mm. The support structure can be formed of a variety of materials. In some implementations, the support structure includes paper that is formed into a tubular configuration. The paper can have an overlap region that is attached together, e.g., by PVA glue.

At least a portion of the support structure 4830 can define a condensation chamber 4832 that extends between the mouthpiece insert 4874 and the vaporizable material 4802 for a vapor generated from the vaporizable material 4802 to condense and form an inhalable aerosol. In instances where no mouthpiece insert or other element is present within the support structure, the entire support structure can define condensation chamber. The support structure 4830 can have a variety of configurations. For example, as shown in FIG. 48C, the support structure 4830 has a tubular configuration. In other implementations, the support structure can have other suitable configurations and therefore the support structure is not limited to the structural configuration illustrated in the figures.

The vaporizable cartridge 4820 can include one or more bypass air inlets 4829 that are configured to allow ambient air to enter the cartridge. As shown, the one or more bypass air inlets 4829 extend through at least the wrapper 4822 to allow ambient air to pass through the one or more bypass air inlets 4829 and into the condensation chamber 4832. In other words, condensation chamber is in fluidic communication with ambient air through the one or more bypass air inlets. In some implementations, the one or more bypass air inlets 4829 can extend through both the wrapper 4822 and the support structure 4830. In some implementations, the vaporizer cartridge can include one bypass air inlet, whereas in other implementations, the vaporizer cartridge can include two or more bypass air inlets. For example, as shown in FIGS. 48A-48C, the vaporizer cartridge 4820 includes two sets of 5 bypass air inlets. A person skilled in the art will appreciate that the number and position of the one or more bypass air inlets can be changed to effect desired airflow characteristics (e.g., the amount of air, air flow speed, and the like) into the condensation chamber to thereby tailor the condensation environment to generate an inhalable aerosol.

In some implementations, the vaporizer cartridge 4820 can include an insert 4864 positioned proximate to the second cartridge end 4820y. In some implementations, the insert 4864, once inserted, can extend from the second cartridge end 4820y towards the first cartridge end 4820x. In other words, a first end 4864a of the insert 4864 can be flush with the second cartridge end 4820y, whereas in other implementations, the first end 4864a of the insert 4874 can be spaced a distance away from the second cartridge end 4820y.

The insert 4864 can include one or more air inlets (not shown) that allow ambient air to enter a heater chamber 4880 defined by the heating element 4842. In some implementations, the insert 4864 can be formed of a vapor-permeable material (e.g., cellulose acetate) that is configured to allow ambient air to pass therethrough. In some implementations, the insert can have a height in the range from about 5 mm to about 10 mm or from about 7 mm to about 10 mm. In one implementation, the insert can have a height of about 8 mm. In some implementations, the density of the insert 4864 can be from about 100 g/100 rod to about 200 g/100 rod or from about 150 g/100 rod to about 200 g/100 rod. In one implementation, the density of the insert 4864 can be about 150 g/100 rod to about 184 g/100 rod. In some implementations, the insert 4864 can have one or more channels (not shown) that can serve as one or more airflow paths for ambient air to pass into the cartridge, and consequently into at least the heating chamber 4880.

In some implementations, the vaporizer cartridge 4820 can include a heating element 4842 configured to heat the vaporizable material 4802. The heating element 4842 can be disposed within the wrapper (e.g., the wrapper can be wrapped about the heating element or inserted into a preformed wrapper during manufacturing of the vaporizer cartridge.) Depending on the configuration of the heating element, the two opposing sides can be longitudinal sides or lateral sides. In the illustrated implementation shown in FIGS. 48A-48D, the two opposing sides of the heating element 4842 are longitudinal sides (e.g., extending along a y-axis).

In some implementations, the heating element 4842 can include an infrared reflective material configured to heat the vaporizable material and reflect heat towards the vaporizable material to generate a vapor. In some implementations, the heating element 4842 can include one or more metals, such as aluminum, an aluminum alloy, copper, brass, zirconium, stainless steel (ferritic or non-ferritic), nickel, the like, or any combination thereof.

As described herein, aluminum is beneficial for spreading heat and stainless steel is better for localized heat. For an inductive heating approach, use of a non-magnetic material, such as aluminum, allows the creation of eddy currents in the heating element, while a magnetic material, such as ferritic stainless steel, is inductively heated by a hysteresis mechanism. Different inductor coil arrangements are generally needed for these two heating approaches, which can have different requirements such as an amount of power required to generate an electromagnetic field. However, in some implementations, the heating element 4842 is non-ferritic and non-magnetically permeable, which can simplify the design of the vaporizer cartridge 4820 and allow for tighter control in heating of the heating element 4842. In some implementations, the vaporizer cartridge 4820 can be configured to couple to a vaporizer body which includes at least one inductor. The at least one inductor can be configured to generate a magnetic and/or electromagnetic field to heat the heating element 4842 such that heat is conducting from the heating element to the vaporizable material 4802 to thereby heat the vaporizable material 4802 to generate vapor.

The at least one inductor described herein can be driven at a variety of frequencies. For example, in some aspects, one or more inductors of a vaporizer device can be driven at a frequency less than 1 megahertz (MHz) (e.g., at a low frequency). In such instances, the frequency can be in a range of 100 kilohertz (kHz) to 600 kilohertz (kHz), 200 kHz to 600 kHz, 200 kHz to 500 kHz, 200 kHz to 400 kHz, 150 kHz to 350 kHz, or 200 kHz to 300 kHz. By contrast, in other aspects, the one or more inductors of a vaporizer device can be driven at a frequency that is equal to or greater than 1 megahertz (MHz) (e.g., at a high frequency). In such instances, the frequency can be in a range of 1 MHz to 50 MHz or 1 MHz to 30 MHz.

In some implementations, the heating element 4842 includes a first sheet. For example, the heating element 4842 can be in the form of a foil sheet (e.g., 1000 or 8000 series aluminum sheet). The heating element 4842, and thus the sheet, can have a thickness in the range from about 10 μm to about 35 μm, or from about 10 μm to about 35 μm, or from about 12 μm to about 20 μm. In certain implementations, the heating element 4842 can also include one or more additional sheets (e.g., such as a paper). In such implementations, the first sheet of the heating element 4842 can be positioned adjacent or disposed on at least a portion of a surface of an additional sheet of the heating element 4842, or vice versa.

In some implementations, the heating element 4842 can define at least a portion of a perimeter of the heater chamber 4880 for containing the vaporizable material 4802. In some implementations, during manufacturing of the vaporizer cartridge 4820 the heating element 4842 can be wrapped around the vaporizable material 4802 or the vaporizable material 4802 can be inserted into the heater chamber 4880 of a partially formed or completely formed heating element.

The heating element 4842 can include similar components to, and otherwise operate in the same manner as the other heating elements discussed, for example, the heating elements of FIG. 13A-15K, except as noted. Separately, the components of the heating element identified and discussed in FIGS. 48A-48D can be combined with any of the components of the other heating elements described with respect to FIG. 13A-15K, except as noted or where impractical.

While the heating element 4842 can have a variety of configurations, the heating element 4842, as shown in greater detail in FIG. 48D, can include a first region 4844, a second region 4845, and a third region 4849, in which the second region 4845 is spaced apart from the first region 4844 by the third region 4849. The first region 4844, the second region 4845, the third region 4849, or any combination thereof, can each extend around at least a portion of the perimeter of the vaporizable material 4802.

In this illustrated implementation, the first region 4844, the second region 4845, the third region 4849 each extend around the entire perimeter of the vaporizable material. As a result, the first region 4844, the second region 4845, and the third region 4949 each form a continuous loop to create an electrically conductive path around the heating element 4842. Each of the first region 4844, the second region 4845, the third region 4849 can form a continuous loop extending in a lateral direction, perpendicular to a longitudinal axis L (see FIG. 48A) of the vaporizer cartridge 4820. In some implementations, the third region 4849 can include perforations 4882 such that current flows through the heating element 1542 in an identifiable manner. In other words, the perforations 4882 can enable the current passing within the first region of the heating element to remain (at least primarily) within the first region and the current passing within the second region of the heating element to remain (at least primarily) within the second region. The number and pattern of the perforations 4882 can vary and therefore are not limited to what is illustrated in the figures.

In additional implementations, heating elements/assemblies shown in FIGS. 49-50I can include similar components to, and otherwise operate in the same manner as the other heating elements/assemblies discussed, for example, the heating elements/assemblies of FIGS. 13A-15K and 48A-48D, except as noted. Separately, the components of the heating element identified and discussed in FIGS. 49-50I can be combined with any of the components of the other heating elements/assemblies described with respect to FIGS. 13A-15K and 48A-48D, except as noted or where impractical.

In other implementations, as shown in FIG. 49, a heating assembly 4942 is provided that includes a first region 4944, a second region 4945, and a third region 4949 that can each extend around a perimeter of the vaporizable material. Depending on the configuration of the heating assembly, the two opposing sides can be longitudinal sides (e.g., sides that extend in a direction along the longitudinal axis L of the heating assembly) or lateral sides. In the illustrated implementation shown in FIG. 49, the two opposing sides of heating assembly 4942 are longitudinal sides. Further, while not shown, a person skilled in the art will appreciate that the heating assembly 4942 could be part of a cartridge. For example, the heating assembly 4942 could replace the heating element 4842 and therefore the heating assembly 4942 can be used in combination with all the other elements of the cartridge 4820 (FIGS. 48A-48C) as discussed above, and any of the vaporizer bodies disclosed herein, except where impractical.

In some implementations, the heating assembly 4942 can include a plurality of heating elements. While the heating assembly 4942 can include two or more heating elements, as shown in FIG. 49, the heating assembly 4942 includes a first heating element 4941a positioned within the first region 4944 and a second heating element 4941b positioned in the second region 4945b. Each of the heating elements 4941a, 4941b can be formed of a respective sheet (e.g., aluminum foil) as discussed above.

The heating assembly 4942 can also include a substrate 4940 having a first end 4950x and a second end 4950y, in which the substrate 4940 can provide structural support for the first and second heating elements 4941a, 4941b. The substrate can be formed of a variety of materials, e.g., paper.

The first heating element 4941a can be positioned proximate to the first end 4950x of the substrate 4940, and a second heating element 4941b can be disposed proximate to the second end 4950y of the substrate 4940, in which the second heating element 4941b is spaced apart from the first heating element 4941b by the third region 4949. In some implementations, the third region 4949 does not include the plurality of heating element 4941a, 4941b. In such implementations, the third region can be formed of only the substrate 4940 (e.g., paper). In some implementations, the first and the second heating elements 4191a, 4941b can be disposed on a surface of the substrate 4940. In some implementations, as shown in FIG. 49, the surface can be an exterior surface 4940a of the substrate 4940. In other implementations, for example, as shown in FIG. 50G, the surface can be an interior surface 5043b opposite to the exterior surface 5043a of the substrate 5042b.

In some implementations, the opposing sides of a heating element (e.g., heating element 4842 or a heating assembly (e.g., heating elements 4842 (FIG. 48D), the first heating element 4941a (see FIG. 49), or the second heating element 4941 (see FIG. 49)) can be connected together (e.g., by gluing or welding, or a combination thereof) to form the continuous loop. In some implementations, two opposing sides of the heating element or a heating assembly can be attached (via gluing, welding, or both) at least partially along the longitudinal edges. In some implementations, the two opposing sides of the heating element/assembly 4842/4942 can be attached at only the first region 4844/4944 and the second region 4845/4945.

In additional implementations, various structures and configurations of a heating element/assembly discussed herein are shown in FIGS. 50A-50I. The two opposing sides of the heating element (e.g., heating element 4842) or the heating assembly (e.g., heating assembly 4942) can be attached (via gluing, welding, or both) to each other to form a loop that extends around a vaporizable material, for example, a cut rag tobacco. The glue can be any suitable glue, for example, a polyvinyl acetate glue. Any suitable welding process can be used to weld the two opposing sides.

FIGS. 50A-50F illustrates different ways of connecting the two opposing sides of an exemplary heating assembly 5042a. The heating element 5042a similarly can have a first region 5044a, a second region 5045a, and a third region 5049a. As shown in FIGS. 50A-50B, in some implementations, a first edge portion 5040x of the substrate 5040 (e.g., paper) can be attached to (e.g., by gluing, welding, taping, or the like, or any combination thereof) a second edge portion 5040y of the substrate 5040. In some embodiments, a first edge segment 5041x of the plurality of the heating elements 5041 can extend over the first edge portion 5040x of the substrate 5040 and can be attached to (e.g., by welding, gluing, or the like, or any combination thereof) a second edge segment 5041y of the plurality of the heating elements 5041 that can extend over the second edge portion 5040y of the substrate 5040. Once the first and the second edge portions 5040x and 5040y of the substrate 5040 are attached to each other, and the first and the second edge segments 5041x and 5041y of the plurality of the heating elements are attached to each other, the attached first and the second edge portions 5040x and 5040y of the substrate 5040, along with the attached first and the second edge segments 5041x and 5041y of the plurality of the heating elements can be folded towards and onto an exterior surface of the heating element 5042a and held against the surface through deformation from the fold or by using glue to adhere the segments to the surface.

In some implementations, as shown in FIGS. 50C-50D, the first edge 5040x of the substrate 5040 in an unfolded state can be glued to the second edge 5040y of the substrate 5040 also in an unfolded state. The first edge 5041x of the plurality of the heating elements 5041 separated from the first edge 5040x of the substrate 5040 and in an unfolded state can be welded to the second edge 5041y of the plurality of the heating elements 5041 that can also be separated from the second edge 5040y of the substrate 5040 and in an unfolded state.

In other implementations, as shown in FIGS. 50E-50F, the first edge 5040x of the substrate 5040 in an unfolded state can be glued to the second edge 5040y of the substrate 5040 in an unfolded state. The substrate 5040 and the plurality of the heating elements 5041 of the heating element 5042a can simply overlap with each other at the two opposing sides of the heating element 5042a. The first edge 5041x of the plurality of the heating elements 5041 can extend over the substrate 5040 and can overlap with and welded to the second edge 5041y of the plurality of the heating elements 5041 that is disposed on the substrate 5040. The plurality of the heating elements 5041 can be laser cut from a continuous roll of foil during manufacturing.

FIGS. 50G-50I illustrates a heating assembly 5042b that includes components that are generally similar to that shown in FIGS. 49-50H. However, the heating assembly 5042b can include the plurality of heating elements 5041 disposed on an interior surface of the substrate 5040, as opposed to on an exterior surface of the substrate 5040 as shown in FIGS. 49-50H. The first edge 5040x of the substrate 5040, along with the plurality of heating elements 5041 disposed on the substrate 5040, can be glued, welded, or mechanically crimped to the second edge 5040y of the substrate 5040, along with the plurality of heating elements 5041 disposed on the substrate 5040, and then folded towards and onto an exterior surface of the heating assembly 5042b and held against the surface with or without glue.

Various manufacturing processes can be used to create any of the vaporizer devices disclosed herein. In some implementations, a method of manufacturing a vaporizer device can include inserting a mouthpiece insert into a support structure such that the mouthpiece insert is positioned proximate to a first end of the support structure; wrapping a heating element around a vaporizable material and positioning the heating element adjacent to a second end of the support structure, the second end opposing the first end of the support structure, the heating element configured to generate heat by induction and heat the vaporizable material to generate a vapor; and wrapping a wrapper around the support structure and the heating element, the heating element being positioned adjacent to the second end of the support structure. The heating element includes a first region, a second region, and a third region, in which the third region is positioned between the first and the second regions, and the third region that include perforations.

In some implementations, wrapping the heating element around the vaporizable material can include attaching two opposing sides of the heating element to form a loop. In certain implementations, attaching the two opposing sides can include welding two opposing sides of the heating element to form the loop. In other implementations, attaching the two opposing sides can include gluing two opposing sides of the heating element to form the loop.

In some implementations, the method can include positioning an insert adjacent to a first end of the heating element. In such implementations, a second end of the heating element can be adjacent the support structure. In certain implementations, the insert can include a cellulose acetate.

In some implementations, the method can include creating one or more bypass air inlets through the support structure and the wrapper to thereby allow ambient air to pass through the one or more bypass air inlets and into the condensation chamber. In such implementations, creating the one or more bypass air inlets can include laser cutting the one or more bypass air inlets through the support structure and the wrapper.

In other implementations, a method of manufacturing a vaporizer device can include inserting a mouthpiece insert into a support structure such that the mouthpiece insert is positioned proximate to a first end of the support structure, providing a heating assembly and wrapping the heating assembly around a vaporizable material and positioning the heating assembly adjacent to a second end of the support structure, the second end opposing the first end of the support structure, the heating assembly configured to generate heat by induction and heat the vaporizable material to generate a vapor; and wrapping a wrapper around the support structure and the heating assembly, the heating assembly being positioned adjacent to the second end of the support structure. The heating assembly includes a plurality of heating elements, in which a first heating element of the plurality of heating elements is positioned proximate to the first end, and a second heating element of the plurality of heating elements is disposed proximate to the second end, where the second heating element is spaced apart from the first heating element by a region.

In some implementations, providing the heating assembly can include applying the plurality of heating elements onto a substrate to form the heating assembly. In such implementations, applying the plurality of heating elements onto the substrate can include laminating the plurality of heating elements.

In some implementations, wrapping the heating assembly around the vaporizable material can include attaching two opposing sides of the heating assembly to form a loop. In certain implementations, attaching the two opposing sides can include welding the two opposing sides of the heating assembly to form the loop. In other implementations, attaching the two opposing sides can include gluing the two opposing sides of the heating assembly to form the loop.

In some implementations, positioning an insert adjacent to a first end of the heating assembly. In such implementations, a second end of the heating assembly can be adjacent the support structure. In certain implementations, the insert can include a cellulose acetate.

In some implementations, the method can include creating one or more bypass air inlets through the support structure and the wrapper to thereby allow ambient air to pass through the one or more bypass air inlets and into the condensation chambers. In such implementations, creating the one or more bypass air inlets can include laser cutting the one or more bypass air inlets through the support structure and the wrapper.

In some implementations, wrapping the heating assembly around the vaporizable material can include attaching a first edge portion of the substrate to a second edge portion, opposite to the first edge portion, of the substrate; and attaching a first edge segment of the plurality of heating elements to a second edge segment, opposite to the first edge segment, of the plurality of heating elements. In certain implementations, the first edge segment of the plurality of heating elements can extend over the first edge portion of the substrate. Alternatively, or in addition, the second edge segment of the plurality of heating elements can extend over the second edge portion of the substrate.

In some implementations, attaching the first edge portion of the substrate to the second edge portion of the substrate can include gluing the first edge portion of the substrate to the second edge portion of the substrate. In other implementations, attaching the first edge segment of the plurality of heating elements to the second edge segment of the plurality of heating elements can include welding the first edge segment of the plurality of heating elements to the second edge segment of the plurality of heating elements.

In some implementations, attaching a first edge portion of the substrate to a second edge portion of the substrate can include welding the first edge portion of the substrate to the second edge portion of the substrate, and folding and gluing the welded edge portion and second edge portion of the substrate toward and onto an exterior surface of the heating assembly.

In additional implementations, heating assemblies shown in FIGS. 51F and 51G can include similar components to, and otherwise operate in the same manner as the other heating elements/assemblies discussed, for example, the heating elements/assemblies of FIGS. 13A-15K and 48A-50I, except as noted. Separately, the components of the heating assembly identified and discussed in FIGS. 51F and 51G can be combined with any of the components of the other heating assemblies described with respect to FIGS. 13A-15K and 48A-48D, except as noted or where impractical. Further, while not shown, a person skilled in the art will appreciate that the heating assembly 5142 could be part of a cartridge. For example, the heating assembly 5142 could replace the heating element 4842 and therefore the heating assembly 5142 can be used in combination with all the other elements of the cartridge 4820 (FIGS. 48A-48C) as discussed above, and any of the vaporizer bodies disclosed herein, except where impractical.

Additional implementations of structure, configuration, and manufacturing process of a heating assembly for a vaporizer cartridge are also disclosed herein. In some implementations, for example, a heating assembly can include a first support structure and a first plurality of heating elements disposed on a first surface of the first support structure, a second support structure and a second plurality of heating elements disposed on a first surface of the second support structure. The first plurality of heating elements can at least partially extend between two opposing sides of the first support structure, and the second plurality of heating elements can at least partially extend between two opposing sides of the second support structure. A first side of the two opposing sides of the first support structure can be in contact with a first side of the two opposing sides of the second support structure, and a second side of the two opposing sides of the first support structure can be in contact with a second side of the two opposing sides of the second support structure. When the first support structure is in contact with the second support structure, at least a portion of the first surface of the first support structure can contact at least a portion of the first surface of the second support structure such that at least a portion of the first plurality of heating elements contacts at least a portion of the second plurality of heating element.

In some implementations, the first side of the two opposing sides of the first support structure can be in contact with a first side of the two opposing sides of the second support structure by being placed against one another, e.g., without the use of an adhesive material or the use of welding. As such, placing the respective first sides together such that they are touching one another can result in contacting the respective first sides. In other words, contacting the respective first sides does not require the use of an adhesive or the need for welding or the like. In certain implementations, the first side of the two opposing sides of the first support structure can be in contact with the first side of the two opposing sides of the second support structure by coupling. The coupling can include using an adhesive material, e.g., by taping, by welding, or the like.

Similarly, in some implementations, the second side of the two opposing sides of the first support structure can be in contact with a second side of the two opposing sides of the second support structure by being placed against one another, e.g., without the use of an adhesive material or the use of welding. As such, placing the respective second sides together such that they are touching one another can result in contacting the respective second sides. In other words, contacting the respective second sides does not require the use of an adhesive or the need for welding or the like. In certain implementations, the second side of the two opposing sides of the first support structure can be in contact with the second side of the two opposing sides of the second support structure by coupling. The coupling can include using an adhesive material, e.g., by taping, by welding, or the like.

In some implementations, the first side of the two opposing sides of the first support structure can be in contact with the first side of the two opposing sides of the second support structure in the same manner as the second side of the two opposing sides of the first support structure and the second side of the two opposing sides of the second support structure. In other implementations, the first side of the two opposing sides of the first support structure can be in contact with the first side of the two opposing sides of the second support structure in a different manner as the second side of the two opposing sides of the first support structure and the second side of the two opposing sides of the second support structure.

In some implementations, the first plurality of heating elements can extend from a first side of the two opposing sides to a second side of the two opposing sides of the first support substrate.

In some implementations, the second plurality of heating elements can extend from a first side of the two opposing sides to a second side of the two opposing sides of the second plurality of heating elements.

In some implementations, a second heating element of the first plurality of heating elements can be spaced a distance apart from a first heating element of the first plurality of heating elements and a second heating element of the second plurality of heating elements can be spaced a distance apart from a first heating element of the second plurality of heating elements.

In some implementations, when the first support substrate is in contact with the second support substrate, at least a portion of the first surface of the first support substrate can face at least a portion of the first surface of the second support substrate.

In some implementations, when the first support substrate is in contact with the second support substrate, the first support substrate and the second support substrate can form, in combination, a continuous loop.

In some implementations, when the first support substrate is in contact with the second support substrate, a respective first segment of the first plurality of heating elements can be positioned and in contact with a respective first segment of the second plurality of heating elements, and a respective second segment of the first plurality of heating elements can be positioned and in contact with a respective second segment of the second plurality of heating elements.

In some implementations, the heating assembly can include a secondary substrate, wherein at least the first support substrate, the second support substrate, or both can be coupled to a surface of the secondary substrate. In certain implementations, the secondary substrate can be paper.

In various implementations, for a method of manufacturing the heating assemblies discussed herein can include providing a first support substrate and a second support substrate. A first plurality of heating elements is disposed on a first surface of the first support substrate, and the first plurality of heating elements extending between two opposing sides of the first support substrate. A second plurality of heating elements is disposed on a first surface of the second support substrate, wherein the second plurality of heating elements extending between two opposing sides of the second support substrate. The method further includes contacting a first side of the two opposing sides of the first support substrate to a first side of the two opposing sides of the second support substrate, and contacting a second side of the two opposing sides of the first support substrate to a second side of the two opposing sides of the second support substrate. When the first support substrate is in contact with the second support substrate, at least a portion of the first surface of the first support substrate contacts at least a portion of the first surface of the second support substrate such that at least a portion of the first plurality of heating elements contacts at least a portion of the second plurality of heating elements. In some implementations, the method can include coupling the first support substrate, the second support substrate, or a combination thereof to a surface of a secondary substrate. In certain implementations, the secondary substrate can include paper.

In some implementations, contacting the first side of the two opposing sides of the first support structure to the first side of the two opposing sides of the second support structure can be carried out by placing the respective first sides against one another, e.g., without the use of an adhesive material or the use of welding. As such, placing the respective first sides together such that they are touching one another can result in contacting the respective first sides. In other words, contacting the respective first sides does not require the use of an adhesive or the need for welding or the like. In other implementations, contacting the first side of the two opposing sides of the first support structure to the first side of the two opposing sides of the second support structure can be carried out by coupling. The coupling can include using an adhesive material, e.g., by taping, by welding, or the like.

Similarly, in some implementations, contacting the second side of the two opposing sides of the first support structure to the second side of the two opposing sides of the second support structure can be carried out by placing the respective second sides against one another, e.g., without the use of an adhesive material or the use of welding. As such, placing the respective second sides together such that they are touching one another can result in contacting the respective second sides. In other words, contacting the respective second sides does not require the use of an adhesive or the need for welding or the like. In other implementations, contacting the second side of the two opposing sides of the first support structure to the second side of the two opposing sides of the second support structure can be carried out by coupling. The coupling can include using an adhesive material, e.g., by taping, by welding, or the like.

In some implementations, contacting the first side of the two opposing sides of the first support structure to the first side of the two opposing sides of the second support structure can be carried out in the same manner as contacting the second side of the two opposing sides of the first support structure to the second side of the two opposing sides of the second support structure. In other implementations, contacting the first side of the two opposing sides of the first support structure to the first side of the two opposing sides of the second support structure can be carried out in a different manner as contacting the second side of the two opposing sides of the first support structure to the second side of the two opposing sides of the second support structure.

FIGS. 51A-51G show an exemplary heating assembly 5142 that can be manufactured in a simplified manufacturing process that reduces manufacturing time and increases efficiency. As illustrated in FIG. 51A, an implementation of the heating assembly can be manufactured from a roll of substrate material 5140 (e.g., a roll of paper) that is rolled out and a conductive material 5141 can be printed (e.g., ink-jetprinted) onto the substrate material 5140. The conductive material 5141 can include a variety of materials. Non-limiting examples of suitable materials include gold, chrome, aluminum, silver, nickel, copper, or any combination thereof. In some implementations, the conductive material 5141 can be any suitable materials that can conduct electricity when placed in contact with one another, for example, silver (e.g., nanosilver) or a combination of silver (e.g., nanosilver) and copper. In other implementations, the conductive material 5141 can contact electricity when welded, taped, laminated, glued, or the like, or any combination thereof, to one another. In some implementations, the conductive material 5141 can be printed in strips that extend between two opposing sides of the substrate material 5140. For example, a conductive solution can be ink-jet printed onto the substrate material 5140, and then the conductive solution can be heated (e.g., via a Xenon lamp that heats the conductive solution to about 400° C. for 1 ms) to form the conductive material on the substrate material. In some implementations, the substrate material 5140 printed with the conductive material 5141 can be cut into segments to form components of the heating assembly 5142 in an assembling process illustrated in FIGS. 51B-51G.

In some implementations, the substrate material 5140 with the conductive material 5141 disposed thereon can be cut into segments that each include a respective support substrate and one or more heating elements disposed on the support substrate to form components of the heating assembly 5142. For example, as shown in FIG. 51B, a first support substrate 5140 can include a first plurality of heating elements having a first heating element 5141a and a second heating element 5141b disposed on a first surface 5140x of the first support substrate 5140. The first and the second heating elements 5141a, 5141b of the first plurality of heating elements can be disposed on the first surface 5140x of the first support substrate 5140 with the second heating element 5141b spaced a distance apart from the first heating element 5141a. Similarly, a second support substrate 5144 can have a second plurality of heating elements having a first heating element 5143a and a second heating element 5143b disposed on a first surface 5144x of the support substrate 5144, with the second heating element 5143b spaced a distance apart from the first heating element 5143a. In some implementations, each of the plurality of heating elements 5141a, 5141b, 5143a, 5143b can extend between two opposing sides of the support substrate 5140/5144. In some implementations, each of the first plurality of heating elements 5141a, 5141b can extend from a first side 5140a of the first support substrate 5140 to a second side 5140b of the first support substrate 5140, and each of the second plurality of heating elements 5143a, 5143b can extend from a first side 5144a of the second support substrate 5144 to a second side 5144b of the second support substrate 5144. In some implementations, the heating assembly 5142 can further include a secondary substrate 5145 (e.g., paper) to provide additional structural support for the heating assembly 5142. In other implementations, the heating assembly 5142 does not include the secondary substrate 5145.

As shown in FIG. 51C, in step one of the assembling process disclosed herein, any one of the first and the second support substrates 5140 and 5144 can be coupled to the secondary substrate 5145 and positioned adjacent a first surface 5145x of the substrate 5145. In some implementations, the second support substrate 5144 can be coupled to the secondary substrate 5145 at the first side 5144a of the second support substrate 5144. In some implementations, the second support substrate 5144 can be coupled to the substrate with tape 5147 along the first side 5144a of the second support substrate 5144.

In step two, as shown in FIGS. 51D-51E, the first support substrate 5140 can be coupled to the substrate 5145, adjacent the first surface 5145x of the substrate 5145. In some implementations, the first support substrate 5140 can be coupled to the secondary substrate 5145 by being coupled to the second support substrate 5144. In some implementations, the second side 5140b, opposite to the first side 5140a, of the first support substrate 5140 can be coupled to the second side 5144b, opposite to the first side 5144a, of the second support substrate 5144. In other implementations, the first support substrate 5140 can be coupled directly to the substrate 5145. In some implementations, the first support substrate 5140 can be coupled to the secondary substrate 5145 or the first support substrate 5140 by tape 5147 or the like along the second side 5140b of the first support substrate 5140 and the second side 5144b of the second support substrate 5144. In some implementations, when the first support substrate 5140 is coupled to the secondary substrate 5145 or the second support substrate 5144, at least a portion of the first surface 5140x of the first support substrate 5140 contacts at least a portion of the first surface 5144x of the second support substrate 5144 such that at least a portion of the first and the second heating elements 5141a, 5141b on the first support substrate 5140 contacts at least a portion of the first and the second heating elements 5143a, 5143b on the second support substrate 5144 to allow electrical connection heating elements placed in contact. In some implementations, for the heating elements to contact one another when the first and the second support substrates 5140, 5144 are coupled, at least a portion of the first surface 5144x of the second support substrate 5144 can face at least a portion of the first surface 5140x of the first support substrate 5140. In some implementations, when the first support substrate 5140 is coupled with the second support substrate 5144, a respective first segment of the first and the second heating elements 5141a, 5141b positioned at the second side 5140b of the first support substrate 5140 is positioned to be in contact with a respective first segment of the first and the second heating elements 5143a, 5143b positioned at the second side 5144b of the first support substrate 5140.

In some implementations, when the first and the second support substrates 5140, 5144 are coupled with the substrate 5145, while a second surface 5044y, opposite to the first surface 5044x, of the second support substrate 5144 faces the first surface of the substrate 5145, the first surface 5040x of the first support substrate 5140 can face the first surface of the substrate 5145. As shown in FIG. 51E, in some implementations, a combined length LC of the first and the second support substrates 5140 and 5144, when coupled to each other, can be longer than a length LSS of the secondary substrate 5145 such that a portion of the second support substrate 5144 along with a portion of the first and the second heating elements 5143a, 5143b of the second support substrate 5144 can be exposed to be made in contact with a portion of the first and second heating elements 5141a, 5141b of the first support substrate 5140 in the next step.

In step three, as illustrated in FIGS. 51F and 51G, the first side 5140a of the first support substrate 5140 can be coupled to the first side 5144a of the second support substrate 5144 by folding the coupled first and second support substrates 5140, 5144 to form a continuous loop. In some implementations, the first side 5140a of the first support substrate 5140 can be coupled to the first side 5144a of the second support substrate 5144 by tape 5147 or the like along the first side 5140a of the first support substrate 5140 and the first side 5144a of the second support substrate 5144. Once folded into a tubular configuration, in some implementations, at least a second segment of the first and the second heating elements 5141a, 5141b positioned at the first side 5140a of first support substrate 5140 can contact at least a second segment of the first and the second heating elements 5143a, 5143b positioned at the first side 5144a of the second support substrate 5144 to form an electrically conductive path around the loop. In some implementations, when folded into the loop, at least a portion of the first surface 5140x of the first support substrate 5140 can contact at least a portion of the first surface 5144x of the second support substrate 5144.

The assembled heating assembly 5142 can have the first heating element 5141a of the first support substrate 5140 and the first heating element 5143a of the second support substrate 5144 forming a continuous electrical path, and the second heating element 5141b of the first support substrate 5140 and the second heating element 5143b of the second support substrate 5144 forming a continuous electrical path. In some implementations, in step three, the secondary substrate 5145 can be folded along with the first and the second support substrates 5140 and 5144 to provide structural support for the heating assembly 5142 in the tube shape. As shown in FIGS. 51F and 51G, in some implementations, the assembled heating assembly 5142 can have the first surface 5144x of the second support substrate 5144 and the second surface 5140y of the first support substrate 5140 facing an exterior. In other implementations, the partially assembled heating assembly 5142 shown in FIGS. 51D-E can also be folded in an opposite direction to form a heating element with only the second surface 5145y of the secondary substrate 5145 facing the exterior. Once folded into a tubular configuration, the heating assembly 5142 can be ready for use in a vaporizer cartridge to heat and receive a vaporizable material in accordance with various implementations disclosed herein.

In further implementations, if the heating element of a cartridge is manufactured such that it includes a joint location (see e.g., the joint location 345 of FIG. 3), this joint location can interfere with the overall performance of a vaporizer device configured to heat the heating element via induction. Although a position of the joint seam can be dictated by manufacturing the joint seam to be in a known or specified location, manufacture of the cartridges can be simplified if the position of the joint seam is not dictated. Separately, if the cartridge is cylindrical, there is no way to dictate the location of the joint seam without creating user friction (e.g., requiring the user to place the cylindrical cartridge in a specific location every time). Accordingly, it can be desirable to mitigate the effect of the joint location, such as by detecting a position of the joint location and/or manufacturing the joint location to have a certain shape or structure (see FIGS. 15A-15E).

For example, as illustrated in FIGS. 14A-14C, a joint location 1445 of a heating element 1442 can be positioned proximate a center of an inductor 1443 (noted as 0° in FIG. 14A), positioned between a center of the inductor 1443 and an end of the inductor 1443 (noted as 300 in FIG. 14B), positioned proximate or outside an end of the inductor 1443 (noted as 60° in FIG. 14C), and/or the like. The closer the joint location 1445 is to the center of the inductor, the worse the performance of the inductor 1443 (e.g., lower thermal efficiency). Accordingly, in some implementations, the relative position of the joint location 1445 can be detected and the power provided to the inductor(s) 1443 that are near joint location 1445 can be reduced.

For example, inductance and/or resistance values of the heating element 1442 can be measured as described herein. The inductance and/or resistance values of the heating element 1442 derived from each inductor 1443 can then be compared to determine a location of the joint location 1445. For example, the inductance and/or resistance values can be averaged, and the inductor 1443 with inductance and/or resistance values that are furthest from the average inductance and/or resistance can be determined as being the inductor 1443 proximate the joint location 1445. Based on this determination, less power can be applied to the inductor 1443 determined to be proximate the joint location 1445, such as by decreasing the duty cycle of power applied to the inductor 1443 (e.g., reducing the overall time during which power is applied to the inductor 1443) relative to a baseline duty cycle and/or duty cycle applied to the other inductors 1443, decreasing the operating frequency of the inductor 1443 relative to a baseline frequency and/or frequency of the other inductors 1443, decreasing the voltage applied to the inductor 1443 relative to a baseline voltage and/or voltage of the other inductors 1443, and/or the like. In some implementations, it can be determined that joint location 1445 is proximate two different inductors 1443. In this case, power applied to the two inductors 1443 determined to be proximate the joint location 1445 can be reduced. In some implementations, the reduction in power applied to each inductor 1443 determined to be proximate the joint location 1445 can be reduced based on proximity of each inductor to the joint location. As such, a greater reduction in power can be applied to the inductor 1443 determined to be closer to the joint location 1445 than the reduction in power to the inductor 1443 determined to be further from the joint location 1445.

FIGS. 10A-10D illustrates top perspective views of vaporizer device 1000, consistent with implementations of the current subject matter. As illustrated in FIG. 10A, a vaporizer device 1000a can include a vaporizer body 1010 and a cartridge 1020 configured to be inserted into a receptacle 1018 of the vaporizer body 1010. The cartridge 1020 can include at least one airflow outlet 1028, though which an inhalable aerosol can be inhaled by a user. In some implementations, the intersection between the cartridge 1020 and the receptacle 1018 into which it is inserted can provide an airflow inlet 1024, such as around a perimeter of the intersection, through which ambient air can enter the receptacle 1018, and thereafter enter the cartridge 1020 at a cartridge distal end, when a user puffs on the cartridge through the at least one airflow outlet 1028.

Additionally or alternatively one or more outputs 1017 in the form of at least one LED (e.g., in the form of a plurality of LEDs arranged in a line) can be disposed on the exterior of the vaporizer body 1010 and/or one or more input devices 1016 in the form of a button can be disposed on the top ledge 1021 of the vaporizer body 1010 (e.g., proximate and on the same face as the cartridge receptacle 1018). As illustrated, the width of the vaporizer body 1010 can be two to three times the width of the cartridge (as cartridge width has been used herein), with the receptacle 1018 proximate one end of the ledge 1021 and the input device 1016 proximate the opposite side of the ledge 1021.

As illustrated in FIG. 10B, a vaporizer device 1000b can include a vaporizer body 1010 and a cartridge 1020 configured to be inserted into a receptacle 1018 that is centered on the ledge 1021 of the vaporizer body 1010. With relatively less space on the ledge 1021, the one or more input devices 1016 (e.g., button) can be disposed on one of the wider faces of the vaporizer body 1010 (e.g., proximate the distal end of the vaporizer body 1010 and on the same side of the vaporizer device 1000b as one of the long sides of the cartridge 1020, as long sides have been used herein) and/or on one of the more narrow faces of the vaporizer body 1010 (e.g., proximate the distal end of the vaporizer body 1010 or proximate the proximate end of the vaporizer body 1010, and on the same side of the vaporizer device 1000b as one of the short sides of the cartridge 1020, as short sides have been used herein).

Although the cartridge 1020 and/or the vaporizer body 1010 can be generally rectangular (cuboid) with rounded edges, as illustrated by the vaporizer devices 1000a, 1000b of FIGS. 10A-10B, in other implementations the cartridge 1020 and/or the vaporizer body 1010 can include a cross-section that has an elliptical or oval shape, as illustrated by the vaporizer devices 1000c, 1000d of FIGS. 10C-10D. As further illustrated in FIGS. 10D and 10E, the one or more outputs 1017 (e.g., LEDs and/or e-ink display((s)) and/or one or more input devices 1016 (e.g., buttons) can be disposed at different locations of the exterior of the vaporizer body 1010 and/or take different shapes. As further illustrated in FIG. 10E, a film 1015 (e.g., plastic film) is disposed over the one or more outputs (e.g., LEDs and/or e-ink display((s)). The film is also disposed over an RF antenna 1019 that is positioned adjacent to the one or more outputs (e.g., LEDs). In some implementations, an E Ink display can be used as the one or more outputs 1017. An E Ink display can be used in place of, or in addition to, the LEDs shown in FIGS. 10D and 10E. An E Ink display can use microparticles to display an output (for example, text and/or one or more lines) that can change depending on the status of the device. For example, a cross-section of the cartridge 1020 and/or the vaporizer body 1010 can be similar to one or more of the cross-sections of FIGS. 8A-8F.

In order to reduce the amount of heat radiated from vaporizer devices during use, it can be beneficial to provide the cartridge with an infrared reflective material as either the heating element or in addition to the heating element. In other words, in some implementations, the heating element can include the infrared reflective material, while in others the heating element includes a susceptor and the infrared reflective material is separate and apart from the susceptor. Alternatively or in addition, an infrared reflective material can be provided on the vaporizer body. In any of the foregoing instances, the infrared reflective material is configured to reflect heat back into the cartridge, more specifically towards the vaporizable material within the wrapper, to reduce the overall temperature of the vaporizer device while the system operates. Alternatively, or additionally, the reflection of heat due to the infrared reflective material can result in a 15-25% reduction of power needed from the vaporizer device during operation. A reduction in power can result in increased number of sessions on the vaporizer device.

In instances where the heating element includes the infrared reflective material or the infrared reflective material is provided separate from the heating element, the heating element can be configured to generate the heat via eddy currents, where such heat is used to heat the vaporizable material to generate a vapor.

The infrared reflective material can include a variety of materials. Non-limiting examples of suitable materials include gold, chrome, aluminum, silver, nickel, copper, or any combination thereof. In some implementations, the infrared reflective material can include silver and copper, e.g., 20% silver and 80% copper. In some implementations, the material can be applied via plasma vapor deposition to thereby form a plasma vapor deposition (PVD) material. In certain implementations, the infrared reflective material includes aluminum, and in such instances, the aluminum can be applied to a surface of an element of the cartridge or of an element of the vaporizer body (also referred to herein as device body) via plasma vapor deposition.

In some implementations, the infrared reflective material can have an emissivity of thermal radiation from about 0% to about 35%. In certain implementations, the infrared reflective material can have an emissivity of thermal radiation from 0% to about 25% or from 0% to 20%.

The infrared reflective material can have a variety of thicknesses. In some implementations, the infrared reflective material can be from about 10 nm to about 40 microns, from about 10 nm to about 200 nanometers, from about 20 microns to about 35 microns, or from about 500 nm to about 2 microns. A person skilled in the art will appreciate that the thickness of the infrared reflected material will depend at least upon the frequency for which the one or more inductors of the vaporizer body operate, the position of the infrared reflective material (e.g., positioned on an element of the cartridge or of the vaporizer body), and the presence or absence of a separate susceptor.

In some implementations, the vaporizer device can include a cartridge extending from a first cartridge end to a second cartridge end. The cartridge can include a wrapper configured to hold a vaporizable material disposed therein, a heating element include a susceptor configured to heat the vaporizable material (as discussed above), and an infrared reflective material configured to reflect heat towards the vaporizable material to generate the vapor. In such implementations, the vaporizer device can further in a vaporizer body (also referred to herein as a device body) having a receptacle configured to insertably receive at least a portion of the cartridge, and at least one inductor (e.g., an inductive coil, such as an inductive helical coil, as described herein) proximate the receptacle, where the at least one inductor is configured to generate a magnetic and/or electromagnetic field to heat the heating element.

In some implementations, as described above, the susceptor can be disposed on at least a portion of an inner surface of the wrapper. Alternatively, or in addition, the infrared reflective material can be disposed on a portion of an outer surface of the wrapper. In certain implementations, the portion of the outer surface can extend from the first cartridge end towards the second cartridge end, whereas in other implementations the portion of the outer surface can extend towards the second cartridge end, from a location that is spaced apart at a distance from the first cartridge end. Alternatively, or in addition, the infrared reflective material can surround at least a portion of the heating element.

In some implementations, the infrared reflective material can be disposed on a portion of an outer surface of the wrapper, and the susceptor can be disposed about an outer surface of the infrared reflective material.

In some implementations, the infrared reflective material can be disposed about and extends along at least a portion of an outer perimeter of the wrapper. In other implementations, the infrared reflective material can be disposed about and extends along an entire outer perimeter of the wrapper.

As shown in FIGS. 18A and 18B, which is a partial cross-sectional view of FIG. 18A, an exemplary cartridge 1820, and as previously described with respect to FIGS. 6A-6N, can include a wrapper 1822, a heating element 1842 that includes a susceptor, and vaporizable material 1802 disposed within the wrapper 1822. In other words, in this illustrated implementation, the heating element 1842, and thus the susceptor, is interposed between the vaporizable material 1802 and the wrapper 1822. As such the heating element 1842, and thus the susceptor, abuts at least a portion of an inner surface 1822a of the wrapper 1822. The cartridge 1820 extends from a first cartridge end 1821a (e.g., a proximal end) to a second cartridge end 1821b (e.g., a distal end). As further shown, and as previously described with respect to FIGS. 6A-6N, one or more inserts 1824 can be wrapped within the wrapper 1822 to form the mouthpiece portion 1830 of the cartridge 1820, where the mouthpiece portion 1830 is disposed towards the second end 1821b, e.g., at or proximate the second end 1821b. The one or more inserts 1824 can be formed of a vapor-permeable material configured to allow the inhalable aerosol to pass through the material. Alternatively, the one or more inserts 1824 can have one or more channels 1897 that can serve as an airflow path for the inhalable aerosol generated in the cartridge 1820. Alternatively, or in addition, the cartridge 1820 can include an end cap 1864 (e.g., filter) positioned at or proximate to the first end 1821a of the cartridge. In this illustrated implementation, the end cap is positioned at the first end 1821a and extends upward towards the second end 1821b of the cartridge 1820.

As further shown in FIGS. 18A-18C, the cartridge 1820 can include bypass air inlets 1829 (e.g., similar to bypass air inlets described herein with respect to FIGS. 6A-6N) that allow ambient air to enter the cartridge and a divider 1854 (e.g., similar to dividers described herein with respect to FIGS. 4R to 4X and FIGS. 6A-6N).

While FIGS. 18A-18B illustrate a cartridge 1820 without an infrared reflective material, FIGS. 19A-19D illustrate perspective views of cartridges 1920A, 1920B, 1920C, and 1920D, respectively, where an infrared reflective material 1984 can be applied, consistent with implementations of the current subject matter. Aside from the differences described in detail below, cartridges 1920A, 1920B, 1920C, and 1920D are similar to cartridge 1820 and therefore common elements are not described in detail herein.

As described herein, the infrared reflective material 1984 can be positioned at various locations on the cartridges 1920A, 1920B, 1920C, and 1920D to vary the amount of heat reflected. For example, as illustrated in FIGS. 19A-19D, the infrared reflective material 1984 can be applied as a layer on a portion 1921 of the outer surface 1922b of the wrapper 1922. For example, as shown in FIG. 19A, the portion 1921 of the outer surface 1922b extends from the first cartridge end 1921a towards the second cartridge end 1921b, whereas in FIG. 19B, the portion 1921 of the outer surface 1922b extends towards the second cartridge end 1921b from a location that is spaced apart a distance D from the first cartridge end 1921a. In either case, the infrared reflective material 1984 is disposed about and extends along at least a portion of outer perimeter of the wrapper 1922. In another exemplary implementation, as shown in FIG. 19C, the infrared reflective material 1984 can be disposed on the entire outer surface of the wrapper 1922.

Due to the properties of the infrared reflective material, a cartridge with complete external infrared reflective material coverage can not require an additional heating element component (e.g., a susceptor). The infrared reflective material can be applied as the heating element. In implementations where the at least one inductor operates at higher frequencies, the infrared reflective material is sufficient as the heating element without requiring an additional element such as a susceptor. Elimination of the heating element simplifies the manufacturing process and improves scalability. To preserve the familiarity and feel of a cigarette, for example, as shown in FIG. 19D, tipping paper or a paper-like material 1986 can be added at or proximate to the second cartridge end 1921a over the infrared reflective material 1984.

In another implementation as shown in FIG. 19E, the infrared reflective material 1984 can be applied to one or more portions 1921 of the outer surface 1922b of the wrapper 1922 only in the area about the heating element (not shown). That is, the infrared reflective material 1984 can be positioned on the outer surface 1922b of the wrapper 1922 so as to surround at least a portion of the heating element (e.g., a portion of the heating element that abuts the wrapper). In implementations with the infrared reflective material on the outer surface of the wrapper, the infrared reflective material is thin enough in thickness to inhibit coupling with the electromagnetic field generated by at least one inductor of the vaporizer body.

FIG. 20 illustrates a vaporizer device 2000 with a cartridge 2020 inserted into a receptacle 2018 of a vaporizer body 2010. The cartridge 2020 is similar to cartridge 1920A in FIG. 19A except that the infrared reflective material extends further towards the second cartridge end (i.e., the length of the infrared reflective material 2084 in this implementation is greater than the length of the infrared reflective material 1984 in FIG. 19A) and the one or more inserts 2024 does not include one or more channels. As shown, upon insertion, the majority of the infrared reflective material 1984 is disposed within the receptacle 2018. In other implementations, depending on at least the size of the receptacle and the length of the infrared reflective material along the outer surface of the wrapper, upon insertion, the infrared reflective material can be completely disposed within the receptacle.

The vaporizer body 2010 is similar to vaporizer bodies described herein (e.g., vaporizer body 1110 in FIG. 11P). For example, the vaporizer body includes a frame 2047 that defines the receptacle 2018 configured to insertable receive at least a portion of the cartridge 2020. The vaporizer body 2010 also includes at least one inductor 2043a, 2043b proximate the receptacle 2018, where the at least one inductor 2043a, 2043b configured to generate a magnetic and/or electromagnetic field to heat the heating element (obstructed in FIG. 20). In this illustrated implementation two inductors 2043a, 2043b are shown, each of which can be in the form of respective helical coils. In some aspects, the at least one inductor can be in the form of a flex based coil (e.g., a inductive material, e.g., copper, etched on a flexible printed circuit board).

As shown in FIG. 22, alternatively, or in addition, a vaporizer body 2210 can include an infrared reflective material 2284 configured to reflect heat towards the vaporizable material 2202 to generate the vapor. Aside from the infrared reflective material being disposed on the vaporizer body, the vaporizer device 2200 is similar to vaporizer device 2000 (FIG. 20) and therefore common elements are not described in detail.

As shown, the infrared reflective material 2284 can disposed on at least a portion of an inner surface 2247a of the frame 2247, and therefore faces the cartridge 2220 when the cartridge 2220 is insertable received within the receptacle 2218. In this illustrated implementation, the infrared reflective material 2284 at least partially surrounds the heating element (obstructed in FIG. 22) when the cartridge 2220 is insertably received within the receptacle 2218. In some implementations, the infrared reflective material 2284 can also be applied to at least a portion of the cartridge 2220, e.g., similar to cartridge 2020.

In some implementations, the cartridge can not have a heating element within the wrapper, e.g., as shown in FIG. 21. Removing the heating element from within the cartridge can ease manufacturing processes and allow for a more scalable cartridge. In various implementations, e.g., as shown in FIGS. 21A, 21B, 21C, the heating element can be positioned on the outer surface of the wrapper, instead of in the interior of the cartridge, e.g., as shown in 18C. The heating element on the outside of the cartridge can be 16 mm to 20 mm in length. When the heating element, or susceptor, is outside the cartridge, the heating element can act as an infrared reflective material and can result in a similar reduction in power as seen in other implementations. In other words, the heating element can be the infrared reflective material, and when the heating element is placed on an outer surface of the wrapper, the susceptor and the infrared reflective material are one in the same. Additional infrared reflective material in combination with the heating element positioned on the exterior of the cartridge can not be necessary to achieve the same power reduction. Alternatively, the heating element can be placed on the exterior of the cartridge and infrared reflective material can be placed on top of the heating element to cover a portion or the entire length of the cartridge.

In some implementations, the vaporizer device can include a cartridge extending from a first cartridge end to a second cartridge end and a vaporizer body. The cartridge can include a wrapper configured to hold a vaporizable material disposed therein, a heating element that includes an infrared reflective material configured to heat the vaporizable material and reflect heat towards the vaporizable material to generate a vapor. The vaporizer body can include a receptacle configured to insertably receive at least a portion of the cartridge; and at least one inductor proximate the receptacle, where the at least one inductor configured to generate a magnetic and/or electromagnetic field to heat the heating element.

In some implementations, as discussed herein, the infrared reflective material can be disposed on a portion of an outer surface of the wrapper. In certain implementations, the portion of the outer surface can extend from the first cartridge end towards the second cartridge end., whereas in other implementations, the portion of the outer surface extends towards the second cartridge end, from a location that is spaced apart at a distance from the first cartridge end.

In some implementations, the infrared reflective material can disposed about and extend along at least a portion of an outer perimeter of the wrapper. In some implementations, the infrared reflective material can be disposed entirely on an outer surface of the wrapper.

FIGS. 21A and 21B illustrates an exemplary cartridge 2120A. Aside from the differences described in detail below, the cartridge 2120A can be similar to cartridge 1820 (FIGS. 18A-18C) and therefore common features are not described in detail herein. As shown, the cartridge 2120A includes a heating element 2142, and the heating element 2142 is not positioned within the wrapper 2122, but rather on at least a portion of the outer surface 2122b of the wrapper 2122. For sake of simplicity, the wrapper 2122 is illustrated in FIG. 21B as transparent and the heating element 2142 has been removed. In this illustrated implementation, the heating element 2142 includes an infrared reflective material 2184 that is configured to heat the vaporizable material 2102 and reflect heat towards the vaporizable material 2102 to generate the a vapor.

Further, as shown in FIG. 21A, the heating element 2142 is disposed on a portion 2121 of the outer surface 2122b of the wrapper 2122 that extends toward the second cartridge end 2121b, from a location that is spaced apart a distance D from the first cartridge end 2121a. Further, while the heating element 2142 can have a variety of configurations, similar to as described with respect to FIG. 15I, the heating element 2142 in FIG. 21A can include a top region 2159a and a bottom region 2159b, with one or more regions 2159c removed (e.g., cut out) between the top region 2159a and the bottom region 2159b. Further, the infrared reflective material 1984 is disposed about and extends along at least a portion of outer perimeter of the wrapper 1922.

Additional exemplary cartridges 2120C, 2120D, 2120E are illustrated in FIGS. 21C-21E. Aside from the differences described in detail below, these cartridges 2120C, 2120D, 2120E can be similar to cartridge 2120A (FIGS. 21A and 21B) and therefore common features are not described in detail herein. The cartridge 2120C, as shown in FIG. 21C, includes a heating element 2142 that can have a top segment 2159a and bottom segment 2159b, where the top segment 2159a and the bottom segment 2159b are separated from each other by a distance D. The heating element 2142 includes infrared reflective material 2184.

As shown in FIG. 21D, the cartridge 2120D includes infrared reflective material 2184 that can be disposed on the entire outer surface of the wrapper 2122. In such implementations, a separate susceptor 2185 can be disposed about a portion of the infrared reflective material 2184, for example, as shown in FIG. 21E.

FIGS. 23A and 23B illustrate side cross-sectional views of a wrapper 2322, according to some implementations. The wrapper can be made of a multi-layer material that can include one or more of metal, metal alloy, paper material such as cardstock, corrugated material such as cardboard or paper, tobacco paper, temperature-resistant plastic such as polyethylene terephthalate (PET), cellulose acetate, non-wood plant fibers such as flax, hemp, sisal, rice straw, and/or esparto, and/or the like. In some implementations, the wrapper 3222 can consist of one, two, three, four, or five or more layers. As illustrated in FIGS. 23A, and 23B wrapper 2322 has a first layer 2322a, a second layer 2322b, and a third layer 2322c. In some implementations each layer is comprised of the same material. Additionally, or alternatively, one or more of the layers can be different from the others. For example, the second layer 2322b can be corrugated or patterned to allow for increased insulation between the first layer 2322a and the third layer 2322c. When configured around one or more inserts, the wrapper 2322 can have an interior surface 2394 that faces the vaporizable material held within. The wrapper 2322 can also have an exterior surface 2393 on the opposing surface. The infrared reflective material can be disposed on one or more surfaces of the wrapper. For example, in FIG. 23A, the infrared reflective material 2386 is disposed on the first layer 2322a and is the exterior surface 2393 of the wrapper 2322. In FIG. 23B, infrared reflective material 2386 is disposed on the first layer 2322a and the third layer 2322c as the interior surface 2394 and the exterior surface 2393 of the wrapper 2322. The infrared reflective material can be applied to the wrapper in a variety of ways. Non-limiting examples of suitable processes include gluing (e.g., by way of an adhesive, such as providing an infrared reflective material as layer, applying adhesive to such layer and adhering the layer onto the wrapper) or printing the infrared reflective material on the wrapper (e.g. pad printing, ink printing (e.g., ink jet printing), or silk printing).

By way of example, FIGS. 24A, 25A, and 26A each illustrate respective cross-sectional views of a wrapper 2422. In each implementation, the wrapper 2422 includes a substrate 2486 where an infrared reflective material 2484 is disposed onto at least one surface 2486a, 2486b of substrate 2486. The substrate 2486 includes a top surface 2486a and an opposing bottom surface 2486b. In FIGS. 24A, the infrared reflective material 2484 is disposed onto the top surface 2486a and onto the bottom surface 2486b of the substrate 2486. In FIG. 25A, the infrared reflective material 2484 is disposed onto the top surface 2486a of the substrate 2486 and an additional material 2487 is disposed onto the bottom surface 2486b of the substrate 2486. The additional material 2487 can be a variety of materials, e.g., an infrared reflective material that is the same or different than the infrared reflective material disponed on the top surface of the substrate, one or more inks, one or more barrier materials, and/or the like. In instances where the additional material is one or more barrier materials, a barrier layer can be formed on the inner surface of the wrapper.

In FIG. 26A, the infrared reflective material 2484 is disposed onto the top surface 2486a of the substrate 2486 and nothing is printed onto the bottom surface 2486b of the substrate 2486. In any of the foregoing implementations, the infrared reflective material 2482 (and the additional material 2487, if present) can be disposed onto the substrate via printing. Alternatively, or in addition, an adhesive can be applied to the substrate and the infrared reflective material can be applied as a layer or as particles to the portion of the substrate with the adhesive. The adhesive can include a variety of materials. For example, in one implementation, the adhesive can include a conductive material (e.g., a silver paste), and in such implementations, the conductive material can be configured to create an electrical connection between a plurality of rolls (e.g., 2488a, 2488b, 2488c as shown in FIGS. 24B, 25B, and 26C). Alternatively, or in addition, one or more punctures (e.g., puncture wells) can be formed in the wrapper, in which the one or more punctures can be configured to create an electrical connection between the plurality of rolls.

In certain implementations, after the infrared reflective material 2484 (and in some implementations, also the additional material 2487 if present) is disposed onto the substrate, the substrate can be rolled into a plurality of rolls 2488a, 2488b, 2488c, as shown in FIGS. 24B, 25B, and 26C. While the number of rolls can vary, in these illustrated implementations, there are three rolls 2488a, 2488b, 2488c. In other implementations, the substrate can be rolled into 2 rolls or more than 3 rolls. In FIG. 24B, the infrared reflective material 2484 is positioned on the outer surface 2422b of the wrapper 2422 and on the inner surface 2422a of the wrapper 2422. In FIG. 25B, the infrared reflective material 2484 is positioned on the outer surface 2422b of the wrapper 2422 and the additional material 2487 is positioned on the inner surface 2422a of the wrapper 2422. In FIG. 26B, the infrared reflective material 2484 is positioned on the outer surface 2422b of the wrapper 2422 and nothing is positioned on the inner surface 2422a of the wrapper 2422.

In some implementations, as shown in FIG. 27, the substrate 2486 can be first rolled into a plurality of rolls 2488a, 2488b, 2488c and thereafter an infrared reflective material 2484 can be disposed onto (e.g., via printing) the outer surface 2422b of the wrapper 2422.

Infrared reflective material described herein can be formed of a variety of materials. In some implementations, the infrared reflective material is formed of at least one or more metals. For example, the one or more metals can include a polished gold material with an emissivity of approximately 0.02. Alternatively, or in addition, the infrared reflective material can be formed of other metals such as aluminum, copper, titanium, chrome, nickel, silver, or similar non-ferrous material.

The infrared reflective material can be applied to a surface, such as an outer surface of the cartridge and/or cartridge receptacle of the vaporizer body using a variety of different applications. In some implementations, the infrared reflect material can be applied in the form of a tape, a foil, plastic, paint, or similar medium. In some implementations, the infrared reflective material can be applied to the intended surface(s) by plasma vapor deposition (PVD). Applying infrared reflective material via PVD can create sheet resistance in a range of 0.5 ohm to 2.5 ohm. As previously described herein, the body of the cartridge can be comprised of a wrapper with the heating element and mouthpiece contained within. The infrared reflective material can be applied by PVD on the interior of the wrapper and/or the exterior of the wrapper. The infrared reflective material can be applied by PVD to either a portion of the wrapper or the entire surface of the wrapper. The infrared reflective material can add unique colors or textures to the exterior of the cartridge allowing for design customization.

In some implementations, the thickness can vary within different portions of the infrared reflective material. In other implementations, the thickness is generally uniform (within manufacturing tolerances). In certain implementation, the infrared reflective material can have a range of 0.05-0.2 μm thick, such as 0.18-0.2 μm thick, 0.05-0.1 μm thick, 0.1-0.15 μm thick. In one implementation, the infrared reflective material can have a thickness of approximately 0.19 μm.

As described herein, inductive heating is utilized to heat the vaporizable material disposed with in the vaporizer devices. In such implementations, the driving circuitry can be one or more inductive coils disposed around the heating element. Between the one or more inductive coils and the heating element can be a gap. The heating coils can be shaped and positioned to reduce resistance and self-heating within the coils, thereby increasing efficiency of the vaporizer device.

In some implementations, when the cartridge is at least partially inserted into a receptable of a vaporizer body, an outer surface of the cartridge can be spaced a distance from an inner surface of the frame. In certain implementations, for example, as shown in FIGS. 28A-28B, the distance can be generally uniform (e.g., uniform within manufacturing tolerances) to thereby create a generally uniform gap (e.g., uniform within manufacturing tolerances) between the outer surface of the cartridge and the inner surface of the frame. In other implementations, for example as shown in FIGS. 29A-29B, when the cartridge is at least partially inserted into the receptable, an outer surface of the cartridge is spaced two or more distances from an inner surface of the frame, where the two or more distances are different from each other thereby creating a variable gap between the outer surface of cartridge and the inner surface of the frame. In such implementation, the two or more distances can include a first distance and a second distance, in which the first distance is greater than the second distance. For example, in some implementations, the first distance can be from about 10% to 3000% greater than the second distance. In any of the foregoing implementations, an insulative material (e.g., air) can be presented within the generally uniform gap or the variable gap. Maximizing the amount of air within the gap, and therefore thermal insulation, can be desired as a way to control heat loss when operating the vaporizer device.

For example, FIGS. 28A-28B and 29A-29B illustrate a cross-sectional and a top view of a vaporizer device 2800, 2900 with a vaporizer body 2810, 2910 and a cartridge 2820, 2920 at least partially inserted into a receptacle 2818, 2918 defined by a frame 2847, 2947 of the vaporizer body 2810, 2910, consistent with implementations of the current subject matter. The vaporizer body 2810, 2910 includes, among other elements, two inductors 2843a, 2843b, 2943a, 2943b (e.g., inductive coils or flex coils). The cartridge 2820, 2920 can be variety of shapes. For example, in this illustrated implementation, the cartridge 2820, 2920 and frame 2847, 2947 each have an oblong shape. As such, the cartridge 2820, 2920 can have a short segment 2820a, 2920a and a long segment 2820b, 2920b. As further shown, a gap exists 2887, 2987 between the outer surface 2822a, 2922b of the cartridge 2820, 2920 and the inner surface 2847a, 2947a of the frame 2847, 2947.

In FIGS. 28A-28B, the gap 2887 can be generally uniform. In other words, the distance D between the outer surface 2822b of the cartridge 2822 and the inner surface 2847a of the frame 2847 can be generally uniform (e.g., uniform within manufacturing tolerances). This distance can include a variety of distances, and a person skilled in the art would appreciate that the distance would depend at least upon the size of the inductor (e.g., the thickness of a wire that forms an inductive coil), the size of the receptacle, and therefore the overall structural configuration of the vaporizer body, as well as the structural configuration of the cartridge. In some implementations, the generally uniform gap can be from about 1 mm to about 5 mm. In certain implementations, the generally uniform gap is about 2 mm to about 3 mm. In one implementation the generally uniform gap can be about 2 mm. In some implementations, the gap can be filled with air and/or the gap can be filled with some other insulating material. In some implementations, the cartridge and the frame can each be circular in shape.

In FIGS. 29A-29B, the gap 2987 can be non-uniform, and thus a variable gap. That is, when the cartridge is at least partially inserted into the receptable, an outer surface of the cartridge is spaced two or more distances from an inner surface of the frame, in which the two or more distances are different from each other thereby creating a variable gap between the outer surface of cartridge and the inner surface of the frame. This variable gap 2987 can be implemented to improve heating and coupling efficiency. Varying the gap 2987 between the long segment 2920b and the short segment 2920a of the cartridge 2922 can have advantages over a generally uniform gap design.

In implementations with a variable gap, the strand count per Litz bundle in the inductors 2943a, 2943b (e.g., inductive coil) can be increased. An increase in strand count increases the overall width and amount of copper present in the inductors 2943a, 2943b. Increasing the width can increase resistance but maintain inductance in the inductors 2943a, 2943b. To compensate for the increased inductor width, the variable gap 2987 can have a first distance D1 between the outer surface 2922a on the short segment 2920a and the inner surface 2947a of the frame 2947, and a second distance D2 between the outer surface 2922a on the long segment 2920b and the inner surface 2947a of the frame 2947, where the first distance D1 is greater than the second distance D2. In another implementation, the first distance D1 can be less than the second distance D2. An additional advantage of implementing a variable gap can be improved cooling since the variable gap can allow the inductors to be positioned closer to an outer shell of the vaporizer body.

In some implementations, the vaporizer body can be designed to direct the magnetic field generated by the inductive coils back to the heating element and/or cartridge. The magnetic field can advantageously be focused toward specific areas or regions of the receptacle, and sometimes concurrently, the magnetic field can be deflected away from other regions of the device. For example, when the magnetic field is focused into the receptacle and/or cartridge, the magnetic field can be inhibited from exiting the device around the inductors. How the flux concentrator is arranged can result in the magnetic field focused to specific regions. In certain implementations, focusing the magnetic field improves electrical efficiency of the vaporizer device. Directing the magnetic field can reduce unwanted coupling between different zones of the device.

In FIG. 30, a cross-sectional view of an implementation of a vaporizer body 3010 taken along cross-section A-A is illustrated. As previously described in FIGS. 4A-4B, FIG. 30 illustrates the vaporizer body 3010 including a frame 3047 defining a receptacle 3018. A cartridge 3020 can be insertably received within the receptacle 3018. The cartridge 3020 can contain a heating element, in some instances a susceptor. The susceptor can have a top portion 3059a, a bottom portion 3059b, and a cutout 3059c between the top and the bottom. External to the frame 3047 and the receptacle 3018, a first inductor 3043a and a second inductor 3043b can be coupled to the frame 3047. In some implementations, each of the one or more inductors can include an inductive coil configured to generate an electromagnetic field. One or more flux concentrators can be coupled to the frame 3047. For example, a first flux concentrator 3095 can be positioned around the first inductor 3043a and a second flux concentrator 3096 can be positioned around the second inductor 3043b. Each of the one or more flux concentrators can include a magnetic material (e.g., ferritic material) configured to control and/or direct an electromagnetic field, generated by a respective inductor, such as by changing magnetic properties of the field. In some implementations, each of the one or more flux concentrators can include a nanocrystal material, a nanometal material, and/or the like.

In some implementations, the flux concentrators are arranged to direct the electromagnetic field toward the heating element and/or the cartridge 3020. As depicted in FIG. 30, the frame 3047 can have one or more regions along the surface proximate the receptacle 3018. Each region can primarily deflect or absorb the magnetic field depending on how the flux concentrator is arranged around it. Around the first inductor 3043a of FIG. 30, the frame 3047 can have a first region 3080a, a second region 3080b, and a third region 3080c positioned between the first and the second regions. The first region 3080a and the second region 3080b can be covered by flux concentrator, and the third region 3080c can receive the magnetic field due to no flux concentrator present.

In some implementations, a second flux concentrator 3096 can be arranged around the second inductor 3043b. The frame 3047 can have a fourth region 3080d, fifth region 3080e, and a sixth region 3080f positioned between the fourth and the fifth regions. Similar to the first flux concentrator 3095, the magnetic field can be directed into the sixth region 3080f that has no flux concentrator present.

The first and second flux concentrators can be comprised of one or more segments. For example, the first flux concentrator 3095 can have a first segment 3090 positioned around the outer circumference of the first inductor 3043a and a second segment 3091 positioned on an outer surface of the first region 3080a of the frame 3047. The first segment 3090 directs the electromagnetic field towards the receptacle 3018 and the second segment 3091 directs the magnetic field away from the receptacle 3018 such that magnetic field is inhibited from penetrating through the first region 3080a of the frame 3047. When a cross-section is taken of the vaporizer device 3000, the first segment 3090 can have a C-shape. Similarly, a third segment 3092 of the flux concentrator can be positioned on the outer surface of the second region 3080b of the frame 3047. The third segment 3092 can function like the second segment 3091 in that it directs the magnetic field away from the receptacle 3018 so that the magnetic field penetrates through the third region 3080c of the frame and into the receptacle 3018. Similarly, the second flux concentrator 3096 can have a fourth segment 3093 positioned around the outer circumference of the second inductor 3043b and a fifth segment 3094 positioned on an outer surface of the fourth region 3080d of the frame 3047. The fourth segment 3093 directs the electromagnetic field towards the receptacle 3018 and the fifth segment 3094 directs the magnetic field away from the receptacle 3018 such that magnetic field is inhibited from penetrating through the fourth region 3080d of the frame 3047. Similarly, a sixth segment 3095 of the flux concentrator can be positioned on the outer surface of the fifth region 3080e of the frame 3047. The sixth segment 3095 can function like the fifth segment 3094 in that it directs the magnetic field away from the receptacle 3018 so that the magnetic field penetrates through the sixth region 3080f of the frame 3047 and into the receptacle 3018. When a cross-section is taken of the vaporizer device 3000, the fourth segment 3093 can have a C-shape.

In some implementations, the first and second inductors can be spaced from the frame 3047 by a distance thereby defining a gap (3097a, 3097b). The gap (3097a, 3097b) can be filled with insulative material (e.g., air) to keep heat contained within the device. The flux concentrator can also have one or more segments around the top and the bottom of the inductor. As further illustrated in FIG. 30, the first flux concentrator 3095 can have a first intermediate segment 3098a extending from the first segment 3090 inward to the second segment 3091. A second intermediate segment 3098b can extend from the first segment 3090 inward to the third segment 3092. The second flux concentrator 3096 can comprise a third intermediate segment 3098c extending from the fourth segment 3093 inward to the fifth segment 3094 and a fourth intermediate segment 3098d extending from the fourth segment 3093 inward to the sixth segment 3095. Like the other flux concentrator segments, the first, second, third, and fourth intermediate segments can direct the magnetic field toward the receptacle 3018.

It can be appreciated that the flux concentrators can be arranged around the inductor in alternative ways to achieve various results. For simplicity, FIGS. 31-36 are schematics of different configurations in which the flux concentrator, coil, and susceptor are arranged. Although not every feature of the vaporizer device is shown, a person skilled in the art would appreciate the configurations demonstrated herein. Like previously described for FIG. 30, the inductor can be proximate a receptacle (not shown) and generate a magnetic field to heat the cartridge (not shown). A first flux concentrator 3095 can comprise a first segment positioned around an outer surface of the inductor, a second segment extending from the first segment toward receptacle/susceptor, and a third segment extending from the first segment toward the receptacle/susceptor. The coil and/or the flux concentrator can have a C-shape when viewed from a cross-section.

FIG. 31 depicts a cross-sectional view of a vaporizer device 3100 according to some implementations. The inductor 3143 can be at least partially surrounded by the flux concentrator 3101. The flux concentrator 3101 comprises a first segment 3190 positioned around the outer surface of the inductor 3143 and a second 3191 and a third segment 3192 extending toward the receptacle 3159, primarily perpendicular to the first segment 3190. The second and third segments extend the width of the inductor 3143.

FIG. 32 depicts a cross-sectional view of a vaporizer device 3200 according to some implementations. The flux concentrator 3201 comprises a first segment 3290 positioned around the outer surface of the inductor 3243 and a second 3291 and a third segment 3292 extending toward the receptacle 3259, primarily perpendicular to the first segment 3290. The second 3291 and third segments 3292 can extend almost entirely to the receptacle 3259.

FIG. 33 depicts a cross-sectional view of a vaporizer device 3300 according to some implementations. In some implementations, the inductor 3343 can be almost as long as the receptacle 3359. A larger inductor 3343 can result in higher coupling and higher efficiency of the vaporizer device 3300. The flux concentrator 3301 comprises a first segment 3390 positioned around the outer surface of the inductor and a second 3391 and a third segment 3392 extending toward the receptacle 3359, primarily perpendicular to the first segment 3390. The second 3391 and third segments 3392 can extend almost entirely to the receptacle 3359.

FIG. 34 depicts a cross-sectional view of a vaporizer device 3400 according to some implementations. In some implementations, the inductor 3443 can be longer than the receptacle 3459. The flux concentrator 3401 comprises a first angled segment 3493 extending from the second segment 3491 towards the receptacle 3459, the first angled segment 3493 can be configured to direct the magnetic field toward the receptacle. The first angled segment 3493 extends in a direction that is orthogonal to the longitudinal axis of the first segment. The flux concentrator 3401 can comprise a second angled segment 3494 extending from the third segment 3492 towards the receptacle 3459, the second angled segment 3494 configured to direct the magnetic field toward the receptacle 3459, wherein the second angled segment 3494 extends in a direction that is orthogonal to the longitudinal axis of the first segment 3490.

FIG. 35 depicts a cross-sectional view of a vaporizer device 3500 according to some implementations. In some implementations, the inductor 3543 can be longer than the receptacle 3559. The flux concentrator 3501 comprises a first angled segment 3593 extending from the second segment 3591 towards the receptacle 3559, the first angled segment 3593 can be configured to direct the magnetic field toward the receptacle 3559. Compared to FIG. 34, the aperture size between the receptacle 3559 and the first angled segment 3593 can be larger. The first angled segment 3593 extends in a direction that is orthogonal to the longitudinal axis of the first segment 3590. The flux concentrator 3501 can comprise a second angled segment 3594 extending from the third segment 3592 towards the receptacle 3559, the second angled segment 3594 can be configured to direct the magnetic field toward the receptacle 3559, wherein the second angled segment 3594 extends in a direction that is orthogonal to the longitudinal axis of the first segment. Compared to FIG. 34, the aperture size between the receptacle/susceptor and the second angled segment can be larger.

In some implementations, the first angled segment can extend in a direction that is greater than 90 degrees relative to the longitudinal axis of the first segment. In some implementations, the first angled segment can extend in a direction that is less than 90 degrees relative to the longitudinal axis of the first segment. In some implementations, the second angled segment can extend in a direction that is greater than 90 degrees relative to the longitudinal axis of the first segment. In some implementations, the second angled segment can extend in a direction that is less than 90 degrees relative to the longitudinal axis of the first segment.

FIG. 36 depicts a cross-sectional view of a vaporizer device 3600 according to some implementations. The flux concentrator 3601 comprises a first additional segment 3693 extending from the second segment 3691 in a direction parallel to the longitudinal axis of the first segment 3690, the first additional segment 3693 can be configured to direct the magnetic field away from the receptacle 3659. The flux concentrator 3601 can comprise a second additional segment 3694 extending from the third segment 3692 in a direction parallel to the longitudinal axis of the first segment 3690, the second additional segment 3694 can be configured to direct the magnetic field away from the receptacle 3659.

In some implementations, the heating element can be a susceptor, and the susceptor can be made of aluminum. In some implementations, there is infrared reflective material that can be made of aluminum. In some implementations, the flux concentrator is made of nanocrystals or a material comprising nanocrystals. In some implementations, the inductor is a litz coil. For each of the previous figures, especially FIGS. 30-36, a person skilled in the art would appreciate that the susceptor, flux concentrator, and inductor can be other materials and therefore are not limited to what is illustrated.

To ensure a pleasant and consistent smoking experience, the cartridge should be accurately situated within the vaporizer body. Misaligned or incomplete insertion of a cartridge into the receptacle of a vaporizer device and often to improper heating, incomplete use of the cartridge, or overall failure of the device. As a result, the user can experience a poor smoking experience. Certain features can be implemented to ensure that a cartridge is fully and properly inserted into the receptacle of a vaporizer body. The features must account for incomplete loading of the cartridge, movement of the cartridge while loaded, misaligned cartridge within the receptacle, and obstructed airflow. In some implementations, a plurality of protrusions within the receptacle can minimize and eliminate many of these shortcomings.

As illustrated in FIG. 37A-37C, a cross-section of a vaporizer device is illustrated from different angles, according to some implementations. As pictured in FIG. 37A, the vaporizer body 3710 can have a receptacle 3718 for receiving a cartridge (not shown). A plurality of first protrusions 3741 can extend from at least one side wall 3740 and toward the receptacle 3718 and/or opening 3742. The plurality of protrusions 3741 can be positioned distal from the base 3744 of the frame 3743 of the vaporizer body 3710 and around the opening 3742 of the vaporizer body 3710. A plurality of second protrusions 3755 can extend from the base 3744 toward the receptacle 3718. In some implementations, at least one of the second protrusions 3755 extends along the sidewall 3740 of the frame 3743. The first plurality of protrusions 3741 and the second plurality of protrusions 3755 can be visualized from the top view of FIG. 37B.

As the cartridge is inserted into the opening 3742 of the vaporizer body 3710, the first end of the cartridge engages with the second protrusions 3755 at the base 3744 of the vaporizer body 3710. Once the cartridge engages with the second protrusions 3755, there can be a distance “D” between the end of the cartridge and the base 3744 of the frame 3743, as illustrated in FIG. 37C. Two or more of the second protrusions 3755 can form a channel 3760 between them to direct airflow toward the base 3744. Air is drawn into the receptacle which enters the cartridge through the cartridge end positioned toward the base 3744 of the vaporizer body 3710. The first and/or second plurality of protrusions can secure the cartridge into place within the receptacle 3718 and minimize movement of the cartridge while in use. The second plurality of protrusions 3755 can ensure that an airflow path is created through the vaporizer device.

In many devices, the user's first puff, or first few puffs, can be inconsistent compared to subsequent puffs as a result from delayed heating of the internal components of the cartridge. As the device and its components take time to warm, variations in the vaporized material can result. Modifications can be made to the cartridge to improve the heating of the vaporizable material and resulting smoking experience of the first few puffs. For example, the cartridge can contain an additional component, such as a core, configured to sit within the vaporizable material.

The core can increase the surface area in contact with the vaporizable material in the top region of the cartridge while compressing the vaporizable material in the top region toward the walls of the cartridge. As a result, the vaporizable material can heat more efficiently thereby improving the vapor delivered in the initial puffs.

The core can have a variety of configurations. In some implementations, the core has a base structure. Additionally, the core can have a flange positioned at or proximate to an end (e.g., open end) of the base structure, e.g., extending radially outward from the end of the base structure. The flange can be configured to help engage the core with a divider of the cartridge. When the core is inserted into the cartridge, the base structure can at least partially extend into a volume defined within the cartridge, e.g., the volume defined within the heating element, where the volume is configured to hold vaporizable material. As a result, when vaporizable material is present, at least a top portion of the vaporizable material is in proximity to the core (e.g., between the base structure 4690 and the inner wall of the heating element 4684 as illustrated in FIG. 46), and therefore the vaporizable material can be heated faster and more efficiently.

In some implementations, the base structure can be conical, round, or oval shaped. A person skilled in the art will appreciate that the overall shape of the core can be changed to effect desired heating characteristics. Further, the base structure can include a plurality of holes extending therethrough, in which the plurality of holes allows vapor to passthrough.

FIG. 46 illustrates an exemplary cartridge 4620 having a wrapper 4621 and a heating element 4642 disposed within the wrapper 4621, in which the heating element 4642 defines a volume 4622 within the cartridge 4620 configured to hold vaporizable material (not shown). The cartridge 4620 also includes a divider 4654 and a core 4694 that engages the divider 4654, wherein the core at least partially extends into the volume 4622 defined by the heating element 4642.

In the illustrated implementation, the core 4694 has a base structure 4690 and a flange 4692 extending from an end 4693 of the base structure 4690. The base structure 4690 can extend through the divider 4654 such that the flange 4692 can be positioned on the top surface 4682 of the divider 4654. As shown, the base structure 4690 further extends into the volume 4622 defined by the heating element 4642. The length of extension of the base structure 4690 into the volume can vary. In this illustrated implementation, the base structure 4690 does not extend past a top region 4659 of the heating element 4642. As depicted, the base structure 4690 has a plurality of holes 4693 to permit airflow through the core 4694. In some implementations, the core can hold vaporizable material, which can be the same or different than the vaporizable material within the volume of the heating element and outside of the core.

Within a vaporizer device, magnetic backing materials of inductive coils and magnetic shielding flux concentrators can become saturated or otherwise affected by external magnetic field(s) (e.g., magnetic field(s) generated outside the vaporizer device). Generally, magnetic saturation occurs in magnetic materials (e.g., magnetically permeable materials within an inductive coil) when an increase in an applied magnetic field cannot further increase the magnetization of the material, causing the total magnetic flux density to level off Even if saturation does not occur, an external magnetic field can change the inductive coil characteristics (e.g., inductance or other electrical properties). And because a flux concentrator (e.g., a nanocrystalline flux concentrator) has a permeability for direct current (DC) magnetic fields, an external DC exciting magnetic field can shift the alternating current (AC) operating point of an inductive coil. The effects of the external magnetic field on the magnetic components of the vaporizer device can cause problems with measuring circuit parameters (e.g., resistance), and, hence, temperatures in the vaporizer device (e.g., a temperature of a heating element).

To mitigate the effects of external magnetic fields, one or more sensors can be implemented within the vaporizer device. These one or more sensors can be placed near an inductor (e.g., inductor coil) and/or flux concentrator to detect a presence of an external magnetic field or of other magnetic irregularities (e.g., a mechanical failure). In some implementations, the one or more sensors can be physically coupled to or otherwise placed in close proximity to a flux concentrator. The one or more sensors can include, for example, a Hall effect sensor, a magnetoresistive sensor (e.g., a giant magnetoresistance (GMR), a tunnel magnetoresistance (TMR) sensor, or the like), a fluxgate sensor, an inductive sensor (e.g., a coil with one or more windings, for example, about the flux concentrator of the vaporizer device), any other type of sensor capable of detecting a magnetic field or any combination thereof.

A Hall effect sensor can be used to sense current in the windings of the inductive coil. A Hall effect sensor can incorporate one or more elements that produces a voltage in response to an axial component of a magnetic field using the Hall effect. The Hall effect sensor can be a single-axis or multi-axis Hall effect sensor. The Hall effect sensor can be provided as an integrated circuit.

A fluxgate sensor can include a ring core with one or more coil windings (e.g., a drive winding and a sense winding) wrapped around the core. When no external field is applied, the two half-cores come into and out of saturation at the same time. But when an external field is applied, the two half-cores come out of saturation at different times, causing changes in flux which induce voltages. The fluxgate sensor can be an integral core or an external core sensor.

The one or more sensors can be configured to provide DC field sensing and/or AC field sensing. DC field sensing can detect a magnitude and/or an angle of an external magnetic field and can be used to determine a location of a source of the external magnetic field (e.g., as shown in FIG. 47C). AC field sensing can also be able to detect a magnitude and/or an angle of an external magnetic field, and be able to sense leakage of the field through the flux concentrator (e.g., as shown in FIG. 47B).

As noted above, the one or more sensors can be placed in a plurality of locations within a vaporizer device, consistent with implementations of the current subject matter. For example, as shown in FIGS. 47A-47C, vaporizer device 4700 (illustrated as a dash-dashed box) can include one or more inductors 4743 (e.g., one or more inductive coils), a flux concentrator 4748 in proximity thereto, and one or more of the foregoing sensors 4703 (i.e., one or more sensors configured to provide DC field sensing and/or AC field sensing) positioned in proximity to the flux concentrator 4748. In other aspects, the one or more foregoing sensors can be placed at another location within the vaporizer device that allows the one or more sensors to detect an external magnetic field.

As shown in FIG. 47A, a magnetic field is produced by the one or more inductors 4743, however, there is no presence of an external magnetic field and thus, no magnetic field effect on the one or more inductors 4743 and/or flux concentrator 4748. FIG. 47B illustrates where there is significant leakage of the magnetic field produced by the one or more inductors 4743, and in such instances, the one or more sensors 403 are configured to detect the saturation event. In FIG. 47C, although external magnetic field 4701 is present (via a magnetic field source 4707), saturation is not present as there is less leakage of the inductor's magnetic field 4705 when compared with FIG. 47B. In either of these implementations, the vaporizer device 4700 can engage a failsafe mechanism. For example, the failsafe can cause the vaporizer device to shift from a temperature profile to a power profile. In some implementations, the failsafe can cause a session to end when saturation is detected.

### Terminology

It will be appreciated that the terms “proximal” and “distal” are used herein to refer to relative locations of the referenced devices and/or components. Although “proximal” is generally used to refer to a location that is at or near a user when the device and/or component is in use, and “distal” is generally used to refer to a location that is away from a user when the device and/or component is in use, these terms are not intended to be absolute. For example, a “proximal” end and/or a “distal” end of a component need not be the absolute furthest points on the referenced ends, and can instead refer to a general region at or near the referenced end. Further, opposing “proximal” ends and “distal” ends of a component need not be completely and/or perfectly opposite each other, as the shapes of each end can differ and/or the component can not be perfectly linear (e.g., one or more longitudinal dimensions of the component can be of different lengths).

When a feature or element is herein referred to as being “on” another feature or element, it can be directly on the other feature or element or intervening features and/or elements can also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements can be present. In contrast, when a feature or element is referred to as being “directly connected”, “directly attached” or “directly coupled” to another feature or element, there are no intervening features or elements present.

Although described or shown with respect to one implementation, the features and elements so described or shown can apply to other implementations. It will also be appreciated by those of skill in the art that references to a structure or feature that is disposed “adjacent” another feature can have portions that overlap or underlie the adjacent feature.

Terminology used herein is for the purpose of describing particular implementations and implementations only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and can be abbreviated as “/”.

In the descriptions above and in the claims, phrases such as “at least one of” or “one or more of” can occur followed by a conjunctive list of elements or features. The term “and/or” can also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device can be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” can be used herein to describe various features/elements (including steps), these features/elements should not be limited by these terms, unless the context indicates otherwise. These terms can be used to distinguish one feature/element from another feature/element. Thus, a first feature/element discussed below could be termed a second feature/element, and similarly, a second feature/element discussed below could be termed a first feature/element without departing from the teachings provided herein.

As used herein in the specification and claims, including as used in the examples and unless otherwise expressly specified, all numbers can be read as if prefaced by the word “about” or “approximately,” even if the term does not expressly appear. The phrase “about” or “approximately” can be used when describing magnitude and/or position to indicate that the value and/or position described is within a reasonable expected range of values and/or positions. For example, a numeric value can have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative implementations are described above, any of a number of changes can be made to various implementations without departing from the teachings herein. For example, the order in which various described method steps are performed can often be changed in alternative implementations, and in other alternative implementations one or more method steps can be skipped altogether. Optional features of various device and system implementations can be included in some implementations and not in others. Therefore, the foregoing description is provided primarily for exemplary purposes and should not be interpreted to limit the scope of the claims.

One or more implementations or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various implementations or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The examples and illustrations included herein show, by way of illustration and not of limitation, specific implementations in which the subject matter can be practiced. As mentioned, other implementations can be utilized and derived there from, such that structural and logical substitutions and changes can be made without departing from the scope of this disclosure. Such implementations of the inventive subject matter can be referred to herein individually or collectively by the term “invention” merely for convenience and without intending to voluntarily limit the scope of this application to any single invention or inventive concept, if more than one is, in fact, disclosed. Thus, although specific implementations have been illustrated and described herein, any arrangement calculated to achieve the same purpose can be substituted for the specific implementations shown. This disclosure is intended to cover any and all adaptations or variations of various implementations. Combinations of the above implementations, and other implementations not specifically described herein, will be apparent to those of skill in the art upon reviewing the above description.

1. A vaporizer device for generating an inhalable aerosol, the vaporizer device comprising:
a cartridge comprising:
a heating element having a first region and a second region, the heating element including one or more cut-out regions between the first region and the second region; and
a vaporizable material having a first portion and a second portion; and
a vaporizer body comprising:
a receptacle configured to insertably receive at least a portion of the cartridge;
at least one first inductive coil configured to generate a first magnetic and/or electromagnetic field to heat the first region of the heating element to generate a vapor from the first portion of the vaporizable material;
at least one second inductive coil configured to generate a second magnetic and/or electromagnetic field to heat the second region of the heating element to generate a vapor from the second portion of the vaporizable material; and
a controller configured to independently apply power to the at least one first inductive coil and the at least one second inductive coil.

2. The vaporizer device of claim 1, wherein the vaporizer body further comprises a holder assembly at least partially defining the cartridge receptacle.

3. The vaporizer device of claim 2, wherein the at least one first inductive coil and the at least one second inductive coil are disposed on an exterior of the holder assembly, and wherein the cartridge receptacle is interior to the holder assembly.

4. The vaporizer device of claim 1, wherein the at least one first inductive coil and the at least one second inductive coil are affixed to the holder assembly.

5. The vaporizer device of claim 1, wherein the holder assembly extends parallel to a longitudinal axis of the vaporizer body.

6. The vaporizer device of claim 1, wherein the at least one first inductive coil and the at least one second inductive coil are disposed proximate opposing ends of the receptacle.

7. The vaporizer device of claim 1, wherein the at least one first inductive coil comprises a helical coil surrounding a first region of the cartridge receptacle.

8. The vaporizer device of claim 1, wherein the at least one second inductive coil comprises a pair of coils proximate opposing long sides of the vaporizer body.

9. The vaporizer device of claim 1, wherein the at least one first inductive coil extends perpendicular to a longitudinal axis of the vaporizer body and the at least one second inductive coil extends parallel to a longitudinal axis of the vaporizer body.

10. The vaporizer device of claim 1, wherein the at least one second inductive coil is flattened and defines an open center region.

11. The vaporizer device of claim 10, wherein the vaporizer body further comprises a sensor disposed at least partially within the open center region.

12. The vaporizer device of claim 1, wherein the sensor comprises a temperature sensor configured to detect a temperature of the at least one second inductive coil.

13. The vaporizer device of claim 12, wherein the controller is configured to apply power to the at least one second inductive coil based on the detected temperature.

14. The vaporizer device of claim 1, wherein the vaporizer body further comprises an external shell and one or more flux concentrators, wherein the one or more flux concentrators are disposed between the at least one first inductive coil and the external shell, and wherein the one or more flux concentrators are disposed between the at least one second inductive coil and the external shell.

15. The vaporizer device of claim 1, wherein the vaporizer body further comprises one or more ridges configured to hold the cartridge within the cartridge receptacle.

16. The vaporizer device of claim 15, wherein the holder assembly comprises the one or more ridges, and wherein the one or more ridges comprise a first set of ridges proximate a first end of the holder assembly and a second set of ridges proximate a second end of the holder assembly.

17. The vaporizer device of claim 16, wherein the first set of ridges form a space for air to enter the cartridge receptacle.

18. The vaporizer device of claim 16, wherein the second set of ridges form a space for air to enter the cartridge.

19. The vaporizer device of claim 1, wherein the heating element at least partially defines an interior volume configured to hold the vaporizable material.

20. The vaporizer device of claim 1, wherein the first region of the heating element comprises an electrically conductive top region, wherein the second region of the heating element comprises an electrically conductive bottom region.

21. The vaporizer device of claim 20, wherein the one or more cut-out regions comprise a first cut-out region is defined within a first side of the heating element and a second cut-out region defined within a second side of the heating element, the first side of the heating element opposing the second side of the heating element along a width or a depth of the heating element.

22. The vaporizer device of claim 21, wherein the cut-out region is configured to reduce heat transferred between the top region and the bottom region of the heating element and/or reduce current flow between the top region and the bottom region of the heating element.

23. The vaporizer device of claim 20, wherein when the cartridge is inserted into the cartridge receptacle, the top region is disposed proximate the at least one first inductive coil and the bottom region is disposed proximate the at least one second inductive coil.

24. The vaporizer device of claim 20, wherein the controller is configured to heat the top region of the heating element to a first temperature at a first time, and the controller is further configured to heat the bottom region of the heating element to a second temperature at a second time, wherein the first temperature is higher than the second temperature and the second time is after the first time.

25. The vaporizer device of claim 24, wherein the first temperature is at or below 270 degrees Celsius, wherein the second temperature is at or above 170 degrees Celsius, and wherein the second time is at least 20 seconds after the first time.

26. The vaporizer device of claim 24, wherein the controller is further configured to heat the top region of the heating element to a third temperature at a third time, and the controller is further configured to heat the bottom region of the heating element to a fourth temperature at a fourth time, wherein the first temperature is higher than the third temperature and the fourth temperature is higher than the second temperature, and wherein the third time is after the first time and the fourth time is after the second time.

27. The vaporizer device of claim 26, wherein the third temperature is at least 15 degrees Celsius colder than the first temperature, wherein the fourth temperature is at least 5 degrees Celsius hotter than the second temperature, wherein the third time is at least 20 seconds after the first time, and wherein the fourth time is at least 20 seconds after the second time.

28. The vaporizer device of claim 1, wherein the heating element comprises a susceptor configured to generate heat via eddy currents.

29. The vaporizer device of claim 1, wherein the heating element comprises a metal layer and at least one layer of paper.

30. The vaporizer device of claim 1, wherein the first magnetic and/or electromagnetic field opposes and/or is orthogonal to the second magnetic and/or electromagnetic field.

31.-429. (canceled)
